(19) United States
(12) Patent Application Publication
(10) Pub. No.: US 2019/0391418 A1
(43) Pub. Date: Dec. 26, 2019

(54) LIQUID CRYSTAL DISPLAY DEVICE

(71) Applicant: DIC Corporation, Tokyo (JP)

(72) Inventors: Hidehiko Yamaguchi, Kita-adachi-gun (JP); Shinji Ogawa, Kita-adachi-gun (JP); Takayuki Miki, Sakura-shi (JP); Minoru Tabuchi, Sakura-shi (JP)

(73) Assignee: DIC Corporation, Tokyo (JP)

(21) Appl. No.: 16/465,323

(22) PCT Filed: Dec. 4, 2017
(86) PCT No.: PCT/JP2017/043431

§ 371 Date: May 30, 2019

(30) Foreign Application Priority Data
Dec. 5, 2016 (JP) 2016-235828

(51) Int. Cl. G02F 1/13; G02F 1/1335; G02F 1/1337; G02F 1/1362; C09K 19/04; C08L 33/14; C08K 3/28; C08K 3/34

(52) U.S. Cl. CPC G02F 1/1303; G02F 1/133528; G02F 1/1337; G02F 1/136277; C09K 19/0403; C09K 19/3852; C08K 3/28; C08K 3/34; G02F 1/133512; G02F 2202/36; C09K 2019/0411; C08L 33/14

(57) ABSTRACT

The liquid crystal display device includes a pair of substrates consisting of first and second substrates arranged to face each other, a liquid crystal layer sandwiched between the first and second substrates, a pixel electrode disposed on at least one of the first and second substrates, a common electrode disposed on at least one of the first and second substrates, a light source section including a light-emitting element, and a photoconversion layer including pixels of three primary colors consisting of red (R), green (G), and blue (B). The photoconversion layer contains a light-emitting nanocrystal having an emission spectrum of any of red (R), green (G), and blue (B) upon receiving light emitted from the light source section on at least one of the three primary colors. The liquid crystal layer contains a liquid crystal composition containing a compound represented by General Formula (i) at 10% to 50% by mass.

### TECHNICAL FIELD

The present invention relates to a liquid crystal display device.

### BACKGROUND ART

Active-matrix liquid-crystal display apparatuses, which offer excellent display quality, have been on the portable terminal market, the liquid-crystal display television market, the projection display market, the computer market, and the like. In an active-matrix display mode, each pixel includes a TFT (thin-film transistor), an MIM (metal-insulator-metal), or the like. An active-matrix display mode has been widely used for common liquid crystal display devices, such as TN (twisted nematic)-mode liquid crystal display devices, in combination with a liquid crystal composition having a high voltage holding ratio. VA (vertical alignment)-mode liquid crystal display devices, IPS (in-plane switching)-mode liquid crystal display device s, FFS (fringe field switching)-mode liquid crystal display devices, which are improved IPS-mode liquid crystal display devices, and the like have been used to achieve further wide viewing angles. In order to address these liquid crystal display devices, novel liquid crystal compounds and liquid crystal compositions are being proposed.

Since liquid crystal display devices are not capable of emitting light by themselves, liquid crystal display devices need to include a light source in order to emit light. White light sources that have an emission spectrum in the color reproduction area required for displays are used. Examples of the light sources include a cold-cathode tube and a white LED (light-emitting diode); today, white LEDs are commonly used in consideration of luminous efficiency. Since it is not possible to cover the entire range of wavelengths of visible light, which ranges from 380 to 750 nm, by using only one LED element, various methods for producing white light are known.

1) Using a blue LED and a yellow phosphor in combination

2) Using LEDs of the three primary colors (red, green, and blue) in combination

3) Using a near-ultraviolet or violet LED and red, green, and blue phosphors in combination

Among the above three methods, the method 3) is the best for producing white light most suitable as a light source for liquid crystal display devices, followed by 2) and 1). When importance is placed on luminous efficiency, the method 1) is the best.

Reducing power consumption is important in liquid crystal display devices. Importance is placed on the luminous efficiencies of light sources in order to address the power saving campaigns studied in the developed countries. Therefore, today, white light is produced by the method 1), in which a blue LED and a yellow phosphor are used in combination.

This method is superior in terms of luminous efficiency but inferior in terms of properties of a white light source, because, for example, shortage of red light may occur. In other words, this method is unsatisfactory in terms of color reproducibility. In particular, since liquid crystal display devices include a color filter in addition to liquid crystal elements in order to achieve color display, it is even difficult to enhance color reproducibility by improving the light source section. Thus, for enhancing color reproducibility, it has been necessary to increase color purity by increasing the pigment concentration in a color filter or increasing the thickness of a color film. However, in such a case, transmittance is reduced. This results in a necessity to increase the amount of light emitted and an increase in power consumption.

Accordingly, attention is being focused on quantum dot technology (see PTL 1), which is an example of light-emitting nanocrystals and enables the improvement of the color reproducibility of a liquid crystal display device and an increase in the luminous efficiency of the liquid crystal display device to be both achieved. Quantum dots are constituted by semiconductor microcrystals having a particle size of a few nanometers to several tens of nanometers and have discrete energy levels due to confinement of electron-hole pairs. The smaller the particle size, the larger the energy band gap. Using this property, a light source having an emission spectrum with a small half-width can be produced by controlling the particle size and reducing variations in band gap. There has been disclosed a technique in which, since producing a trichromatic light source having a small half-width enables the production of wide-color gamut displays, a liquid crystal display device having enhanced color reproducibility is produced by using quantum dots as a component of a backlight (see PTL 2 and NPL 1). There has also been proposed a technique in which trichromatic quantum dots are used instead of the color filters that have been used in the related art while short-wavelength visible light, such as near-ultraviolet radiation or blue light, is used as a light source (see PTL 3). In theory, the above display elements are considered capable of achieving both high luminous efficiency and high color reproducibility.

### CITATION LIST

### Patent Literature

PTL 1: Japanese Unexamined Patent Application Publication (Translation of PCT Application) No. 2001-523758
PTL 2: International Publication No. 2004/074739
PTL 3: U.S. Pat. No. 8,648,524

### Non Patent Literature

NPL 1: SID 2012 DIGEST, pp. 895-896

### SUMMARY OF INVENTION

### Technical Problem

In the case where quantum dots, which are an example of light-emitting nanocrystals, are used for producing liquid crystal display devices as described above, that is, as in PTL 2, PTL 3, and NPL 1, it becomes necessary to use a visible light source that emits short-wavelength light or ultraviolet light as a light source for causing excitation of the quantum dots. Consequently, light that passes through the liquid crystal layer is primarily short-wavelength light unlike in the case where white light is used as in the related art.

Further details follow below. Since short-wavelength visible light and ultraviolet light that are used as a light source for causing light-emitting nanocrystals to emit light are high-energy light beams, the liquid crystal layer, which serves as an optical switch, is required to be capable of withstanding a long period of exposure to the high-energy light. In particular, it has been confirmed that exposing a liquid crystal layer to a high-energy light beam, such as short-wavelength visible light or ultraviolet light, may result in, for example, decomposition of the liquid crystal material.

Accordingly, an object of the present invention is to provide a liquid crystal display device that includes a photoconversion layer containing light-emitting nanocrystals instead of a color filter and reduces or prevents the degradation of the liquid crystal layer which may be caused due to irradiation of a high-energy light beam while achieving a high luminous efficiency and high color reproducibility.

### Solution to Problem

The inventors of the present invention conducted extensive studies in order to address the above issues and, consequently, found that the issues may be addressed by using a liquid crystal layer containing a particular liquid crystal compound for producing a liquid crystal display device that includes light-emitting nanocrystals, such as quantum dots, serving as a color filter. Thus, the present invention was made.

### Advantageous Effects of Invention

The liquid crystal display device according to the present invention is resistant to degradation even when a high-energy light beam, such as short-wavelength visible light or ultraviolet light is used and capable of maintaining the color reproduction area over a prolonged period of time.

The liquid crystal display device according to the present invention has an excellent transmittance and is capable of maintaining the color reproduction area over a prolonged period of time.

### BRIEF DESCRIPTION OF DRAWINGS

FIG. 1 is a perspective view of a liquid crystal display device according to an embodiment of the present invention.

FIG. 2 is a perspective view of a liquid crystal display device according to another embodiment of the present invention.

FIG. 3 is a perspective view of a liquid crystal display device according to another embodiment of the present invention.

FIG. 4 is a perspective view of a liquid crystal display device according to another embodiment of the present invention.

FIG. 5 is a schematic cross-sectional view of the liquid crystal display devices illustrated in FIGS. 1 to 4 which is taken along the line I-I, illustrating an example of a photoconversion layer included in a liquid crystal display device according to the present invention.

FIG. 6 is a schematic cross-sectional view of the liquid crystal display devices illustrated in FIGS. 1 to 4 which is taken along the line I-I, illustrating another example of a photoconversion layer included in a liquid crystal display device according to the present invention.

FIG. 7 is a schematic cross-sectional view of the liquid crystal display devices illustrated in FIGS. 1 to 4 which is taken along the line I-I, illustrating another example of a photoconversion layer included in a liquid crystal display device according to the present invention.

FIG. 8 is a schematic cross-sectional view of the liquid crystal display devices illustrated in FIGS. 1 to 4 which is taken along the line I-I, illustrating another example of a photoconversion layer included in a liquid crystal display device according to the present invention.

FIG. 9 is a schematic cross-sectional view of the liquid crystal display devices illustrated in FIGS. 1 to 4 which is taken along the line I-I, illustrating another example of a photoconversion layer included in a liquid crystal display device according to the present invention.

FIG. 10 is a schematic cross-sectional view of the liquid crystal display devices illustrated in FIGS. 1 to 4 which is taken along the line I-I, illustrating another example of a photoconversion layer included in a liquid crystal display device according to the present invention.

FIG. 11 is a schematic cross-sectional view of the liquid crystal display devices illustrated in FIGS. 1 to 4 which is taken along the line I-I, illustrating another example of a photoconversion layer included in a liquid crystal display device according to the present invention.

FIG. 12 is a schematic diagram illustrating pixels included in a liquid crystal display device according to the present invention as an equivalent circuit.

FIG. 13 is a schematic diagram illustrating an example of the shape of a pixel electrode according to the present invention.

FIG. 14 is a schematic diagram illustrating an example of the shape of a pixel electrode according to the present invention.

FIG. 15 is a schematic diagram illustrating the structure of electrodes included in an IPS-mode liquid crystal display device according to the present invention.

FIG. 16 is an example of a cross-sectional view of the liquid crystal display device illustrated in FIG. 2 which is taken along the line III-III illustrated in FIG. 13 or 14.

FIG. 17 is a cross-sectional view of an IPS-mode liquid crystal panel which is taken along the line III-III illustrated in FIG. 15.

FIG. 18 is an enlarged plan view of a region of the electrode layer 3, which is disposed on a substrate and includes a thin-film transistor, illustrated in FIG. 3 or 4 which is surrounded by the line II.

FIG. 19 is a cross-sectional view of the liquid crystal display device illustrated in FIG. 3 or 4 which is taken in the direction of the line III-III illustrated in FIG. 18.

FIG. 20 is a schematic diagram illustrating an example of a photoconversion layer 6.

FIG. 21 is a schematic diagram illustrating an example of a photoconversion layer 6.

FIG. 22 is a schematic diagram illustrating an example of a photoconversion layer 6.

FIG. 23 is a diagram illustrating the emission spectrum of quantum dots.

### DESCRIPTION OF EMBODIMENTS

The first aspect of the present invention relates to a liquid crystal display device including a pair of substrates consisting of first and second substrates arranged to face each other; a liquid crystal layer sandwiched between the first and second substrates; a pixel electrode disposed on at least one of the first and second substrates; a common electrode disposed on at least one of the first and second substrates; a light source section including a light-emitting element; and a photoconversion layer including pixels of three primary colors consisting of red (R), green (G), and blue (B), the photoconversion layer containing a light-emitting nanocrystal that has an emission spectrum of any of red (R), green (G), and blue (B) upon receiving light emitted from the light source section on at least one of the three primary colors.

The liquid crystal layer contains a liquid crystal composition containing a compound represented by General Formula (i) in an amount of 10% to 50% by mass.

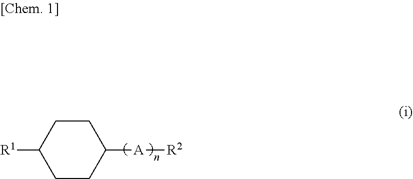

(in Formula (i), R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; A represents a 1,4-phenylene group or a trans-1,4-cyclohexylene group; and n represents 0 or 1)

In the present invention, a liquid crystal layer having a particular structure is used. This enables the production of a highly reliable liquid crystal display device that includes a liquid crystal layer capable of withstanding a long period of exposure to a high-energy light beam, such as short-wavelength visible light or ultraviolet light, used as a light source.

The light-emitting element is preferably a light-emitting element that emits ultraviolet or visible light.

First, a suitable liquid crystal display device according to the present invention is described below with reference to the attached drawings. Subsequently, each of the components of the liquid crystal display device is described.

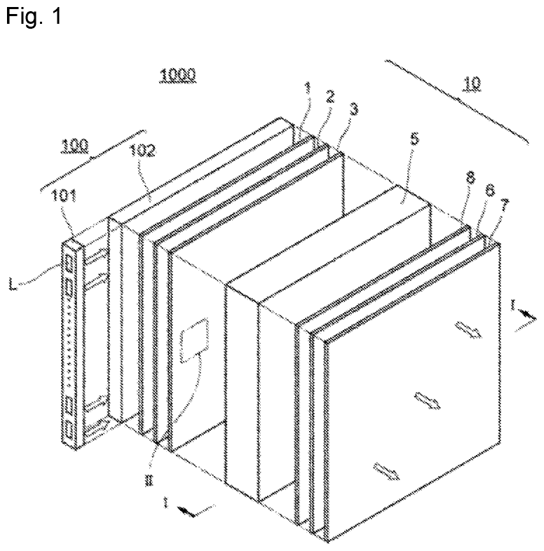

FIG. 1 is a perspective view of the entirety of an example of the liquid crystal display device used in this embodiment. In FIG. 1, the components are separated from one another for illustrative purposes.

A liquid crystal display device 1000 according to the present invention includes a backlight unit 100 and a liquid crystal panel 10. The backlight unit 100 includes a light source section 101 that includes light-emitting elements L. The backlight unit 100 also includes a light guide section 102 that serves as a light guide plate (not illustrated) or a light diffusion plate (not illustrated). As illustrated in FIG. 1, in the backlight 100 according to an embodiment, the light source section 101 includes a plurality of light-emitting elements L and is disposed on one of the side surfaces of the light guide section 102. As needed, the light source section 101 including a plurality of light-emitting elements L may be disposed on not only one of the side surfaces of the liquid crystal panel 10 (one of the side surfaces of the light guide section 102) but also the other side surface of the liquid crystal panel 10 (two opposing side surfaces). Alternatively, the light source section 101 including a plurality of light-emitting elements L may be disposed on three side surfaces of the light guide section 102 so as to surround the periphery of the light guide section 102. In another case, the light source section 101 including a plurality of light-emitting elements L may be disposed on four side surfaces of the light guide section 102 so as to surround the entire periphery of the light guide section 102. The light guide section 102 may optionally include a light diffusion plate (not illustrated) instead of a light guide plate.

The liquid crystal panel 10 illustrated in FIG. 1 includes a first (transparent, insulating) substrate 2 provided with a polarizing layer 1 disposed on a surface of the first substrate 2 and an electrode layer 3 disposed on the other surface of the first substrate 2. The liquid crystal panel 10 also includes a second (transparent, insulating) substrate 7 arranged to face the first substrate 2 across a liquid crystal layer 5. The substrate 7 is provided with a photoconversion layer (i.e., a color layer) 6 and a polarizing layer 8 disposed on the substrate 7 in this order. The photoconversion layer (color layer) 6 includes pixels of three primary colors consisting of red (R), green (G), and blue (B). At least one of the pixels of three primary colors contains light-emitting nanocrystals that have an emission spectrum of any of red (R), green (G), and blue (B) upon receiving light from the light source section.

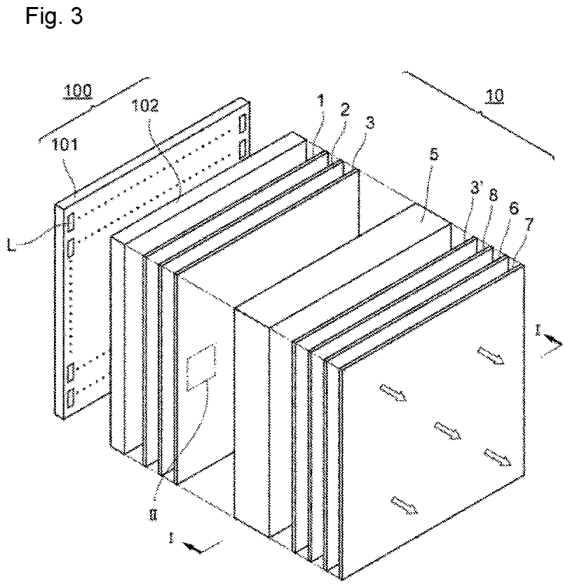

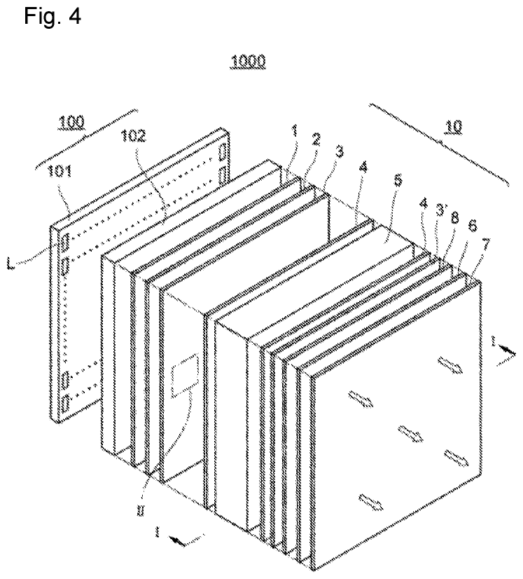

Although a pixel electrode (not illustrated) and a common electrode (not illustrated) are disposed on the first substrate 2 as an electrode layer 3 in the embodiment illustrated in FIG. 1, a pixel electrode may be disposed on the first substrate 2 and a common electrode 3′ may be disposed on the second substrate 7 in another embodiment (e.g., FIGS. 3 and 4).

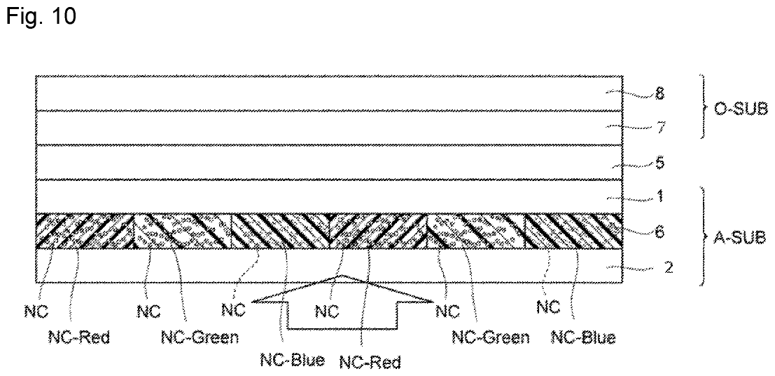

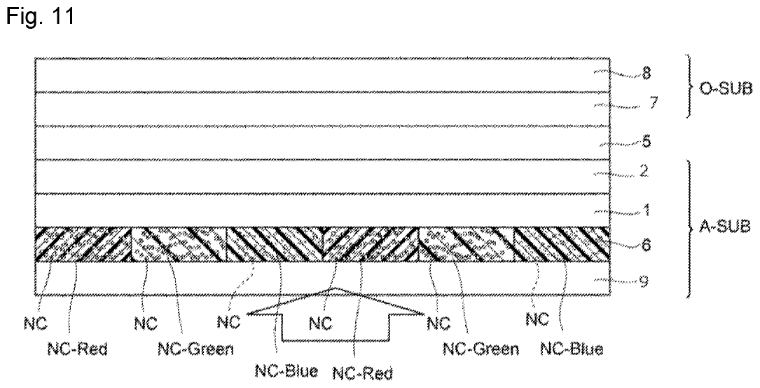

Although the photoconversion layer 6 is interposed between the second substrate 7 and the liquid crystal layer 5 in FIG. 1, a liquid crystal display device according to another embodiment of the present invention may be a color-filter-on-array (COA)-type element as illustrated in FIGS. 10 and 11. In such a case, the photoconversion layer 6 may be interposed between the electrode layer 3 and the liquid crystal layer 5 or between the electrode layer 3 and the first substrate 2. Optionally, an overcoat layer (not illustrated) may be arranged to cover the photoconversion layer 6 in order to prevent the discharge of substances contained in the photoconversion layer into the liquid crystal layer.

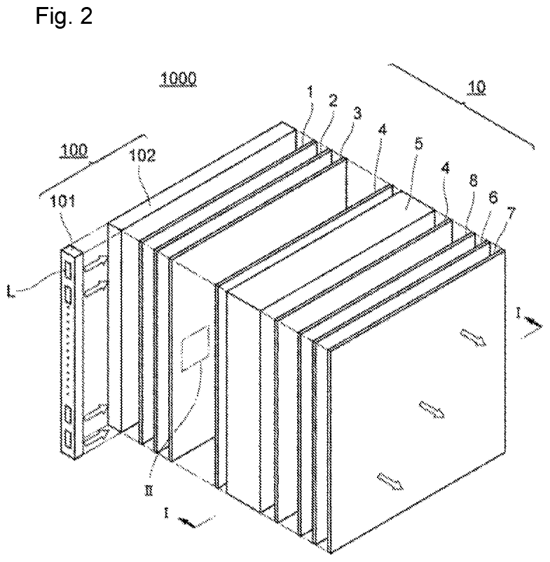

In the liquid crystal display device 1000 illustrated in FIG. 2, alignment layers 4 are added to the liquid crystal panel 10 illustrated in FIG. 1. Specifically, the liquid crystal panel 10 illustrated in FIG. 2 includes a first (transparent, insulating) substrate 2 provided with a polarizing layer 1 disposed on a surface of the first substrate 2 and an electrode layer 3 disposed on the other surface of the first substrate 2. The liquid crystal panel 10 further includes an alignment layer 4 disposed on the electrode layer 3. The liquid crystal panel 10 also includes a photoconversion layer 6 containing light-emitting nanocrystals which is disposed on a second (transparent, insulating) substrate 7, such that the photoconversion layer 6 faces the first substrate 2 across a liquid crystal layer 5. A polarizing layer 8 is disposed on a surface of the photoconversion layer 6 which faces the first substrate 2. An alignment layer 4 is disposed on a surface of the polarizing layer 8 which faces the first substrate 2.

Although a pixel electrode (not illustrated) and a common electrode (not illustrated) are disposed on the first substrate 2 as an electrode layer 3 in FIG. 2, a pixel electrode 3 may be disposed on the first substrate 2 and a common electrode may be disposed on the second substrate 7 in another embodiment (e.g., FIGS. 3 and 4).

The alignment layers 4 enable liquid crystal molecules included in the liquid crystal composition to be aligned in a predetermined direction relative to the substrates 2 and 7 when no voltage is applied. Although the liquid crystal layer 5 is sandwiched between the pair of alignment layers 4 in the embodiment illustrated in FIG. 2, the alignment layer 4 may be disposed on only one of the first substrate 2 and the second substrate.

Although the photoconversion layer 6 is interposed between the second substrate 7 and the alignment layer 4 in FIG. 2, the photoconversion layer 6 may be disposed on the first substrate 2 as in FIG. 1, that is, as in the color-filter-on-array (COA)-type element. Although the alignment layer 4 is disposed on both first substrate 2 and second substrate 7 so as to come into contact with the liquid crystal layer 5 in FIGS. 2 and 4 below, the alignment layer 4 may be disposed on one of the first substrate 2 and the second substrate 7.

As described above, the liquid crystal panel 10 according to the present invention preferably has a structure including a first polarizing layer 1, a first substrate 2, an electrode layer 3, a liquid crystal layer 5, a second polarizing layer 8, a photoconversion layer 6, and a second substrate 7 that are stacked on top of one another in this order or a structure including a first polarizing layer 1, a first substrate 2, an electrode layer 3, an alignment layer 4, a liquid crystal layer 5 containing a liquid crystal composition, an alignment layer 4, a second polarizing layer 8, a photoconversion layer 6, and a second substrate 7 that are stacked on top of one another in this order.

In FIGS. 1 and 2, the light emitted from the light-emitting elements L transmits through the light guide section 102 (e.g., through a light guide plate or a light diffusion plate) and enters the surface of the liquid crystal panel 10. The light incident on the liquid crystal panel 10 is polarized through the first polarizing layer 1 in a particular direction. Subsequently, since the direction in which liquid crystal molecules included in the liquid crystal layer 5 are aligned can be controlled by driving the electrode layer 3, the direction of polarization of the light is changed by the liquid crystal layer 5, which serves as an optical shutter. Then, the light is blocked or polarized in a particular direction by the second polarizing layer 8 and subsequently enters the photoconversion layer 6. In the photoconversion layer 6, the light incident on the photoconversion layer 6 is absorbed by the light-emitting nanocrystals and converted into an emission spectrum of any of red (R), green (G), and blue (B). Thus, any color of red (R), green (G), and blue (B) can be displayed.

The light guide section 102 (in particular, a light guide plate) preferably has a flat plate-like shape with side surfaces inclined such that the thickness of the light guide section 102 decreases in the direction from the side surface on which the light emitted from the light-emitting elements L is incident toward the opposing side surface (flat plate having tapered side surfaces or wedge-shaped rectangular plate) in order to enable conversion of linear light into flat light and thereby increase the likelihood of the light entering the liquid crystal panel 10 (described below as an embodiment).

FIG. 3 is a perspective view of the entirety of an example of a liquid crystal display device that includes a backlight unit 100 having a “direct backlight structure” including a plurality of light-emitting elements L arranged in a flat-plate-like light guide section 102 in a planar pattern. In FIG. 3, the components are separated from one another for illustrative purposes.

Since the light emitted from the light-emitting elements L included in the direct backlight structure is flat light, the light guide section 102 does not necessarily have a tapered shape unlike in FIGS. 1 and 2.

The liquid crystal panel 10 illustrated in FIG. 3 includes a first substrate 2 provided with a first electrode layer 3 (e.g., a pixel electrode) disposed on a surface of the first substrate 2 and a first polarizing layer 1 disposed on the other surface of the first substrate 2; a second substrate 7 provided with a second electrode layer 3′ (e.g., a common electrode); and a liquid crystal layer 5 sandwiched between the first substrate 2 and the second substrate 7. The liquid crystal panel 10 further includes a photoconversion layer 6 interposed between the second substrate 7 and the second electrode layer 3′ and a second polarizing layer 8 disposed on a surface of the photoconversion layer 6 which faces the second electrode layer 3′.

That is, the liquid crystal display device 1000 according to the embodiment illustrated in FIG. 3 has a structure including a backlight unit 100, a first polarizing plate 1, a first substrate 2, an electrode layer (also referred to as “thin-film transistor layer” or “pixel electrode”) 3 including thin-film transistors, a layer 5 including a liquid crystal composition, a second electrode layer 3′, a second polarizing plate 8, a photoconversion layer 6, and a second substrate 7 that are stacked on top of one another in this order.

In the liquid crystal display device 1000 illustrated in FIG. 4, alignment layers 4 are added to the liquid crystal panel 10 illustrated in FIG. 3. Specifically, the liquid crystal panel 10 illustrated in FIG. 4 includes a first substrate 2 provided with a first electrode layer 3 (e.g., a pixel electrode) disposed on a surface of the first substrate 2 and a first polarizing layer 1 disposed on the other surface of the first substrate 2; a second substrate 7 provided with a second electrode layer 3′ (e.g., a common electrode); an alignment layer 4 provided with a liquid crystal composition (or a liquid crystal layer 5) sandwiched between the first substrate 2 and the second substrate 7, the alignment layer 4 being interposed between the first substrate 2 and the liquid crystal layer 5 so as to come into contact with the liquid crystal layer 5; and an alignment layer 4 interposed between the second substrate 7 and the liquid crystal layer 5 so as to come into contact with the liquid crystal layer 5. The liquid crystal panel 10 further includes a photoconversion layer 6 interposed between the second substrate 7 and the second electrode layer 3′ and a second polarizing layer 8 disposed on a surface of the photoconversion layer 6 which faces the second electrode layer 3′.

That is, the liquid crystal display device 1000 according to the embodiment illustrated in FIG. 4 preferably has a structure including a backlight unit 100, a first polarizing plate 1, a first substrate 2, an electrode layer (also referred to as “thin-film transistor layer”) 3 that includes thin-film transistors, an alignment layer 4, a layer 5 containing a liquid crystal composition, an alignment layer 4, a second electrode layer 3′, a second polarizing plate 8, a photoconversion layer 6, and a second substrate 7 that are stacked on top of one another in this order.

In FIGS. 3 and 4, the light emitted from the light-emitting elements L transmits through the light guide section 102 (e.g., through a light diffusion plate) and enters the surface of the liquid crystal panel 10. The light incident on the liquid crystal panel 10 is polarized through the first polarizing layer 1 in a particular direction. Subsequently, the direction of polarization of the light is changed in the liquid crystal layer 5 by driving the first electrode layer 3 and the second electrode layer 3′. Then, the light is blocked or polarized in a particular direction by the second polarizing layer 8 and subsequently enters the photoconversion layer 6. In the photoconversion layer 6, the light incident on the photoconversion layer 6 is absorbed by the light-emitting nanocrystals and converted into an emission spectrum of any one of red (R), green (G), and blue (B). Thus, any color of red (R), green (G), and blue (B) can be displayed.

As a light guide section 102, a light diffusion plate is preferably interposed between the liquid crystal panel 10 and the light guide section 102 (described below as an embodiment).

The cross-sectional structure of the liquid crystal panel included in a preferable liquid crystal display device according to the present invention and, in particular, the manner in which the polarizing layers, the photoconversion layer, the liquid crystal layer, etc. are stacked are described below.

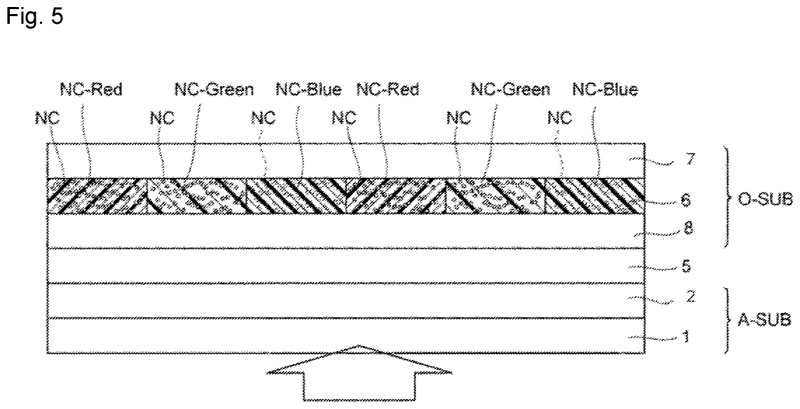

FIGS. 5 to 11 are schematic cross-sectional views of the liquid crystal panel 10 included in the liquid crystal display device, illustrating the structure of the liquid crystal panel used in this embodiment. FIGS. 5 to 11 schematically illustrate the manner in which the polarizing layers, the photoconversion layer, and the liquid crystal layer are stacked in the liquid crystal panel 10. Since FIGS. 5 to 11 are schematic diagrams illustrating the positional relationship between the polarizing layers, the photoconversion layer, and the liquid crystal layer, the electrode layer 3 (including TFTs), the electrode layer 3′, the alignment layers 4, etc. illustrated in FIGS. 1 to 4 are omitted for the sake of simplicity.

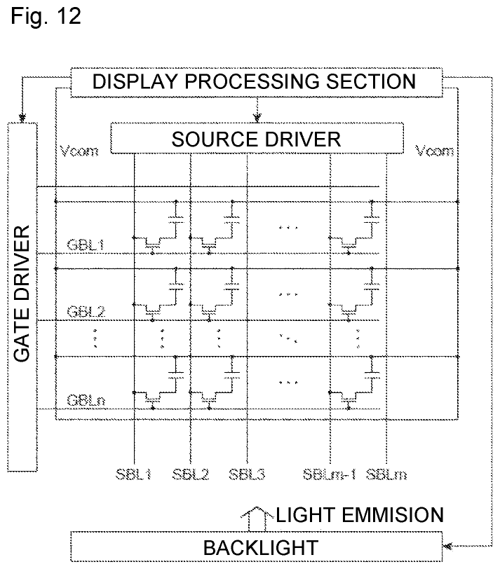

In FIGS. 5 to 11, the substrate disposed on a side of the liquid crystal layer 5 which faces the backlight unit (the light source) and the multilayer body disposed on the substrate are referred to as an array substrate (A-SUB), and another substrate that faces the array substrate across the liquid crystal layer 5 and the multilayer body disposed on the other substrate are referred to as an opposite substrate (O-SUB). The structures and preferable embodiments of the array substrate (A-SUB) and the opposite substrate (O-SUB) are described in detail in the description of the electrode structure with reference to FIGS. 12 to 19 below. Although the TFTs are disposed in the array substrate in the examples illustrated in FIGS. 5 to 11, the positions of the array substrate and the opposite substrate are interchangeable.

In the liquid crystal panel illustrated in FIG. 5, the photoconversion layer 6 is included in the opposite substrate (O-SUB) and the photoconversion layer 6 and the second polarizing layer 8 are interposed between the pair of substrates (the first substrate 2 and the second substrate 7). That is, the liquid crystal panel illustrated in FIG. 5 includes an “in-cell polarizing layer”.

While common liquid crystal display devices perform color display by subjecting light emitted from a white light source to wavelength selection through a color filter, which absorbs part of the light, in the present invention, the photoconversion layer containing light-emitting nanocrystals is used as an alternative to a color filter. Thus, the photoconversion layer 6 according to the present invention includes pixels of three primary colors consisting of red (R), green (G), and blue (B) and has a function comparable to a “color filter”.

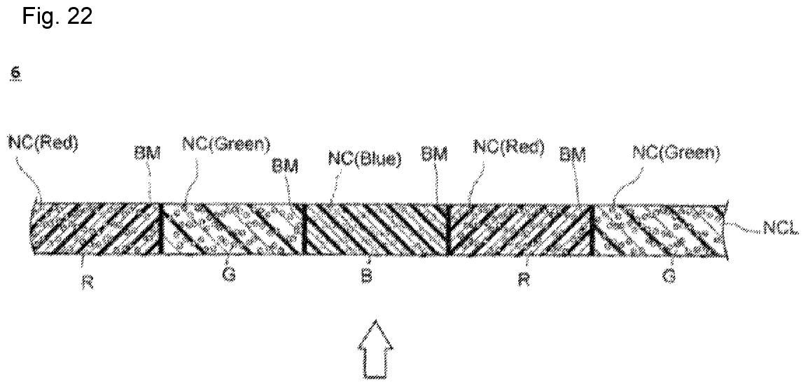

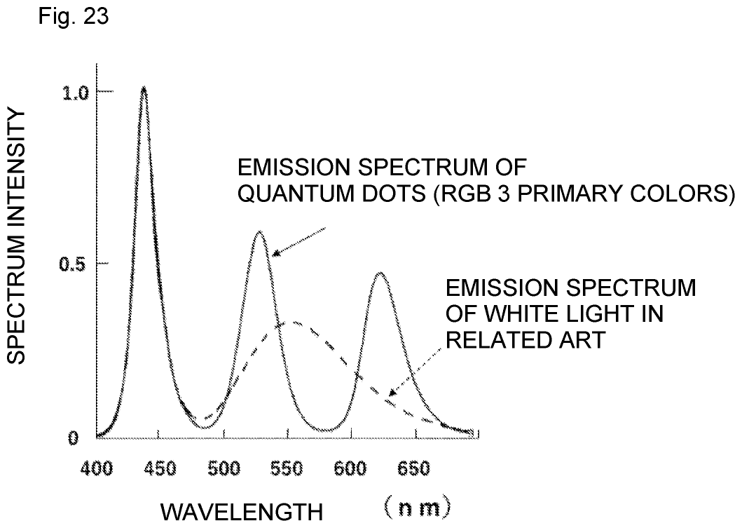

Specifically, the photoconversion layer 6 includes, for example, red (R) pixel portions (red color layer portions) including a photoconversion pixel layer (NC-Red) each of which includes red light-emitting nanocrystals; green (R) pixel portions (green color layer portions) including a photoconversion pixel layer (NC-Green) each of which includes green light-emitting nanocrystals; and blue (B) pixel portions (blue color layer portions) each of which includes a photoconversion pixel layer (NC-Blue) containing blue light-emitting nanocrystals. FIG. 22 illustrates an example of such a single-layer photoconversion layer 6.

Specifically, when light having a main emission peak around 450 nm, such as a blue LED, is used as a light source, the photoconversion layer 6 may use the blue light emitted by the blue LED as blue color. Therefore, when the light emitted from the light source section is blue light, among the photoconversion pixel layers of the above colors (NC-Red, NC-Green, and NC-Blue), the photoconversion pixel layer (NC-Blue) may be omitted and the light emitted from the backlight may be directly used as blue color. In such a case, the color layer used for displaying blue may be, for example, composed of a transparent resin or may be a coloring material layer containing a blue coloring material (i.e., a blue color filter). Thus, in FIGS. 5 and 22, blue light-emitting nanocrystals are denoted with a dot-and-dash line since they may be optional.

In the photoconversion layer 6 described as a particularly preferable embodiment, the red color layer contains red light-emitting nanocrystals NC that absorb light emitted from the light source section (e.g., blue light) and emit red light, and the green color layer contains green light-emitting nanocrystals NC that absorb light emitted from the light source section (e.g., blue light) and emit green light. However, the present invention is not limited to this.

The light-emitting nanocrystals NC according to the present invention are preferably at least one type of light-emitting nanocrystals selected from the group consisting of blue light-emitting nanocrystals NC that absorb light emitted from the light source section (e.g., blue light) and emit blue light, green light-emitting nanocrystals NC that absorb light emitted from the light source section (e.g., blue light) and emit green light, and red light-emitting nanocrystals NC that absorb light emitted from the light source section (e.g., blue light) and emit red light and are more preferably two types of light-emitting nanocrystals selected from the group consisting of blue light-emitting nanocrystals NC that absorb light emitted from the light source section (e.g., blue light) and emit blue light, green light-emitting nanocrystals NC that absorb light emitted from the light source section (e.g., blue light) and emit green light, and red light-emitting nanocrystals NC that absorb light emitted from the light source section (e.g., blue light) and emit red light. The photoconversion layer according to the present invention particularly preferably includes a layer (NC-Red) containing the red light-emitting nanocrystals and a layer (NC-Green) containing the green light-emitting nanocrystals.

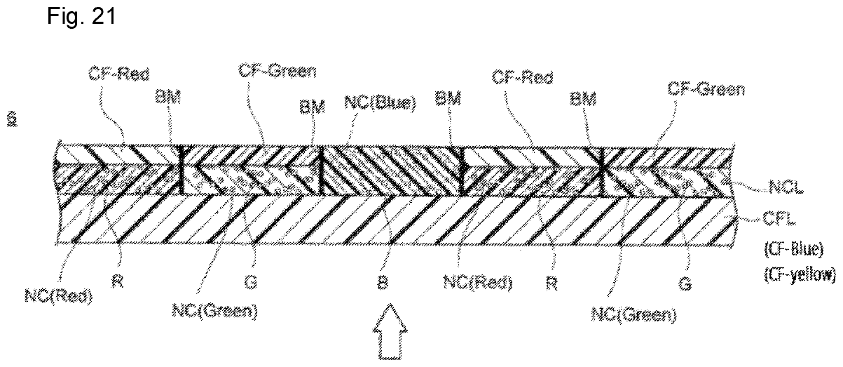

The liquid crystal display device according to the present invention illustrated in FIG. 5 may include a black matrix in order to prevent color mixture among the color layers. In FIG. 5, depending on the type (blue LED as a light-emitting element) of the light source used, it is preferable to interpose a color layer (i.e., a blue color filter) containing a blue coloring material between the photoconversion layer 6 and the second polarizing layer 8 so as to cover the entire surfaces of the photoconversion layer 6 and the second polarizing layer 8 in order to block unwanted light from entering from the outside and limit the degradation of image qualities. FIG. 21 illustrates the structure including such a blue color filter.

In the case where the embodiment illustrated in FIG. 5 is applied to a VA-mode liquid crystal display device, it is preferable that, in the opposite substrate O-SUB, the electrode layer 3′ (common electrode) be interposed between the liquid crystal layer 5 and the second polarizing layer 8 or between the second polarizing layer 8 and the photoconversion layer 6 and that the electrode layer 3 (pixel electrode) be disposed on the first substrate 2. It is preferable that the alignment layer 4 be disposed on the surface of at least one of the opposite substrate (O-SUB) and the array substrate (A-SUB) which comes into contact with the liquid crystal layer. In the case where the liquid crystal display device illustrated in FIG. 5 is an FFS-mode or IPS-mode liquid crystal display device, the pixel electrode and the common electrode are preferably disposed on the first substrate 2.

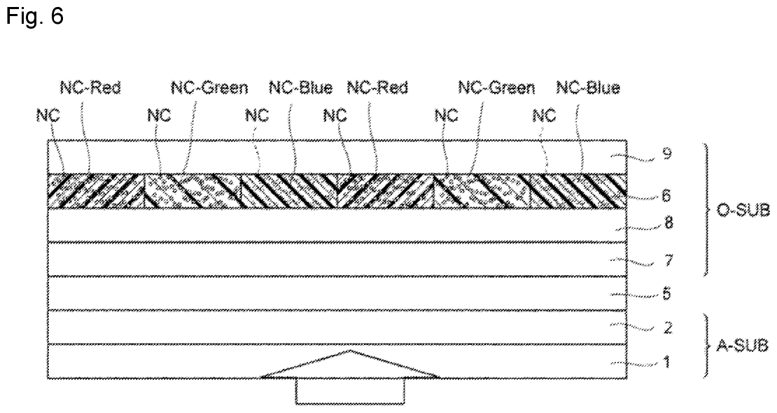

In the embodiment illustrated in FIG. 6, the photoconversion layer 6 is included in the opposite substrate (O-SUB) and the photoconversion layer 6 is disposed outside the pair of substrates (the first substrate 2 and the second substrate 7). Therefore, the liquid crystal panel according to the embodiment illustrated in FIG. 6 includes a supporting substrate 9 that supports the second polarizing layer 8 and the photoconversion layer 6. The supporting substrate 9 is preferably a transparent substrate.

The photoconversion layer 6 illustrated in FIG. 6 includes, as in the embodiment illustrated in FIG. 5, red (R) pixel portions (red color layer portions) each of which includes a photoconversion pixel layer (NC-Red) containing red light-emitting nanocrystals; green (G) pixel portions (green color layer portions) each of which includes a photoconversion pixel layer (NC-Green) containing green light-emitting nanocrystals; and blue (B) pixel portions (blue color layer portions) each of which includes a photoconversion pixel layer (NC-Blue) optionally containing blue light-emitting nanocrystals. The preferable structure of the red (R) pixel portions, the green (G) pixel portions, and the blue (B) pixel portions included in the photoconversion layer 6 illustrated in FIG. 6 is the same as that illustrated in FIG. 5 and the description thereof is omitted.

In the case where the embodiment illustrated in FIG. 6 is applied to a VA-mode liquid crystal display device, it is preferable that, in the opposite substrate O-SUB, the electrode layer 3′ (common electrode) be interposed between the liquid crystal 5 and the second polarizing layer 8 and that the electrode layer 3 (pixel electrode) be disposed on the first substrate 2. It is preferable that the alignment layer 4 be disposed on the surface of at least one of the opposite substrate (O-SUB) and the array substrate (A-SUB) which comes into contact with the liquid crystal layer. In the case where the liquid crystal display device illustrated in FIG. 6 is an FFS-mode or IPS-mode liquid crystal display device, the pixel electrode and the common electrode are preferably disposed on the first substrate 2.

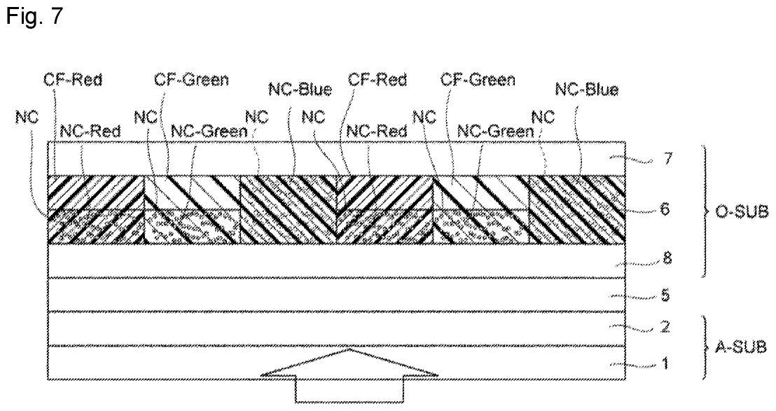

In the embodiment illustrated in FIG. 7, the photoconversion layer 6 is included in the opposite substrate (O-SUB) and the photoconversion layer 6 and the second polarizing layer 8 are interposed between the pair of substrates (the first substrate 2 and the second substrate 7). That is, the liquid crystal panel according to the embodiment illustrated in FIG. 7 includes an “in-cell polarizing plate”. Furthermore, in the red and green portions of the color layer which constitute the photoconversion layer 6, the red color layer portion has a two-layer structure consisting of a photoconversion pixel layer (NC-Red) containing red light-emitting nanocrystals and a coloring material layer (CF-Red) containing a red coloring material (i.e., a red color filter) which are stacked on top of each other, and the green color layer portion has a two-layer structure consisting of a photoconversion pixel layer (NC-Green) containing green light-emitting nanocrystals that emit green light and a coloring material layer (CF-Green) containing a green coloring material (i.e., a green color filter) which are stacked on top of each other.

Specifically, the above two-layer structure of the color layer is formed as a result of stacking a color filter (CFL) and a coloring material layer of each color on top of each other in order not to pass but absorb the part of excitation light which remains when the whole amount of incident light (light emitted from a light source, preferably blue light) cannot be converted in the photoconversion pixel layers containing the nanocrystals.

According to FIG. 7, in the liquid crystal panel section of the liquid crystal display device according to the present invention, the second polarizing layer 8 and the photoconversion layer 6, which includes red color layers, green color layers, and blue color layers, are disposed in the substrate O-SUB, which is opposite to the substrate A-SUB disposed on the backlight unit (light source)-side. In FIG. 7, the second polarizing layer 8 is interposed between the pair of substrates (the first substrate 2 and the second substrate 7). That is, the liquid crystal panel includes an in-cell polarizing plate. In the embodiment illustrated in FIG. 7, the photoconversion layer 6 illustrated in FIG. 5 is formed as two layers. Specifically, the photoconversion layer 6 includes red color layer portions, green color layer portions, and blue color layer portions. The red (R) pixel portions (red color layer portions) have a two-layer structure consisting of a photoconversion pixel layer (NC-Red) containing red light-emitting nanocrystals and a coloring material layer (CF-Red) containing a red coloring material. The green (R) pixel portions (green color layer portions) have a two-layer structure consisting of a photoconversion pixel layer (NC-Green) containing green light-emitting nanocrystals and a coloring material layer (CF-Green) containing a green coloring material. In this case, in FIG. 7, the green color layer portions may include a photoconversion pixel layer (NC-Green) containing green light-emitting nanocrystals and a coloring material layer (CF-Yellow) containing a yellow coloring material in combination in order to perform color compensation taking the penetration of the excitation light into account. The blue (R) pixel portions (blue color layer portions) are constituted by a color layer (NC-Blue) that optionally contains blue light-emitting nanocrystals.

The preferable embodiment of the photoconversion pixel layers (NC-Red) containing red light-emitting nanocrystals, the photoconversion pixel layers (NC-Green) containing green light-emitting nanocrystals, and the color layers (NC-Blue) optionally containing blue light-emitting nanocrystals included in the photoconversion layer 6 illustrated in FIG. 7 are the same as that illustrated in FIG. 5 and the description thereof is omitted. Although FIG. 7 illustrates that the red color layer portions, the green color layer portions, and the blue color layer portions are in contact with one another, a black matrix which serves as a light-shielding layer may optionally be interposed between the color layer portions in order to prevent color mixture.

In the case where a blue LED or the like is used as a light-emitting element, it is preferable to interpose a coloring material layer (i.e., a blue color filter) containing a blue coloring material between the photoconversion layer 6 and the second polarizing layer 8 illustrated in FIG. 7 so as to cover the entire surfaces of the photoconversion layer 6 and the second polarizing layer 8 in order to block unwanted light from entering from the outside and limit the degradation of image qualities. FIG. 22 illustrates an example of the layer structure that includes such a photoconversion layer 6 having the two-layer structure and a blue color filter as essential components.

In the case where the embodiment illustrated in FIG. 7 is applied to a VA-mode liquid crystal display device, it is preferable that, in the opposite substrate O-SUB, the electrode layer 3′ (common electrode) be interposed between the liquid crystal 5 and the second polarizing layer 8 and that the electrode layer 3 (pixel electrode) be disposed on the first substrate 2. In the case where the liquid crystal display device illustrated in FIG. 7 is an FFS-mode or IPS-mode liquid crystal display device, the pixel electrode and the common electrode are preferably disposed on the first substrate 2. In a VA-mode, FFS-mode, or IPS-mode liquid crystal display device, it is preferable that the alignment layer 4 be disposed on the surface of at least one of the opposite substrate (O-SUB) and the array substrate (A-SUB) which comes into contact with the liquid crystal layer.

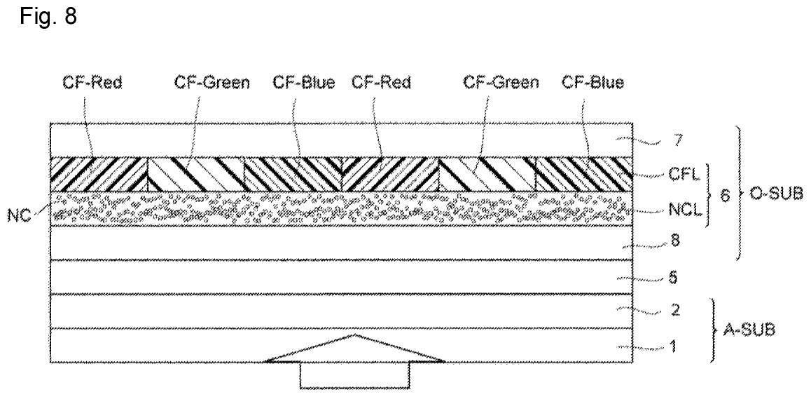

In the embodiment illustrated in FIG. 8, the second polarizing layer 8 is interposed between the pair of substrates (the first substrate 2 and the second substrate 7). That is, the liquid crystal panel according to the embodiment illustrated in FIG. 8 includes an in-cell polarizing plate. The liquid crystal panel includes a two-layer photoconversion layer 6 consisting of a layer containing light-emitting nanocrystals and a color filter disposed on the layer. Specifically, the photoconversion layer 6 includes red (R) pixel portions (red color layer portions) having a two-layer structure consisting of a layer (NCL) containing light-emitting nanocrystals and a coloring material layer containing a red coloring material; green (R) pixel portions (green color layer portions) having a two-layer structure consisting of a layer (NC) containing light-emitting nanocrystals and a coloring material layer containing a green coloring material; and blue (R) pixel portions (blue color layer portions) having a two-layer structure consisting of a layer (NC) containing light-emitting nanocrystals and a coloring material layer containing a blue coloring material.

In this case, the light-emitting nanocrystals contained in the layer containing light-emitting nanocrystals NC are preferably one or two types of light-emitting nanocrystals selected from the group consisting of blue light-emitting nanocrystals that absorb incident light (light emitted from a light source; preferably, blue light) and emit blue light, green light-emitting nanocrystals that absorb incident light (light emitted from a light source; preferably, blue light) and emit green light, and red light-emitting nanocrystals that absorb incident light (light emitted from a light source; preferably, blue light) and emit red light. In this embodiment, a black matrix may also be used to prevent color mixture among the color layers.

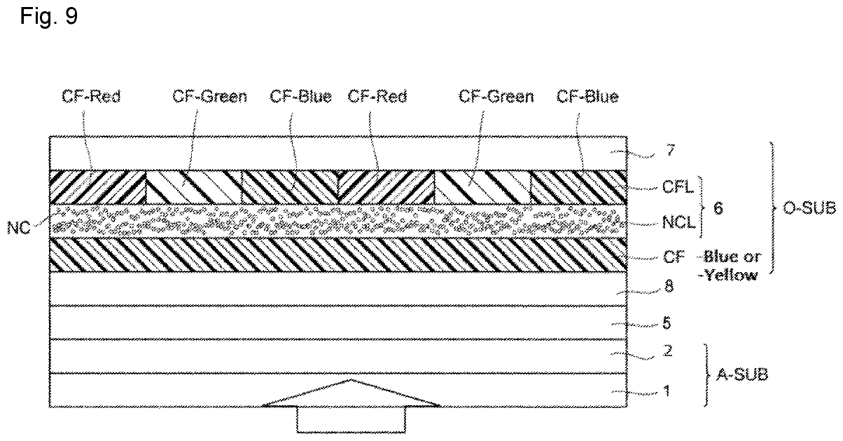

In the embodiment illustrated in FIG. 8, it is preferable to arrange a blue or yellow color filter on the entirety of a surface of the photoconversion layer 6 which faces the liquid crystal layer so as to come into contact with the photoconversion layer 6 in order to block unwanted light from entering from the outside and limit the degradation of image qualities. FIG. 9 illustrates the structure that includes such a blue or yellow color filter.

In the case where the embodiment illustrated in FIG. 8 or 9 is applied to a VA-mode liquid crystal display device, it is preferable that, in the opposite substrate O-SUB, the electrode layer 3′ (common electrode) be interposed between the liquid crystal 5 and the second polarizing layer 8 and that the electrode layer 3 (pixel electrode) be disposed on the first display substrate. It is preferable that the alignment layer 4 be disposed on the surface of at least one of the opposite substrate (O-SUB) and the array substrate (A-SUB) which comes into contact with the liquid crystal layer. In the case where the liquid crystal display device illustrated in FIG. 8 is an FFS-mode or IPS-mode liquid crystal display device, the pixel electrode and the common electrode are preferably disposed on the first display substrate.

In the embodiments illustrated in FIGS. 5 to 9, which are described above in detail, color display is performed as a result of the light-emitting nanocrystals contained in the photoconversion layer absorbing light emitted from a light source that emits a high-energy light beam, such as short-wavelength visible light or ultraviolet light, through the liquid crystal layer that serves as an optical switch and the polarizing layer, converting the absorbed light into light having specific wavelengths, and emitting the converted light.

FIG. 10 illustrates a color-filter-on-array-type liquid crystal panel in which the photoconversion layer 6 is included in the array substrate (A-SUB), the second polarizing layer 8 is disposed on the outside surface of the second substrate 7, and the first polarizing layer 1 is interposed between the pair of substrates (the first substrate 2 and the second substrate 7). That is, the liquid crystal panel includes an in-cell polarizing plate.

In the case where the embodiment illustrated in FIG. 10 is applied to a VA-mode liquid crystal display device, it is preferable that, in the opposite substrate O-SUB, the electrode layer 3′ (common electrode) be interposed between the liquid crystal 5 and the second substrate 7 and that the electrode layer 3 (pixel electrode) be disposed on the first substrate 2.

For example, it is preferable that the pixel electrode 3 be interposed between the first substrate 2 and the photoconversion layer 6, between the first polarizing layer 1 and the photoconversion layer 6, or between the first polarizing layer 1 and the liquid crystal layer 5.

It is preferable that the alignment layer 4 be disposed on the surface of at least one of the opposite substrate (O-SUB) and the array substrate (A-SUB) which comes into contact with the liquid crystal layer.

In the case where the liquid crystal display device illustrated in FIG. 10 is an FFS-mode or IPS-mode liquid crystal display device, the pixel electrode and the common electrode are preferably disposed on the first substrate 2. That is, the pixel electrode and the common electrode are preferably interposed between, for example, the first substrate 2 and the photoconversion layer 6, between the first polarizing layer 1 and the photoconversion layer 6, or the first polarizing layer 1 and the liquid crystal layer 5. It is preferable to interpose a blue color filter between the photoconversion layer 6 and the first substrate 2 so as to cover the entire surfaces of the photoconversion layer 6 and the first substrate 2 in order to block unwanted light from entering from the outside and limit the degradation of image qualities. In the case where the incident light is blue light, the color layer used for displaying blue does not necessarily contain blue light-emitting nanocrystals. In such a case, the color layer used for displaying blue may be, for example, composed of a transparent resin or may be a color layer containing a blue coloring material (i.e., a blue color filter).

FIG. 11 illustrates an embodiment in which the photoconversion layer 6 is included in the array substrate (A-SUB), which is disposed on the backlight unit (light source)-side, and the first polarizing layer 1 and the second polarizing layer 8 are disposed on the outer surfaces of the pair of substrates (the first substrate 2 and the second substrate 7). Therefore, a supporting substrate 9 that supports the first polarizing layer 1 and the photoconversion layer 6 is disposed on the light source section (backlight unit)-side of the first substrate 2.

In the case where the embodiment illustrated in FIG. 11 is applied to a VA-mode liquid crystal display device, it is preferable that, in the opposite substrate O-SUB, the electrode layer 3′ (common electrode) be interposed between the liquid crystal 5 and the second substrate 7 and that the electrode layer 3 (pixel electrode) be disposed on the first substrate 2. For example, it is preferable that the common electrode 3′ be interposed between the first substrate 2 and the liquid crystal layer 5. It is preferable that the alignment layer 4 be disposed on the surface of at least one of the opposite substrate (O-SUB) and the array substrate (A-SUB) which comes into contact with the liquid crystal layer. In the case where the liquid crystal display device illustrated in FIG. 11 is an FFS-mode or IPS-mode liquid crystal display device, the pixel electrode and the common electrode are preferably disposed on the first substrate 2. That is, the pixel electrode and the common electrode are preferably interposed between, for example, the first substrate 2 and the liquid crystal layer 5. It is preferable to interpose a blue color filter between the photoconversion layer 6 and the supporting substrate 9 so as to cover the entire surfaces of the photoconversion layer 6 and the supporting substrate 9 in order to block unwanted light from entering from the outside and limit the degradation of image qualities. In the case where the incident light is blue light, the color layer used for displaying blue does not necessarily contain blue light-emitting nanocrystals. In such a case, the color layer used for displaying blue may be, for example, composed of a transparent resin or may be a coloring material layer containing a blue coloring material (i.e., a blue color filter).

As described above in detail, in the embodiments illustrated in FIGS. 10 and 11, color display is performed as a result of part of light emitted from a light source that emits a high-energy light beam, such as short-wavelength visible light or ultraviolet light, which is not absorbed by the light-emitting nanocrystals contained in the photoconversion layer, that is, in particular, part of the light which passed through the blue color layer portions, passing through the liquid crystal layer that serves as an optical switch.

Among the embodiments illustrated in FIGS. 5 to 11 above, the structures illustrated in FIGS. 5 to 9, in which the photoconversion layer 6 is disposed in the substrate O-SUB which is opposite to the substrate A-SUB disposed on the backlight unit (light source)-side, are particularly preferable because they enable the advantageous effects of the present invention, that is, reduction or prevention of the degradation of the liquid crystal layer which may be caused by irradiation of a high-energy light beam, to be significantly produced.

As described above, the positional relationship between the polarizing layers, the photoconversion layer, and the liquid crystal layer included in a preferable liquid crystal display device (in particular, liquid crystal panel) according to the present invention is described with reference to the schematic diagrams of FIGS. 5 to 11.

### “Photoconversion Layer”

The photoconversion layer according to the present invention is further described below in detail. The pixel portions of the photoconversion layer contain light-emitting nanocrystals as essential components and may contain a resin component and, as needed, molecules having an affinity for the light-emitting nanocrystals, publicly known additives, and coloring materials. As described above, it is preferable to arrange a black matrix at the boundaries of the pixel layers in order to enhance contrast.

### (Light-Emitting Nanocrystals)

The photoconversion layer according to the present invention contains light-emitting nanocrystals. The term “nanocrystal” used herein refers to, preferably, a particle having at least one length of 100 nm or less. The nanocrystals may have any geometric shape and may be either symmetrical or asymmetrical. Specific examples of the shape of the nanocrystals include slender, rod-like, circular (spherical), oval, pyramidal, disc-like, dendritic, net-like, and various irregular shapes. In an embodiment, the nanocrystals are preferably quantum dots or quantum rods.

The light-emitting nanocrystal preferably includes a core containing at least one first semiconductor material and a shell covering the core and containing a second semiconductor material that is the same as or different from the semiconductor material contained in the core.

Thus, the light-emitting nanocrystal is constituted by a core containing at least a first semiconductor material and a shell containing a second semiconductor material. The first semiconductor material may be the same as or different from the second semiconductor material. The core and/or the shell may contain a third semiconductor material other than the first semiconductor and/or the second semiconductor. Note that, the expression “covering the core” used herein means covering at least a part of the core.

The light-emitting nanocrystal preferably includes a core containing at least one first semiconductor material, a first shell covering the core and containing a second semiconductor material that is the same as or different from the semiconductor material contained in the core, and, as needed, a second shell covering the first shell and containing a third semiconductor material that is the same as or different from the semiconductor material contained in the first shell.

Thus, the light-emitting nanocrystals according to the present invention preferably have at least one of the following three structures: a structure including a core containing a first semiconductor material and a shell covering the core and containing a second semiconductor material that is the same as the semiconductor material contained in the core, that is, a structure consisting of one or two or more semiconductor materials (i.e., a structure including only cores (also referred to as “core structure”)); a structure including a core containing a first semiconductor material and a shell covering the core and containing a second semiconductor material that is different from the semiconductor material contained in the core, that is, a core/shell structure; and a structure including a core containing a first semiconductor material, a first shell covering the core and containing a second semiconductor material that is different from the semiconductor material contained in the core, and a second shell covering the first shell and containing a third semiconductor material that is different from the semiconductor material contained in the first shell, that is, a core/shell/shell structure.

As described above, the light-emitting nanocrystals according to the present invention preferably have the above three structures, that is, the core structure, the core/shell structure, and the core/shell/shell structure. In such a case, the core may be composed of mixed crystals containing two or more semiconductor materials (e.g., CdSe+CdS and CIS+ZnS). Similarly to the core, the shell may be composed of mixed crystals containing two or more semiconductor materials.

The photoconversion layer according to the present invention may contain molecules having an affinity for the light-emitting nanocrystals arranged to come into contact with the light-emitting nanocrystals.

The molecules having an affinity for the light-emitting nanocrystals are low-molecular weight and high-molecular weight molecules including a functional group having an affinity for the light-emitting nanocrystals. The functional group having an affinity for the light-emitting nanocrystals is not limited but is preferably a group including one element selected from the group consisting of nitrogen, oxygen, sulfur, and phosphorus. Examples thereof include an organic sulfur group, an organic phosphate group, a pyrrolidone group, a pyridine group, an amino group, an amide group, an isocyanate group, a carbonyl group, and a hydroxyl group.

The semiconductor material according to the present invention is preferably one or two or more semiconductor materials selected from the group consisting of a Group II-VI semiconductor, a Group III-V semiconductor, a Group I-III-VI semiconductor, a Group IV semiconductor, and a Group I-II-IV-VI semiconductor. Preferable examples of the first semiconductor material and the third semiconductor material according to the present invention are the same as the above semiconductor materials.

Specifically, the semiconductor material according to the present invention is at least one semiconductor material selected from the group consisting of CdS, CdSe, CdTe, ZnS, ZnSe, ZnTe, ZnO, HgS, HgSe, HgTe, CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, CdHgZnTe, CdZnSeS, CdZnSeTe, CdZnSTe, CdHgSeS, CdHgSeTe, CdHgSTe, HgZnSeS, HgZnSeTe, and HgZnSTe; GaN, GaP, GaAs, GaSb, AlN, AlP, AlAs, AlSb, InN, InP, InAs, InSb, GaNP, GaNAs, GaNSb, GaPAs, GaPSb, AlNP, AlNAs, AlNSb, AlPAs, AlPSb, InNP, InNAs, InNSb, InPAs, InPSb, GaAlNP, GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, and InAlPSb; SnS, SnSe, SnTe, PbS, PbSe, PbTe, SnSeS, SnSeTe, SnSTe, PbSeS, PbSeTe, PbSTe, SnPbS, SnPbSe, SnPbTe, SnPbSSe, SnPbSeTe, and SnPbSTe; and SiC, SiGe, AgInSe₂, CuGaSe₂, CuInS₂, CuGaS₂, CuInSe₂, AgInS₂, AgGaSe₂, AgGaS₂, C, Si, and Ge. The above compound semiconductors may be used alone or in a mixture of two or more. The semiconductor material according to the present invention is more preferably at least one semiconductor material selected from the group consisting of CdS, CdSe, CdTe, ZnS, ZnSe, ZnTe, ZnO, HgS, HgSe, HgTe, InP, InAs, InSb, GaP, GaAs, GaSb, AgInS₂, AgInSe₂, AgInTe₂, AgGaS₂, AgGaSe₂, AgGaTe₂, CuInS₂, CuInSe₂, CuInTe₂, CuGaS₂, CuGaSe₂, CuGaTe₂, Si, C, Ge, and Cu₂ZnSnS₄. The above compound semiconductors may be used alone or in a mixture of two or more.

The light-emitting nanocrystals according to the present invention preferably include at least one type of nanocrystals selected from the group consisting of red light-emitting nanocrystals that emit red light, green light-emitting nanocrystals that emit green light, and blue light-emitting nanocrystals that emit blue light. While the color of light emitted from light-emitting nanocrystals generally varies with particle size on the basis of the solution of the Schrodinger wave equation for potential well model, it also varies with the energy gap of the light-emitting nanocrystals. Therefore, the color of light emitted from light-emitting nanocrystals is selected by adjusting the type of light-emitting nanocrystals used and the particle size of the light-emitting nanocrystals.

In the present invention, the upper limit for the wavelength peak of the fluorescence emission spectrum of the red light-emitting nanocrystals that emit red light is preferably 665 nm, 663 nm, 660 nm, 658 nm, 655 nm, 653 nm, 651 nm, 650 nm, 647 nm, 645 nm, 643 nm, 640 nm, 637 nm, 635 nm, 632 nm, or 630 nm. The lower limit for the wavelength peak is preferably 628 nm, 625 nm, 623 nm, 620 nm, 615 nm, 610 nm, 607 nm, or 605 nm.

In the present invention, the upper limit for the wavelength peak of the fluorescence emission spectrum of the green light-emitting nanocrystals that emit green light is preferably 560 nm, 557 nm, 555 nm, 550 nm, 547 nm, 545 nm, 543 nm, 540 nm, 537 nm, 535 nm, 532 nm, or 530 nm. The lower limit for the wavelength peak is preferably 528 nm, 525 nm, 523 nm, 520 nm, 515 nm, 510 nm, 507 nm, 505 nm, 503 nm, or 500 nm.

In the present invention, the upper limit for the wavelength peak of the fluorescence emission spectrum of the blue light-emitting nanocrystals that emit blue light is preferably 480 nm, 477 nm, 475 nm, 470 nm, 467 nm, 465 nm, 463 nm, 460 nm, 457 nm, 455 nm, 452 nm, or 450 nm. The lower limit for the wavelength peak is preferably 450 nm, 445 nm, 440 nm, 435 nm, 430 nm, 428 nm, 425 nm, 422 nm, or 420 nm.

In the present invention, it is desirable that the semiconductor materials contained in the red light-emitting nanocrystals that emit red light have a peak emission wavelength of 635 nm±30 nm. It is also desirable that the semiconductor materials contained in the green light-emitting nanocrystals that emit green light have a peak emission wavelength of 530 nm±30 nm. It is also desirable that the semiconductor materials contained in the blue light-emitting nanocrystals that emit blue light have a peak emission wavelength of 450 nm±30 nm.

The lower limit for the fluorescence quantum yield of the light-emitting nanocrystals according to the present invention is preferably 40% or more, is more preferably 30% or more, is further preferably 20% or more, and is most preferably 10% or more.

The upper limit for the half-width of the fluorescence emission spectrum of the light-emitting nanocrystals according to the present invention is preferably 60 nm or less, is more preferably 55 nm or less, is further preferably 50 nm or less, and is most preferably 45 nm or less.

The upper limit for the particle size (primary particle) of the red light-emitting nanocrystals according to the present invention is preferably 50 nm or less, is more preferably 40 nm or less, is further preferably 30 nm or less, and is most preferably 20 nm or less.

The upper and lower limits for the peak wavelength of the red light-emitting nanocrystals according to the present invention are 665 nm and 605 nm, respectively. The compound used and the particle size thereof are selected such that the peak wavelength of the red light-emitting nanocrystals falls within the above range. In the same manner as above, since the upper and lower limits for the peak wavelength of the green light-emitting nanocrystals are 560 nm and 500 nm, respectively, and the upper and lower limits for the peak wavelength of the blue light-emitting nanocrystals are 480 nm and 420 nm, the compound used and the particle size thereof are selected such that the peak wavelength of the green light-emitting nanocrystals or the blue light-emitting nanocrystals falls within the above range.

The liquid crystal display device according to the present invention includes at least one pixel. Colors constituting the pixel are produced by three adjacent pixels, each of which contains different nanocrystals that emit red light (e.g., CdSe light-emitting nanocrystals, CdSe rod-like light-emitting nanocrystals, rod-like light-emitting nanocrystals having a core-shell structure with the shell portion composed of CdS and the inner core portion composed of CdSe, rod-like light-emitting nanocrystals having a core-shell structure with the shell portion composed of CdS and the inner core portion composed of ZnSe, light-emitting nanocrystals having a core-shell structure with the shell portion composed of CdS and the inner core portion composed of CdSe, light-emitting nanocrystals having a core-shell structure with the shell portion composed of CdS and the inner core portion composed of ZnSe, light-emitting nanocrystals that are mixed crystals of CdSe and ZnS, rod-like light-emitting nanocrystals that are mixed crystals of CdSe and ZnS, InP light-emitting nanocrystals, InP rod-like light-emitting nanocrystals, light-emitting nanocrystals that are mixed crystals of CdSe and CdS, rod-like light-emitting nanocrystals that are mixed crystals of CdSe and CdS, light-emitting nanocrystals that are mixed crystals of ZnSe and CdS, and rod-like light-emitting nanocrystals that are mixed crystals of ZnSe and CdS), green light (e.g., CdSe light-emitting nanocrystals, CdSe rod-like light-emitting nanocrystals, light-emitting nanocrystals that are mixed crystals of CdSe and ZnS, and rod-like light-emitting nanocrystals that are mixed crystals of CdSe and ZnS), and blue light (ZnSe light-emitting nanocrystals, ZnSe rod-like light-emitting nanocrystals, ZnS light-emitting nanocrystals, ZnS rod-like light-emitting nanocrystals, light-emitting nanocrystals having a core-shell structure with the shell portion composed of ZnSe and the inner core portion composed of ZnS, rod-like light-emitting nanocrystals having a core-shell structure with the shell portion composed of ZnSe and the inner core portion composed of ZnS, CdS light-emitting nanocrystals, and CdS rod-like light-emitting nanocrystals). The photoconversion layer may contain other colors (e.g., yellow) as needed. Furthermore, different colors produced by four or more adjacent pixels may be used.

In this disclosure, the average particle size (primary particle) of the light-emitting nanocrystals according to the present invention can be measured by TEM observation. Common examples of the method for measuring the average particle size of nanocrystals include light scattering, a sedimentation particle size measurement method using a solvent, and a method in which particles are directly observed with an electron microscope to measure the average particle size. Since light-emitting nanocrystals are likely to become degraded by moisture and the like, it is suitable in the present invention to directly observe a plurality of crystals with a transmission electron microscope (TEM) or a scanning electron microscope (SEM), determine the particle size of each of the crystals on the basis of the ratio between the major and minor axes of the crystal measured using a two-dimensional projected image of the crystal, and calculate the average thereof. Therefore, in the present invention, average particle size is determined using the above-described method. Primary particles of a light-emitting nanocrystal are single-crystals or crystallites analogous to single-crystals which constitute the light-emitting nanocrystal and have a size of a few nanometers to several tens of nanometers. It is considered that the size and shape of primary particles of the light-emitting nanocrystals vary with the chemical composition and structure of the primary particles, production method, production conditions, and the like.

In the photoconversion layer according to the present invention, the light-emitting nanocrystals preferably include an organic ligand bonded to the surfaces thereof in order to enhance dispersion stability. The organic ligand may be, for example, coordinately bonded to the surfaces of the light-emitting nanocrystals. In other words, the surfaces of the light-emitting nanocrystals may be passivated with an organic ligand. The light-emitting nanocrystals may include a polymer dispersant deposited on the surfaces thereof. According to an embodiment, for example, a polymer dispersant may be bonded to the surfaces of light-emitting nanocrystals by removing an organic ligand from the light-emitting nanocrystals including an organic ligand and replacing the organic ligand with the polymer dispersant. However, in order to enhance dispersion stability in the case where an ink-jet ink is used, it is preferable that a polymer dispersant be mixed with light-emitting nanocrystals including an organic ligand coordinately bonded to the surfaces of the nanocrystals without replacing the organic ligand with the polymer dispersant.

The organic ligand is a low-molecular weight or high-molecular weight compound including a functional group having an affinity for the light-emitting nanocrystal particles. The functional group having an affinity for the light-emitting nanocrystal particles is not limited but is preferably a group including one element selected from the group consisting of nitrogen, oxygen, sulfur, and phosphorus. Examples thereof include an organic sulfur group, an organic phosphate group, a pyrrolidone group, a pyridine group, an amino group, an amide group, an isocyanate group, a carbonyl group, and a hydroxyl group. Examples thereof include TOP (trioctylphosphine), TOPO (trioctylphosphine oxide), oleic acid, oleylamine, octylamine, trioctylamine, hexadecylamine, octanethiol, dodecanethiol, hexylphosphonic acid (HPA), tetradecylphosphonic acid (TDPA), and octylphosphinic acid (OPA).

Another example of the organic ligand is preferably a ligand including an aliphatic hydrocarbon having an ethylene oxide chain and/or a propylene oxide chain serving as an affinity group in order to further enhance the dispersibility and emission intensity of the light-emitting nanocrystal particles.

The above preferable organic ligand may be, for example, the organic ligand represented by General Formula (1) below.

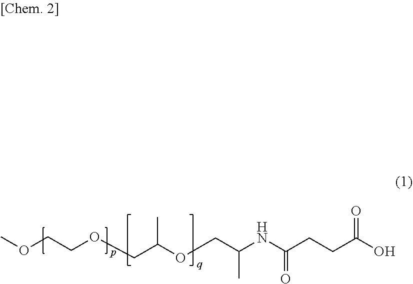

[in Formula (1), p represents an integer of 0 to 50, and q represents an integer of 0 to 50]

In the organic ligand represented by General Formula (1) above, it is preferable that at least one of p and q be 1 or more, and it is more preferable that both p and q be 1 or more.

The light-emitting nanocrystals may be dispersed in an organic solvent in a colloidal form. The surfaces of light-emitting nanocrystals dispersed in an organic solvent are preferably passivated with the above organic ligand. Examples of the organic solvent include cyclohexane, hexane, heptane, chloroform, toluene, octane, chlorobenzene, tetralin, diphenyl ether, propylene glycol monomethyl ether acetate, butyl carbitol acetate, and mixtures thereof.

The photoconversion layer (or an ink composition used for preparing the photoconversion layer) according to the present invention preferably contains a polymer dispersant. The polymer dispersant enables light-scattering particles to be uniformly dispersed in an ink.

The photoconversion layer according to the present invention preferably contains, in addition to the light-emitting nanocrystal particles described above, a polymer dispersant that enables the light-emitting nanocrystal particles to be dispersed and stabilized at an adequate level.

In the present invention, the polymer dispersant is a high-molecular-weight compound that has a weight-average molecular weight of 750 or more and includes a functional group having an affinity for light-scattering particles. The polymer dispersant enables the dispersion of the light-scattering particles. The polymer dispersant adsorbs to the light-scattering particles with the functional group having an affinity for the light-scattering particles, and the electrostatic repulsion and/or steric repulsion between the polymer dispersant particles causes the light-scattering particles to be dispersed in an ink composition. The polymer dispersant is preferably adsorbed to the light-scattering particles by being bonded to the surfaces of the light-scattering particles. Alternatively, the polymer dispersant may be adsorbed to the light-emitting nanoparticles by being bonded onto the surfaces of the light-emitting nanocrystals. In another case, the polymer dispersant may be contained in an ink composition as a free component.

Examples of the functional group having an affinity for the light-scattering particles include an acidic functional group, a basic functional group, and a nonionic functional group. The acidic functional group includes a dissociative proton and may be neutralized with a base, such as amine or a hydroxide ion. The basic functional group may be neutralized with an acid, such as an organic acid or an inorganic acid.

Examples of the acidic functional group include a carboxyl group (—COOH), a sulfo group (—SO₃H), a sulfate group (—OSO₃H), a phosphonic acid group (—PO(OH)₃), a phosphate group (—OPO(OH)₃), a phosphinic acid group (—PO(OH)—), and a mercapto group (—SH).

Examples of the basic functional group include primary, secondary, and tertiary amino groups, an ammonium group, an imino group, and nitrogen-containing heterocyclic groups, such as pyridine, pyrimidine, pyrazine, imidazole, and triazole.

Examples of the nonionic functional group include a hydroxyl group, an ether group, a thioether group, a sulfinyl group (—SO—), a sulfonyl group (—SO₂—), a carbonyl group, a formyl group, an ester group, a carbonate ester group, an amide group, a carbamoyl group, an ureido group, a thioamide group, a thioureido group, a sulfamoyl group, a cyano group, an alkenyl group, an alkynyl group, a phosphine oxide group, and a phosphine sulfide group.

In order to enhance the dispersion stability of the light-scattering particles, to reduce a side effect that causes sedimentation of the light-emitting nanocrystals, to increase ease of synthesis of the polymer dispersant, and to enhance the stability of the functional group, the acidic functional group is preferably a carboxyl group, a sulfo group, a phosphonic acid group, or a phosphate group, and the basic functional group is preferably an amino group. Among the above groups, a carboxyl group, a phosphonic acid group, and an amino group are more preferably used. Most preferably, an amino group is used.

A polymer dispersant including an acidic functional group has an acid value. The acid value of the polymer dispersant including an acidic functional group is preferably 1 to 150 mgKOH/g in terms of solid content. When the acid value of the polymer dispersant is 1 or more, the light-scattering particles are likely to have sufficiently high dispersibility. When the acid value of the polymer dispersant is 150 or less, degradation of the preservation stability of the pixel portions (cured products of the ink composition) may be limited.

A polymer dispersant including a basic functional group has an amine value. The amine value of the polymer dispersant including a basic functional group is preferably 1 to 200 mgKOH/g in terms of solid content. When the amine value of the polymer dispersant is 1 or more, the light-scattering particles are likely to have sufficiently high dispersibility. When the amine value of the polymer dispersant is 200 or less, degradation of the preservation stability of the pixel portions (cured products of the ink composition) may be limited.

The polymer dispersant may be a homopolymer produced from a single monomer or a copolymer produced from a plurality of types of monomers. The polymer dispersant may be any of a random copolymer, a block copolymer, and a graft copolymer. In the case where the polymer dispersant is a graft copolymer, the polymer dispersant may be a comb-shaped graft copolymer or a star graft copolymer. Examples of the polymer dispersant include an acrylic resin, a polyester resin, a polyurethane resin, a polyamide resin, polyether, a phenolic resin, a silicone resin, a polyurea resin, an amino resin, polyamines, such as polyethyleneimine and polyallylamine, an epoxy resin, and polyimide.

The polymer dispersant may be a commercial product. Examples of the commercial product include AJISPER PB series produced by Ajinomoto Fine-Techno Co., Inc., DISPERBYK series and BYK-series produced by BYK, and Efka series produced by BASF SE.

The photoconversion layer (or an ink composition used for preparing the photoconversion layer) according to the present invention preferably contains a resin component that serves as a binder in the cured product. The resin component according to the present invention is preferably a curable resin. The curable resin is preferably a thermosetting resin or a UV-curable resin.

The thermosetting resin includes a curable group. Examples of the curable group include an epoxy group, an oxetane group, an isocyanate group, an amino group, a carboxyl group, and a methylol group. The curable group is preferably an epoxy group in order to enhance the heat resistance and preservation stability of the cured product of the ink composition and to increase adhesion to the light-shielding portion (e.g., a black matrix) and the substrates. The thermosetting resin may include one type of curable groups or two or more types of curable groups.

The thermosetting resin may be a homopolymer produced from a single monomer or a copolymer produced from a plurality of types of monomers. The thermosetting resin may be any of a random copolymer, a block copolymer, and a graft copolymer.

The thermosetting resin is a compound that has two or more thermosetting functional groups per molecule and is commonly used in combination with a curing agent. In the case where the thermosetting resin is used, a catalyst capable of accelerating a thermosetting reaction (curing accelerator) may be further used. In other words, the ink composition may contain a thermosetting component including the thermosetting resin (in addition, as needed, the curing agent and the curing accelerator). In addition to the above components, a polymer that is not capable of initiating a polymerization reaction alone may be further used.

The compound that has two or more thermosetting functional groups per molecule may be, for example, an epoxy resin that has two or more epoxy groups per molecule (hereinafter, also referred to as “polyfunctional epoxy resin”). The term “epoxy resin” used herein refers to both monomer-type epoxy resin and polymer-type epoxy resin. The number of epoxy groups included in the polyfunctional epoxy resin per molecule is preferably 2 to 50 and is more preferably 2 to 20. The epoxy group may be any group having an oxirane ring structure. Examples of such an epoxy group include a glycidyl group, an oxyethylene group, and an epoxycyclohexyl group. Examples of the epoxy resin include publicly known polyvalent epoxy resins capable of becoming cured with carboxylic acid. Such epoxy resins are broadly disclosed in, for example, “Epoxy Resin Handbook”, edited by Masaki SHIMBO, published by The Nikkan Kogyo Shimbun, Ltd. (Showa 62 (1987)). The above polyvalent epoxy resins may be used.

Using a polyfunctional epoxy resin having a relatively low molecular weight as a thermosetting resin enables epoxy groups to be charged into the ink composition (ink-jet ink). Consequently, the epoxy concentration at the reaction point is increased, and the crosslinking density is increased accordingly.

The curing agent and the curing accelerator used for curing the thermosetting resin may be selected from publicly known and commonly used curing agents and curing accelerators which can be dissolved or dispersed in the organic solvent.

The thermosetting resin may be insoluble in alkalis. In such a case, highly reliable color filter pixel portions are likely to be produced. The expression “a thermosetting resin is insoluble in alkalis” used herein means that the amount of thermosetting resin that can be dissolved in a 1-mass % aqueous potassium hydroxide solution at 25° C. is 30% by mass or less of the total mass of the thermosetting resin. The amount of the thermosetting resin that dissolves in the solution is preferably 10% by mass or less and is more preferably 3% by mass or less of the total mass of the thermosetting resin.

The weight-average molecular weight of the thermosetting resin may be set to 750 or more, 1000 or more, or 2000 or more in order to increase the likelihood of the ink composition having an appropriate viscosity for ink-jet inks, to enhance the curability of the ink composition, and to enhance the resistance of the pixel portions (cured products of the ink composition) to solvents and abrasion. The weight-average molecular weight of the thermosetting resin may be set to 500000 or less, 300000 or less, or 200000 or less in order to adjust the viscosity of the composition to be within an appropriate range for ink-jet inks. Note that, the above limitations do not apply to the molecular weight of the thermosetting resin that has been cross-linked.

The amount of thermosetting resin may be set to 10% by mass or more, 15% by mass or more, or 20% by mass or more of the mass of the nonvolatile component of the ink composition in order to increase the likelihood of the ink composition having an appropriate viscosity for ink-jet inks, to enhance the curability of the ink composition, and to enhance the resistance of the pixel portions (cured products of the ink composition) to solvents and abrasion. The amount of thermosetting resin may be set to 90% by mass or less, 80% by mass or less, 70% by mass or less, 60% by mass or less, or 50% by mass or less of the mass of the nonvolatile component of the ink composition in order to prevent the pixel portions from having an excessively large thickness compared with the photoconversion function.

The UV-curable resin is preferably a resin produced by polymerizing a photo-radical polymerizable compound or a photo-cationic polymerizable compound, which becomes polymerized upon being irradiated with light. The UV-curable resin may be a photopolymerizable monomer or oligomer. The above substances are used in combination with a photopolymerization initiator. The photo-radical polymerizable compound is preferably used in combination with a photo-radical polymerization initiator. The photo-cationic polymerizable compound is preferably used in combination with a photo-cationic polymerization initiator. In other words, the ink composition used for preparing the photoconversion layer according to the present invention may contain a photopolymerizable component including a photopolymerizable compound and a photopolymerization initiator, may contain a photo-radical polymerizable component including a photo-radical polymerizable compound and a photo-radical polymerization initiator, and may contain a photo-cationic polymerizable component including a photo-cationic polymerizable compound and a photo-cationic polymerization initiator. The photo-radical polymerizable compound may be used in combination with the photo-cationic polymerizable compound. A compound having photo-radical polymerizability and photo-cationic polymerizability may be used. The photo-radical polymerization initiator may be used in combination with the photo-cationic polymerization initiator. One type of a photopolymerizable compound may be used alone. Two or more types of photopolymerizable compounds may be used in combination.

Examples of the photo-radical polymerizable compound include a (meth)acrylate compound. The (meth)acrylate compound may be a monofunctional (meth)acrylate having one (meth)acryloyl group or a polyfunctional (meth)acrylate having a plurality of (meth)acryloyl groups. It is preferable to use a monofunctional (meth)acrylate and a polyfunctional (meth)acrylate in combination in order to limit the degradation of flatness and smoothness which may be caused due to cure shrinkage that occurs in the production of color filters. Note that, the term “(meth)acrylate” used herein refers to “acrylate” and “methacrylate” corresponding to the acrylate. The same applies to the expression “(meth)acryloyl” used herein.

Examples of the photo-cationic polymerizable compound include an epoxy compound, an oxetane compound, and a vinyl ether compound.

The photopolymerizable compound used in this embodiment may be the photopolymerizable compound described in Paragraphs 0042 to 0049 in Japanese Unexamined Patent Application Publication No. 2013-182215.

In the ink composition used for preparing the photoconversion layer according to the present invention, in the case where the curable component is only the photopolymerizable compound or includes the photopolymerizable compound as a principal constituent, it is more preferable to use, as a photopolymerizable compound, a polyfunctional photopolymerizable compound having two or more polymerizable functional groups per molecule, that is, having two or more functional groups, as an essential component in order to further enhance the durability (e.g., strength and heat resistance) of the cured product.

The photopolymerizable compound may be insoluble in alkalis. In such a case, highly reliable color filter pixel portions are likely to be produced. The expression “a photopolymerizable compound is insoluble in alkalis” used herein means that the amount of photopolymerizable compound that can be dissolved in a 1-mass % aqueous potassium hydroxide solution at 25° C. is 30% by mass or less of the total mass of the photopolymerizable compound. The amount of the photopolymerizable compound that dissolves in the solution is preferably 10% by mass or less and is more preferably 3% by mass or less of the total mass of the photopolymerizable compound.

The amount of photopolymerizable compound may be set to 10% by mass or more, 15% by mass or more, or 20% by mass or more of the mass of the nonvolatile component of the ink composition in order to enhance the curability of the ink composition and to enhance the resistance of the pixel portions (cured products of the ink composition) to solvents and abrasion. The amount of photopolymerizable compound may be set to 90% by mass or less, 80% by mass or less, 70% by mass or less, 60% by mass or less, or 50% by mass or less of the mass of the nonvolatile component of the ink composition in order to further enhance optical properties (exit of light).

The photopolymerizable compound may have a crosslinkable group in order to enhance the stability of the pixel portions (cured products of the ink composition)(e.g., to limit age degradation and enhance high-temperature preservation stability and wet-heat preservation stability). The crosslinkable group is a functional group capable of reacting with other crosslinkable groups by heat or an active energy ray (e.g., ultraviolet radiation). Examples of the crosslinkable group include an epoxy group, an oxetane group, a vinyl group, an acryloyl group, an acryloyloxy group, and a vinyl ether group.

The photo-radical polymerization initiator is suitably a molecule-opening or hydrogen-abstracting photo-radical polymerization initiator.

The amount of photopolymerization initiator may be set to 0.1 parts by mass or more. 0.5 parts by mass or more, or 1 part by mass or more relative to 100 parts by mass of the photopolymerizable compound in order to enhance the curability of the ink composition. The amount of photopolymerization initiator may be set to 40 parts by mass or less, 30 parts by mass or less, or 20 parts by mass or less relative to 100 parts by mass of the photopolymerizable compound in order to enhance the temporal stability of the pixel portions (cured products of the ink composition).

The above UV-curable resins may be used in combination with a thermoplastic resin. Examples of the thermoplastic resin include a urethane resin, an acrylic resin, a polyamide resin, a polyimide resin, a styrene-maleic acid resin, and a styrene-maleic anhydride resin.

The ink composition used for preparing the photoconversion layer according to the present invention may contain publicly known organic solvents, such as ethylene glycol monobutyl ether acetate, diethylene glycol monobutyl ether acetate, diethylene glycol monoethyl ether acetate, diethylene glycol dibutyl ether, diethyl adipate, dibutyl oxalate, dimethyl malonate, diethyl malonate, dimethyl succinate, diethyl succinate, 1,4-butanediol diacetate, and glyceryl triacetate.

The photoconversion layer according to the present invention (or the ink composition used for preparing the photoconversion layer) may further contain publicly known additives, such as light-scattering particles, in addition to the above-described curable resin, the above-described polymer dispersant, and the above-described light-emitting nanocrystal particles.

When color filter pixel portions (hereinafter, may be referred to simply as “pixel portions”) are formed using an ink composition containing the light-emitting nanocrystals, light emitted from a light source may fail to be absorbed by the light-emitting nanocrystals and exit from the pixel portions. Since such exited light degrades the color reproducibility of the pixel portions, it is preferable to minimize the amount of the exited light when the photoconversion layer includes such pixel portions. The light-scattering particles are suitably used for preventing the light from exiting from the pixel portions. The light-scattering particles are, for example, inorganic fine particles which are optically inactive. The light-scattering particles are capable of scattering light emitted from a light source and impinged to the color filter pixel portions.

Examples of the material constituting the light-scattering particles include simple-substance metals, such as tungsten, zirconium, titanium, platinum, bismuth, rhodium, palladium, silver, tin, platinum, and gold; metal oxides, such as silica, barium sulfate, barium carbonate, calcium carbonate, talc, titanium oxide, clay, kaolin, barium sulfate, barium carbonate, calcium carbonate, alumina white, titanium oxide, magnesium oxide, barium oxide, aluminum oxide, bismuth oxide, zirconium oxide, and zinc oxide; metal carbonates, such as magnesium carbonate, barium carbonate, bismuth subcarbonate, and calcium carbonate; metal hydroxides, such as aluminum hydroxide; composite oxides, such as barium zirconate, calcium zirconate, calcium titanate, barium titanate, and strontium titanate, and metal salts, such as bismuth subnitrate. The light-scattering particles preferably contain at least one substance selected from the group consisting of titanium oxide, alumina, zirconium oxide, zinc oxide, calcium carbonate, barium sulfate, and silica and more preferably contain at least one substance selected from the group consisting of titanium oxide, barium sulfate, and calcium carbonate in order to further reduce the exit of light.

The shape of the light-scattering particles may be spherical, filamentous, indefinite, or the like. However, as for the shape of the light-scattering particles, it is preferable to use light-scattering particles having low directionality (e.g., spherical or tetrahedral particles) in order to further enhance the uniformity, flowability, and light-scattering property of the ink composition.

The average size (volume-average size) of the light-scattering particles contained in the ink composition may be 0.05 μm or more, 0.2 μm or more, or 0.3 μm or more in order to further reduce the exit of the light. The average size (volume-average size) of the light-scattering particles contained in the ink composition may be 1.0 μm or less, 0.6 μm or less, or 0.4 μm or less in order to enhance ejection consistency. The average size (volume-average size) of the light-scattering particles contained in the ink composition may also be 0.05 to 1.0 μm, 0.05 to 0.6 μm, 0.05 to 0.4 μm, 0.2 to 1.0 μm, 0.2 to 0.6 μm, 0.2 to 0.4 μm, 0.3 to 1.0 μm, 0.3 to 0.6 μm, or 0.3 to 0.4 μm. In order to increase the likelihood of the light-scattering particles contained in the ink composition having the above average size (volume-average size), the average size (volume-average size) of the light-scattering particles used may be set to 50 nm or more or 1000 nm or less. The average size (volume-average size) of the light-scattering particles can be determined by subjecting the light-scattering particles to a dynamic light-scattering particle size distribution analyzer Nanotrac and calculating the volume-average size thereof. The average size (volume-average size) of the light-scattering particles used can be determined by, for example, measuring the size of each of the particles with a transmission electron microscope or a scanning electron microscope and calculating the volume-average size of the particles.

The amount of the light-scattering particles may be set to 0.1% by mass or more, 1% by mass or more, 5% by mass or more, 7% by mass or more, 10% by mass or more, or 12% by mass or more of the mass of the nonvolatile component of the ink composition in order to further reduce the exit of the light. The amount of the light-scattering particles may be set to 60% by mass or less, 50% by mass or less, 40% by mass or less, 30% by mass or less, 25% by mass or less, 20% by mass or less, or 15% by mass or less of the mass of the nonvolatile component of the ink composition in order to further reduce the exit of the light and enhance ejection consistency. Since the ink composition contains a polymer dispersant in this embodiment, the light-scattering particles can be dispersed in a suitable manner even when the amount of the light-scattering particles is limited to be within the above range.

The mass ratio of the light-scattering particles to the light-emitting nanocrystals (light-scattering particles/light-emitting nanocrystals) is 0.1 to 5.0. The above mass ratio (light-scattering particles/light-emitting nanocrystals) may be set to 0.2 or more or 0.5 or more in order to further reduce the exit of the light. The above mass ratio (light-scattering particles/light-emitting nanocrystals) may be set to 2.0 or less or 1.5 or less in order to further reduce the exit of the light. The above mass ratio (light-scattering particles/light-emitting nanocrystals) may be set to 0.1 to 2.0, 0.1 to 1.5, 0.2 to 5.0, 0.2 to 2.0, 0.2 to 1.5, 0.5 to 5.0, 0.5 to 2.0, or 0.5 to 1.5. It is considered that the light-scattering particles reduce the exit of the light by the following mechanisms. Specifically, in the case where the light-scattering particles are absent, light emitted from the backlight travels inside the pixel portions in substantially straight lines and only passes through the pixel portions. In such a case, the light does not have a high opportunity to be absorbed by the light-emitting nanocrystals. In contrast, in the case where the light-scattering particles are present in the pixel portions that contain the light-emitting nanocrystals, light emitted from the backlight is scattered inside the pixel portions in all directions, and the light-emitting nanocrystals can receive the scattered light. In such a case, although the backlight used is the same, the amount of light absorbed in the pixel portions can be increased. It is considered that the exit of the light can be reduced by the above-described mechanisms.

The photoconversion layer according to the present invention preferably contains, in addition to the above-described light-emitting nanocrystals, a resin component that enables the light-emitting nanocrystals to be dispersed and stabilized at a level adequate for the production process.

The resin component is preferably a polymer that is produced from a photopolymerizable compound and enables alkali development in order to enable the production of the photoconversion layer by photolithography. Specific examples thereof include polymers produced from a difunctional monomer, such as 1,6-hexanediol diacrylate, ethylene glycol diacrylate, neopentyl glycol diacrylate, triethylene glycol diacrylate, bis(acryloxy ethoxy) bisphenol A, or 3-methyl pentanediol diacrylate: polymers produced from a polyfunctional monomer having a relatively low molecular weight, such as trimethylolpropatone triacrylate, pentaerythritol triacrylate, tris[2-(meth)acryloyloxy ethyl) isocyanurate, dipentaerythritol hexaacrylate, or dipentaerythritol pentaacrylate; and polymers produced from a polyfunctional monomer having a relatively high molecular weight, such as polyester acrylate, polyurethane acrylate, or polyether acrylate.

The above polymers may be used in combination with a thermoplastic resin. Examples of the thermoplastic resin include a urethane resin, an acrylic resin, a polyamide resin, a polyimide resin, a styrene-maleic acid resin, and a styrene-maleic anhydride resin.

The photoconversion layer according to the present invention may further contain, as needed, publicly known additives, such as a polymerization initiator, a catalyst, and a scattering agent composed of alumina, silica, titanium oxide beads, zeolite, zirconia, or the like, in addition to the above-described transparent resin and the above-described light-emitting nanocrystals.

### (Coloring Material)

The photoconversion layer according to the present invention includes three-color pixel portions, that is, red (R) pixel portions, green (G) pixel portions, and blue (B) pixel portions, and may optionally contain coloring materials. The coloring materials may be publicly known coloring materials. For example, it is preferable that the red (R) pixel portions contain a diketopyrrolopyrrole pigment and/or an anionic red organic dye, the green (G) pixel portions contain at least one coloring material selected from the group consisting of a halogenated copper phthalocyanine pigment, a phthalocyanine green dye, and a mixture of a phthalocyanine blue dye and an azo yellow organic dye, and the blue (B) pixel portions contain an s-type copper phthalocyanine pigment and/or a cationic blue organic dye.

A preferable coloring material that may optionally be added to the red color layers according to the present invention in combination with the light-emitting nanocrystals preferably includes a diketopyrrolopyrrole pigment and/or an anionic red organic dye. Specifically, the diketopyrrolopyrrole pigment is preferably one or two or more pigments selected from C.I. Pigment Red 254, C.I. Pigment Red 255, C.I. Pigment Red 264, C.I. Pigment Red 272, C.I. Pigment Orange 71, and C.I. Pigment Orange 73, is more preferably one or two or more pigments selected from C.I. Pigment Red 254, C.I. Pigment Red 255, C.I. Pigment Red 264, and C.I. Pigment Red 272, and is particularly preferably C.I. Pigment Red 254. The anionic red organic dye is, specifically, preferably one or two or more pigments selected from C.I. Solvent Red 124, C.I. Acid Red 52, and C.I. Acid Red 289 and is particularly preferably C.I. Solvent Red 124.

The red color layers according to the present invention preferably further contain, as a coloring material, at least one organic dye or pigment selected from the group consisting of C.I. Pigment Red 177, C.I. Pigment Red 242, C.I. Pigment Red 166, C.I. Pigment Red 167, C.I. Pigment Red 179, C.I. Pigment Orange 38, C.I. Pigment Orange 71, C.I. Pigment Yellow 150, C.I. Pigment Yellow 215, C.I. Pigment Yellow 185, C.I. Pigment Yellow 138, C.I. Pigment Yellow 139, C.I. Solvent Red 89, C.I. Solvent Orange 56, C.I. Solvent Yellow 21, C.I. Solvent Yellow 82, C.I. Solvent Yellow 83:1, C.I. Solvent Yellow 33, and C.I. Solvent Yellow 162.

A preferable coloring material that may optionally be added to the green color layers according to the present invention in combination with the light-emitting nanocrystals preferably includes at least one substance selected from the group consisting of a halogenated metal phthalocyanine pigment, a phthalocyanine green dye, and a mixture of a phthalocyanine blue dye and an azo yellow organic dye. Examples of the halogenated metal phthalocyanine pigment include halogenated metal phthalocyanine pigments belonging to the following two groups.

### (Group 1)

Halogenated metal phthalocyanine pigments including a metal selected from the group consisting of Al, Si, Sc, Ti, V, Mg, Fe, Co, Ni, Zn, Ga, Ge, Y, Zr, Nb, In, Sn, and Pb as a central metal, wherein 8 to 16 halogen atoms per phthalocyanine molecule are bonded to the benzene rings of the phthalocyanine molecule and wherein, when the central metal is trivalent, one atom or group selected from a halogen atom, a hydroxyl group, and a sulfonic group (—SO₃H) is bonded to the central metal or, when the central metal is a tetravalent metal, one oxygen atom or two identical or different atoms or groups selected from a halogen atom, a hydroxyl group, and a sulfonic group are bonded to the central metal.

### (Group 2)

Pigments that are halogenated metal phthalocyanine dimers having a structural unit constituted by two halogenated metal phthalocyanine molecules, the halogenated metal phthalocyanine molecules each including a trivalent metal selected from the group consisting of Al, Sc, Ga, Y, and In as a central metal and 8 to 16 halogen atoms bonded to the benzene rings of the phthalocyanine molecule, the central metals in the structural unit being bonded to each other via a divalent atomic group selected from the group consisting of an oxygen atom, a sulfur atom, sulfinyl (—SO—), and sulfonyl (—SO₂—).

In the halogenated metal phthalocyanine pigment used in the present invention, the halogen atoms bonded to the benzene rings may be all identical or different. Different halogen atoms may be bonded to one benzene ring.

When 9 to 15 bromine atoms of the 8 to 16 halogen atoms per phthalocyanine molecule are bonded to the benzene rings of the phthalocyanine molecule, the halogenated metal phthalocyanine pigment used in the present invention appears yellowish-light green and is most suitably used for green pixel portions of the color filter. The halogenated metal phthalocyanine pigment used in the present invention is insoluble or hardly soluble in water and organic solvents. The halogenated metal phthalocyanine pigment used in the present invention may be a halogenated metal phthalocyanine pigment that has not yet been subjected to the finishing treatment described below (also referred to as “crude pigment”) or may be a halogenated metal phthalocyanine pigment that has been subjected to the finishing treatment.

The halogenated metal phthalocyanine pigments belonging to Group 1 or 2 above can be represented by General Formula (PIG-1) below:

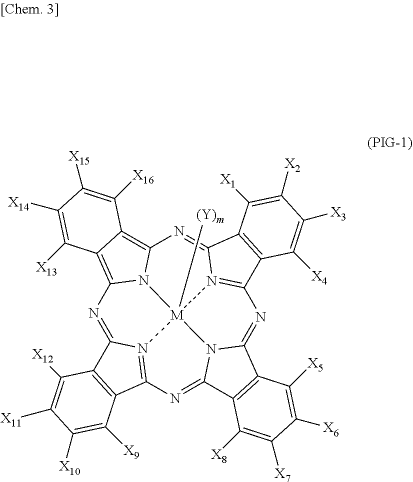

In General Formula (PIG-1), the halogenated metal phthalocyanine pigments belonging to Group 1 are as follows.

In General Formula (PIG-1), X₁ to X₁₆ represent a hydrogen atom, a chlorine atom, a bromine atom, or an iodine atom. The four atoms X bonded to one benzene ring may be identical or different. Among X₁ to X₁₆ bonded to the 4 benzene rings, 8 to 16 X's are chlorine atoms, bromine atoms, or iodine atoms. M represents a central metal. Among halogenated metal phthalocyanine pigments having the same Y described below and the same m, which is the number of Y's, a pigment in which, among 16 X's of X₁ to X₁₆, the total number of chlorine atoms, bromine atoms, and iodine atoms is less than 8 appears blue. In the same manner, among pigments in which, among 16 X's of X₁ to X₁₆, the total number of chlorine atoms, bromine atoms, and iodine atoms is 8 or more, the greater the total number of chlorine atoms, bromine atoms, and iodine atoms, the higher the degree of yellow. Y bonded to the central metal M is a monovalent atomic group selected from the group consisting of a halogen atom that is any one of a fluorine atom, a chlorine atom, a bromine atom, and an iodine atom; an oxygen atom; a hydroxyl group; and a sulfonic group, and m represents the number of Y's bonded to the central metal M and is an integer of 0 to 2.

The value of m is determined on the basis of the valence of the central metal M. When the central metal M is trivalent as is the case for Al, Sc, Ga, Y, and In, m=i. In this case, one atom or group selected from the group consisting of a fluorine atom, a chlorine atom, a bromine atom, an iodine atom, a hydroxyl group, and a sulfonic group is bonded to the central metal. When the central metal M is tetravalent as is the case for Si, Ti, V, Ge, Zr, and Sn, m=2. In this case, one oxygen atom is bonded to the central metal, or two groups selected from the group consisting of a fluorine atom, a chlorine atom, a bromine atom, an iodine atom, a hydroxyl group, and a sulfonic group are bonded to the central metal. When the central metal M is divalent as is the case for Mg, Fe, Co, Ni, Zn, Zr, Sn, and Pb, Y is absent.

In General Formula (PIG-1) above, the halogenated metal phthalocyanine pigments belonging to Group 2 are as follows.

In General Formula (PIG-1), X₁ to X₁₆ are the same as defined above, the central metal M represents a trivalent metal selected from the group consisting of Al, Sc, Ga, Y, and In, and m is 1. Y represents the following atomic group:

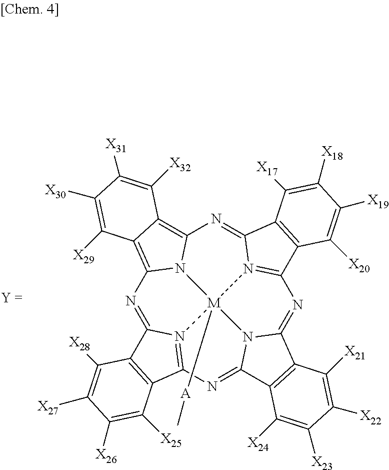

In the chemical structure of the atomic group Y, the central metal M is the same as defined above, and X₁ to X₃₂ are the same as the above-described definition of X₁ to X₁₆ in General Formula (PIG-1). A represents a divalent atomic group selected from the group consisting of an oxygen atom, a sulfur atom, sulfinyl (—SO—), and sulfonyl (—SO₂—). M of General Formula (PIG-1) and M of the atomic group Y are bonded to each other via the divalent atomic group A.

In other words, the halogenated metal phthalocyanine pigments belonging to Group 2 are halogenated metal phthalocyanine dimers having a structural unit constituted by two halogenated metal phthalocyanine molecules bonded to each other via the divalent atomic group.

Specific examples of the halogenated metal phthalocyanine pigments represented by General Formula (PIG-1) include (1) to (4) described below.

(1) Halogenated metal phthalocyanine pigments including a divalent metal selected from the group consisting of Mg, Fe, Co, Ni, Zn, Zr, Sn, and Pb as a central metal, in which 8 to 16 halogen atoms are bonded to 4 benzene rings per phthalocyanine molecule, such as a halogenated tin phthalocyanine pigment, a halogenated nickel phtalocyanine pigment, and a halogenated zinc phtalocyanine pigment. Among such halogenated metal phthalocyanine pigments, in particular, a chlorinated and brominated zinc phtalocyanine pigment, that is, C.I. Pigment Green 58, is preferably used.

(2) Halogenated metal phthalocyanine pigments including a trivalent metal selected from the group consisting of Al, Sc, Ga, Y, and In as a central metal, in which one atom or group selected from a halogen atom, a hydroxyl group, and a sulfonic group is bonded to the central metal and 8 to 16 halogen atoms are bonded to 4 benzene rings per phthalocyanine molecule, such as halogenated chloroaluminum phthalocyanine.

(3) Halogenated metal phthalocyanine pigments including a tetravalent metal selected from the group consisting of Si, Ti, V, Ge, Zr, and Sn as a central metal, in which one oxygen atom or two identical or different atoms or groups selected from a halogen atom, a hydroxyl group, and a sulfonic group are bonded to the central metal and 8 to 16 halogen atoms are bonded to 4 benzene rings per phthalocyanine molecule, such as halogenated oxytitanium phthalocyanine and halogenated oxyvanadium phthalocyanine.

(4) Pigments that are halogenated metal phthalocyanine dimers having a structural unit constituted by two halogenated metal phthalocyanine molecules, the halogenated metal phthalocyanine molecules each including a trivalent metal selected from the group consisting of Al, Sc, Ga, Y, and In as a central metal and 8 to 16 halogen atoms bonded to 4 benzene rings per phthalocyanine molecule, the central metals in the structural unit being bonded to each other via a divalent atomic group selected from the group consisting of an oxygen atom, a sulfur atom, sulfinyl, and sulfonyl, such as a halogenated p-oxo-aluminium phthalocyanine dimer and a halogenated p-thio-aluminium phthalocyanine dimer.

It is preferable that the green color layers optionally contain, as other coloring materials, a mixture of C.I. Solvent Blue 67 and C.I. Solvent Yellow 162 or C.I. Pigment Green 7 and/or C.I. Pigment Green 36.

The green color layers according to the present invention preferably further contain, as a coloring material, at least one organic dye or pigment selected from the group consisting of C.I. Pigment Yellow 150, C.I. Pigment Yellow 215, C.I. Pigment Yellow 185, C.I. Pigment Yellow 138, C.I. Solvent Yellow 21, C.I. Solvent Yellow 82, C.I. Solvent Yellow 83:1, and C.I. Solvent Yellow 33.

A preferable coloring material that may optionally be added to the blue color layers according to the present invention in combination with the light-emitting nanocrystals preferably includes an s-type copper phthalocyanine pigment and/or a cationic blue organic dye. The s-type copper phthalocyanine pigment is C.I. Pigment Blue 15:6. The cationic blue organic dye is, specifically, preferably C.I. Solvent Blue 2, C.I. Solvent Blue 3, C.I. Solvent Blue 4, C.I. Solvent Blue 5, C.I. Solvent Blue 6, C.I. Solvent Blue 7, C.I. Solvent Blue 23, C.I. Solvent Blue 43, C.I. Solvent Blue 72, C.I. Solvent Blue 124, C.I. Basic Blue 7, or C.I. Basic Blue 26, is more preferably C.I. Solvent Blue 7 or C.I. Basic Blue 7, and is particularly preferably C.I. Solvent Blue 7.

The blue color layers according to the present invention preferably further contain, as a coloring material, at least one organic dye or pigment selected from the group consisting of C.I. Pigment Blue 1, C.I. Pigment Violet 23, C.I. Basic Blue 7, C.I. Basic Violet 10, C.I. Acid Blue 1, C.I. Acid Blue 90, C.I. Acid Blue 83, and C.I. Direct Blue 86.

In the case where the photoconversion layer according to the present invention includes yellow (Y) pixel portions (yellow color layer), the yellow color layer preferably contains, as a coloring material, at least one yellow organic dye or pigment selected from the group consisting of C.I. Pigment Yellow 150, C.I. Pigment Yellow 215, C.I. Pigment Yellow 185, C.I. Pigment Yellow 138, C.I. Pigment Yellow 139, C.I. Solvent Yellow 21, C.I. Solvent Yellow 82, C.I. Solvent Yellow 83:1, C.I. Solvent Yellow 33, and C.I. Solvent Yellow 162.

In the photoconversion layer according to the present invention, the upper limit for the amount of the light-emitting nanocrystals relative to the transparent resin is preferably 80 parts by mass, 70 parts by mass, 60 parts by mass, or 50 parts by mass relative to 100 parts by mass of the transparent resin. The lower limit for the amount of the light-emitting nanocrystals is preferably 1.0 parts by mass, 3.0 parts by mass, 5.0 parts by mass, or 10.0 parts by mass relative to 100 parts by mass of the transparent resin. In the case where the photoconversion layer contains a plurality of types of light-emitting nanocrystals, the term “the amount of the light-emitting nanocrystals” refers to the total amount of a plurality of types of light-emitting nanocrystals.

### (Color Filter)

The photoconversion layer according to the present invention is preferably a multilayer body including a layer (NC) containing the light-emitting nanocrystals and a color filter (CF) that are stacked on top of each other (e.g., FIG. 19). Specifically, the photoconversion layer preferably includes red color layers R, green color layers G, and blue color layers B. In this case, the red (R) pixels R (red color layer portions R) are preferably constituted by a layer (NC) containing red light-emitting nanocrystals and a coloring material layer (CF-Red) containing a red coloring material. The green (R) pixel portions (green color layer portions G) are preferably constituted by a layer (NC) containing green light-emitting nanocrystals and a coloring material layer (CF-Green) containing a green coloring material or a coloring material layer (yellow color layer) containing a yellow coloring material. The blue (R) pixel portions (blue color layer portions B) are preferably constituted by a coloring material layer (CF-Blue, a layer containing a blue coloring material) containing a blue coloring material and/or a transparent resin layer and, as needed, a layer (NC) containing blue light-emitting nanocrystals. In the present invention, a color filter containing coloring materials, such as the coloring material layers (CF-Green, CF, Red) included in the photoconversion pixel layer in FIG. 7, the color filters (CFL) illustrated in FIGS. 8 and 9, or the blue color filter (CF-Blue) illustrated in FIG. 9, may optionally be used.

The color filter is preferably formed using the above-described coloring materials. For example, the red (R) color filters preferably contain a diketopyrrolopyrrole pigment and/or an anionic red organic dye. The green (G) color filters preferably contain at least one dye or pigment selected from the group consisting of a halogenated copper phthalocyanine pigment, a phthalocyanine green dye, and a mixture of a phthalocyanine blue dye and an azo yellow organic dye. The blue (B) color filters preferably contain an s-type copper phthalocyanine pigment and/or a cationic blue organic dye.

The color filter may optionally contain the above-described transparent resin, a photo-curable compound, a dispersing agent, and the like, which are described below. The color filter can be formed by a publicly known method, such as photolithography.

### (Method for Producing Photoconversion Layer)

The photoconversion layer may be formed by the method known in the related art. One of the common methods for forming the pixel portions is photolithography. In photolithography, the light-emitting nanocrystal-containing photo-curable composition described below is applied to a surface of a transparent substrate, which is commonly used for preparing color filters in the related art, on which a black matrix has been formed and then dried by being heated (pre-baked). Subsequently, the surface of the transparent substrate is irradiated with ultraviolet radiation through a photomask, that is, subjected to pattern exposure, to cure portions of the photo-curable compound which correspond to pixel portions. The other portions of the photo-curable compound which have not exposed to light are developed with a developing solution, and non-pixel portions are removed. Thus, the pixel portions are fixed on the transparent substrate. In this method, pixel portions formed of a cured, colored coating film composed of the light-emitting nanocrystal-containing photo-curable composition are formed on the transparent substrate.

For each of red (R) pixels, green (G) pixels, blue (B) pixels, and, as needed, other color pixels such as yellow (Y) pixels, the photo-curable compositions described below are prepared and the above-described operations are repeated to produce a photoconversion layer including colored pixel portions of red (R) pixels, green (G) pixels, blue (B) pixels, and yellow (Y) pixels formed at predetermined positions.

The light-emitting nanocrystal-containing photo-curable composition described below can be applied to a transparent substrate composed of glass or the like by, for example, spin coating, roll coating, or an ink-jet method.

The conditions under which the coating film composed of the light-emitting nanocrystal-containing photo-curable composition which is deposited on the transparent substrate is dried vary depending on, for example, the types and proportions of the constituents of the photo-curable composition, but are generally at 50° C. to 150° C. for about 1 to 15 minutes. The light used for photo-curing of the light-emitting nanocrystal-containing photo-curable composition is preferably ultraviolet radiation or visible light at wavelengths of 200 to 500 nm. Any light source that emits light in this wavelength range may be used.

Examples of the developing method include a liquid application method, a dipping method, and a spraying method. After the exposure and development of the photo-curable composition, the transparent substrate on which the pixel portions of the intended colors are formed is washed with water and then dried. The resulting color filter is subjected to a heat treatment (post-baking) at 90° C. to 280° C. for a predetermined amount of time using a heating device, such as a hot plate or an oven. This removes volatile constituents of the colored coating film and also causes thermosetting of an unreacted portion of the photo-curable compound which remains in the cured, colored coating film composed of the light-emitting nanocrystal-containing photo-curable composition. Thus, a photoconversion layer is formed.

By using the above-described coloring materials for the photoconversion layer and resins according to the present invention in combination with the light-emitting nanocrystals according to the present invention, a liquid crystal display apparatus that may limit a reduction in the voltage holding ratio (VHR) of the liquid crystal layer, the degradation of the liquid crystal layer caused by blue light or ultraviolet light, and an increase in the ion density (ID) in the liquid crystal layer and thereby address the issues of faulty display, such as white missing pixels, orientation inconsistencies, and image-sticking, can be provided.

In general, the light-emitting nanocrystal-containing photo-curable composition is prepared by the following method. The light-emitting nanocrystals are mixed with an organic solvent. As needed, molecules having an affinity, a dispersing agent, and coloring materials (i.e., dyes and/or pigment compositions) are added to the resulting mixture. The mixture is stirred to form a uniform dispersion liquid for forming the pixel portions of the photoconversion layer. To the dispersion liquid, the photo-curable compound and, as needed, the thermoplastic resin, the photopolymerization initiator, and the like are added. Hereby, a light-emitting nanocrystal-containing photo-curable composition that contains the light-emitting nanocrystals is prepared.

Examples of the organic solvent used above include aromatic compound solvents, such as toluene, xylene, and methoxybenzene; acetate ester solvents, such as ethyl acetate, propyl acetate, butyl acetate, propylene glycol monomethyl ether acetate, propylene glycol monoethyl ether acetate, diethylene glycol methyl ether acetate, diethylene glycol ethyl ether acetate, diethylene glycol propyl ether acetate, and diethylene glycol butyl ether acetate; propionate solvents, such as ethoxyethyl propionate; alcohol solvents, such as methanol and ethanol; ether solvents, such as butyl cellosolve, propylene glycol monomethyl ether, diethylene glycol ethyl ether, and diethylene glycol dimethyl ether; ketone solvents, such as methyl ethyl ketone, methyl isobutyl ketone, and cyclohexanone; aliphatic hydrocarbon solvents, such as hexane; nitrogen compound solvents, such as N,N-dimethylformamide, γ-butyrolactam, N-methyl-2-pyrrolidone, aniline, and pyridine; lactone solvents, such as γ-butyrolactone; and carbamate ester, such as a 48:52 mixture of methyl carbamate and ethyl carbamate.

Examples of the dispersant used above include DISPERBYK 130, DISPERBYK 161, DISPERBYK 162, DISPERBYK 163, DISPERBYK 170, DISPERBYK 171, DISPERBYK 174, DISPERBYK 180, DISPERBYK 182, DISPERBYK 183, DISPERBYK 184, DISPERBYK 185, DISPERBYK 2000, DISPERBYK 2001, DISPERBYK 2020, DISPERBYK 2050, DISPERBYK 2070, DISPERBYK 2096, DISPERBYK 2150, DISPERBYK LPN21116, and DISPERBYK LPN6919 produced by BYK-Chemie; EFKA 46, EFKA 47, EFKA 452, EFKA LP4008, EFKA 4009, EFKA LP4010, EFKA LP4050, LP4055, EFKA 400, EFKA 401, EFKA 402, EFKA 403, EFKA 450, EFKA 451, EFKA 453, EFKA 4540, EFKA 4550, EFKA LP4560, EFKA 120, EFKA 150, EFKA 1501, EFKA 1502, and EFKA 1503 produced by EFKA; Solsperse 3000, Solsperse 9000, Solsperse 13240, Solsperse 13650, Solsperse 13940, Solsperse 17000, 18000, Solsperse 20000, Solsperse 21000, Solsperse 20000, Solsperse 24000, Solsperse 26000, Solsperse 27000, Solsperse 28000, Solsperse 32000, Solsperse 36000, Solsperse 37000, Solsperse 38000, Solsperse 41000, Solsperse 42000, Solsperse 43000, Solsperse 46000, Solsperse 54000, and Solsperse 71000 produced by Lubrizol Corporation; and AJISPER PB711, AJISPER PB821, AJISPER PB822, AJISPER PB814, AJISPER PN411, and AJISPER PA111 produced by Ajinomoto Co., Inc. In addition, acrylic resins; urethane resins; alkyd resins; natural rosins, such as a wood rosin, a gum rosin, and a tall rosin; and synthetic resins that are insoluble in water and liquid at room temperature may also be used. Examples of such synthetic resins include polymerized rosins, disproportionated rosins, hydrogenated rosins, oxidized rosins, modified rosins such as a maleated rosin, rosin amine, lime rosin, and rosin derivatives, such as alkylene oxide adducts of a rosin, alkyd adducts of a rosin, and a rosin-modified phenol. Addition of the above-described dispersants and the above-described resins also reduces flocculation and improves the dispersion stability of the pigments and the viscometric property of the dispersion solutions.

An organic pigment derivative, such as a phthalimidemethyl derivative, a phthalimide-sulfonic acid derivative, a phthalimide-N-(dialkylamino)methyl derivative, or a phthalimide-N-(dialkylaminoalkyl)sulfonic acid amide derivative, may also be used as a dispersing aid. Needless to say that two or more different types of these derivatives may be used in combination.

Examples of the thermoplastic resin used for preparing the light-emitting nanocrystal-containing photo-curable composition include a urethane resin, an acrylic resin, a polyamide resin, a polyimide resin, a styrene-maleic acid resin, and a styrene-maleic anhydride resin.

Examples of the light-emitting nanocrystal-containing photo-curable compound include difunctional monomers, such as 1,6-hexanediol diacrylate, ethylene glycol diacrylate, neopentyl glycol diacrylate, triethylene glycol diacrylate, bis(acryloxyethoxy)bisphenol A, and 3-methylpentanediol diacrylate; polyfunctional monomers having a relatively low molecular weight, such as trimethylolpropatone triacrylate, pentaerythritol triacrylate, tris[2-(meth)acryloyloxyethyl]isocyanurate, dipentaerythritol hexaacrylate, and dipentaerythritol pentaacrylate; and polyfunctional monomers having a relatively high molecular weight, such as polyester acrylate, polyurethane acrylate, and polyether acrylate.

Examples of the photopolymerization initiator include acetophenone, benzophenone, benzildimethylketanol, benzoyl peroxide, 2-chlorothioxanthone, 1,3-bis(4′-azidobenzal)-2-propane, 1,3-bis(4′-azidobenzal)-2-propane-2′-sulfonic acid, and 4,4′-diazidostilbene-2,2′-disulfonic acid. Examples of commercially available photopolymerization initiators include “Irgacure (trade name)-184”, “Irgacure (trade name)-369”, “Darocur (trade name)-1173”, and “Lucirin-TPO” produced by BASF SE, “KAYACURE (trade name) DETX” and “KAYACURE (trade name) OA” produced by Nippon Kayaku Co., Ltd., “Vicure 10” and “Vicure 55” produced by Stauffer Chemical Co., “Trigonal PI” produced by Akzo Nobel N.V., “Sandrey 1000” produced by Sand, “Deep” produced by Upjohn Company, and “Biimidazole” produced by KUROGANE KASEI Co., Ltd.

Publicly known and commonly used photosensitizers may be used in combination with the above-described photopolymerization initiators. Examples of the photosensitizers include amines, ureas, compounds containing a sulfur atom, compounds containing a phosphorus atom, compounds containing a chlorine atom, nitriles, and other compounds containing a nitrogen atom. These photosensitizers may be used alone or in combination of two or more.

The mixing proportion of the photopolymerization initiator is preferably, but is not limited to, 0.1% to 30% by mass relative to the amount of compounds including a photo-polymerizable or photo-curable functional group. If the mixing proportion of the photopolymerization initiator is less than 0.1%, the photographic sensitivity in photo-curing may be reduced. If the mixing proportion of the photopolymerization initiator exceeds 30%, the crystals of the photopolymerization initiator may precipitate when a pigment-dispersed resist coating film is dried, which may degrade the physical properties of the coating film.

Using the above-described materials, by mass, 100 parts of the light-emitting nanocrystals according to the present invention are mixed with 300 to 100000 parts of an organic solvent and 1 to 500 parts of molecules having an affinity and a dispersant, and the resulting mixture is stirred so as to uniformly disperse the components. Thus, the above-described dye and/or pigment solution can be prepared. Subsequently, a thermoplastic resin, a photo-curable compound, a photopolymerization initiator, and, as needed, an organic solvent are added to the pigment dispersion such that the total amount of the thermoplastic resin and the photo-curable compound is 0.125 to 2500 parts relative to 100 part of the pigment dispersion and the amount of the photopolymerization initiator is 0.05 to 10 parts relative to 1 part of the photo-curable compound. The resulting mixture is stirred so as to uniformly disperse the above components. Thus, a light-emitting nanocrystal-containing photo-curable composition for forming the pixel portions is prepared.

Publicly known and commonly used organic solvents and aqueous alkaline solutions may be used as a developing solution. In particular, when the photo-curable composition includes a thermoplastic resin or a photo-curable compound and at least one of them has an acid value and is soluble in alkalis, washing with an aqueous alkaline solution may be effective in forming the color filter pixel portions.

A method for producing R, G, B, and Y colored pixel portions by photolithography is described above in detail. Alternatively, the pixel portions prepared using the light-emitting nanocrystal-containing composition according to the present invention may be formed by another method, such as an electrodeposition method, a transfer method, a micelle electrolysis method, a PVED (photovoltaic electrodeposition) method, an ink-jet method, a reverse printing method, or a thermosetting method. The pixel portions are formed for each color to produce a photoconversion layer.

The method for producing the ink composition used for preparing the photoconversion layer according to the present invention is described below. The method for producing the ink composition includes, for example, a first step in which a light-scattering particle dispersion containing light-scattering particles and a polymer dispersant is prepared and a second step in which the light-scattering particle dispersion is mixed with light-emitting nanocrystal particles. In this method, the light-scattering particle dispersion may further contain a thermosetting resin, and a thermosetting resin may be further mixed in the second step. This method enables the light-scattering particles to be dispersed at a sufficient level. Consequently, an ink composition that limits the exit of light from the pixel portions can be readily produced.

In the step in which the light-scattering particle dispersion is prepared, light-scattering particles, a polymer dispersant, and, optionally, a thermosetting resin may be mixed with one another and the resulting mixture is dispersed to form a light-scattering particle dispersion. The mixing and dispersion treatment may be performed using a dispersion apparatus, such as a bead mill, Paint Conditioner, or a planetary stirrer. It is preferable to use a bead mill or Paint Conditioner in order to enhance the dispersibility of the light-scattering particles and increase ease of adjusting the average size of the light-scattering particles to be within the intended range.

The method for producing the ink composition may further include a step preceding the second step in which a light-emitting nanocrystal particle dispersion containing light-emitting nanocrystal particles and a thermosetting resin is prepared. In such a case, the light-scattering particle dispersion is mixed with the light-emitting nanocrystal particle dispersion in the second step. This method enables the light-emitting nanocrystal particles to be dispersed to a sufficient degree. Consequently, an ink composition that limits the exit of light from the pixel portions can be readily produced. In the step in which the light-emitting nanocrystal particle dispersion is prepared, the mixing and dispersion treatment of the light-emitting nanocrystal particles and the thermosetting resin may be performed using the same dispersion apparatus as in the step in which the light-scattering particle dispersion is prepared.

In the case where the ink composition according to this embodiment is used as an ink composition for an ink-jet method, it is preferable to apply the ink composition to a piezoelectric-jet ink-jet recording apparatus, which has a mechanical ejection system including a piezoelectric element. Since the ink composition is not subjected to high temperatures instantaneously upon ejection in the piezoelectric-jet system, the degradation of the light-emitting nanocrystal particles hardly occurs and the likelihood of the color filter pixel portions (photoconversion layer) having the intended emission properties is increased.

The photoconversion layer according to the present invention can be produced by, for example, forming a black matrix, which serves as a light-shielding portion, on a substrate in a predetermined pattern, selectively depositing the ink composition (ink-jet ink) according to the above-described embodiment into pixel portion-forming regions defined by the light-shielding portion disposed on the substrate by ink-jet method, and curing the ink composition by irradiation of an active energy ray or heat.

The light-shielding portion can be formed by, for example, forming a metal thin-film composed of chromium or the like or a thin-film composed of a resin composition containing light-shielding particles in a specific region of a surface of the substrate which serves as a boundary between a plurality of pixel portions and creating a pattern in the thin-film. The metal thin-film can be formed by, for example, sputtering or vacuum vapor deposition. The thin-film composed of a resin composition containing light-shielding particles can be formed by, for example, coating or printing. The pattern can be created by photolithography or the like.

Examples of the ink-jet method include a bubble jet (registered trademark) method in which an electrothermal conversion member is used as an energy-generating element and a piezoelectric-jet method in which a piezoelectric element is used.

In the case where the ink composition is cured by irradiation of an active energy ray (e.g., ultraviolet radiation), a mercury-vapor lamp, a metal halide lamp, a xenon lamp, an LED, and the like may be used. The wavelength of the light may be, for example, 200 nm or more and 440 nm or less. The amount of light exposure may be, for example, 10 mJ/cm² or more and 4000 mJ/cm² or less.

In the case where the ink composition is cured by heating, the heating temperature may be set to, for example, 110° C. or more and 250° C. or less, and the amount of time during which heating is performed may be set to, for example, 10 minutes or more and 120 minutes or less.

In the present disclosure, the materials, such as compounds and resins, used in an ink-jet method may also be used in photolithography. It is needless to say that, conversely, the materials, such as compounds and resins, used in photolithography may also be used in an ink-jet method.

The color filter and the photoconversion layer according to an embodiment and the methods for producing the color filter and the photoconversion layer according to an embodiment are described above. The present invention is not limited to the above-described embodiments.

### “Liquid Crystal Panel”

The structure of the liquid crystal panel included in the liquid crystal display device according to the present invention is described below.

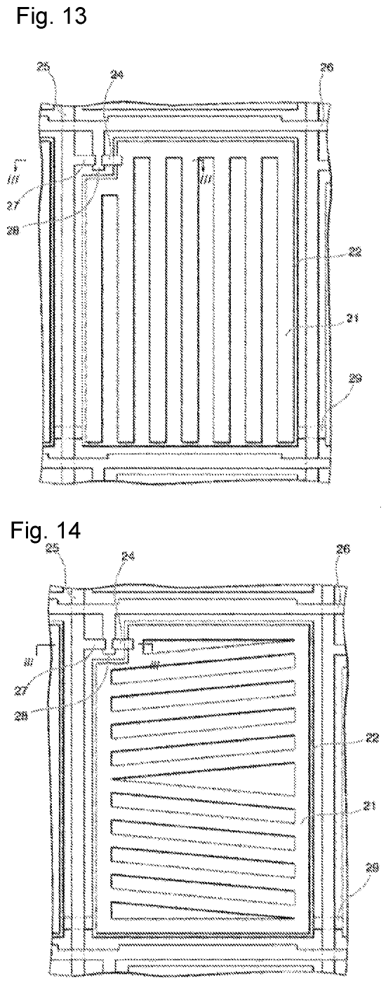

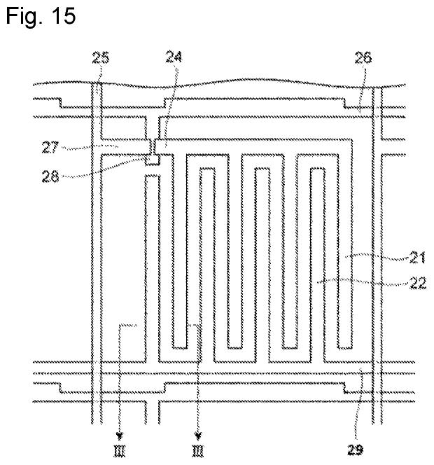

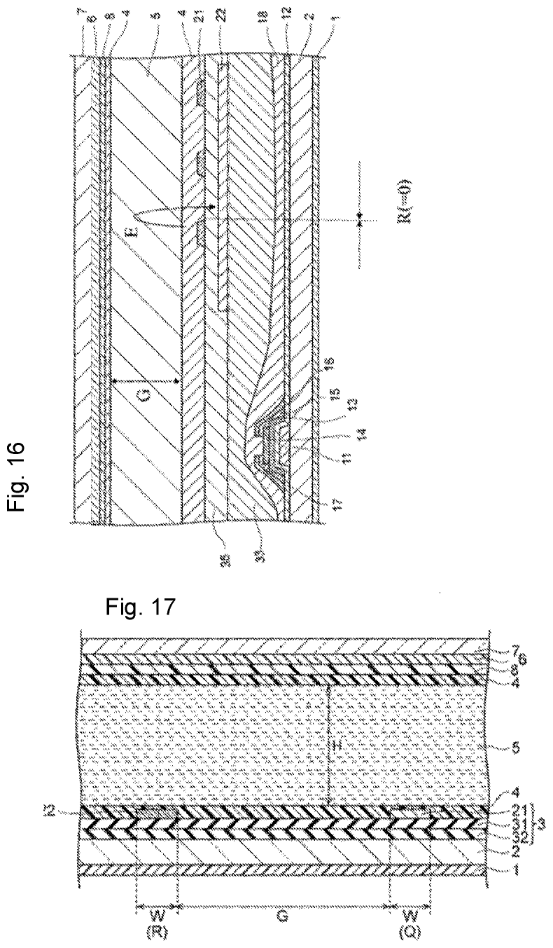

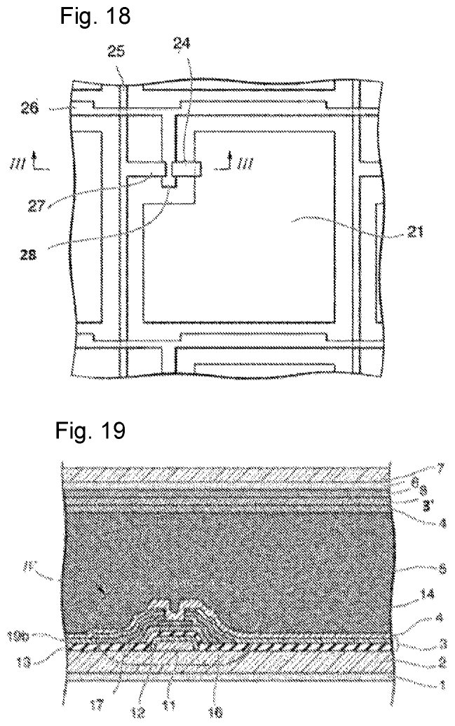

A liquid crystal panel 10 according to a preferable embodiment is described below with reference to FIGS. 12 to 19 and FIGS. 20 to 22. FIG. 12 is a schematic diagram illustrating the structure of the electrode layer 3 included in the liquid crystal display section. FIG. 12 is a schematic diagram illustrating the electrode portion of the liquid crystal panel 10 as an equivalent circuit. FIGS. 13 and 14 are schematic diagrams illustrating an example of the shape of the pixel electrode. FIGS. 13 and 14 are schematic diagrams illustrating the electrode structure of an FFS-mode liquid crystal display device according to an example of this embodiment. FIG. 16 is a schematic cross-sectional view of a liquid crystal panel included in an FFS-mode liquid crystal display device. FIG. 15 is a schematic diagram illustrating the electrode structure of an IPS-mode liquid crystal display device according to an example of the embodiment. FIG. 17 is a schematic cross-sectional view of a liquid crystal panel included in an IPS-mode liquid crystal display device. FIG. 18 is a schematic diagram illustrating the electrode structure of a VA-mode liquid crystal display device according to an example of this embodiment. FIG. 19 is a schematic cross-sectional view of a liquid crystal panel included in a VA-mode liquid crystal display device. As illustrated in FIGS. 1 to 4, the liquid crystal panel 10 is provided with a backlight unit serving as lighting means that illuminates the liquid crystal panel 10 from the side surface or the rear surface. This enables the liquid crystal panel 10 to serve as a liquid crystal display device.

In FIGS. 1 to 4 and FIG. 12, the electrode layers 3 and 3′ according to the present invention include one or more common electrodes and/or one or more pixel electrodes. For example, in an FFS-mode liquid crystal display device, the pixel electrode is disposed on the common electrode with an insulation layer (e.g., silicon nitride (SiN)) interposed therebetween. In a VA-mode liquid crystal display device, the pixel electrode and the common electrode are arranged to face each other across the liquid crystal layer 5.

Each of the display pixels is provided with one pixel electrode, and a slit-like opening is formed. The common electrode and the pixel electrode are, for example, transparent electrodes composed of ITO (indium tin oxide). In the display section, the electrode layer 3 includes gate bus lines GBL (GBL1, GBL2, . . . GBLm) each of which extends along a specific one of the rows in which a plurality of display pixels are arranged, source bus lines SBL (SBL1, SBL2, . . . SBLm) each of which extends along a specific one of the columns in which a plurality of display pixels are arranged, and thin-film transistors each of which is disposed in the vicinity of a specific one of the points at which the gate bus lines intersect the source bus lines, the thin-film transistors serving as pixel switches. The gate electrode of each of the thin-film transistors is electrically connected to a corresponding one of the gate bus lines GBL. The source electrode of each of the thin-film transistors is electrically connected to a corresponding one of the signal lines SBL. The drain electrode of each of the thin-film transistors is electrically connected to a corresponding one of the pixel electrodes.

The electrode layer 3 includes a gate driver and a source driver, which serve as driving means for driving a plurality of display pixels. The gate driver and the source driver are disposed in the periphery of the liquid crystal display section. A plurality of the gate bus lines are electrically connected to the output terminal of the gate driver. A plurality of the source bus lines are electrically connected to the output terminal of the source driver.

The gate driver applies an on-state voltage to a plurality of gate bus lines and feeds the on-state voltage to the gate electrodes of the thin-film transistors electrically connected to the selected gate bus lines. Consequently, electrical continuity is established between the source and drain electrodes of each of the thin-film transistors which has received the on-state voltage at the gate electrode. The source driver feeds each of the source bus lines a corresponding output signal. The signal fed to each of the source bus lines is applied to corresponding pixel electrodes through the thin-film transistors in which electrical continuity between the source and drain electrodes has been established. The operations of the gate driver and the source driver are controlled by a display processing section (also referred to as “control circuit”) disposed outside the liquid crystal display device.

The display processing section according to the present invention may have, in addition to a normal driving mode, a low-frequency driving mode and an intermittent driving mode in order to reduce the driving power. The display processing section according to the present invention controls the action of the gate driver serving as an LSI for driving the gate bus lines of the TFT liquid crystal panel and the action of the source driver serving as an LSI for driving the source bus lines of the TFT liquid crystal panel. The display processing section also feeds a common voltage V_{COM} to the common electrode and controls the action of the backlight unit. For example, the display processing section according to the present invention may include local dimming means that divides the entire display screen into a plurality of segments and adjusts the intensity of light emitted from the backlight for each of the segments in accordance with the brightness of the image displayed on the segment.

An example of an FFS-mode liquid crystal panel included in the liquid crystal display device according to the present invention is described below with reference to FIGS. 13, 14, and 16.

FIG. 13 illustrates a comb-shaped pixel electrode, which is an example of the shape of the pixel electrode. FIG. 13 is an enlarged plan view of a region of the electrode layer 3 illustrated in FIG. 1 or 2 disposed on the substrate 2 which is surrounded by the line II. As illustrated in FIG. 13, the electrode layer 3 disposed on the surface of the first substrate 2 includes thin-film transistors, a plurality of gate bus lines 26 through which a scanning signal is fed, and a plurality of source bus lines 25 through which a display signal is fed. The gate bus lines 26 intersect the source bus lines 25 to form a matrix-like pattern. The regions defined by the gate bus lines 26 and the source bus lines 25 form unit pixels of the liquid-crystal display apparatus. Each of the unit pixels includes a pixel electrode 21 and a common electrode 22. A thin-film transistor including a source electrode 27, a drain electrode 24, and a gate electrode 28 is disposed in the vicinity of each of the points at which the gate bus lines 26 intersect the source bus lines 25. The thin-film transistor is connected to the pixel electrode 21 to serve as a switch element used for feeding a display signal to the pixel electrode 21. Common lines 29 are arranged parallel to the gate bus lines 26. Each of the common lines 29 is connected to the common electrode 22 in order to feed a common signal to the common electrode 22.

The common electrode 22 is disposed on the entire rear surface of the pixel electrode 21 with an insulation layer 18 (not illustrated) interposed therebetween. The horizontal component of the minimum spacing path between the common electrode and the pixel electrode that are adjacent to each other is smaller than the minimum spacing (cell gap) between the alignment layers (or the substrates). The surface of the pixel electrode is preferably covered with a protective insulation film and an alignment layer. The term “horizontal component of minimum spacing path” used herein refers to a component of the minimum spacing path that connects the common electrode and the pixel electrode that are adjacent to each other in the horizontal direction of the substrate, which can be determined by dividing the minimum spacing path into the horizontal direction and a direction perpendicular to the substrate (i.e., the thickness direction). Optionally, each of the regions defined by the gate bus lines 26 and the source bus lines 25 may be provided with a storage capacitor (not illustrated) disposed therein, which stores the display signal fed through the source bus line 25.

FIG. 14 is a modification example of FIG. 13. FIG. 14 illustrates a slit-shaped pixel electrode, which is an example of the shape of the pixel electrode. The pixel electrode 21 illustrated in FIG. 14 is a substantially rectangular, flat plate-like electrode having triangular grooves formed at the center and both edges of the flat plate and substantially rectangular, frame-like grooves formed in the other portions of the flat plate. The shapes of the grooves are not limited; grooves having publicly known shapes, such as oval, circular, rectangular, rhombic, triangular, or parallelogrammatic, may be formed.

Note that, FIGS. 13 and 14 illustrate only one pair of the gate bus lines 26 and only one pair of the source bus lines 25 associated with one pixel.

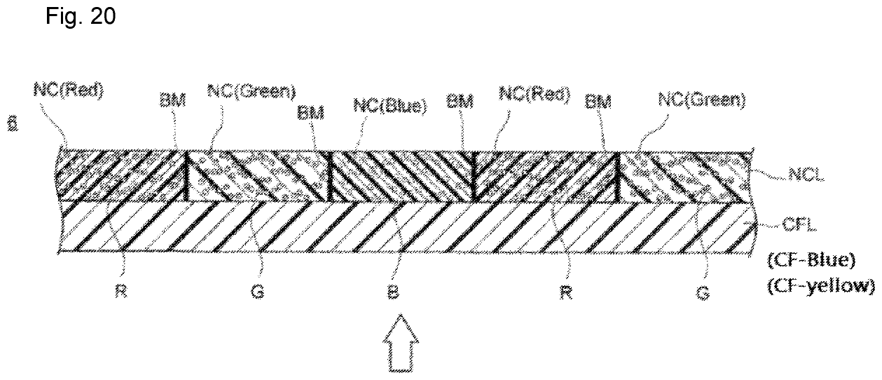

FIG. 16 is an example of a cross-sectional view of the liquid crystal display device illustrated in FIG. 2 which is taken in the direction of the line III-III illustrated in FIG. 13 or 14. A first substrate 2 is provided with an alignment layer 4 and an electrode layer 3 including thin-film transistors (TFTs) that are disposed on a surface of the first substrate 2 and a first polarizing layer 1 disposed on the other surface. A second substrate 7 is provided with an alignment layer 4, a second polarizing layer 8, and a photoconversion layer 6 that are disposed on a surface of the second substrate 7. The first substrate 2 and the second substrate 7 are arranged at a predetermined interval G such that the two alignment layers face each other. The gap between the first substrate 2 and the second substrate 7 is filled with a liquid crystal layer 5 containing a liquid crystal composition. On and above a part of the surface of the first substrate 2, a gate insulation film 12, thin-film transistors (11, 13, 15, 16, and 17), a passivation film 18, a planarization film 33, a common electrode 22, an insulation film 35, a pixel electrode 21, and an alignment layer 4 are stacked on top of one another in this order. Although the passivation film 18 and the flat film 33 are provided as two separated layers in the example illustrated in FIG. 16, alternatively, a planarization film that serves as both passivation film 18 and flat film 33 may be provided as one layer. Although alignment layers 4 are used in the example illustrated in FIG. 16, the alignment layers 4 may be omitted as illustrated in FIG. 1. The photoconversion layer 6 contains light-emitting nanocrystals (not illustrated) that have an emission spectrum of any of red (R), green (G), and blue (B) when receiving light emitted from the light source section on at least one of the three primary colors of red (R), green (G), and blue (B). The photoconversion layer 6 is described below with reference to FIGS. 20 to 22.

FIG. 20 is an example of a schematic diagram illustrating the photoconversion layer 6 according to the present invention 6 under magnification. The photoconversion layer 6 includes red color layers R, green color layers G, and blue color layers B. Each of the red (R) pixels R (red color layers R) is constituted by a photoconversion pixel layer (NC-Red) containing red light-emitting nanocrystals and a coloring material layer (i.e., a yellow color filter or a blue color filter) containing a blue or yellow coloring material. Each of the green (G) pixels G (green color layers G) is constituted by a photoconversion pixel layer (NC-Green) containing green light-emitting nanocrystals and a coloring material layer (i.e., a yellow color filter or a blue color filter) containing a blue or yellow coloring material. Each of the blue (B) pixels B (blue color layers B) is constituted by a photoconversion pixel layer (or transparent resin layer) optionally containing blue light-emitting nanocrystals as needed and a coloring material layer (i.e., a yellow color filter or a blue color filter) containing a blue or yellow coloring material. Thus, the photoconversion layer 6 includes two layers consisting of a nanocrystal layer NCL including the red color layers, the green color layers, and the blue color layers and a color layer (i.e., a color filter) CFL containing a coloring material, the color layer being stacked on a surface of the nanocrystal layer which faces the light source. A black matrix BM that serves as a light-shielding layer is interposed between the red color layers, the green color layers, and the blue color layers in order to prevent color mixture. Arranging the yellow color filter on the entire surface of the photoconversion layer blocks blue light that cannot be absorbed by the light-emitting nanocrystals.

FIG. 20 illustrates a photoconversion layer according to a preferable embodiment, which includes the nanocrystal layer NCL and the coloring material layer (i.e., the color filter) CFL containing a coloring material which are stacked on top of each other. Since the photoconversion layer is not capable of converting the whole amount of light (excitation light, such as blue light) emitted from the light source, it is necessary to cause the remaining part of the excitation light not to pass through the photoconversion layer but to be absorbed in the photoconversion layer. Accordingly, the photoconversion layer, which includes the layer (NC) containing light-emitting nanocrystals and the color layer (i.e., the color filter) CFL containing a coloring material that are stacked on top of each other, prevents the remaining part of the excitation light (blue light) from being visually identified from the outside. However, if needed, the color layer (i.e., the color filter) CFL containing a coloring material may be omitted. In such a case, a preferable photoconversion layer according to another embodiment is constituted by a nanocrystal layer NCL as illustrated in, for example, FIG. 22.

Although a color layer containing a blue coloring material is used as a color filter layer CFL in FIG. 20 assuming the use of light having a primary emission peak in a wavelength range of 420 nm or more and 480 nm or less (e.g., light from a blue LED) as a light source, the type of the color layer used may be changed appropriately in accordance with the type of the light source used.

The red color layers R, the green color layers G, and the blue color layers B may optionally contain a coloring material as needed. The layer (NCL) containing the light-emitting nanocrystals NC may contain coloring materials corresponding to the respective colors.

FIG. 21 schematically illustrates a preferable photoconversion layer according to another embodiment. The photoconversion layer 6 includes red color layers R, green color layers G, and blue color layers B. Each of the red (R) pixels R (red color layers R) is constituted by a coloring material layer (i.e., a red color filter) CF-Red containing a red coloring material, a photoconversion pixel layer (NC) containing red light-emitting nanocrystals, and a coloring material layer CFL (blue or yellow color filter CF-BLue or CF-Yellow) containing a blue coloring material. Each of the green (G) pixel portions (green color layers G) is constituted by a coloring material layer (i.e., a green color filter) CF-Green containing a green coloring material, a photoconversion pixel layer (NC) containing green light-emitting nanocrystals, and a coloring material layer CFL (blue or yellow color filter CF-Blue or CF-Yellow) containing a blue coloring material. Each of the blue (R) pixel portions (blue color layers B) is constituted by a color layer CFL (i.e., a blue or yellow color filter) containing a transparent resin layer and/or a blue or yellow coloring material, a layer (NC) optionally containing light-emitting nanocrystals as needed, and a color layer CFL (blue or yellow color filter) containing a blue coloring material. Furthermore, a black matrix that serves as a light-shielding layer is interposed between the red color layers, the green color layers, and the blue color layers. Arranging the yellow color filter on the entire surface of the photoconversion layer blocks the blue light that cannot be absorbed by the light-emitting nanocrystals.

Thus, the photoconversion layer 6 has a three-layer multilayer structure consisting of a (blue or yellow) color filter layer CFL, a layer (NCL) containing the light-emitting nanocrystals NC, and a red (R), green (G), and blue (B) color filter including pixels of three primary colors consisting of red (R), green (G), and blue (B) that are stacked on top of one another in this order. The color filter layer CFL may be omitted if needed. The coloring material layer (i.e., the green color filter) CF-Green containing a green coloring material may be replaced with a coloring material layer (i.e., a yellow color filter) containing a yellow coloring material in order to perform color adjustment.

The red color layers R, the green color layers G, and the blue color layers B may optionally contain a coloring material as needed. The layer (NCL) containing the light-emitting nanocrystals NC may contain coloring materials corresponding to the respective colors.

The above structure enables part of the light (excitation light, such as blue light) emitted from the light source which cannot be absorbed by the light-emitting nanocrystals to be absorbed by the red, green, and blue color filters and the blue color filter layer CFL disposed on the entire surface of the photoconversion layer and reduces or prevents the penetration of the remaining part of the excitation light through the photoconversion layer. Although a blue color filter layer is also used as a color filter layer CFL in FIG. 21 assuming the use of a blue LED as a light source, the color of the color filter layer used may be changed appropriately in accordance with the type of the light source used.

FIG. 22 is another example of a schematic diagram illustrating the photoconversion layer 6 according to the present invention 6 under magnification. The photoconversion layer 6 includes red color layers R, green color layers G, and blue color layers B. Each of the red (R) pixels R (red color layers R) is constituted by a photoconversion pixel layer (NC-Red) containing red light-emitting nanocrystals. Each of the green (G) pixels G (green color layers G) is constituted by a photoconversion pixel layer (NC-Green) containing green light-emitting nanocrystals. Each of the blue (B) pixels B (blue color layer portions B) is constituted by a (photoconversion pixel) layer (or transparent resin layer) optionally containing blue light-emitting nanocrystals as needed. Thus, the photoconversion layer 6 includes only one layer that is a nanocrystal layer NCL including the red color layers R, the green color layers G, and the blue color layers B. A black matrix BM that serves as a light-shielding layer is interposed between the red color layers R, the green color layers G, and the blue color layers B in order to prevent color mixture.

The red color layers R, the green color layers G, and the blue color layers B may optionally contain a coloring material as needed. The layer (NCL) containing the light-emitting nanocrystals NC may contain coloring materials corresponding to the respective colors.

Although the photoconversion layer 6 according to a preferable embodiment of the present invention is described with reference to FIGS. 20 to 22 taking the FFS-mode liquid crystal panel illustrated in FIG. 16 as an example, the photoconversion layer 6 according to the preferable embodiment may be applied to an IPS-mode liquid crystal display device and a VA-mode liquid crystal display device.

In FIG. 16, the structure of the thin-film transistor according to a preferable embodiment includes a gate electrode 11 disposed on the surface of the substrate 2, a gate insulation layer 12 arranged to cover the gate electrode 11 and substantially the entire surface of the substrate 2, a semiconductor layer 13 disposed on the surface of the gate insulation layer 12 so as to face the gate electrode 11, a protection film 14 arranged to cover a part of the surface of the semiconductor layer 13, a drain electrode 16 arranged to cover one of the side edges of the protection layer 14 and one of the side edges of the semiconductor layer 13 and come into contact with the gate insulation layer 12 disposed on the surface of the substrate 2, a source electrode 17 arranged to cover the other side edge of the protection layer 14 and the other side edge of the semiconductor layer 13 and come into contact with the gate insulation layer 12 disposed on the surface of the substrate 2, and an insulative protection layer 18 arranged to cover the drain electrode 16 and the source electrode 17. Optionally, an anodic oxidation film (not illustrated) may be formed on the surface of the gate electrode 11 in order to, for example, eliminate the step created by the gate electrode.

In the FFS-mode liquid crystal display devices illustrated in FIGS. 1, 2, 13, 14, and 16, the common electrode 22 is a flat-plate-like electrode disposed on substantially the entire surface of the gate insulation layer 12, and the pixel electrode 21 is a comb-shaped electrode disposed on the insulative protection layer 18 that covers the common electrode 22. That is, the common electrode 22 is arranged closer to the first substrate 2 than the pixel electrode 21, and the two electrodes are arranged to superimpose each other with the insulative protection layer 18 interposed therebetween. The pixel electrode 21 and the common electrode 22 are composed of, for example, a transparent conductive material, such as ITO (indium tin oxide), IZO (indium zinc oxide), or IZTO (indium zinc tin oxide). Forming the pixel electrode 21 and the common electrode 22 using a transparent conductive material increases the area of openings formed in the unit pixels and results in increases in the opening ratio and transmittance.

In order to generate a fringe electric field between the pixel electrode 21 and the common electrode 22, the pixel electrode 21 and the common electrode 22 are formed such that the horizontal component R of the path (also referred to as “horizontal component of minimum spacing path”) between the pixel electrode 21 and the common electrode 22 is smaller than the thickness G of the liquid crystal layer 5 interposed between the first substrate 2 and the second substrate 7. The horizontal component R of the path between the electrodes is the distance between the electrodes in the horizontal direction of the substrates. In the example illustrated in FIG. 16, since the flat-plate-like common electrode 22 and the comb-shaped pixel electrode 21 superimpose each other, the horizontal component R of the minimum spacing path (i.e., the distance between the electrodes) is 0. Since the horizontal component R of the minimum spacing path is smaller than thickness (also referred to as “cell gap”) G of the liquid crystal layer 5 interposed between the first substrate 2 and the second substrate 7, a fringe electric field E is generated. Thus, an FFS-mode liquid crystal display device uses a horizontal electric field and a parabolic electric field generated in a direction perpendicular to the lines constituting the comb-like shape of the pixel electrode 21. The width 1 of the portions of the pixel electrode 21 which form the comb-like shape and the intervals m between the comb-like portions of the pixel electrode 21 are preferably adjusted such that all the liquid crystal molecules present inside the liquid crystal layer 5 can be driven by the electric fields generated. The horizontal component R of the minimum spacing path between the pixel electrode and the common electrode can be adjusted by, for example, changing the (average) thickness of the insulation film 35.

An example of an IPS-mode liquid crystal panel, which is a modification example of the FFS-mode liquid crystal panel included in the liquid crystal display device according to the present invention, is described below with reference to FIGS. 15 and 17. The liquid crystal panel 10 included in an IPS-mode liquid crystal display device has a structure in which an electrode layer 3 (including a common electrode, pixel electrodes, and TFTs) is disposed on only one of the substrates, as in the FFS-mode illustrated in FIG. 1, that is, a structure including a first polarizing layer 1, a first substrate 2, an electrode layer 3, an alignment layer 4, a liquid crystal layer 5 containing a liquid crystal composition, an alignment layer 4, a second polarizing layer 8, a photoconversion layer 6, and a second substrate 7 that are stacked on top of one another in this order.

FIG. 15 is an enlarged plan view of a part of the region of the electrode layer 3 disposed on the first substrate 2 illustrated in FIG. 1 or 2 included in an IPS-mode liquid crystal display section which is surrounded by the line II. As illustrated in FIG. 15, in each of the regions (unit pixels) defined by a plurality of gate bus lines 26 used for feeding a scanning signal and a plurality of source bus lines 25 used for feeding a display signal, a comb-teeth-shaped first electrode (e.g., a pixel electrode) 21 and a comb-teeth-shaped second electrode (e.g., a common electrode) 22 are arranged to freely fit to each other (the two electrodes are arranged to mesh with each other while being spaced from each other at a certain distance). In the unit pixels, a thin-film transistor including a source electrode 27, a drain electrode 24, and a gate electrode 28 is disposed in the vicinity of each of the points at which the gate bus lines 26 intersect the source bus lines 25. The thin-film transistor is connected to the first electrode 21 to serve as a switch element used for feeding a display signal to the first electrode 21. Common lines (V_{com}) 29 are arranged parallel to the gate bus lines 26. Each of the common lines 29 is connected to the second electrode 22 in order to feed a common signal to the second electrode 22.

FIG. 17 is a cross-sectional view of an IPS-mode liquid crystal panel which is taken in the direction of the line III-III illustrated in FIG. 15. The first substrate 2 is provided with a gate insulation layer 32 arranged to cover the gate bus lines 26 (not illustrated) and substantially the entire surface of the first substrate 2 and an insulative protection layer 31 disposed on the surface of the gate insulation layer 32. The first electrode (the pixel electrode) 21 and the second electrode (the common electrode) 22 are disposed on the insulative protection film 31 so as to be spaced from each other. The insulative protection layer 31 has an insulating property and is composed of silicon nitride, silicon dioxide, a silicon oxide or nitride film, or the like. The first substrate 2 is provided with an alignment layer 4 and an electrode layer 3 including thin-film transistors that are disposed on a surface of the first substrate 2 and a first polarizing layer 1 disposed on the other surface. A second substrate 7 is provided with an alignment layer 4, a second polarizing layer 8, and a photoconversion layer 6 that are disposed on a surface of the second substrate 7. The first substrate 2 and the second substrate 7 are arranged at a predetermined interval such that the two alignment layers face each other. The gap created therebetween is filled with a liquid crystal layer 5 containing a liquid crystal composition. The photoconversion layer 6 contains light-emitting nanocrystals (not illustrated) that have an emission spectrum of any of red (R), green (G), and blue (B) when receiving light emitted from the light source section on at least one of the three primary colors of red (R), green (G), and blue (B). The photoconversion layer 6 is as described above with reference to FIGS. 20 to 22.

In the embodiment illustrated in FIGS. 15 and 17, the first electrode 21 and the second electrode 22 are comb-shaped electrodes disposed on the insulative protection layer 31, that is, on the same layer, and are arranged to mesh with each other while being spaced from each other. In the IPS-mode liquid crystal display section, the distance G between the first electrode 21 and the second electrode 22 and the thickness (cell gap) H of the liquid crystal layer interposed between the first substrate 2 and the second substrate 7 satisfy the relationship G Z H. The distance G between the electrodes is the minimum distance between the first electrode 21 and the second electrode 22 in the horizontal direction of the substrates. In the example illustrated in FIGS. 15 and 17, the distance G between the electrodes is measured in the horizontal direction with respect to the lines alternately formed as a result of the first electrode 21 and the second electrode 22 being freely fit to each other. The distance H between the first substrate 2 and the second substrate 7 is the thickness of the liquid crystal layer interposed between the first substrate 2 and the second substrate 7 and is, specifically, the distance (i.e., the cell gap) between (the uppermost surfaces of) the alignment layers 4 disposed on the first substrate 2 and the second substrate 7, that is, the thickness of the liquid crystal layer.

Although the example illustrated in FIG. 17 includes the alignment layers 4, the alignment layers 4 are omissible as illustrated in FIG. 1.

While the thickness of the liquid crystal layer interposed between the first substrate 2 and the second substrate 7 is set to be equal to or more than the minimum distance between the first electrode 21 and the second electrode 22 in the horizontal direction of the substrates in the above-described FFS-mode liquid crystal panel, the thickness of the liquid crystal layer interposed between the first substrate 2 and the second substrate 7 is set to be less than the minimum distance between the first electrode 21 and the second electrode 22 in the horizontal direction of the substrates in the IPS-mode liquid crystal display section.

The IPS-mode liquid crystal panel drives the liquid crystal molecules by using an electric field generated between the first electrode 21 and the second electrode 22 in the horizontal direction of the substrates. The width Q of the first electrode 21 and the width R of the second electrode 22 are preferably adjusted such that all the liquid crystal molecules present inside the liquid crystal layer 5 can be driven by the electric field generated.

A preferable liquid crystal panel according to another embodiment of the present invention is a vertical alignment-mode liquid crystal panel (VA-mode liquid crystal display). An example of the VA-mode liquid crystal panel included in the liquid crystal display device according to the present invention is described below with reference to FIGS. 18 and 19. FIG. 18 is an enlarged plan view of the region of the electrode layer 3 including thin-film transistors (also referred to as “thin-film transistor layer 3”) disposed on the substrate illustrated in FIG. 2 which is surrounded by the line II. FIG. 19 is a cross-sectional view of the liquid crystal panel illustrated in FIG. 3 or 4 which is taken in the direction of the line III-III illustrated in FIG. 18.

The liquid crystal panel 10 included in the liquid crystal display device according to the present invention is, as illustrated in FIGS. 3 and 4, a liquid crystal display device including a second substrate 7 provided with a (transparent) electrode layer 3′ (also referred to as “common electrode 3′”), a second polarizing layer 8, and a photoconversion layer 6; a first substrate 2 provided with an electrode layer 3 including pixel electrodes and thin-film transistors that are disposed on the respective pixels and control the pixel electrodes; and a liquid crystal layer 5 (composed of a liquid crystal composition) sandwiched between the first substrate 2 and the second substrate 7. The orientation of liquid crystal molecules contained in the liquid crystal composition is substantially perpendicular to the substrates 2 and 7 when no voltage is applied. The liquid crystal layer contains a particular liquid crystal composition. The electrode layer 3′ is preferably composed of a transparent conductive material as in the other types of liquid crystal display devices. Although the photoconversion layer 6 is interposed between the second substrate 7 and the common electrode 3′ in the example illustrated in FIG. 17, the structure is not limited to this. Optionally, a pair of alignment layers 4 may be disposed on the surfaces of the transparent electrodes (layers) 3 and 3′ as needed so as to be adjacent to the liquid crystal layer 5 according to the present invention and come into direct contact to the liquid crystal composition constituting the liquid crystal layer 5 (the alignment layers 4 are illustrated in FIG. 19). A first polarizing layer 1 is disposed on a surface of the first substrate 2 which faces the backlight unit. The second polarizing layer 8 is interposed between the transparent electrode (layer) 3′ and the photoconversion layer 6. Thus, the liquid crystal panel 10 of the liquid crystal display device according to a preferable embodiment of the present invention includes a first substrate 2 provided with an alignment layer 4 and an electrode layer 3 including thin-film transistors that are disposed on a surface of the first substrate 2 and a first polarizing layer 1 disposed on the other surface and a second substrate 7 provided with an alignment layer 4, a transparent electrode (layer) 3′, a second polarizing layer 8, and a photoconversion layer 6 that are disposed on a surface of the second substrate 7. The first substrate 2 and the second substrate 7 are arranged at a predetermined interval such that the two alignment layers face each other. The gap between the first substrate 2 and the second substrate 7 is filled with a liquid crystal layer 5 containing a liquid crystal composition. The photoconversion layer 6 contains light-emitting nanocrystals (not illustrated) that have an emission spectrum of any of red (R), green (G), and blue (B) when receiving light emitted from the light source section on at least one of the three primary colors of red (R), green (G), and blue (B). The photoconversion layer 6 is as described above with reference to FIGS. 20 to 22.

FIG. 18 is an enlarged plan view of the region of the electrode layer 3 disposed on the substrate 2 illustrated in FIG. 3 or 4 which is surrounded by the line II, illustrating an “L”-shaped pixel electrode as an example of the shape of the pixel electrode 21. Although the pixel electrode 21 is formed on substantially the entire surface of the region surrounded by the gate bus lines 26 and the source bus lines 25 as in FIGS. 13, 14, and 15 in an “L”-shape, the shape of the pixel electrode is not limited to this. In the case where the pixel electrode is used in PSVA or the like, a pixel electrode having a fishbone structure may be used instead. The other structure and functions of the pixel electrode 21 are as described above, and the description thereof is omitted.

In the liquid crystal panel section of the vertical alignment-mode liquid crystal display device, unlike the IPS-mode or FFS-mode liquid crystal display device, the common electrode 3′ (not illustrated) is disposed on the substrate other than the substrate including TFTs so as to face the pixel electrodes 21 while being spaced from the pixel electrodes 21. In other words, the pixel electrodes 21 and the common electrode 22 are disposed on different substrates, while the pixel electrodes 21 and the common electrode 22 are disposed on the same substrate in the FFS-mode and IPS-mode liquid crystal display devices described above.

The photoconversion layer 6 may optionally include a black matrix (not illustrated) disposed on the portion corresponding to the thin-film transistors and storage capacitors 23 in order to prevent the exit of light.

FIG. 19 is a cross-sectional view of the liquid crystal display device illustrated in FIG. 3 or 4 which is taken in the direction of the line III-III illustrated in FIG. 18. Specifically, the liquid crystal panel 10 of the liquid crystal display device according to the present invention includes a first polarizing layer 1, a first substrate 2, an electrode layer (also referred to as “thin-film transistor layer”) 3 including thin-film transistors, an alignment layer 4, a liquid crystal layer 5 containing a liquid crystal composition, an alignment layer 4, a common electrode 3′, a first polarizing layer 8, a photoconversion layer 6, and a second substrate 7 that are stacked on top of one another in this order. The structure of thin-film transistors (the region denoted with “IV” in FIG. 19) of the liquid crystal display device according to a preferable embodiment of the present invention is as described above, and the description thereof is omitted.

The liquid crystal display device according to the present invention may optionally use local dimming in which contrast is enhanced by controlling the brightness of the backlight unit 100 for each of a plurality of segments, the number of which is smaller than the number of the liquid crystal pixels.

Local dimming can be performed by using a plurality of light-emitting elements L as light sources for respective particular regions of the liquid crystal panel and controlling each of the light-emitting elements L in accordance with the brightness of the corresponding display region. In this case, the light-emitting elements L may be arranged in a planar array or in a line on one of the side surfaces of the liquid crystal panel 10.

In the case where the local dimming is performed using the light guide section 102 of the backlight unit 100 and the liquid crystal panel 10, the light guide section 102 may include a control layer interposed between a light guide plate (and/or a light diffusion plate) and the substrate disposed on the light source-side of the liquid crystal panel, the control layer being capable of controlling the amount of light emitted from the backlight for each of the particular regions, the number of which is smaller than the number of the liquid crystal pixels.

In order to control the amount of light emitted from the backlight, the liquid crystal display device may further include liquid crystal elements the number of which is smaller than the number of the liquid crystal pixels. Although various common methods may be used for producing the liquid crystal elements, an LCD layer containing liquid crystals forming a polymer network is preferably used in order to enhance transmittance. Since the layer containing (nematic) liquid crystals forming a polymer network (the layer containing (nematic) liquid crystals forming a polymer network which may be sandwiched between a pair of transparent electrodes as needed) scatters light when a voltage is not applied and transmits light when a voltage is applied, local dimming can be achieved by interposing an LCD layer containing liquid crystals forming a polymer network, the LCD layer including a plurality of segments that divide the entire display screen, between a light guide plate (and/or a light diffusion plate) and the substrate disposed on the light source-side of the liquid crystal panel.

In the liquid crystal display device according to the present invention, the retardation (Re) (25° C.) defined by the Formula (1) below is represented by Re=Δn×d in the case where a light source section having a primary emission peak at 450 nm is used.

(in Formula (1), Δn represents an anisotropy of refractive index at 589 nm, and d represents the cell thickness (run) of the liquid crystal layer included in the liquid crystal display device)

220 to 300 nm is preferable.

Light that pass through a liquid crystal display device and the optical properties of the light differ between a common liquid crystal display device that selects whether to transmit ordinary white light containing wavelengths of the entire visible light range and a liquid crystal display device that selects whether to transmit blue visible light (i.e., short-wavelength light) or ultraviolet radiation having a wavelength of about 500 nm or less, which causes excitation of the quantum dots. Therefore, properties and the like required for a liquid crystal display device also differ between the two types of liquid crystal display devices. It was confirmed that, in the related art, there has been no study of optimization of optical properties of a liquid crystal material which results from the difference between a light source included in a liquid crystal display device that contains light-emitting nanocrystals, such as quantum dots, as a light-emitting element and a light source included in a common liquid crystal display device that does not contain light-emitting nanocrystals such as quantum dots and, therefore, it has been not possible to maximize the utilization of the optical properties of a display element that contains light-emitting nanocrystals, such as quantum dots. However, the above retardation conditions enable the enhancement of the transmittance of the liquid crystal display device. Accordingly, another object of the present invention is to limit or prevent a reduction in the transmittance of the liquid crystal display device.

Hereinafter, the light source section, the polarizing layer, and the liquid crystal layer, and the alignment layer, which are the main components of the liquid crystal display device according to the present invention, are described below.

### (Light Source Section)

The light source section according to the present invention includes light-emitting elements that emit ultraviolet or visible light. The wavelength range of the light-emitting elements is not limited. The light-emitting elements preferably have a primary emission peak in the blue region. For example, light-emitting diodes (blue light-emitting diodes) having a primary emission peak in the wavelength range of 420 nm or more and 480 nm or less may be suitably used.

The wavelength range of the light-emitting elements (i.e., light-emitting diodes) according to the present invention is not limited. The light-emitting elements preferably have a primary emission peak in the blue region. For example, light-emitting diodes having a primary emission peak in the wavelength range of 430 nm or more and 500 nm or less (420 nm or more and 480 nm or less) may be suitably used. The light-emitting diodes having a primary emission peak in the blue region may be publicly known light-emitting diodes. Examples of the light-emitting diodes having a primary emission peak in the blue region include a light-emitting diode including at least an AlN seed layer disposed on a sapphire substrate, a ground layer disposed on the seed layer, and a multilayer semiconductor layer composed primarily of GaN. Examples of the multilayer semiconductor layer include a semiconductor layer including a ground layer, an n-type semiconductor layer, a light-emitting layer, and a p-type semiconductor layer stacked on top of one another in this order from the substrate.

Examples of an ultraviolet light source include a low-pressure mercury-vapor lamp, a medium-pressure mercury-vapor lamp, a high-pressure mercury-vapor lamp, an ultra-high-pressure mercury-vapor lamp, a carbon-arc lamp, an electrodeless lamp, a metal-halide lamp, a xenon arc lamp, and an LED. The light-emitting elements L according to the present invention is preferably an LED that emits ultraviolet light, as well as an LED having a primary emission peak in the above wavelength range of 420 nm or more and 480 nm or less.

Hereinafter, light having an emission center wavelength in the wavelength range of 420 to 480 nm is referred to as “blue light”, light having an emission center wavelength in the wavelength range of 500 to 560 nm is referred to as “green light”, and light having an emission center wavelength in the wavelength range of 605 to 665 nm is referred to as “red light”. The term “ultraviolet light” used herein refers to light having an emission center wavelength in the wavelength range of 300 nm or more and less than 420 nm. The term “half-width” used herein refers to the width of the peak at ½ of the height of the peak.

### (Polarizing Layer)

The polarizing layer according to the present invention is not limited, and publicly known polarizing plates (polarizing layers) may be used. Examples thereof include a dichroic organic colorant polarizer, a coating polarizing layer, a wire-grid polarizer, and a cholesteric liquid crystal polarizer. For example, the wire-grid polarizer may be formed on the first substrate, the second substrate, or the color filter. The wire-grid polarizer is preferably formed by any one of a nanoimprint method, a block copolymer method, E-beam lithography, and glancing angle vapor deposition. In the case where a coating polarizing layer is formed, the alignment layer described below may be further formed. Therefore, in the case where the polarizing layer according to the present invention is a coating polarizing layer, the polarizing layer is preferably provided with an alignment layer.

The liquid crystal layer, the alignment layer, etc., which are the components of the liquid crystal panel section of the liquid crystal display device according to the present invention, are described below.

The liquid crystal layer according to the present invention includes a liquid crystal composition containing the compound represented by General Formula (i):

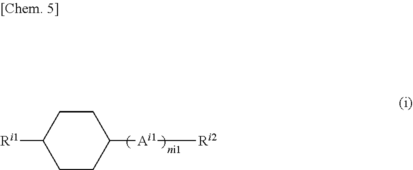

(in General Formula (i), Rⁱ¹ and Rⁱ² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; Aⁱ¹ represents a 1,4-phenylene group or a trans-1,4-cyclohexylene group; and nⁱ¹ represents 0 or 1)

The above compound enables the formation of a liquid crystal layer containing a compound highly reliable in terms of light fastness and, consequently, limits or prevents the degradation of the liquid crystal layer which may be caused by light emitted from the light source and, in particular, blue light (emitted from a blue LED). Furthermore, the retardation of the liquid crystal layer may be adjusted. This limits or prevents a reduction in the transmittance of the liquid crystal display device.

The lower limit for the amount of the compound represented by General Formula (i) above included in the liquid crystal layer according to the present invention is preferably 1% by mass, 2% by mass, 3% by mass, 5% by mass, 7% by mass, 10% by mass, 15% by mass, 20% by mass, 25% by mass, 30% by mass, 35% by mass, 40% by mass, 45% by mass, 50% by mass, or 55% by mass of the total amount of the composition according to the present invention. The upper limit for the amount of the compound represented by General Formula (i) above is preferably 95% by mass, 90% by mass, 85% by mass, 80% by mass, 75% by mass, 70% by mass, 65% by mass, 60% by mass, 55% by mass, 50% by mass, 45% by mass, 40% by mass, 35% by mass, 30% by mass, or 25% by mass of the total amount of the composition according to the present invention.

The content of the compound represented by General Formula (i) above in the liquid crystal layer according to the present invention is particularly preferably 10% to 50% by mass.

The compound represented by General Formula (i) above is preferably a compound selected from the compounds represented by General Formulae (i-1) and (i-2).

The compound represented by General Formula (i-1) is the following compound.

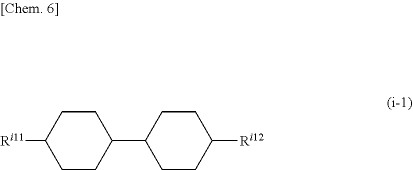

(in General Formula (i-1), Rⁱ¹¹ and Rⁱ¹² each independently represent the same things as Rⁱ¹ and Rⁱ² in General Formula (i))

Rⁱ¹¹ and Rⁱ¹² preferably represent a linear alkyl group having 1 to 5 carbon atoms, a linear alkoxy group having 1 to 4 carbon atoms, or a linear alkenyl group having 2 to 5 carbon atoms.

The compound represented by General Formula (i-1) may be used alone. Optionally, two or more compounds may be used in combination. The types of the compounds used in combination are not limited. Compounds are used in combination in accordance with the intended properties, such as solubility at low temperatures, transition temperature, electrical reliability, and birefringence. The number of types of the compounds used is, for example, in an embodiment of the present invention, one, two, three, four, or five or more.

The lower limit for the amount of the compound is preferably 1% by mass, 2% by mass, 3% by mass, 5% by mass, 7% by mass, 10% by mass, 12% by mass, 15% by mass, 17% by mass, 20% by mass, 22% by mass, 25% by mass, 27% by mass, 30% by mass, 35% by mass, 40% by mass, 45% by mass, 50% by mass, or 55% by mass of the total amount of the composition according to the present invention. The upper limit for the amount of the compound is preferably 95% by mass, 90% by mass, 85% by mass, 80% by mass, 75% by mass, 70% by mass, 65% by mass, 60% by mass, 55% by mass, 50% by mass, 48% by mass, 45% by mass, 43% by mass, 40% by mass, 38% by mass, 35% by mass, 33% by mass, 30% by mass, 28% by mass, 25% by mass, 23% by mass, or 20% by mass of the total amount of the composition according to the present invention.

In the case where the viscosity of the composition according to the present invention needs to be kept low in order to produce a composition having a high response speed, it is preferable that the above lower limit be set high and the upper limit be set high. In the case where the T, of the composition according to the present invention needs to be kept high in order to produce a composition having good temperature stability, it is preferable that the above lower limit be set medium and the upper limit be set medium. In the case where dielectric anisotropy needs to be increased in order to keep the driving voltage low, it is preferable that the above lower limit be set low and the upper limit be set low.

The compound represented by General Formula (i-1) is preferably a compound selected from compounds represented by General Formula (i-1-1).

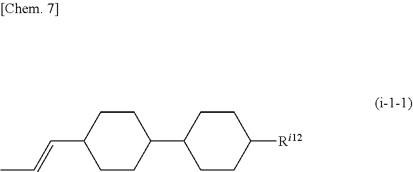

(in General Formula (i-1-1), R¹¹ represents the same thing as in General Formula (i-1))

The compound represented by General Formula (i-1-1) is preferably a compound selected from the compounds represented by Formulae (i-1-1.1) to (i-1-1.3), is preferably a compound represented by Formula (i-1-1.2) or (i-1-1.3), and is particularly preferably the compound represented by Formula (i-1-1.3).

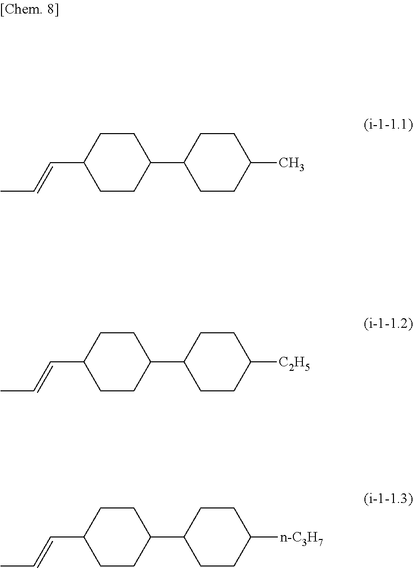

The lower limit for the amount of the compound represented by Formula (i-1-1.3) is preferably 1% by mass, 2% by mass, 3% by mass, 5% by mass, 7% by mass, or 10% by mass of the total amount of the composition according to the present invention. The upper limit for the amount of the compound represented by Formula (i-1-1.3) is preferably 20% by mass, 15% by mass, 13% by mass, 10% by mass, 8% by mass, 7% by mass, 6% by mass, 5% by mass, or 3% by mass of the total amount of the composition according to the present invention.

The compound represented by General Formula (i-1) is preferably a compound selected from compounds represented by General Formula (i-1-2). In such a case, excellent durability and a high voltage holding ratio can be achieved even when irradiated with light having a wavelength of 200 to 400 nm, which is in the ultraviolet range, as backlight.

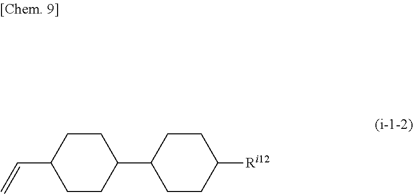

(in General Formula (i-1-2), Rⁱ¹² represents the same thing as in General Formula (i-1))

The lower limit for the amount of the compound represented by Formula (i-1-2) is preferably 1% by mass, 5% by mass, 10% by mass, 15% by mass, 17% by mass, 20% by mass, 23% by mass, 25% by mass, 27% by mass, 30% by mass, or 35% by mass of the total amount of the composition according to the present invention. The upper limit for the amount of the compound represented by Formula (i-1-2) is preferably 60% by mass, 55% by mass, 50% by mass, 45% by mass, 42% by mass, 40% by mass, 38% by mass, 35% by mass, 33% by mass, or 30% by mass of the total amount of the composition according to the present invention.

The compound represented by General Formula (i-1-2) is preferably a compound selected from the compounds represented by Formulae (i-1-2.1) to (i-1-2.4) and is preferably the compound represented by Formulae (i-1-2.2) to (i-1-2.4). The compound represented by Formula (i-1-2.2) is particularly preferable because it markedly improves the response speed of the composition according to the present invention. In the case where a high T_{NI} has a higher priority than response speed, the compound represented by Formula (i-1-2.3) or (i-1-2.4) is preferably used. In order to enhance solubility at low temperatures, it is not preferable to set the amount of the compound represented by Formulae (i-1-2.3) and (i-1-2.4) to be 30% by mass or more.

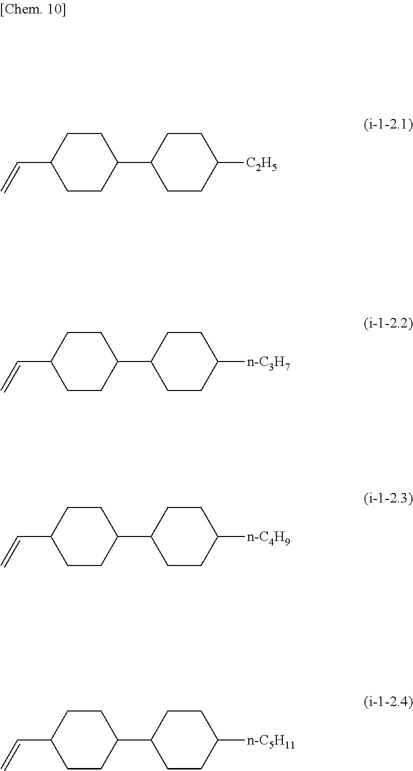

The lower limit for the amount of the compound represented by Formula (i-1-2.2) is preferably 10% by mass, 15% by mass, 18% by mass, 20% by mass, 23% by mass, 25% by mass, 27% by mass, 30% by mass, 33% by mass, 35% by mass, 38% by mass, or 40% by mass of the total amount of the composition according to the present invention. The upper limit for the amount of the compound represented by Formula (i-1-2.2) is preferably 60% by mass, 55% by mass, 50% by mass, 45% by mass, 43% by mass, 40% by mass, 38% by mass, 35% by mass, 32% by mass, 30% by mass, 20% by mass, 15% by mass, or 10% by mass of the total amount of the composition according to the present invention. The upper limit for the amount of the compound represented by Formula (i-1-2.2) is preferably set to 15% by mass and is particularly preferably set to 10% by mass in order to prevent the degradation of the liquid crystal layer by blue visible light.

The lower limit for the total amount of the compound represented by Formula (i-1-1.3) and the compound represented by Formula (i-1-2.2) is preferably 10% by mass, 15% by mass, 20% by mass, 25% by mass, 27% by mass, 30% by mass, 35% by mass, or 40% by mass of the total amount of the composition according to the present invention. The upper limit for the total amount of the compound represented by Formula (i-1-1.3) and the compound represented by Formula (i-1-2.2) is preferably 60% by mass, 55% by mass, 50% by mass, 45% by mass, 43% by mass, 40% by mass, 38% by mass, 35% by mass, 32% by mass, 30% by mass, 27% by mass, 25% by mass, or 22% by mass of the total amount of the composition according to the present invention.

The compound represented by General Formula (i-1) is preferably a compound selected from compounds represented by General Formula (i-1-3).

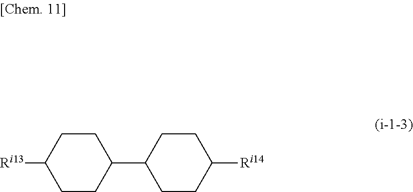

(in General Formula (i-1-3), Rⁱ¹³ and Rⁱ¹⁴ each independently represent an alkyl group having 1 to 8 carbon atoms or an alkoxy group having 1 to 8 carbon atoms) Rⁱ¹³ and R¹⁴ preferably represent a linear alkyl group having 1 to 5 carbon atoms, a linear alkoxy group having 1 to 4 carbon atoms, or a linear alkenyl group having 2 to 5 carbon atoms.

The lower limit for the amount of the compound represented by Formula (i-1-3) is preferably 1% by mass, 5% by mass, 10% by mass, 13% by mass, 15% by mass, 17% by mass, 20% by mass, 23% by mass, 25% by mass, or 30% by mass of the total amount of the composition according to the present invention. The upper limit for the amount of the compound represented by Formula (i-1-3) is preferably 60% by mass, 55% by mass, 50% by mass, 45% by mass, 40% by mass, 37% by mass, 35% by mass, 33% by mass, 30% by mass, 27% by mass, 25% by mass, 23% by mass, 20% by mass, 17% by mass, 15% by mass, 13% by mass, or 10% by mass of the total amount of the composition according to the present invention.

The compound represented by General Formula (i-1-3) is preferably a compound selected from the compounds represented by Formulae (i-1-3.1) to (i-1-3.12) and is preferably the compound represented by Formula (i-1-3.1), (i-1-3.3), or (i-1-3.4). The compound represented by Formula (i-1-3.1) is particularly preferably because it markedly improves the response speed of the composition according to the present invention. In the case where a high T_{NI} has a higher priority than response speed, the compound represented by Formula (i-1-3.3), (i-1-3.4), (i-i-3.11), or (i-1-3.12) is preferably used. In order to enhance solubility at low temperatures, it is not preferable to set the total amount of the compounds represented by Formulae (i-1-3.3), (i-1-3.4), (i-1-3.11) and (i-1-3.12) to be 20% by mass or more.

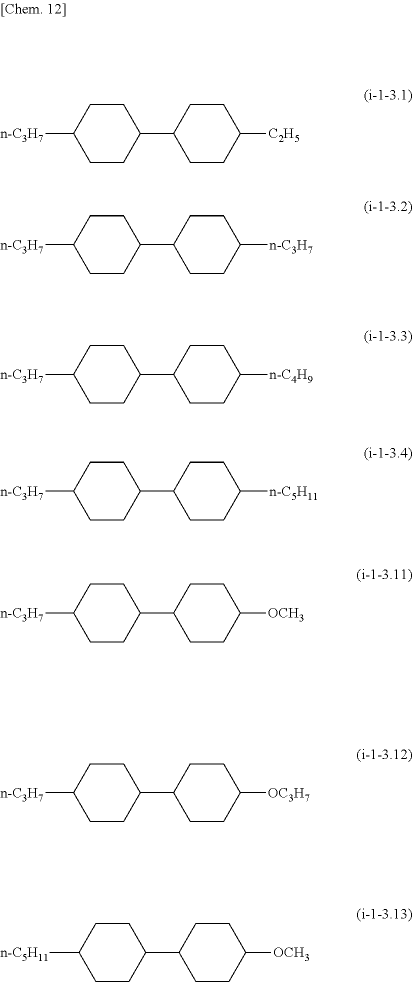

The lower limit for the amount of the compound represented by Formula (i-1-3.1) is preferably 1% by mass, 2% by mass, 3% by mass, 5% by mass, 7% by mass, 10% by mass, 13% by mass, 15% by mass, 18% by mass, or 20% by mass of the total amount of the composition according to the present invention. The upper limit for the amount of the compound represented by Formula (i-1-3.1) is preferably 20% by mass, 17% by mass, 15% by mass, 13% by mass, 10% by mass, 8% by mass, 7% by mass, or 6% by mass of the total amount of the composition according to the present invention.

The compound represented by General Formula (i-1) is preferably a compound selected from the compounds represented by General Formulae (i-1-4) and/or (i-1-5).

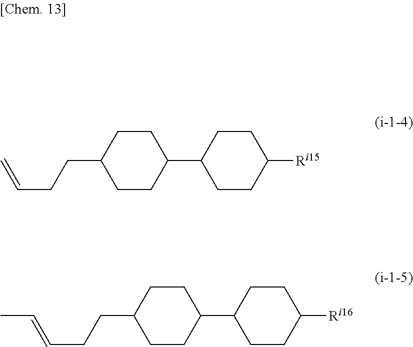

(in General Formulae (i-1-4) and (i-1-5), Rⁱ¹⁵ and Rⁱ¹⁶ each independently represent an alkyl group having 1 to 8 carbon atoms or an alkoxy group having 1 to 8 carbon atoms)

Rⁱ¹⁵ and Rⁱ¹⁶ preferably represent a linear alkyl group having 1 to 5 carbon atoms, a linear alkoxy group having 1 to 4 carbon atoms, or a linear alkenyl group having 2 to 5 carbon atoms.

The lower limit for the amount of the compound represented by Formula (i-1-4) is preferably 1% by mass, 5% by mass, 10% by mass, 13% by mass, 15% by mass, 17% by mass, or 20% by mass of the total amount of the composition according to the present invention. The upper limit for the amount of the compound represented by Formula (i-1-4) is preferably 25% by mass, 23% by mass, 20% by mass, 17% by mass, 15% by mass, 13% by mass, or 10% by mass of the total amount of the composition according to the present invention.

The lower limit for the amount of the compound represented by Formula (i-1-5) is preferably 1% by mass, 5% by mass, 10% by mass, 13% by mass, 15% by mass, 17% by mass, or 20% by mass of the total amount of the composition according to the present invention. The upper limit for the amount of the compound represented by Formula (i-1-5) is preferably 25% by mass, 23% by mass, 20% by mass, 17% by mass, 15% by mass, 13% by mass, or 10% by mass of the total amount of the composition according to the present invention.

The compound represented by General Formula (i-1-4) and (i-1-5) is preferably a compound selected from the compounds represented by Formulae (i-1-4.1) to (i-1-5.3) and is preferably the compound represented by Formula (i-1-4.2) or (i-1-5.2).

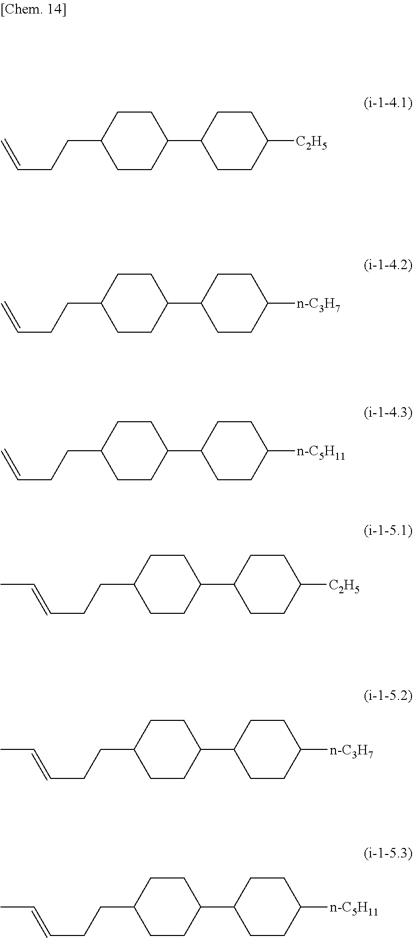

The lower limit for the amount of the compound represented by Formula (i-1-4.2) is preferably 1% by mass, 2% by mass, 3% by mass, 5% by mass, 7% by mass, 10% by mass, 13% by mass, 15% by mass, 18% by mass, or 20% by mass of the total amount of the composition according to the present invention. The upper limit for the amount of the compound represented by Formula (i-1-4.2) is preferably 20% by mass, 17% by mass, 15% by mass, 13% by mass, 10% by mass, 8% by mass, 7% by mass, or 6% by mass of the total amount of the composition according to the present invention.

It is preferable to use two or more compounds selected from the compounds represented by Formulae (i-1-1.3), (i-i-2.2), (i-1-3.1), (i-1-3.3), (i-1-3.4), (i-1-3.11), and (i-1-3.12) in combination. It is preferable to use two or more compounds selected from the compounds represented by Formulae (i-1-1.3), (i-1-2.2), (i-1-3.1), (i-1-3.3), (i-1-3.4), and (i-1-4.2) in combination. The lower limit for the total amount of the above compounds is preferably 1% by mass, 2% by mass, 3% by mass, 5% by mass, 7% by mass, 10% by mass, 13% by mass, 15% by mass, 18% by mass, 20% by mass, 23% by mass, 25% by mass, 27% by mass, 30% by mass, 33% by mass, or 35% by mass of the total amount of the composition according to the present invention. The upper limit for the total amount of the above compounds is preferably 80% by mass, 70% by mass, 60% by mass, 50% by mass, 45% by mass, 40% by mass, 37% by mass, 35% by mass, 33% by mass, 30% by mass, 28% by mass, 25% by mass, 23% by mass, or 20% by mass of the total amount of the composition according to the present invention. In the case where importance is placed on the reliability of the composition, it is preferable to use two or more compounds selected from the compounds represented by Formulae (i-1-3.1), (i-1-3.3), and (i-1-3.4) in combination. In the case where importance is placed on the response speed of the composition, it is preferable to use two or more compounds selected from the compounds represented by Formulae (i-1-1.3) and (i-1-2.2) in combination.

The compound represented by General Formula (i-1) is preferably a compound selected from compounds represented by General Formula (i-1-6).

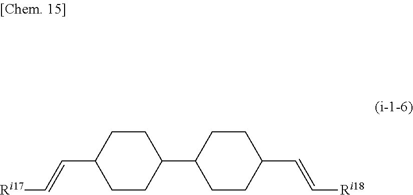

(in General Formula (i-1-6), Rⁱ¹⁷ and Rⁱ¹⁸ each independently represent a methyl group or a hydrogen atom)

The lower limit for the amount of the compound represented by Formula (i-1-6) is preferably 1% by mass, 5% by mass, 10% by mass, 15% by mass, 17% by mass, 20% by mass, 23% by mass, 25% by mass, 27% by mass, 30% by mass, or 35% by mass of the total amount of the composition according to the present invention. The upper limit for the amount of the compound represented by Formula (i-1-6) is preferably 60% by mass, 55% by mass, 50% by mass, 45% by mass, 42% by mass, 40% by mass, 38% by mass, 35% by mass, 33% by mass, or 30% by mass of the total amount of the composition according to the present invention.

The compound represented by General Formula (i-1-6) is preferably a compound selected from the compounds represented by Formulae (i-1-6.1) to (i-1-6.3).

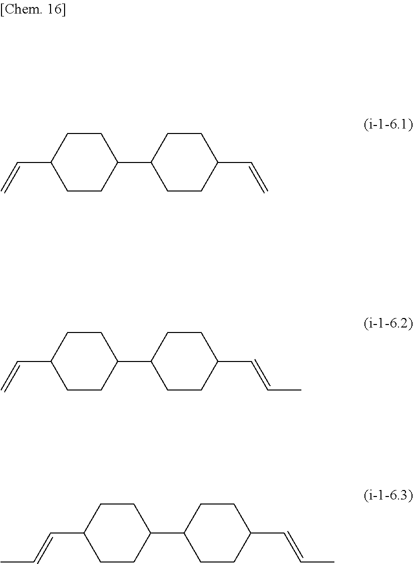

The compound represented by General Formula (i-2) is the following compound.

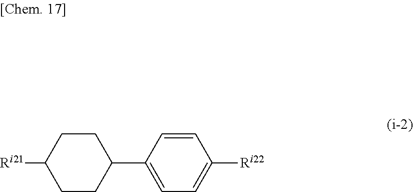

(in General Formula (i-2), Rⁱ²¹ and Rⁱ²² each independently represent the same things as Rⁱ¹ and Rⁱ² in General Formula (i), respectively)

Rⁱ²¹ is preferably an alkyl group having 1 to 5 carbon atoms or an alkenyl group having 2 to 5 carbon atoms. Rⁱ²² is preferably an alkyl group having 1 to 5 carbon atoms, an alkenyl group having 4 or 5 carbon atoms, or an alkoxy group having 1 to 4 carbon atoms.

The compound represented by General Formula (i-2) may be used alone. Optionally, two or more compounds may be used in combination. The types of the compounds used in combination are not limited. Compounds are used in combination in accordance with the intended properties, such as solubility at low temperatures, transition temperature, electrical reliability, and birefringence. The number of types of the compounds used is, for example, in an embodiment of the present invention, one, two, three, four, or five or more.

In the case where importance is placed on solubility at low temperatures, it is advantageous to increase the amount of the compound. On the other hand, in the case where importance is placed on response speed, it is advantageous to reduce the amount of the compound. For improving traces of droplets and image-sticking property, it is preferable to set the amount of the compound to be medium.

The lower limit for the amount of the compound represented by Formula (i-2) is preferably 1% by mass, 2% by mass, 3% by mass, 5% by mass, 7% by mass, or 10% by mass of the total amount of the composition according to the present invention. The upper limit for the amount of the compound represented by Formula (i-2) is preferably 20% by mass, 15% by mass, 13% by mass, 10% by mass, 8% by mass, 7% by mass, 6% by mass, 5% by mass, or 3% by mass of the total amount of the composition according to the present invention.

The compound represented by General Formula (i-2) is preferably a compound selected from the compounds represented by Formulae (i-2.1) to (i-2.6) and is preferably the compound represented by Formula (i-2.1), (i-2.3), (i-2.4), or (i-2.6).

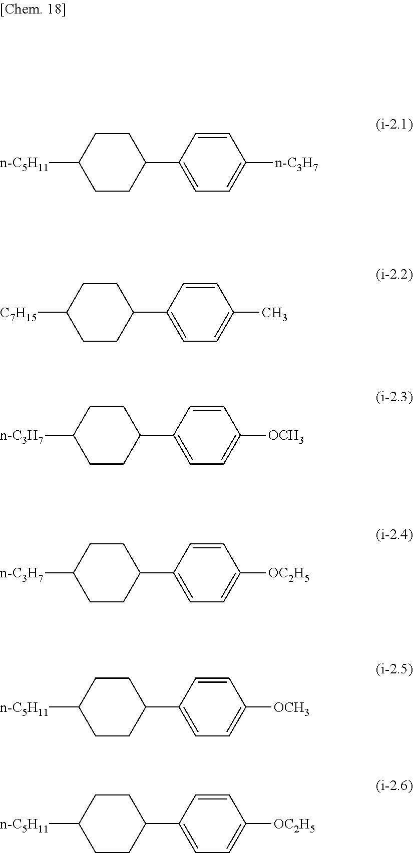

The composition according to the present invention preferably further includes one or two or more compounds selected from the compounds represented by General Formulae (N-1), (N-2), (N-3), and (N-4). The following compounds are dielectrically negative compounds (Δε has negative sign, and the absolute value of Δε is larger than 2).

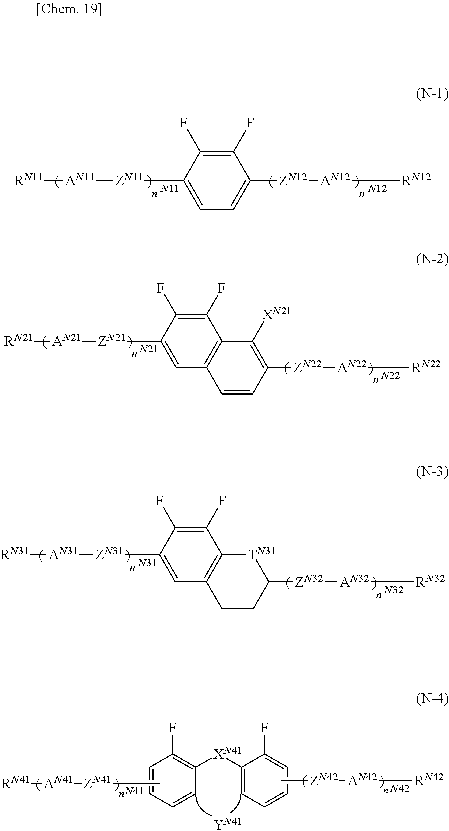

[in General Formulae (N-1), (N-2), (N-3), and (N-4), R^{N11}, R^{N12}, R^{N21}, R^{N22}, R^{N31}, R^{N32}, R^{N41}, and R^{N42} each independently represent an alkyl group having 1 to 8 carbon atoms or a structural site having a chemical structure formed by independently replacing one or two or more —CH₂— groups that are included in an alkyl chain having 2 to 8 carbon atoms and are not adjacent to one another with —CH═CH—, —C≡C—, —O—, —CO—, —COO—, or —OCO—;

A^{N11}, A^{N12}, A^{N21}, A^{N22}, A^{N31}, A^{N32}, A^{N41}, and A^{N42} each independently represent a group selected from the group consisting of

(a) a 1,4-cyclohexylene group (in this group, one —CH₂— group or two or more —CH₂— groups that are not adjacent to one another may be replaced with —O—),

(b) a 1,4-phenylene group (in this group, one —CH═ group or two or more —CH═ groups that are not adjacent to one another may be replaced with —N═),

(c) a naphthalene-2,6-diyl group, a 1,2,3,4-tetrahydronaphthalene-2,6-diyl group, or a decahydronaphthalene-2,6-diyl group (in the naphthalene-2,6-diyl group or the 1,2,3,4-tetrahydronaphthalene-2,6-diyl group, one —CH═ group or two or more —CH═ groups that are not adjacent to one another may be replaced with —N═), and

(d) a 1,4-cyclohexenylene group and, in the group (a), the group (b), the group (c), and the group (d), hydrogen atoms may be each independently replaced with a cyano group, a fluorine atom, or a chlorine atom;

Z^{N11}, Z^{N12}, Z^{N21}, Z^{N22}, Z^{N31}, Z^{N32}, Z^{N41} and Z^{N42} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C═C—;

X^{N21} represents a hydrogen atom or a fluorine atom; T^{N31} represents —CH₂— or an oxygen atom; X^{N41} represents an oxygen atom, a nitrogen atom, or —CH₂—; Y^{N41} represents a single bond or —CH₂—; n^{N11}, n^{N12}, n^{N21}, n^{N22}, n^{N31}, n^{N32}, n^{N41}, and n^{N42} each independently represent an integer of 0 to 3; n^{N31}+n^{N12}, n^{N21}+n^{N22}, and n^{N31}+n^{N32} each independently represent 1, 2, or 3 and, in the case where the number of any of A^{N11} to A^{N32} and Z^{N11} to Z^{N32} is two or more, they may be identical to or different from one another; and n^{N41}+n^{N42} represents an integer of 0 to 3 and, in the case where the number of any of A^{N41}, A^{N42}, Z ^{N41}, and Z^{N42} is two or more, they may be identical to or different from one another]

The compounds represented by General Formulae (N-1), (N-2), (N-3), and (N-4) are preferably compounds having a negative Δε with an absolute value larger than 2.

In General Formulae (N-1), (N-2), (N-3), and (N-4), R^{N11}, R^{N12}, R^{N21}, R^{N22}, R^{N31}, R^{N32}, R^{N41}, and R^{N42} preferably each independently represent an alkyl group having 1 to 8 carbon atoms, an alkoxy group having 1 to 8 carbon atoms, an alkenyl group having 2 to 8 carbon atoms, or an alkenyloxy group having 2 to 8 carbon atoms; preferably each independently represent an alkyl group having 1 to 5 carbon atoms, an alkoxy group having 1 to 5 carbon atoms, an alkenyl group having 2 to 5 carbon atoms, or an alkenyloxy group having 2 to 5 carbon atoms; further preferably each independently represent an alkyl group having 1 to 5 carbon atoms or an alkenyl group having 2 to 5 carbon atoms; further preferably each independently represent an alkyl group having 2 to 5 carbon atoms or an alkenyl group having 2 or 3 carbon atoms; and particularly preferably represent an alkenyl group having 3 carbon atoms (a propenyl group).

In the case where the ring structure to which the Rⁿ¹¹, R^{N12}, R^{N21}, R^{N22}, R^{N31}, R^{N32}, R^{N41}, or R^{N42} group is bonded is a phenyl group (an aromatic group), the above group is preferably a linear alkyl group having 1 to 5 carbon atoms, a linear alkoxy group having 1 to 4 carbon atoms, or an alkenyl group having 4 or 5 carbon atoms. In the case where the ring structure to which the R^{N11}, R^{N12}, R^{N11}, R^{N22}, R^{N31}, R^{N32}, R^{N41}, or R^{N42} group is bonded is a saturated ring structure, such as cyclohexane, pyran, or dioxane, the above group is preferably a linear alkyl group having 1 to 5 carbon atoms, a linear alkoxy group having 1 to 4 carbon atoms, or a linear alkenyl group having 2 to 5 carbon atoms. In order to stabilize the nematic phase, the total number of carbon atoms and, if present, oxygen atoms is preferably five or less and the above group is preferably linear.

The alkenyl group is preferably selected from the groups represented by Formulae (R1) to (R5) (in Formulae (R1) to (R5), the black dot represents a carbon atom included in a ring structure).

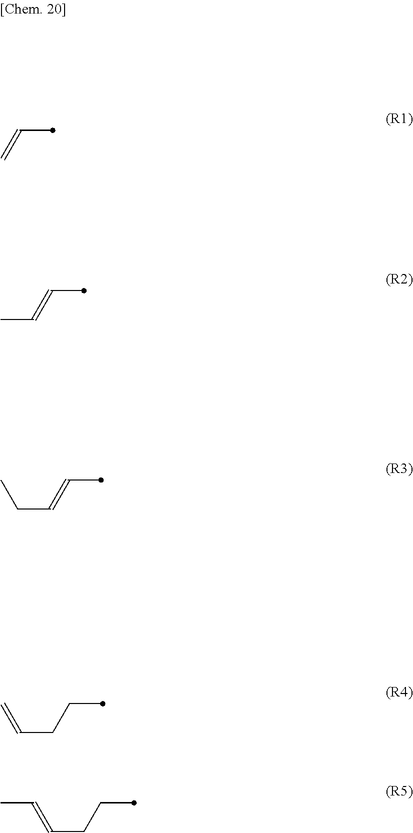

A^{N11}, A^{N12}, A^{N21}, A^{N22}, A^{N31}, and A^{N32} preferably each independently represent an aromatic group in the case where importance is placed on an increase in Δn and preferably each independently represent an aliphatic group in the case where importance is placed on the improvement of response speed. A^{N11}, A^{N12}, A^{N21}, A^{N22}, A^{N31}, and A^{N32} preferably represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. A^{N11}, A^{N12}, A^{N21}, A^{N22}, A^{N31}, and A^{N32} more preferably represent the following structures.

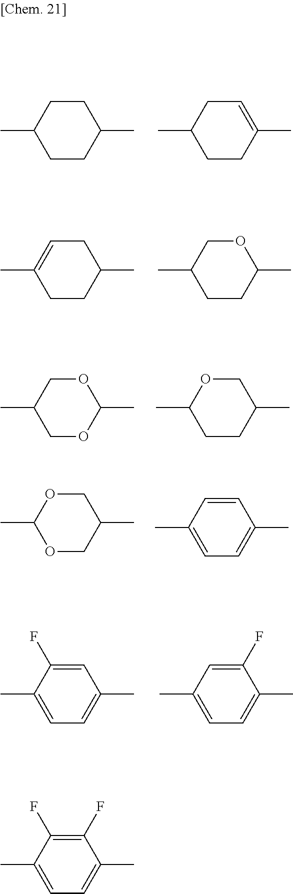

A^{N11}, A^{N12}, A^{N21}, A^{N22}, A^{N31}, and A^{N32} more preferably represent a trans-1,4-cyclohexylene group, a 1,4-cyclohexenylene group, or a 1,4-phenylene group.

Z^{N11}, Z^{N12}, Z^{N21}, Z^{N22}, Z^{N31}, and Z^{N32} preferably each independently represent —CH₂O—, —CF₂O—, —CH₂CH₂—, —CF₂CF₂—, or a single bond, further preferably each independently represent —CH₂O—, —CH₂CH₂—, or a single bond, and particularly preferably each independently represent —CH₂O— or a single bond.

X^{N21} is preferably a fluorine atom.

T^{N31} is preferably an oxygen atom.

n^{N11}+n^{N12}, n^{N21}+n^{N22}, and n^{N31}+n^{N32} are preferably 1 or 2. A combination of n^{N11}=1 and n^{N12}=0, a combination of n^{N11}=2 and n^{N12}=0, a combination of n^{N11}=1 and n^{N12}=1, a combination of n^{N11}=2 and n^{N12}=1, a combination of n^{N21}=1 and n^{N22}=0, a combination of n^{N21}=2 and n^{N22}=0, a combination of n^{N31}=1 and n^{N32}=0, and a combination of n^{N31}=2 and n^{N32}=0 are preferable.

The lower limit for the amount of the compound represented by Formula (N-1) is preferably 1% by mass, 10% by mass, 20% by mass, 30% by mass, 40% by mass, 50% by mass, 55% by mass, 60% by mass, 65% by mass, 70% by mass, 75% by mass, or 80% by mass of the total amount of the composition according to the present invention. The upper limit for the amount of the compound represented by Formula (N-1) is preferably 95% by mass, 85% by mass, 75% by mass, 65% by mass, 55% by mass, 45% by mass, 35% by mass, 25% by mass, or 20% by mass.

The lower limit for the amount of the compound represented by Formula (N-2) is preferably 1% by mass, 10% by mass, 20% by mass, 30% by mass, 40% by mass, 50% by mass, 55% by mass, 60% by mass, 65% by mass, 70% by mass, 75% by mass, or 80% by mass of the total amount of the composition according to the present invention. The upper limit for the amount of the compound represented by Formula (N-2) is preferably 95% by mass, 85% by mass, 75% by mass, 65% by mass, 55% by mass, 45% by mass, 35% by mass, 25% by mass, or 20% by mass.

The lower limit for the amount of the compound represented by Formula (N-3) is preferably 1% by mass, 10% by mass, 20% by mass, 30% by mass, 40% by mass, 50% by mass, 55% by mass, 60% by mass, 65% by mass, 70% by mass, 75% by mass, or 80% by mass of the total amount of the composition according to the present invention. The upper limit for the amount of the compound represented by Formula (N-3) is preferably 95% by mass, 85% by mass, 75% by mass, 65% by mass, 55% by mass, 45% by mass, 35% by mass, 25% by mass, or 20% by mass.

In the case where the viscosity of the composition according to the present invention needs to be kept low in order to produce a composition having a high response speed, it is preferable that the above lower limit be set low and the upper limit be set low. In the case where the T_{NI} of the composition according to the present invention needs to be kept high in order to produce a composition having good temperature stability, it is preferable that the above lower limit be set low and the upper limit be set low. In the case where dielectric anisotropy needs to be increased in order to keep the driving voltage low, it is preferable that the above lower limit be set high and the upper limit be set high.

Among the compound represented by General Formula (N-1), the compound represented by General Formula (N-2), the compound represented by General Formula (N-3), and the compound represented by General Formula (N-4), the compound represented by General Formula (N-1) is preferably included in the liquid crystal composition according to the present invention.

Examples of the compound represented by General Formula (N-1) include the compounds represented by General Formulae (N-1a) to (N-1g) below.

Examples of the compound represented by General Formula (N-4) include compounds represented by General Formula (N-1h) below.

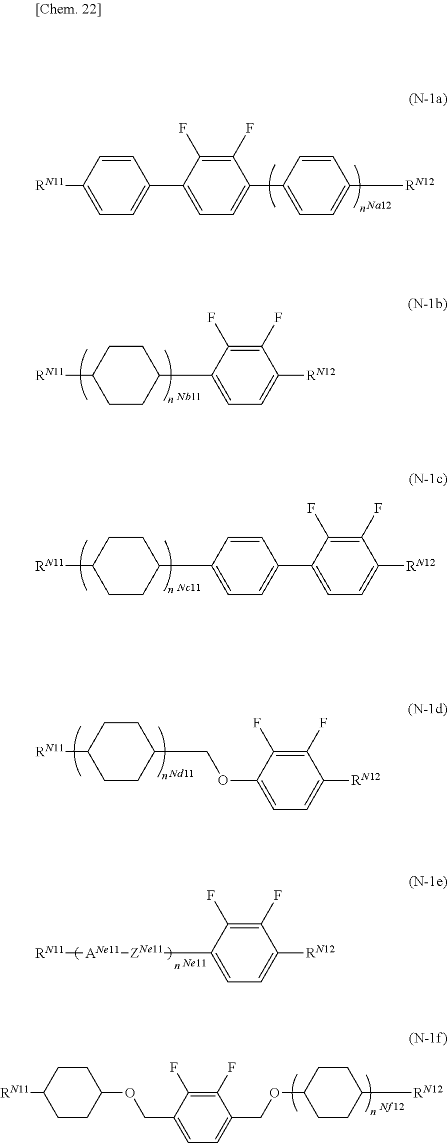

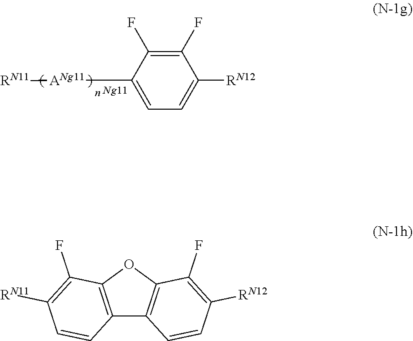

(in General Formulae (N-1a) to (N-1h), R^{N11} and R^{N12} represent the same things as R^{N11} and R^{N12} in General Formula (N-1); n^{Na11} represents 0 or 1; n^{Nb11} represents 0 or 1, n^{Nc11} represents 0 or 1, n^{Nd11} represents 0 or 1, n^{Nell} represents 1 or 2, n^{Nf11} represents 1 or 2, n^{Ng11} represents 1 or 2, A^{Nc11} represents a trans-1,4-cyclohexylene group or a 1,4-phenylene group, A^{Ng11} represents a trans-1,4-cyclohexylene group, a 1,4-cyclohexenylene group, or a 1,4-phenylene group, and at least one A^{Ng11} group is a 1,4-cyclohexenylene group; and Z^{Na11} represents a single bond or ethylene, and at least one Z^{Na11} group is ethylene)

(p-Type Compound)

The composition according to the present invention preferably further includes one or two or more of compounds represented by General Formula (J). The following compounds are dielectrically positive compounds (Δε is larger than 2).

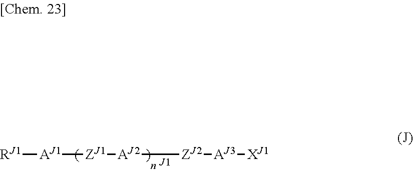

(in General Formula (J), R^{J1} represents an alkyl group having 1 to 8 carbon atoms and, in the alkyl group, one —CH₂— group or two or more —CH₂— groups that are not adjacent to one another may be each independently replaced with —CH═CH—, —C═C—, —O—, —CO—, —COO—, or —OCO—;

n^{J1} represents 0, 1, 2, 3, or 4;

A^{J1}, A^{J2}, and A^{J3} each independently represent a group selected from the group consisting of

(a) a 1,4-cyclohexylene group (in this group, one —CH₂— group or two or more —CH₂— groups that are not adjacent to one another may be replaced with —O—),

(b) a 1,4-phenylene group (in this group, one —CH═ group or two or more —CH═ groups that are not adjacent to one another may be replaced with —N═), and

(c) a naphthalene-2,6-diyl group, a 1,2,3,4-tetrahydronaphthalene-2,6-diyl group, or a decahydronaphthalene-2,6-diyl group (in the naphthalene-2,6-diyl group or the 1,2,3,4-tetrahydronaphthalene-2,6-diyl group, one —CH═ group or two or more —CH═ groups that are not adjacent to one another may be replaced with —N═), and the group (a), the group (b), and the group (c) may be each independently substituted with a cyano group, a fluorine atom, a chlorine atom, a methyl group, a trifluoromethyl group, or a trifluoromethoxy group;

Z^{J1} and Z^{J2} each independently represent a single bond, —CH₂CH₂—, —(CH₂)₄—, —OCH₂—, —CH₂O—, —OCF₂—, —CF₂O—, —COO—, —OCO—, or —C═C—;

in the case where n^{J1} is 2, 3, or 4 and a plurality of A^{J2} groups are present, they may be identical to or different from one another, in the case where n^{J1} is 2, 3, or 4 and a plurality of Z^{J1} groups are present, they may be identical to or different from one another; and

X^{J1} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group)

In General Formula (J), R^{J1} preferably represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms; preferably represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms; further preferably represents an alkyl group having 1 to 5 carbon atoms or an alkenyl group having 2 to 5 carbon atoms; further preferably represents an alkyl group having 2 to 5 carbon atoms or an alkenyl group having 2 or 3 carbon atoms; and particularly preferably represents an alkenyl group having 3 carbon atoms (propenyl group).

In the case where importance is placed on reliability, R^{J1} is preferably an alkyl group. In the case where importance is placed on a reduction in viscosity, R^{J1} is preferably an alkenyl group.

In the case where the ring structure to which the R^{J1} group is bonded is a phenyl group (an aromatic group), the R^{J1} group is preferably a linear alkyl group having 1 to 5 carbon atoms, a linear alkoxy group having 1 to 4 carbon atoms, or an alkenyl group having 4 or 5 carbon atoms. In the case where the ring structure to which the R^{J1} group is bonded is a saturated ring structure, such as cyclohexane, pyran, or dioxane, the R^{J1} group is preferably a linear alkyl group having 1 to 5 carbon atoms, a linear alkoxy group having 1 to 4 carbon atoms, or a linear alkenyl group having 2 to 5 carbon atoms. In order to stabilize the nematic phase, the total number of carbon atoms and, if present, oxygen atoms is preferably five or less and the R^{J1} group is preferably linear.

The alkenyl group is preferably selected from the groups represented by Formulae (R1) to (R5) (where the black dot represents a carbon atom included in the ring structure to which the alkenyl group is bonded).

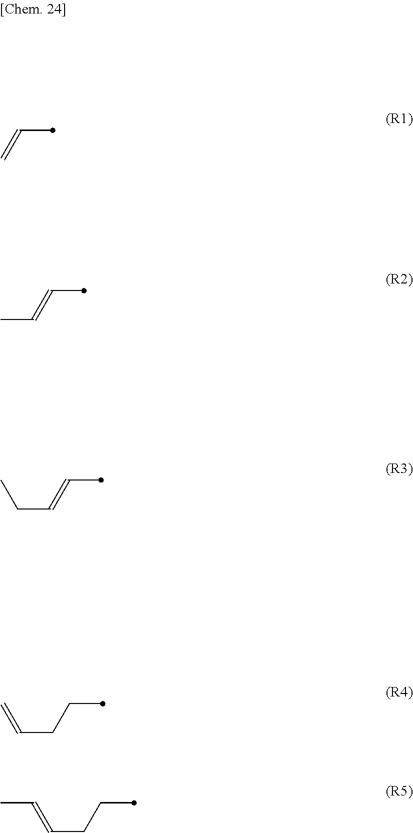

A^{J1}, A^{J2}, and A^{J3} preferably each independently represent an aromatic group in the case where importance is placed on an increase in Δn and preferably each independently represent an aliphatic group in the case where importance is placed on the improvement of response speed. A^{J1}, A^{J2}, and A^{J3} preferably each independently represent a trans-1,4-cyclohexylene group, a 1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. The above groups may be substituted with a fluorine atom. A^{J1}, A^{J2}, and A^{J3} more preferably represent the following structures.

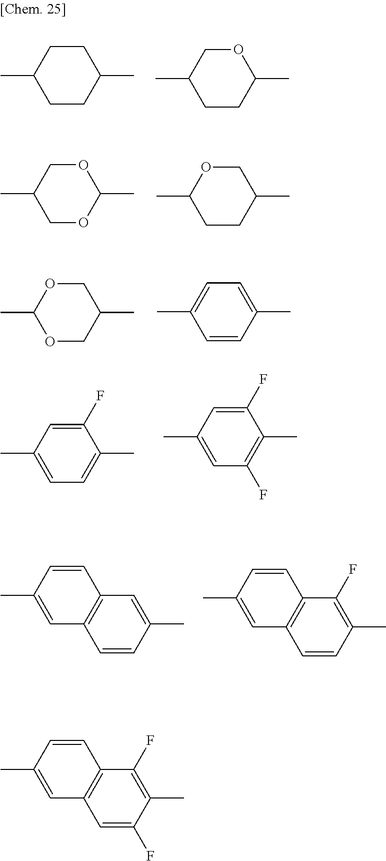

A^{J1}, A^{J2}, and A^{J3} more preferably represent the following structures.

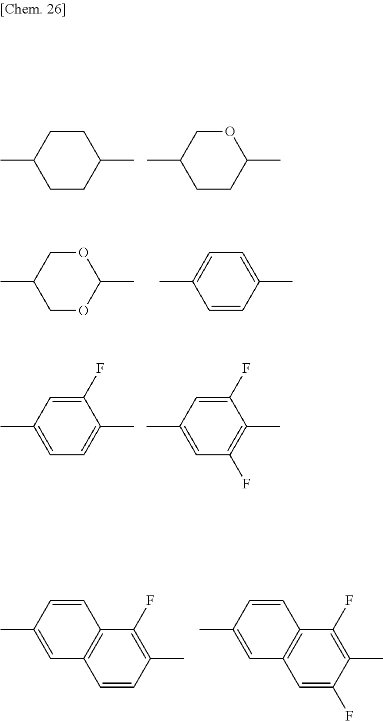

Z^{J1} and Z^{J2} preferably each independently represent —CH₂O—, —OCH₂—, —CF₂O—, —CH₂CH₂—, —CF₂CF₂—, or a single bond, further preferably each independently represent —OCH₂—, —CF₂O—, —CH₂CH₂—, or a single bond, and particularly preferably each independently represent —OCH₂—, —CF₂O—, or a single bond.

X^{J1} is preferably a fluorine atom or a trifluoromethoxy group and is preferably a fluorine atom.

n^{J1} is preferably 0, 1, 2, or 3 and is preferably 0, 1, or 2. In the case where importance is placed on improvement of Δε, n^{J1} is preferably 0 or 1. In the case where importance is placed on T_{N1}, n^{J1} is preferably 1 or 2.

The types of compounds that can be used in combination are not limited. Compounds are used in combination in accordance with the intended properties, such as solubility at low temperatures, transition temperature, electrical reliability, and birefringence. The number of types of the compounds used is, for example, in an embodiment of the present invention, one, two, or three. The number of types of the compounds used is, in another embodiment of the present invention, four, five, six, or seven or more.

The content of the compound represented by General Formula (J) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by General Formula (J) is preferably 1% by mass, 10% by mass, 20% by mass, 30% by mass, 40% by mass, 50% by mass, 55% by mass, 60% by mass, 65% by mass, 70% by mass, 75% by mass, or 80% by mass of the total amount of the composition according to the present invention. The upper limit for the amount of the compound represented by Formula (J) is, for example, in an embodiment of the present invention, preferably 95% by mass, 85% by mass, 75% by mass, 65% by mass, 55% by mass, 45% by mass, 35% by mass, or 25% by mass of the total amount of the composition according to the present invention.

In the case where the viscosity of the composition according to the present invention needs to be kept low in order to produce a composition having a high response speed, it is preferable that the above lower limit be set relatively low and the upper limit be set relatively low. In the case where the T_{N1} of the composition according to the present invention needs to be kept high in order to produce a composition having good temperature stability, it is preferable that the above lower limit be set relatively low and the upper limit be set relatively low. In the case where dielectric anisotropy needs to be increased in order to keep the driving voltage low, it is preferable that the above lower limit be set relatively high and the upper limit be set relatively high.

In the case where importance is placed on reliability, R^{J1} is preferably an alkyl group. In the case where importance is placed on a reduction in viscosity, R^{J1} is preferably an alkenyl group.

The compound represented by General Formula (J) is preferably the compound represented by General Formula (M) or the compound represented by General Formula (K).

The composition according to the present invention preferably further include one or two or more of compounds represented by General Formula (M). The following compounds are dielectrically positive compounds (Δε is larger than 2).

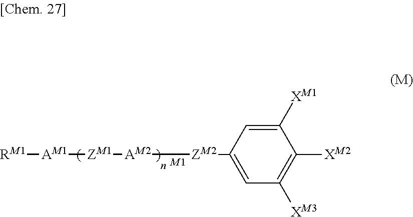

(in General Formula (M), R^{M1} represents an alkyl group having 1 to 8 carbon atoms and, in the alkyl group, one —CH₂— group or two or more —CH₂— groups that are not adjacent to one another may be each independently replaced with —CH═CH—, —C═C—, —O—, —CO—, —COO—, or —OCO—;

n^{M1} represents 0, 1, 2, 3, or 4;

A^{M1} and A^{M2} each independently represent a group selected from the group consisting of

(a) a 1,4-cyclohexylene group (in this group, one —CH₂— group or two or more —CH₂— groups that are not adjacent to one another may be replaced with —O— or —S—), and

(b) a 1,4-phenylene group (in this group, one —CH═ group or two or more —CH═ groups that are not adjacent to one another may be replaced with —N═) and, in the group (a) and the group (b), hydrogen atoms may be each independently replaced with a cyano group, a fluorine atom, or a chlorine atom;

Z^{M1} and Z^{M2} each independently represent a single bond, —CH₂CH₂—, —(CH₂)₄—, —OCH₂—, —CH₂O—, —OCF₂—, —CF₂O—, —COO—, —OCO—, or —C═C—;

in the case where n^{M1} is 2, 3, or 4 and a plurality of A^{M2} groups are present, they may be identical to or different from one another; in the case where n^{M1} is 2, 3, or 4 and a plurality of Zen groups are present, they may be identical to or different from one another;

X^{M1} and X^{M3} each independently represent a hydrogen atom, a chlorine atom, or a fluorine atom; and

X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.

In General Formula (M), R^{M1} preferably represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms; preferably represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms; further preferably represents an alkyl group having 1 to 5 carbon atoms or an alkenyl group having 2 to 5 carbon atoms; further preferably represents an alkyl group having 2 to 5 carbon atoms or an alkenyl group having 2 or 3 carbon atoms; and particularly preferably represents an alkenyl group having 3 carbon atoms (propenyl group).

In the case where importance is placed on reliability, R^{M1} is preferably an alkyl group. In the case where importance is placed on a reduction in viscosity, R^{M1} is preferably an alkenyl group.

In the case where the ring structure to which the R^{M1} group is bonded is a phenyl group (an aromatic group), the R^{M1} group is preferably a linear alkyl group having 1 to 5 carbon atoms, a linear alkoxy group having 1 to 4 carbon atoms, or an alkenyl group having 4 or 5 carbon atoms. In the case where the ring structure to which the R^{M1} group is bonded is a saturated ring structure, such as cyclohexane, pyran, or dioxane, the R^{M1} group is preferably a linear alkyl group having 1 to 5 carbon atoms, a linear alkoxy group having 1 to 4 carbon atoms, or a linear alkenyl group having 2 to 5 carbon atoms. In order to stabilize the nematic phase, the total number of carbon atoms and, if present, oxygen atoms is preferably five or less and the R^{M1} group is preferably linear.

The alkenyl group is preferably selected from the groups represented by Formulae (R1) to (R5) (where the black dot represents a carbon atom included in the ring structure to which the alkenyl group is bonded).

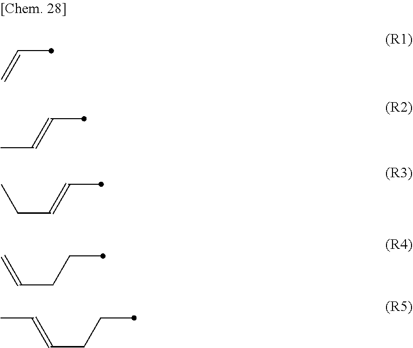

A^{M1} and A^{M2} preferably each independently represent an aromatic group in the case where importance is placed on an increase in Δn and preferably each independently represent an aliphatic group in the case where importance is placed on the improvement of response speed. A^{M1} and A^{M2} preferably each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. A^{N1} and A^{N2} more preferably represent the following structures.

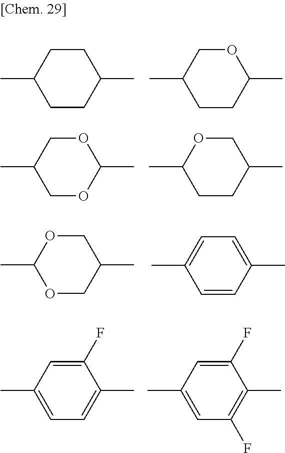

A^{M1} and A^{M2} more preferably represent the following structures.

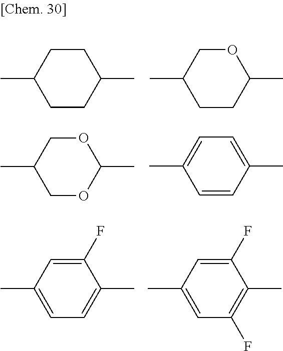

Z^{M1} and Z^{M2} preferably each independently represent —CH₂O—, —CF₂O—, —CH₂CH₂—, —CF₂CF₂—, or a single bond, further preferably each independently represent —CF₂O—, —CH₂CH₂—, or a single bond, and particularly preferably each independently represent —CF₂O— or a single bond.

n^{M1} is preferably 0, 1, 2, or 3 and is preferably 0, 1, or 2. In the case where importance is placed on improvement of Δε, n^{M1} is preferably 0 or 1. In the case where importance is placed on T_{M1}, n^{M1} is preferably 1 or 2.

The types of compounds that can be used in combination are not limited. Compounds are used in combination in accordance with the intended properties, such as solubility at low temperatures, transition temperature, electrical reliability, and birefringence. The number of types of the compounds used is, for example, in an embodiment of the present invention, one, two, or three. The number of types of the compounds used is, in another embodiment of the present invention, four, five, six, or seven or more.

The content of the compound represented by General Formula (M) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by Formula (M) is preferably 1% by mass, 10% by mass, 20% by mass, 30% by mass, 40% by mass, 50% by mass, 55% by mass, 60% by mass, 65% by mass, 70% by mass, 75% by mass, or 80% by mass of the total amount of the composition according to the present invention. The upper limit for the amount of the compound represented by Formula (M) is, for example, in an embodiment of the present invention, preferably 95% by mass, 85% by mass, 75% by mass, 65% by mass, 55% by mass, 45% by mass, 35% by mass, or 25% by mass of the total amount of the composition according to the present invention.

In the case where the viscosity of the composition according to the present invention needs to be kept low in order to produce a composition having a high response speed, it is preferable that the above lower limit be set relatively low and the upper limit be set relatively low. In the case where the T_{NI} of the composition according to the present invention needs to be kept high in order to produce a composition having good temperature stability, it is preferable that the above lower limit be set relatively low and the upper limit be set relatively low. In the case where dielectric anisotropy needs to be increased in order to keep the driving voltage low, it is preferable that the above lower limit be set relatively high and the upper limit be set relatively high.

The composition according to the present invention preferably include one or two or more of compounds represented by General Formula (K). The following compounds are dielectrically positive compounds (Δε is larger than 2).

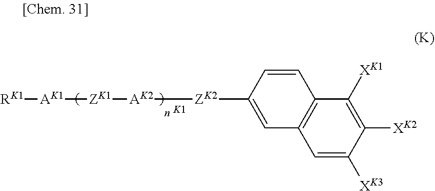

(in General Formula (K), R^{K1} represents an alkyl group having 1 to 8 carbon atoms and, in the alkyl group, one —CH₂— group or two or more —CH₂— groups that are not adjacent to one another may be each independently replaced with —CH═CH—, —C═C—, —O—, —CO—, —COO—, or —OCO—;

n^{K1} represents 0, 1, 2, 3, or 4;

A^{K1} and A^{K2} each independently represent a group selected from the group consisting of

(a) a 1,4-cyclohexylene group (in this group, one —CH₂— group or two or more —CH₂— groups that are not adjacent to one another may be replaced with —O— or —S—), and

(b) a 1,4-phenylene group (in this group, one —CH═ group or two or more —CH═ groups that are not adjacent to one another may be replaced with —N═) and, in the group (a) and the group (b), hydrogen atoms may be each independently replaced with a cyano group, a fluorine atom, or a chlorine atom;

Z^{K1} and Z^{K2} each independently represent a single bond, —CH₂CH₂—, —(CH₂)₄—, —OCH₂—, —CH₂O—, —OCF₂—, —CF₂O—, —COO—, —OCO—, or —C═C—;

in the case where n^{K1} is 2, 3, or 4 and a plurality of A^{E2} groups are present, they may be identical to or different from one another; in the case where n^{K1} is 2, 3, or 4 and a plurality of Z^{K1} groups are present, they may be identical to or different from one another;

X^{K1} and X^{K3} each independently represent a hydrogen atom, a chlorine atom, or a fluorine atom; and

X^{E2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group)

In General Formula (K), R^{K1} preferably represents an alkyl group having 1 to 8 carbon atoms, an alkoxy group having 1 to 8 carbon atoms, an alkenyl group having 2 to 8 carbon atoms, or an alkenyloxy group having 2 to 8 carbon atoms; preferably represents an alkyl group having 1 to 5 carbon atoms, an alkoxy group having 1 to 5 carbon atoms, an alkenyl group having 2 to 5 carbon atoms, or an alkenyloxy group having 2 to 5 carbon atoms; further preferably represents an alkyl group having 1 to 5 carbon atoms or an alkenyl group having 2 to 5 carbon atoms; further preferably represents an alkyl group having 2 to 5 carbon atoms or an alkenyl group having 2 or 3 carbon atoms; and particularly preferably represents an alkenyl group having 3 carbon atoms (propenyl group).

In the case where importance is placed on reliability, R^{K1} is preferably an alkyl group. In the case where importance is placed on a reduction in viscosity, R^{K1} is preferably an alkenyl group.

In the case where the ring structure to which the R^{K1} group is bonded is a phenyl group (an aromatic group), the R^{K1} group is preferably a linear alkyl group having 1 to 5 carbon atoms, a linear alkoxy group having 1 to 4 carbon atoms, or an alkenyl group having 4 or 5 carbon atoms. In the case where the ring structure to which the R^{K1} group is bonded is a saturated ring structure, such as cyclohexane, pyran, or dioxane, the R^{K1} group is preferably a linear alkyl group having 1 to 5 carbon atoms, a linear alkoxy group having 1 to 4 carbon atoms, or a linear alkenyl group having 2 to 5 carbon atoms. In order to stabilize the nematic phase, the total number of carbon atoms and, if present, oxygen atoms is preferably five or less and the R^{K1} group is preferably linear.

The alkenyl group is preferably selected from the groups represented by Formulae (R1) to (R5) (where the black dot represents a carbon atom included in the ring structure to which the alkenyl group is bonded).

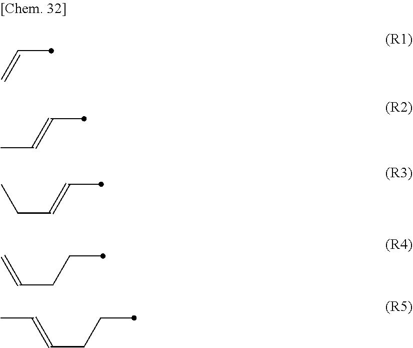

A^{K1} and A^{K2} preferably each independently represent an aromatic group in the case where importance is placed on an increase in Δn and preferably each independently represent an aliphatic group in the case where importance is placed on the improvement of response speed. A^{K1} and A^{K2} preferably each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. A^{K1} and A^{K2} more preferably represent the following structures.

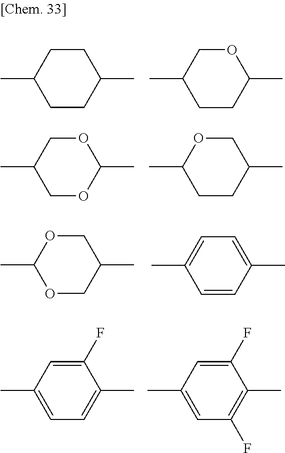

A^{K1} and A^{K2} more preferably represent the following structures.

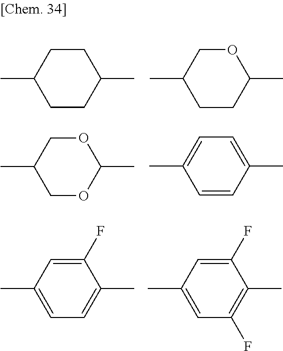

Z^{K1} and Z^{K2} preferably each independently represent —CH₂O—, —CF—O—, —CH₂CH₂—, —CF₂CF₂—, or a single bond, further preferably each independently represent —CF₂O—, —CH₂CH₂—, or a single bond, and particularly preferably each independently represent —CF₂O— or a single bond.

n^{K1} is preferably 0, 1, 2, or 3 and is preferably 0, 1, or 2. In the case where importance is placed on improvement of As, n^{K} is preferably 0 or 1. In the case where importance is placed on T_{NI}, n^{K1} is preferably 1 or 2.

The types of compounds that can be used in combination are not limited. Compounds are used in combination in accordance with the intended properties, such as solubility at low temperatures, transition temperature, electrical reliability, and birefringence. The number of types of the compounds used is, for example, in an embodiment of the present invention, one, two, or three. The number of types of the compounds used is, in another embodiment of the present invention, four, five, six, or seven or more.

The content of the compound represented by General Formula (K) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by Formula (K) is preferably 1% by mass, 10% by mass, 20% by mass, 30% by mass, 40% by mass, 50% by mass, 55% by mass, 60% by mass, 65% by mass, 70% by mass, 75% by mass, or 80% by mass of the total amount of the composition according to the present invention. The upper limit for the amount of the compound represented by Formula (K) is, for example, in an embodiment of the present invention, preferably 95% by mass, 85% by mass, 75% by mass, 65% by mass, 55% by mass, 45% by mass, 35% by mass, or 25% by mass of the total amount of the composition according to the present invention.

In the case where the viscosity of the composition according to the present invention needs to be kept low in order to produce a composition having a high response speed, it is preferable that the above lower limit be set relatively low and the upper limit be set relatively low. In the case where the T_{NI} of the composition according to the present invention needs to be kept high in order to produce a composition having good temperature stability, it is preferable that the above lower limit be set relatively low and the upper limit be set relatively low. In the case where dielectric anisotropy needs to be increased in order to keep the driving voltage low, it is preferable that the above lower limit be set relatively high and the upper limit be set relatively high.

The liquid crystal composition according to the present invention preferably further include one or two or more of compounds represented by General Formula (L). The compounds represented by General Formula (L) are substantially dielectrically neutral compounds (Δε is −2 to 2).

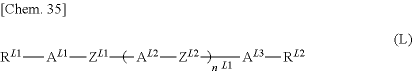

(in General Formula (L), R^{L1} and R^{L2} each independently represent an alkyl group having 1 to 8 carbon atoms and, in the alkyl group, one —CH₂— group or two or more —CH₂— groups that are not adjacent to one another may be each independently replaced with —CH═CH—, —C═C—, —O—, —CO—, —COO—, or —OCO—;

n^{L1} represents 0, 1, 2, or 3;

A^{L1}, A^{L2}, and A^{L3} each independently represent a group selected from the group consisting of

(a) a 1,4-cyclohexylene group (in this group, one —CH₂— group or two or more —CH₂— groups that are not adjacent to one another may be replaced with —O—),

(b) a 1,4-phenylene group (in this group, one —CH═ group or two or more —CH═ groups that are not adjacent to one another may be replaced with —N═), and

(c) a naphthalene-2,6-diyl group, a 1,2,3,4-tetrahydronaphthalene-2,6-diyl group, or a decahydronaphthalene-2,6-diyl group (in the naphthalene-2,6-diyl group or the 1,2,3,4-tetrahydronaphthalene-2,6-diyl group, one —CH═ group or two or more —CH═ groups that are not adjacent to one another may be replaced with —N═), and the group (a), the group (b), and the group (c) may be each independently substituted with a cyano group, a fluorine atom, or a chlorine atom;

Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C═C—; and

in the case where n^{L1} is 2 or 3 and a plurality of A^{L2} groups are present, they may be identical to or different from one another, and in the case where n^{L1} is 2 or 3 and a plurality of Z^{L2} groups are present, they may be identical to or different from one another, except the compounds represented by General Formulae (N-1), (N-2), (N-3), (J), and (i))

The compound represented by General Formula (L) may be used alone or in combination. The types of compounds that can be used in combination are not limited. The compounds are used in combination appropriately in accordance with the intended properties, such as solubility at low temperatures, transition temperature, electrical reliability, and birefringence. The number of types of the compounds used is, for example, in an embodiment of the present invention, one. The number of types of the compounds used is, in another embodiment of the present invention, two, three, four, five, six, seven, eight, nine, or ten or more.

The content of the compound represented by General Formula (L) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by Formula (L) is preferably 1% by mass, 10% by mass, 20% by mass, 30% by mass, 40% by mass, 50% by mass, 55% by mass, 60% by mass, 65% by mass, 70% by mass, 75% by mass, or 80% by mass of the total amount of the composition according to the present invention. The upper limit for the amount of the compound represented by Formula (L) is preferably 95% by mass, 85% by mass, 75% by mass, 65% by mass, 55% by mass, 45% by mass, 35% by mass, or 25% by mass.

In the case where the viscosity of the composition according to the present invention needs to be kept low in order to produce a composition having a high response speed, it is preferable that the above lower limit be set high and the upper limit be set high. In the case where the T_{NI} of the composition according to the present invention needs to be kept high in order to produce a composition having good temperature stability, it is preferable that the above lower limit be set high and the upper limit be set high. In the case where dielectric anisotropy needs to be increased in order to keep the driving voltage low, it is preferable that the above lower limit be set low and the upper limit be set low.

In the case where importance is placed on reliability, R^{L1} and R^{L2} are preferably alkyl groups. In the case where importance is placed on a reduction in the volatility of the compound, R^{L1} and R^{L2} preferably represent an alkoxy group. In the case where importance is placed on a reduction in the viscosity of the compound, at least one of the R^{L1} and R^{L2} groups is preferably an alkenyl group.

The number of halogen atoms included in the molecule is preferably 0, 1, 2, or 3 and is preferably 0 or 1. In the case where importance is placed on the compatibility with other liquid crystal molecules, the number of halogen atoms included in the molecule is preferably 1.

In the case where the ring structure to which the R^{L1} or R^{L2} group is bonded is a phenyl group (an aromatic group), the above group is preferably a linear alkyl group having 1 to 5 carbon atoms, a linear alkoxy group having 1 to 4 carbon atoms, or an alkenyl group having 4 or 5 carbon atoms. In the case where the ring structure to which the R^{L1} or R^{L2} group is bonded is a saturated ring structure, such as cyclohexane, pyran, or dioxane, the above group is preferably a linear alkyl group having 1 to 5 carbon atoms, a linear alkoxy group having 1 to 4 carbon atoms, or a linear alkenyl group having 2 to 5 carbon atoms. In order to stabilize the nematic phase, the total number of carbon atoms and, if present, oxygen atoms is preferably five or less and the above group is preferably linear.

The alkenyl group is preferably selected from the groups represented by Formulae (R1) to (R5) (where the black dot represents a carbon atom included in a ring structure).

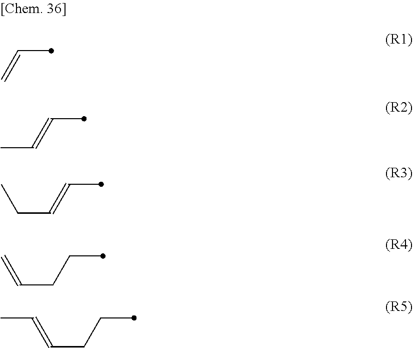

In the case where importance is placed on response speed, n^{L1} is preferably 0. In the case where importance is placed on improvement of the maximum temperature of the nematic phase, n^{L1} is preferably 2 or 3. In the case where importance is placed on the balance between the two properties, n^{L1} is preferably 1. It is preferable to use compounds having different n^{L1} values in order to achieve the intended properties of the composition.

A^{L1}, A^{L2}, and A^{L3} preferably represent an aromatic group in the case where importance is placed on an increase in Δn and preferably represent an aliphatic group in the case where importance is placed on the improvement of response speed. A^{L1}, A^{L2}, and A^{L3} preferably each independently represent a trans-1,4-cyclohexylene group, a 1,4-phenylene group, a 2-fluoro-1,4-phenylene group, a 3-fluoro-1,4-phenylene group, a 3,5-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group. A^{L1}, A^{L2}, and A^{L3} more preferably represent the following structures.

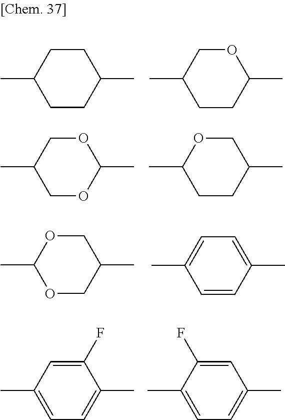

A^{L1}, A^{L2}, and A^{L3} more preferably represent a trans-1,4-cyclohexylene group or a 1,4-phenylene group.

Z^{L1} and Z^{L2} preferably represent a single bond in the case where importance is placed on response speed.

The number of halogen atoms included in the molecule of the compound represented by General Formula (L) is preferably 0 or 1.

The compound represented by General Formula (L) is preferably a compound selected from the compounds represented by General Formulae (L-3) to (L-8).

The compound represented by General Formula (L-3) is the following compound.

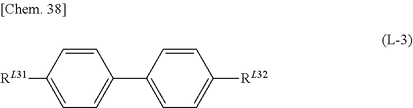

(in General Formula (L-3), R^{L31} and R^{L32} each independently represent the same things as R^{L1} and R^{L2} in General Formula (L), respectively)

R^{L31} and R^{L3} preferably each independently represent an alkyl group having 1 to 5 carbon atoms, an alkenyl group having 4 or 5 carbon atoms, or an alkoxy group having 1 to 4 carbon atoms.

Compounds represented by General Formula (L-3) may be used alone or in combination of two or more. The types of compounds that can be used in combination are not limited. The compounds are used in combination appropriately in accordance with the intended properties, such as solubility at low temperatures, transition temperature, electrical reliability, and birefringence. The number of types of the compounds used is, for example, in an embodiment of the present invention, one, two, three, four, or five or more.

The lower limit for the amount of the compound represented by Formula (L-3) is preferably 1% by mass, 2% by mass, 3% by mass, 5% by mass, 7% by mass, or 10% by mass of the total amount of the composition according to the present invention. The upper limit for the amount of the compound represented by Formula (L-3) is preferably 20% by mass, 15% by mass, 13% by mass, 10% by mass, 8% by mass, 7% by mass, 6% by mass, 5% by mass, or 3% by mass of the total amount of the composition according to the present invention.

It is advantageous to set the amount of the compound represented by Formula (L-3) to be relatively high in the case where importance is placed on high birefringence. On the other hand, it is advantageous to set the amount of the compound represented by Formula (L-3) to be relatively low in the case where importance is placed on high T_{NI}. In the case where importance is placed on the improvement of traces of droplets and image-sticking property, it is preferable to set the amount of the compound represented by Formula (L-3) to be medium.

The compound represented by General Formula (L-4) is the following compound.

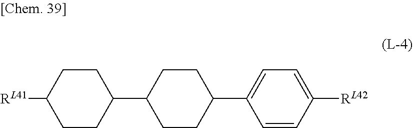

(in General Formula (L-4), R^{L41} and R^{L42} each independently represent the same things as R^{L1} and R^{L2} in General Formula (L), respectively)

R^{L41} preferably represents an alkyl group having 1 to 5 carbon atoms or an alkenyl group having 2 to 5 carbon atoms. R^{L42} preferably represents an alkyl group having 1 to 5 carbon atoms, an alkenyl group having 4 or 5 carbon atoms, or an alkoxy group having 1 to 4 carbon atoms)

Compounds represented by General Formula (L-4) may be used alone or in combination of two or more. The types of compounds that can be used in combination are not limited. The compounds are used in combination appropriately in accordance with the intended properties, such as solubility at low temperatures, transition temperature, electrical reliability, and birefringence. The number of types of the compounds used is, for example, in an embodiment of the present invention, one, two, three, four, or five or more.

The content of the compound represented by General Formula (L-4) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by Formula (L-4) is preferably 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass of the total amount of the composition according to the present invention. The upper limit for the amount of the compound represented by Formula (L-4) is preferably 50% by mass, 40% by mass, 35% by mass, 30% by mass, 20% by mass, 15% by mass, 10% by mass, or 5% by mass of the total amount of the composition according to the present invention.

The compound represented by General Formula (L-5) is the following compound.

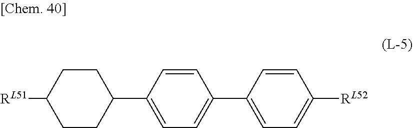

(in General Formula (L-5), R^{L51} and R^{L52} each independently represent the same things as R^{L1} and R^{L2} in General Formula (L), respectively)

R^{L51} preferably represents an alkyl group having 1 to 5 carbon atoms or an alkenyl group having 2 to 5 carbon atoms. R^{L52} preferably represents an alkyl group having 1 to 5 carbon atoms, an alkenyl group having 4 or 5 carbon atoms, or an alkoxy group having 1 to 4 carbon atoms.

Compounds represented by General Formula (L-5) may be used alone or in combination of two or more. The types of compounds that can be used in combination are not limited. The compounds are used in combination appropriately in accordance with the intended properties, such as solubility at low temperatures, transition temperature, electrical reliability, and birefringence. The number of types of the compounds used is, for example, in an embodiment of the present invention, one, two, three, four, or five or more.

The content of the compound represented by General Formula (L-5) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by Formula (L-5) is preferably 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass of the total amount of the composition according to the present invention. The upper limit for the amount of the compound represented by Formula (L-5) is preferably 50% by mass, 40% by mass, 35% by mass, 30% by mass, 20% by mass, 15% by mass, 10% by mass, or 5% by mass of the total amount of the composition according to the present invention.

The compound represented by General Formula (L-6) is the following compound.

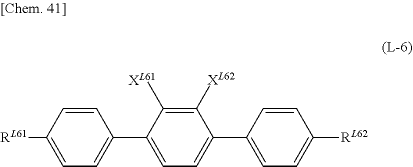

(in General Formula (L-6), R^{L61} and R⁶²² each independently represent the same things as R^{L1} and R^{L2} in General Formula (L), respectively; and X^{L61} and X^{L62} each independently represent a hydrogen atom or a fluorine atom)

R^{L61} and R^{L62} preferably each independently represent an alkyl group having 1 to 5 carbon atoms or an alkenyl group having 2 to 5 carbon atoms. It is preferable that one of X^{L61} and X^{L62} be a fluorine atom and the other be a hydrogen atom.

Compounds represented by General Formula (L-6) may be used alone or in combination of two or more. The types of compounds that can be used in combination are not limited. The compounds are used in combination appropriately in accordance with the intended properties, such as solubility at low temperatures, transition temperature, electrical reliability, and birefringence. The number of types of the compounds used is, for example, in an embodiment of the present invention, one, two, three, four, or five or more.

The lower limit for the amount of the compound represented by Formula (L-6) is preferably 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass of the total amount of the composition according to the present invention. The upper limit for the amount of the compound represented by Formula (L-6) is preferably 50% by mass, 40% by mass, 35% by mass, 30% by mass, 20% by mass, 15% by mass, 10% by mass, or 5% by mass of the total amount of the composition according to the present invention. In the case where importance is placed on an increase in Δn, the amount of the compound represented by Formula (L-6) is preferably set to be large. In the case where importance is placed on occurrence of precipitation at low temperatures, the amount of the compound represented by Formula (L-6) is preferably set to be small.

The compound represented by General Formula (L-7) is the following compound.

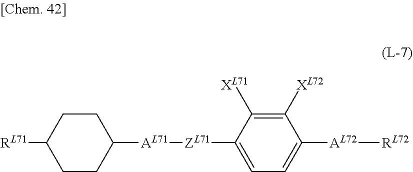

(in General Formula (L-7), R^{L71} and R^{L72} each independently represent the same things as R^{L1} and R^{L2} in General Formula (L), respectively; A^{L71} and A^{L72} each independently represent the same things as A^{L2} and A^{L3} in General Formula (L), respectively, and the hydrogen atoms included in A^{L71} and A^{L72} may be each independently replaced with a fluorine atom; Z^{L71} represents the same thing as Z^{L2} in General Formula (L); and X^{L71} and X^{L72} each independently represent a fluorine atom or a hydrogen atom)

In General Formula (L-7), R^{L71} and R^{L72} preferably each independently represent an alkyl group having 1 to 5 carbon atoms, an alkenyl group having 2 to 5 carbon atoms, or an alkoxy group having 1 to 4 carbon atoms. A^{L71} and A^{L72} preferably each independently represent a 1,4-cyclohexylene group or a 1,4-phenylene group, and the hydrogen atoms included in A^{L71} and A^{L72} may be each independently replaced with a fluorine atom. Z^{L71} is preferably a single bond or COO— and is preferably a single bond. X^{L71} and X^{L72} preferably represent a hydrogen atom.

The types of compounds that can be used in combination are not limited. Compounds are used in combination in accordance with the intended properties, such as solubility at low temperatures, transition temperature, electrical reliability, and birefringence. The number of types of the compounds used is, for example, in an embodiment of the present invention, one, two, three, or four.

The content of the compound represented by General Formula (L-7) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by Formula (L-7) is preferably 1% by mass, 2% by mass, 3% by mass, 5% by mass, 7% by mass, 10% by mass, 14% by mass, 16% by mass, or 20% by mass of the total amount of the composition according to the present invention. The upper limit for the amount of the compound represented by Formula (L-7) is preferably 30% by mass, 25% by mass, 23% by mass, 20% by mass, 18% by mass, 15% by mass, 10% by mass, or 5% by mass of the total amount of the composition according to the present invention.

In the case where importance is placed on an increase in the T_{NI} of the composition according to the present invention, the amount of the compound represented by Formula (L-7) is preferably set to be relatively high. In the case where importance is placed on a reduction in the viscosity of the composition according to the present invention, the amount of the compound represented by Formula (L-7) is preferably set to be relatively low.

The compound represented by General Formula (L-8) is the following compound.

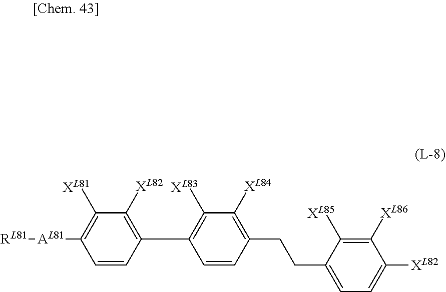

(in General Formula (L-8), R^{L81} and R^{L82} each independently represent the same things as R^{L1} and R^{L2} in General Formula (L), respectively; A^{L81} represents the same thing as A^{L1} in General Formula (L) or a single bond, and the hydrogen atoms included in A^{L81} may be each independently replaced with a fluorine atom; and X^{L81} to X^{L86} each independently represent a fluorine atom or a hydrogen atom)

In General Formula (L-8), R^{L81} and R^{L82} preferably each independently represent an alkyl group having 1 to 5 carbon atoms, an alkenyl group having 2 to 5 carbon atoms, or an alkoxy group having 1 to 4 carbon atoms. A^{L81} preferably represents a 1,4-cyclohexylene group or a 1,4-phenylene group, and the hydrogen atoms included in A^{L81} may be each independently replaced with a fluorine atom. The number of fluorine atoms included in one ring structure in General Formula (L-8) is preferably 0 or 1. The number of fluorine atoms included in one molecule is preferably 0 or 1.

The types of compounds that can be used in combination are not limited. Compounds are used in combination in accordance with the intended properties, such as solubility at low temperatures, transition temperature, electrical reliability, and birefringence. The number of types of the compounds used is, for example, in an embodiment of the present invention, one, two, three, or four.

The content of the compound represented by General Formula (L-8) in the composition according to the present invention needs to be adjusted appropriately in accordance with the intended properties, such as solubility at low temperatures, transition temperature, electrical reliability, birefringence, process compatibility, traces of droplets, image-sticking, and dielectric anisotropy.

The lower limit for the amount of the compound represented by Formula (L-8) is preferably 1% by mass, 2% by mass, 3% by mass, 5% by mass, 7% by mass, 10% by mass, 14% by mass, 16% by mass, or 20% by mass of the total amount of the composition according to the present invention. The upper limit for the amount of the compound represented by Formula (L-8) is preferably 30% by mass, 25% by mass, 23% by mass, 20% by mass, 18% by mass, 15% by mass, 10% by mass, or 5% by mass of the total amount of the composition according to the present invention.

In the case where importance is placed on an increase in the T_{NI} of the composition according to the present invention, the amount of the compound represented by Formula (L-8) is preferably set to be relatively large. In the case where importance is placed on a reduction in the viscosity of the composition according to the present invention, the amount of the compound represented by Formula (L-8) is preferably set to be relatively small.

The lower limit for the total amount of the compounds represented by General Formulae (i), (L), (N-1), (N-2), (N-3), and (J) is preferably 80% by mass, 85% by mass, 88% by mass, 90% by mass, 92% by mass, 93% by mass, 94% by mass, 95% by mass, 96% by mass, 97% by mass, 98% by mass, 99% by mass, or 100% by mass of the total amount of the composition according to the present invention. The upper limit for the total amount of the above compounds is preferably 100% by mass, 99% by mass, 98% by mass, or 95% by mass. In the case where importance is placed on an increase in the absolute value of Δε of the composition, the amount of any one of the compounds represented by General Formulae (N-1), (N-2), (N-3), and (J) is preferably 0% by mass.

The composition according to present invention preferably does not contain a compound having a structure including oxygen atoms bonded to one another, such as a peracid (—CO—OO—) structure, in the molecule.

In the case where importance is placed on the reliability and prolonged stability of the composition, the amount of a compound including a carbonyl group is preferably set to 5% by mass or less, is more preferably set to 3% by mass or less, and is further preferably set to 1% by mass or less of the total mass of the composition. It is most preferable that the composition substantially do not contain a compound including a carbonyl group.

In the case where importance is placed on stability against irradiation of UV radiation, the amount of a compound substituted with a chlorine atom is preferably set to 15% by mass or less, 10% by mass or less, or 8% by mass or less and is more preferably set to 5% by mass or less or 3% by mass or less of the total mass of the composition. It is further preferable that the composition substantially do not contain a compound substituted with a chlorine atom.

It is preferable to increase the amount of a compound in which all the ring structures included in the molecule are six-membered rings. The amount of a compound in which all the ring structures included in the molecule are six-membered rings is preferably set to 80% by mass or more, is more preferably set to 90% by mass or more, and is further preferably set to 95% by mass or more of the total mass of the composition. It is most preferable that the composition be substantially composed only of a compound in which all the ring structures included in the molecule are six-membered rings.

It is preferable to reduce the amount of a compound that includes a cyclohexenylene group as a ring structure in order to limit the degradation of the composition due to oxidation. The amount of a compound that includes a cyclohexenylene group is preferably set to 10% by mass or less or 8% by mass or less and is more preferably set to 5% by mass or less or 3% by mass or less of the total mass of the composition. It is further preferable that the composition substantially do not contain such a compound.

In the case where importance is placed on the improvement of viscosity and T_{NI}, it is preferable to reduce the amount of a compound that includes, in the molecule, a 2-methylbenzene-1,4-diyl group in which hydrogen atoms may be replaced with halogen. The amount of the compound that includes a 2-methylbenzene-1,4-diyl group in the molecule is preferably set to 10% by mass or less or 8% by mass or less and is more preferably set to 5% by mass or less or 3% by mass or less of the total mass of the composition. It is further preferable that the composition substantially do not contain such a compound.

The expression “substantially do not contain” used herein means not containing the compound except compounds that are inevitably contained in the composition.

In the case where a compound contained in the composition according to the first embodiment of the present invention includes an alkenyl group as a side chain, the number of the carbon atoms included in the alkenyl group is preferably 2 to 5 when the alkenyl group is bonded to cyclohexane, the number of the carbon atoms included in the alkenyl group is preferably 4 or 5 when the alkenyl group is bonded to benzene, and it is preferable that the unsaturated bond of the alkenyl group be not directly bonded to benzene.

The average elastic constant (K_{AVG}) of the liquid crystal composition used in the present invention is preferably 10 to 25. The lower limit for the average elastic constant (K_{AVG}) of the liquid crystal composition is preferably 10, is preferably 10.5, is preferably 11, is preferably 11.5, is preferably 12, is preferably 12.3, is preferably 12.5, is preferably 12.8, is preferably 13, is preferably 13.3, is preferably 13.5, is preferably 13.8, is preferably 14, is preferably 14.3, is preferably 14.5, is preferably 14.8, is preferably 15, is preferably 15.3, is preferably 15.5, is preferably 15.8, is preferably 16, is preferably 16.3, is preferably 16.5, is preferably 16.8, is preferably 17, is preferably 17.3, is preferably 17.5, is preferably 17.8, and is preferably 18. The upper limit for the average elastic constant (K_{AVG}) of the liquid crystal composition is preferably 25, is preferably 24.5, is preferably 24, is preferably 23.5, is preferably 23, is preferably 22.8, is preferably 22.5, is preferably 22.3, is preferably 22, is preferably 21.8, is preferably 21.5, is preferably 21.3, is preferably 21, is preferably 20.8, is preferably 20.5, is preferably 20.3, is preferably 20, is preferably 19.8, is preferably 19.5, is preferably 19.3, is preferably 19, is preferably 18.8, is preferably 18.5, is preferably 18.3, is preferably 18, is preferably 17.8, is preferably 17.5, is preferably 17.3, and is preferably 17. In the case where importance is placed on a reduction in power consumption, it is effective to reduce the amount of light emitted from the backlight and it is preferable to enhance the light transmittance of the liquid crystal display device. Accordingly, it is preferable to set the K_{AVG} value to be relatively low. In the case where importance is placed on the improvement of response speed, it is preferable to set the K_{AVG} value to be relatively high.

The composition according to the present invention may contain a polymerizable compound in order to produce, for example, PS-mode, horizontal-electric-field PSA-mode, and horizontal-electric-field PSVA-mode liquid crystal display devices. Examples of the polymerizable compound include photopolymerizable monomers that undergo polymerization when irradiated with energy beams such as light. Examples of such photopolymerizable monomers include polymerizable compounds having a liquid crystal skeleton constituted by a plurality of six-membered rings connected to one another, such as a biphenyl derivative and a terphenyl derivative. More specifically, the difunctional monomer represented by General Formula (XX) is preferably used.

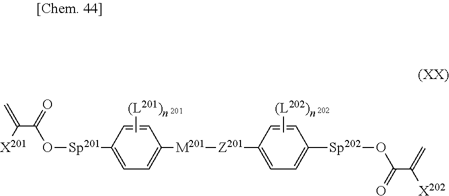

(In General Formula (XX), X²⁰¹ and X²⁰² each independently represent a hydrogen atom or a methyl group;

Sp²⁰¹ and Sp²⁰² preferably each independently represent a single bond, an alkylene group having 1 to 8 carbon atoms, or —O—(CH₂)ₛ— (where s is an integer of 2 to 7 and the oxygen atom is bonded to an aromatic ring);

Z²⁰¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (where Y¹ and Y² each independently represent a fluorine atom or a hydrogen atom), —C═C—, or a single bond;

L²⁰¹ and L²⁰² each independently represent a fluorine atom, an alkyl group having 1 to 8 carbon atoms, or an alkoxy group having 1 to 8 carbon atoms;

M²⁰¹ represents a 1,4-phenylene group, a trans-1,4-cyclohexylene group, or a single bond; in all the 1,4-phenylene groups in General Formula (XX), any hydrogen atom may be replaced with a fluorine atom, an alkyl group having 1 to 8 carbon atoms, or an alkoxy group having 1 to 8 carbon atoms; and n201 and n202 each independently represent an integer of 0 to 4)

A diacrylate derivative represented by General Formula (XX) in which both X²⁰¹ and X²⁰² represent a hydrogen atom and a dimethacrylate derivative represented by General Formula (XX) in which both X²⁰¹ and X²⁰² represent a methyl group are preferably used. A compound represented by General Formula (XX) in which one of X²⁰¹ and X²⁰² represents a hydrogen atom and the other represents a methyl group is also preferably used. Among these compounds, the diacrylate derivative has the highest polymerization rate, the dimethacrylate derivative has the lowest polymerization rate, and the asymmetrical compound has an intermediate polymerization rate. A polymerizable compound suitable for a desired application may be selected. In PSA display elements, the dimethacrylate derivative is particularly preferably used.

Sp²⁰¹ and Sp²⁰² each independently represent a single bond, an alkylene group having 1 to 8 carbon atoms, or a —O—(CH₂)ₛ— group. In PSA display elements, it is preferable that at least one of Sp²⁰¹ and Sp²⁰² be a single bond, and it is also preferable that both Sp²⁰¹ and Sp²⁰² represent a single bond or that one of Sp²⁰¹ and Sp²⁰² represent a single bond and the other represent an alkylene group having 1 to 8 carbon atoms or a —O—(CH₂)ₛ— group. In this case, an alkyl group having 1 to 4 is preferably used, and s is preferably 1 to 4.

Z²⁰¹ is preferably —OCH₂—, —CH₂O—, —COO—, —OCO—, —CF₂O—, —OCF₂—, —CH₂CH₂—, —CF₂CF₂—, or a single bond, is more preferably —COO—, —OCO—, or a single bond, and is particularly preferably a single bond.

M²⁰¹ represents a 1,4-phenylene group in which any hydrogen atom may be replaced with a fluorine atom, a trans-1,4-cyclohexylene group, or a single bond and is preferably a 1,4-phenylene group or a single bond. When C is not a single bond but represents a ring structure, it is also preferable that Z²⁰¹ be a linking group other than a single bond. When M²⁰¹ is a single bond, Z²⁰¹ is preferably a single bond.

In light of the above-described points, specifically, the ring structure between Sp²⁰¹ and Sp²⁰² in General Formula (XX) is preferably any one of the following structures.

When M²⁰¹ represents a single bond and the ring structure is constituted by two rings in General Formula (XX), the ring structure is preferably represented by any one of Formulae (XXa-1) to (XXa-5) below, is more preferably represented by any one of Formulae (XXa-1) to (XXa-3) below, and is particularly preferably represented by Formulae (XXa-1).

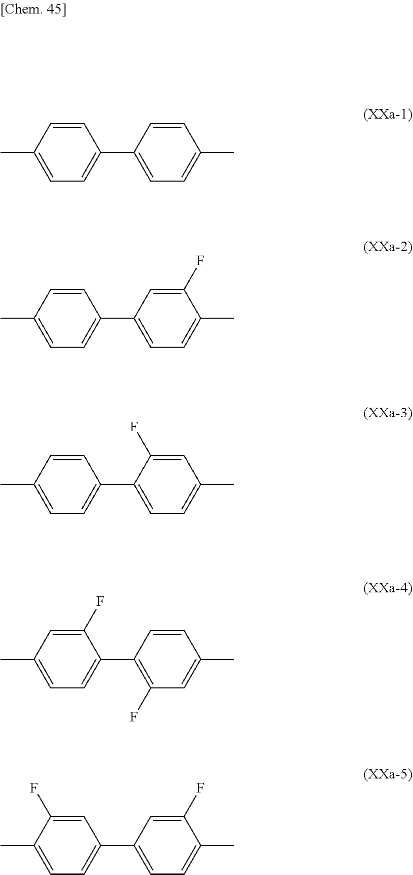

(In Formulae (XXa-1) to (XXa-5), both terminals are bonded to Sp²⁰¹ and Sp²⁰², respectively)

A polymerizable compound having any one of these skeletons offers an anchoring force most suitable for PSA liquid crystal display devices after being polymerized and improves orientation. Therefore, such a polymerizable compound reduces or eliminates the risk of display unevenness.

Thus, the polymerizable monomer is particularly preferably any one of the compounds represented by General Formulae (XX-1) to (XX-4) and is most preferably the compound represented by General Formula (XX-2).

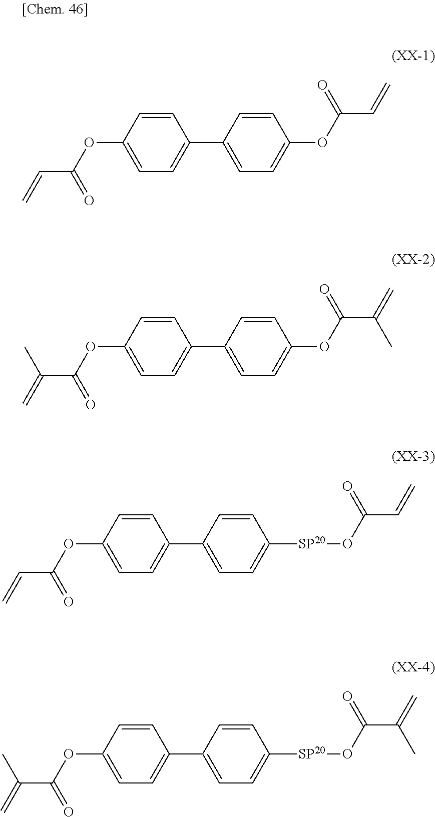

(in General Formulae (XX-1) to (XX-4), benzene may be substituted with a fluorine atom; and Sp²⁰ represents an alkylene group having 2 to 5 carbon atoms)

In the case where the composition according to the present invention contains the above polymerizable compound, the content of the polymerizable compound in the composition according to the present invention is preferably 0.01% to 5% by mass, is preferably 0.05% to 3% by mass, and is preferably 0.1% to 2% by mass.

In the case where the monomer is added to the composition according to the present invention, a polymerization initiator may be used in order to promote polymerization. However, polymerization would proceed even in the absence of a polymerization initiator. Examples of the polymerization initiator include benzoin ethers, benzophenones, acetophenones, benzil ketals, and acylphosphine oxides.

As described above, the liquid crystal display device according to the present invention may include the alignment layers 4. Alternatively, instead of using alignment layers, it is preferable to add a spontaneous orientation aid to the liquid crystal composition constituting the liquid crystal layer according to the present invention in order to cause the liquid crystals to support themselves without using alignment films, to use an orientation-type polyimide soluble in solvents in order to align the liquid crystals, or to use a photoalignment film or, in particular, a non-polyimide photoalignment film in order to align the liquid crystals, because the above methods increase ease of production of the liquid crystal display device.

The liquid crystal composition according to the present invention preferably contains a spontaneous orientation aid. The spontaneous orientation aid controls the orientation of liquid crystal molecules contained in the liquid crystal composition constituting the liquid crystal layer. It is considered that the constituents of the spontaneous orientation aid accumulate at or adsorb onto the interface of the liquid crystal layer and thereby control the orientation of the liquid crystal molecules. Therefore, in the case where the liquid crystal composition contains a spontaneous orientation aid, the alignment layers included in the liquid crystal panel may be omitted.

The content of the spontaneous orientation aid in the liquid crystal composition according to the present invention is preferably 0.1% to 10% by mass of the total amount of the liquid crystal composition. In the liquid crystal composition according to the present invention, the spontaneous orientation aid may be used in combination with the above-described polymerizable compounds.

The liquid crystal composition according to the present invention preferably contains a spontaneous orientation aid. The spontaneous orientation aid controls the orientation of liquid crystal molecules contained in the liquid crystal composition constituting the liquid crystal layer. It is considered that the constituents of the spontaneous orientation aid accumulate at or adsorb onto the interface of the liquid crystal layer and thereby control the orientation of the liquid crystal molecules. Therefore, in the case where the liquid crystal composition contains a spontaneous orientation aid, the alignment layers included in the liquid crystal panel may be omitted.

The content of the spontaneous orientation aid in the liquid crystal composition according to the present invention is preferably 0.1% to 10% by mass of the total amount of the liquid crystal composition. In the liquid crystal composition according to the present invention, the spontaneous orientation aid may be used in combination with the above-described polymerizable compounds.

The spontaneous orientation aid includes a polar group and a mesogenic group and preferably includes, as needed, a polymerizable group.

The mesogenic group is a group that induces the behavior of a liquid crystal phase. However, a surface-modified compound containing a mesogenic group does not necessarily exhibit a liquid crystal phase. In other words, the term “mesogenic group” used herein refers to a group that is likely to induce a structural order and typically includes a strong portion that is a cyclic group such as an aromatic ring. The term “liquid crystal phase” used herein refers to a phase having both flowability as liquid and anisotropy as crystals, such as a nematic liquid crystal, a smectic liquid crystal, or a cholesteric liquid crystal.

The shape of the mesogenic group contained in the surface-modified compound according to the present invention and the shape of molecules of the surface-modified compound are not limited. Examples of the shapes include rod-like, disc-like, banana-like, L-like, T-like, and inclusion type, such as cyclo dextrin, calixarene, or cucurbituril. It is more preferable to use a shape that induces the behavior of a liquid crystal phase.

The polymerizable group is preferably represented by any one of General Formulae (P-1) to (P-15) below.

The polar group is preferably an atomic group including a polarity component (from which an electrical charge is separated) containing a hetero atom and is more preferably an atomic group including a polarity component containing a hetero atom, such as N, O, S, P, B, or Si. The polar group according to the present invention may be a cyclic atomic group including a polarity component containing a hetero atom or a linear or branched atomic group including a polarity component containing a hetero atom.

The valence of the polarity component containing a hetero atom which is included in the polar group according to the present invention is not limited and may be, for example, one, two, or three. The number of the polarity components containing a hetero atom is not limited. Specifically, the polarity component containing a hetero atom is preferably a structural element represented by any one of the following: a nitrogen-containing group; a cyano group (—CN), a primary amino group (—NH₂), a secondary amino group (—NH—), a tertiary amino group (—NRR′, where R and R′ are alkyl groups), a pyridyl group, and an oxygen-containing group; a hydroxyl group (—OH), an alkoxy group (—OR, where R is an alkyl group), a formyl group (—CHO), a carboxyl group (—COOH), an ether group (—R^{a}′OR^{a}″—, where R^{a}′ and R^{a}″ represent an alkylene group or an alkenylene group), a ketone group (—R^{a}′C(═O)R^{a}″—, where R^{a}′ and R^{a}″ represent an alkylene group or an alkenylene group), a carbonate group (—O—C(═O)—O—), an alkoxy (alkenyloxy) carbonyl group (—COOR″—, where R″ is an alkylene group or an alkenylene group), a carbamoyl group (—CONH₂), an ureido group (—NHCONH₂), and a phosphorus-containing group; a phosphinyl group (—P(═O)H₂), a phosphate group (—OP(═O)(OH)₂), and a boron-containing group; a boric acid group (—B(OH)₂) and a sulfur-containing group; and a mercapto group (—SH), a sulfide group (—S—), a sulfinyl group (—S(═O)—), a sulfonyl group (—SO₂—), a sulfone amide group (—SO₂NH₂), a sulfo acid group (—SO₃H), and a sulfino group (—S(═O)OH).

The spontaneous orientation aid is preferably represented by General Formulae (al-1) and/or (al-2).

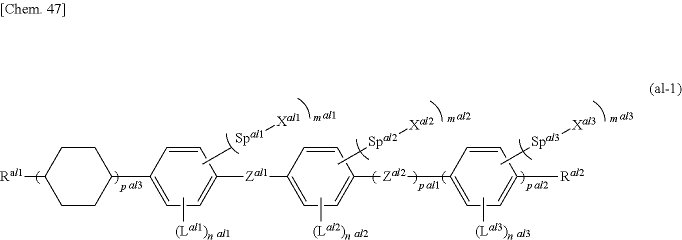

(in General Formula (al-1), R^{a11}, R^{a12}, Z^{a11}, Z^{a12}, L^{a11}, L^{a12}, L^{a13}, Sp^{a11}, Sp^{a12}, Sp^{a13}, X^{a11}, X^{a12}, X^{a13}, m^{a11}, m^{a12}, m^{a13}, n^{a11}, n^{a12}, n^{a13}, p^{a11}, p^{a12}, and p^{a13} each independently,

R^{a11} represents a hydrogen atom, a halogen, or a linear, branched, or cyclic alkyl having 1 to 20 carbon atoms, in the alkyl group, one CH₂ group or two or more CH₂ groups that are not adjacent to one another may be replaced with —O—, —S—, —CO—, —CO—O—, —O—CO—, or —O—CO—O— such that any two O atoms and/or any two S atoms are directly bonded to each other, and one or two or more hydrogen atoms may be replaced with F or Cl;

R^{a12} represents a group including any of the following structural elements;

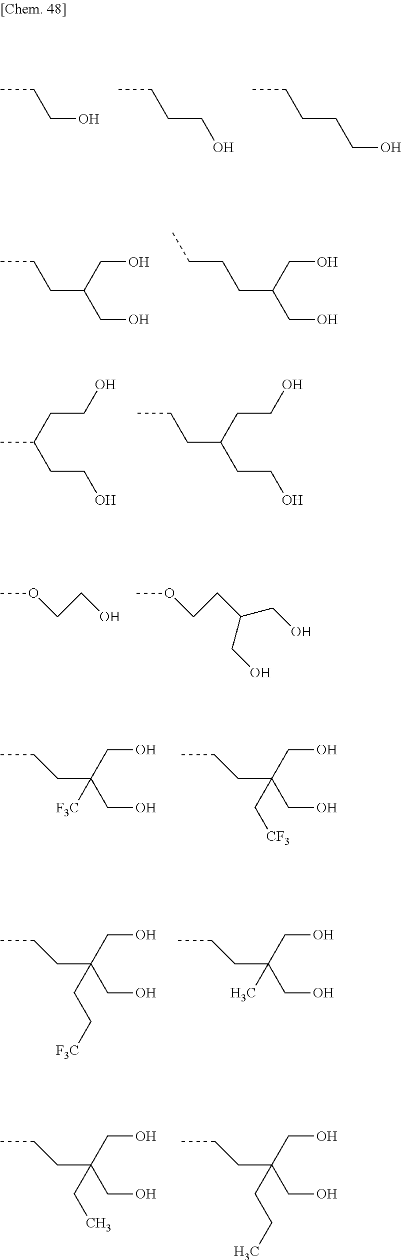

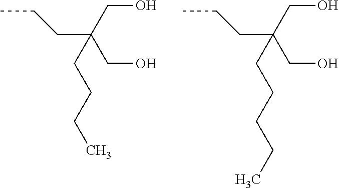

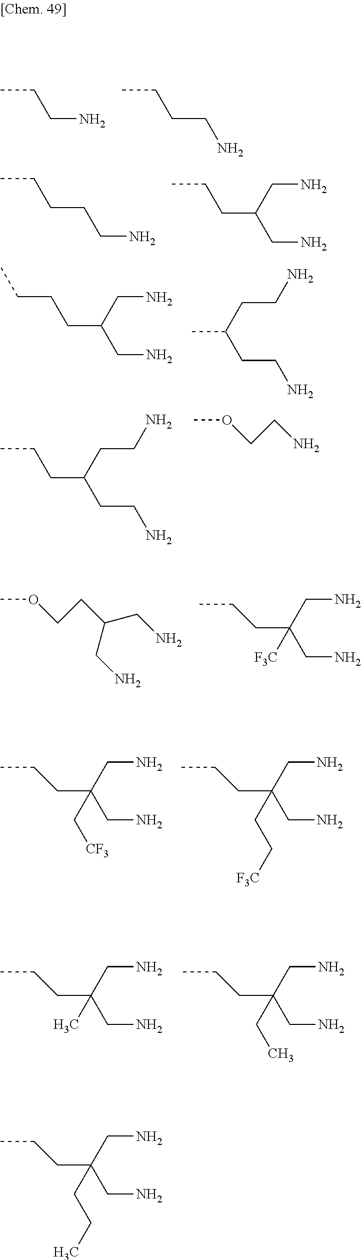

Sp^{a11}, Sp^{a12}, and Sp^{a13} each independently represent an alkyl group having 1 to 12 carbon atoms or a single bond;

X^{a11}, X^{a12}, and X^{a13} each independently represent an alkyl group, an acryl group, a methacryl group, or a vinyl group;

Z^{a11} represents —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)ₙ^{a1}—, —CF₂CH₂—, —CH₂CF₂—, —(CF₂)ₙ^{a1}—, —CH═CH—, —CF═CF—, —C═C—, —CH═CH—COO—, —OCO—CH═CH—, —(CR^{a13}R^{a14})ₐ₁—, —CH (-Sp^{a11}-X^{a11})—, —CH₂CH (-Sp^{a11}-X^{a11})—, or —CH(-Sp^{a11}-X^{a11}) CH (-Sp^{a11}-X^{a11})—;

Z^{a12} each independently represents a single bond, —O—, —S—, —CO—, —CO—O—, —OCO—, —O—CO—O—, —OCH₂—, —CH₂O—, —SCH₂—, —CH₂S—, —CF₂O—, —OCF₂—, —CF₂S—, —SCF₂—, —(CH₂)n1-, —CF₂CH₂—, —CH₂CF₂—, —(CF₂)ₙ^{a1}—, —CH═CH—, —CF═CF—, —C≡C—, —CH═CH—COO—, —OCO—CH═CH—, —(CR^{a13}R^{a14})ₙₐ₁—, —CH(-Sp^{a11}-X^{a11})—, —CH₂CH (-Sp^{a11}-X^{a11})—, or —CH(-Sp^{a11}-X^{a11})CH(-Sp^{a11}-X^{a11})—;

L^{a11}, L^{a12}, and L^{a13} each independently represent a hydrogen atom, a fluorine atom, a chlorine atom, a bromine atom, an iodine atom, —CN, —NO₂, —NCO, —NCS, —OCN, —SCN, —C(═O)N(R^{a13})₂, —C(═O)R^{a13}, an optionally substituted silyl group having 3 to 15 carbon atoms, an optionally substituted aryl group or cycloalkyl group, or 1 to 25 carbon atoms, and one or two or more hydrogen atoms may be replaced with a halogen atom (a fluorine atom or a chlorine atom);

R^{a13} represents an alkyl group having 1 to 12 carbon atoms, R^{a14} represents a hydrogen atom or an alkyl group having 1 to 12 carbon atoms, and n^{a1} represents an integer of 1 to 4; and

p^{a11}, p^{a12}, and p^{a13} each independently represent 0 or 1, m^{a11}, m^{a12}, and m^{a13} each independently represent an integer of 0 to 3, and n^{a11}, n^{a12}, and n^{a13} each independently represent an integer of 0 to 3)

General Formula (Al-2):

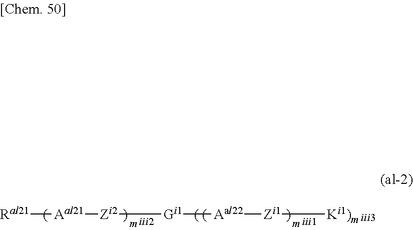

(in General Formula (al-2), Zⁱ¹ and Zⁱ² each independently represent a single bond, —CH═CH—, —CF═CF—, —C═C—, —COO—, —OCO—, —OCOO—, —OOCO—, —CF₂O—, —OCF₂—, —CH═CHCOO—, —OCOCH═CH—, —CH₂—CH₂COO—, —OCOCH₂—CH₂—, —CH═C(CH₃)COO—, —OCOC(CH₃)═CH—, —CH₂—CH(CH₃)COO—, —OCOCH(CH₃)—CH₂—, —OCH₂CH₂O—, or an alkylene group having 2 to 20 carbon atoms, in the alkyl group, one —CH₂— group or two or more —CH₂— groups that are not adjacent to one another may be replaced with —O—, —COO—, or —OCO—, and, when Kⁱ¹ is (K-11), the mesogenic group includes at least one of —CH₂—CH₂COO—, —OCOCH₂—CH₂—, —CH═C(CH₃)COO—, —OCOC(CH₃)═CH—, —CH₂—CH(CH₃)COO—, —OCOCH(CH₃)—CH₂—, and —OCH₂CH₂O—;

A^{a121} and A^{a122} each independently represent a divalent six-membered ring aromatic group or a divalent six-membered ring aliphatic group and preferably each independently represent a divalent unsubstituted six-membered ring aromatic group, a divalent unsubstituted six-membered ring aliphatic group, it is preferable that the hydrogen atoms included in these ring structures be not replaced with any substituent group or be replaced with an alkyl group having 1 to 6 carbon atoms, an alkoxy group having 1 to 6 carbon atoms, or a halogen atom, and A^{a121} and A^{a122} preferably each independently represent a divalent unsubstituted six-membered ring aromatic group, a group formed by replacing the hydrogen atoms included in the ring structure with a fluorine atom, or a divalent unsubstituted six-membered ring aliphatic group and preferably each independently represent a 1,4-phenylene group, a 2,6-naphthalene group, or a 1,4-cyclohexyl group in which the hydrogen atoms included in the substituent groups may be replaced with a halogen atom, an alkyl group, or an alkoxy group, where at least one substituent group is replaced with Pⁱ¹-Spⁱ¹-;

When the number of the Zⁱ¹ groups, the A^{a121} groups, or the A^{a122} groups is two or more, they may be identical to or different from one another;

Spⁱ¹ preferably represents a linear alkylene group having 1 to 18 carbon atoms or a single bond, more preferably represents a linear alkylene group having 2 to 15 carbon atoms or a single bond, and further preferably represents a linear alkylene group having 3 to 12 carbon atoms or a single bond;

R^{a121} represents a hydrogen atom, a linear or branched alkyl group having 1 to 20 carbon atoms, a halogenated alkyl group, or Pⁱ¹-Spⁱ¹-, and the —CH₂— group included in the alkyl group is preferably —O—, —OCO—, or —COO— (however, no two —O— groups are adjacent to each other) and more preferably represents a hydrogen atom, a linear or branched alkyl group having 1 to 18 carbon atoms, or Pⁱ¹-Spⁱ¹-, and the —CH₂— group included in the alkyl group is —O— or —OCO— (however, no two —O— groups are adjacent to each other);

Kⁱ¹ represents a substituent group represented by General Formulae (K-1) to (K-11) below;

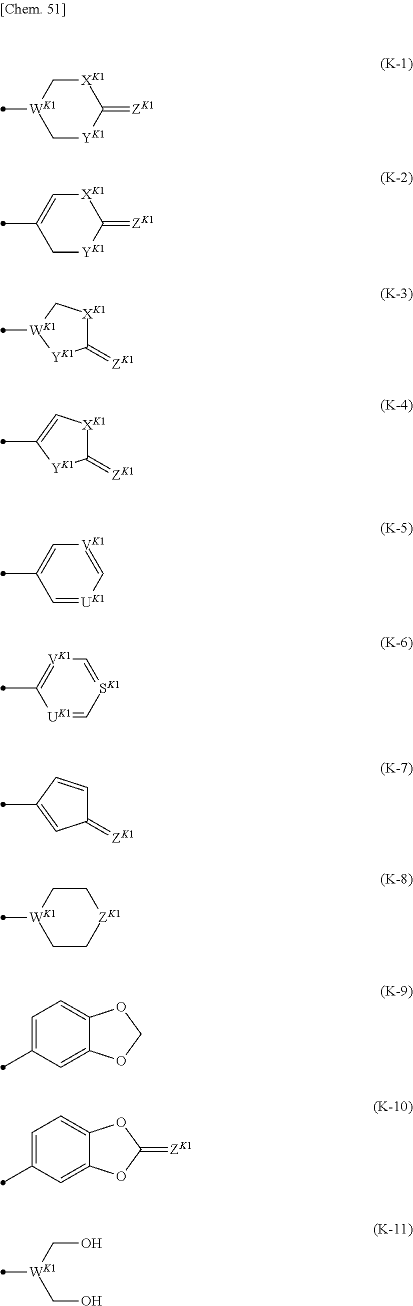

Pⁱ¹ represents a polymerizable group, which is a substituent group selected from the groups represented by General Formulae (P-1) to (P-15) below (where the black dot at the right end represents a bond)

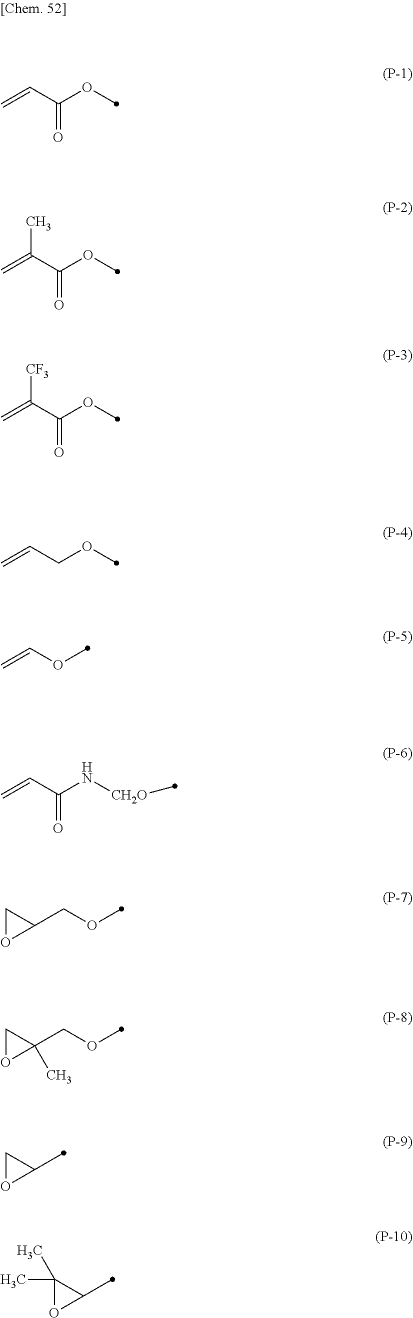

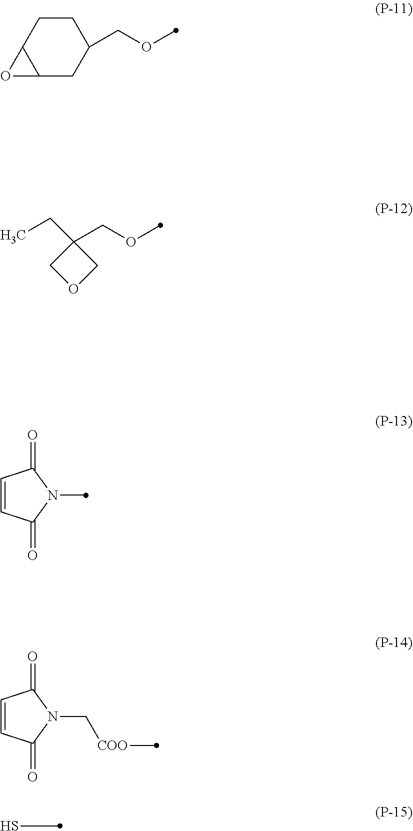

In the case where the number of the Zⁱ¹ groups, the Zⁱ² groups, the A^{a121} groups, the mⁱⁱⁱ¹ groups, and/or the A^{a122} groups is two or more, they may be identical to or different from one another; any one of Aⁱ¹ and Aⁱ² is substituted with at least one Pⁱ¹-Spⁱ¹-; in the case where Kⁱ¹ is (K-11), Zⁱⁱ¹ includes at least one of —CH₂—CH₂COO—, —OCOCH₂—CH₂—, —CH₂—CH(CH₃)COO—, —OCOCH(CH₃)—CH₂—, and —OCH₂CH₂O—;

mⁱⁱⁱ¹ represents an integer of 1 to 5;

mⁱⁱⁱ² represents an integer of 1 to 5;

Gⁱ¹ represents a divalent, trivalent, or tetravalent branched structure or a divalent, trivalent, or tetravalent aliphatic or aromatic ring structure; and

mⁱⁱⁱ³ represents an integer smaller than the valence of Gⁱ¹ by 1)

The spontaneous orientation aid according to the present invention is more preferably the compound represented by General Formula (al-1-1).

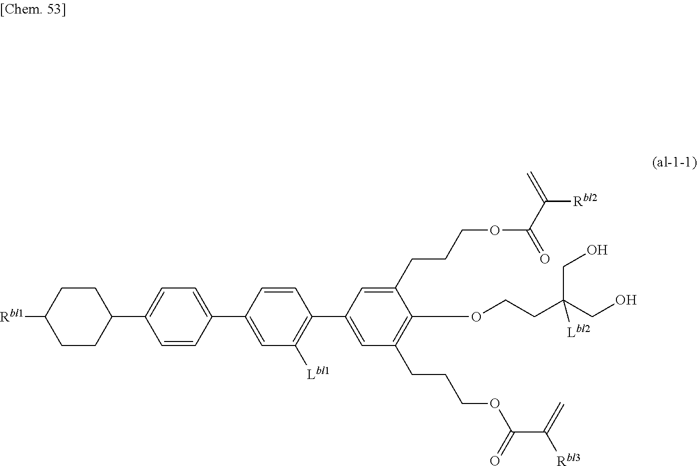

(in General Formula (al-1-1), R^{b11} represents a linear alkyl group having 1 to 12 carbon atoms; R^{b12} and R^{b13} each independently represent a hydrogen atom or a linear alkyl group having 1 to 3 carbon atoms; and L^{b11} each independently represent a hydrogen atom or a linear alkyl group having 1 to 7 carbon atoms)

Another method for eliminating the need to form alignment layers in the liquid crystal panel is, for example, to charge the liquid crystal composition containing a polymerizable compound into the gap between the first substrate and the second substrate while the temperature of the crystal composition is kept equal to or higher than Tₙᵢ and irradiate the liquid crystal composition containing a polymerizable compound with UV light in order to cause curing of the polymerizable compound.

The composition according to the present invention may further contain the compound represented by General Formula (Q).

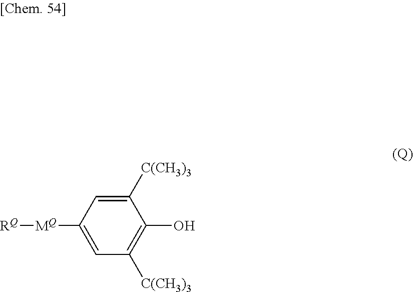

(in General Formula (Q), R^{Q} represents a linear or branched alkyl group having 1 to 22 carbon atoms and, in the alkyl group, one or two or more CH₂ groups may be replaced with —O—, —CH═CH—, —CO—, —OCO—, —COO—, —C═C—, —CF═O—, or —OCF₂— such that no two oxygen atoms are directly adjacent to each other; and M° represents a trans-1,4-cyclohexylene group, a 1,4-phenylene group, or a single bond) R^{Q5} represents a linear or branched alkyl group having 1 to 22 carbon atoms. In the alkyl group, one or two or more CH₂ groups may be replaced with —O—, —CH═CH—, —CO—, —OCO—, —COO—, —C═C—, —CF₂O—, or —OCF₂— such that no two oxygen atoms are directly adjacent to each other. R^{Q} preferably represents a linear alkyl group having 1 to 10 carbon atoms, a linear alkoxy group, a linear alkyl group in which one CH₂ group is replaced with —OCO— or —COO—, a branched alkyl group, a branched alkoxy group, or a branched alkyl group in which one CH₂ group is replaced with —OCO— or —COO—. R^{Q} further preferably represents a linear alkyl group having 1 to 20 carbon atoms, a linear alkyl group in which one CH₂ group is replaced with —OCO— or —COO—, a branched alkyl group, a branched alkoxy group, or a branched alkyl group in which one CH₂ group is replaced with —OCO— or —COO—. N represents a trans-1,4-cyclohexylene group, a 1,4-phenylene group, or a single bond and is preferably a trans-1,4-cyclohexylene group or a 1,4-phenylene group.

More specifically, the compound represented by General Formula (Q) is preferably any one of the compounds represented by General Formulae (Q-a) to (Q-d) below.

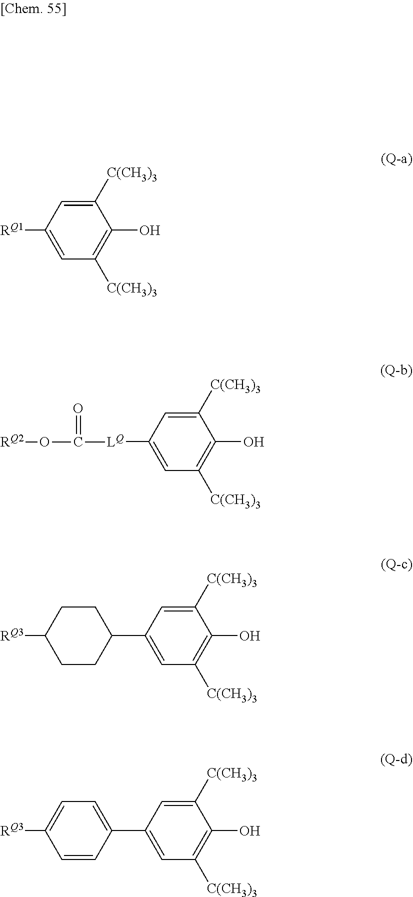

In General Formulae (Q-a) to (Q-d), R^{Q1} is preferably a linear or branched alkyl group having 1 to 10 carbon atoms, R^{Q2} is preferably a linear or branched alkyl group having 1 to 20 carbon atoms, R³ is preferably a linear or branched alkyl or alkoxy group having 1 to 8 carbon atoms, and L^{Q} is preferably a linear or branched alkylene group having 1 to 8 carbon atoms. Among the compounds represented by General Formulae (Q-a) to (Q-d), the compounds represented by General Formulae (Q-c) and (Q-d) are further preferable.

The composition according to the present invention preferably contains one or two of compounds represented by General Formula (Q) and further preferably contains one to five of compounds represented by General Formula (Q). The content of the compounds represented by General Formula (Q) in the composition is preferably 0.001% to 1% by mass, is further preferably 0.001% to 0.1% by mass, and is particularly preferably 0.001% to 0.05% by mass.

More specifically, the antioxidant or light stabilizer that can be used in the present invention is preferably selected from the compounds represented by (III-1) to (III-40) below.

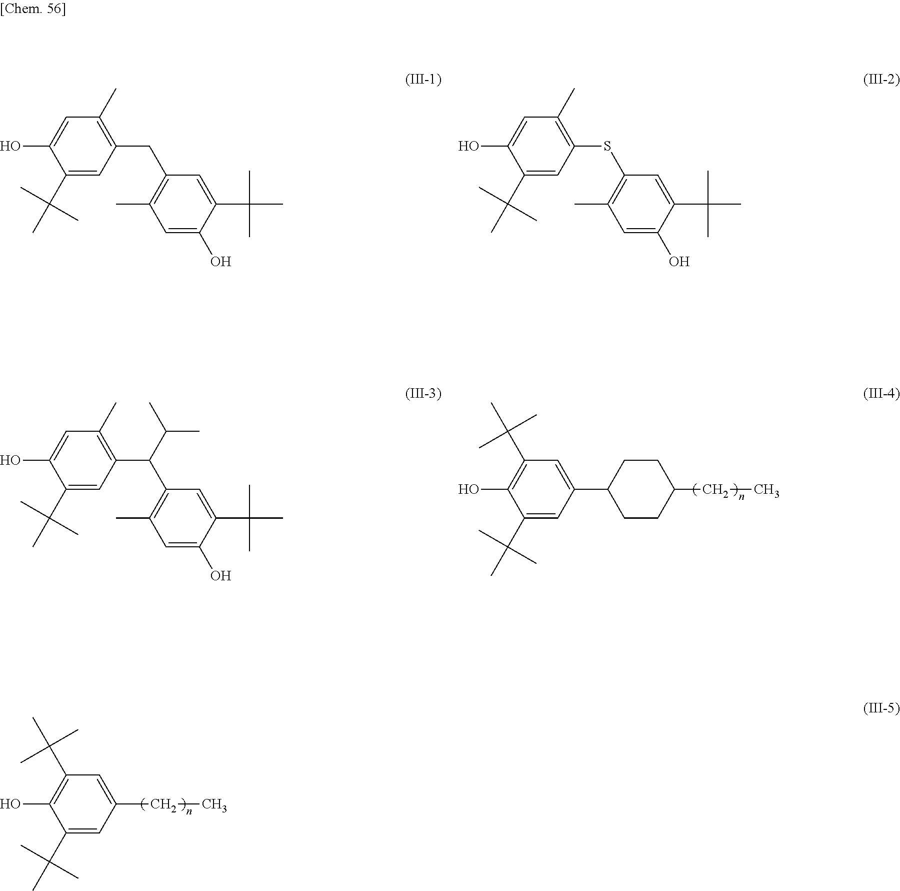 [SMILES: Cc1cc(O)c(C(C)(C)C)cc1Cc1cc(C(C)(C)C)c(O)cc1C ; Cc1cc(O)c(C(C)(C)C)cc1Sc1cc(C(C)(C)C)c(O)cc1C ; Cc1cc(O)c(C(C)(C)C)cc1C(c1cc(C(C)(C)C)c(O)cc1C)C(C)C ; CCC1CCC(c2cc(C(C)(C)C)c(O)c(C(C)(C)C)c2)CC1 ; CCc1cc(C(C)(C)C)c(O)c(C(C)(C)C)c1]

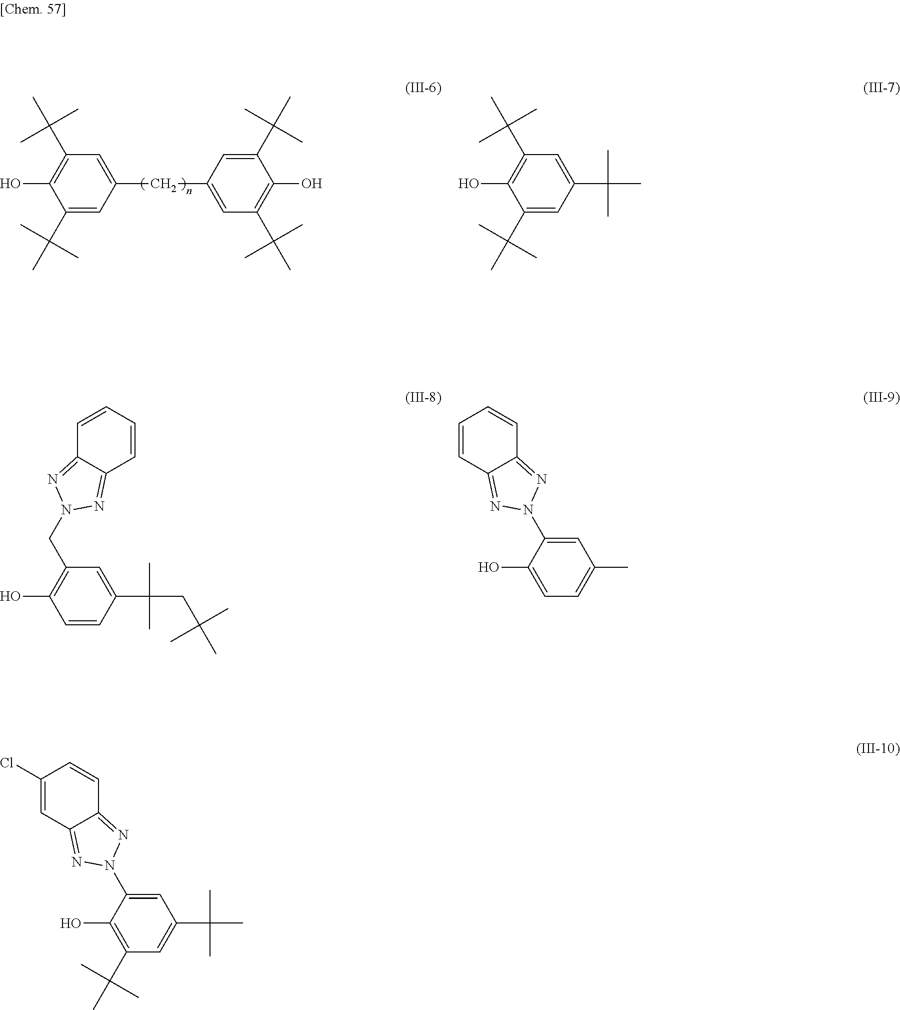 [SMILES: CC(C)(C)c1cc(Cc2cc(C(C)(C)C)c(O)c(C(C)(C)C)c2)cc(C(C)(C)C)c1O ; CC(C)(C)c1cc(C(C)(C)C)c(O)c(C(C)(C)C)c1 ; CC(C)(C)CC(C)(C)c1ccc(O)c(Cn2nc3ccccc3n2)c1 ; Cc1ccc(O)c(-n2nc3ccccc3n2)c1 ; CC(C)(C)c1cc(-n2nc3ccc(Cl)cc3n2)c(O)c(C(C)(C)C)c1]

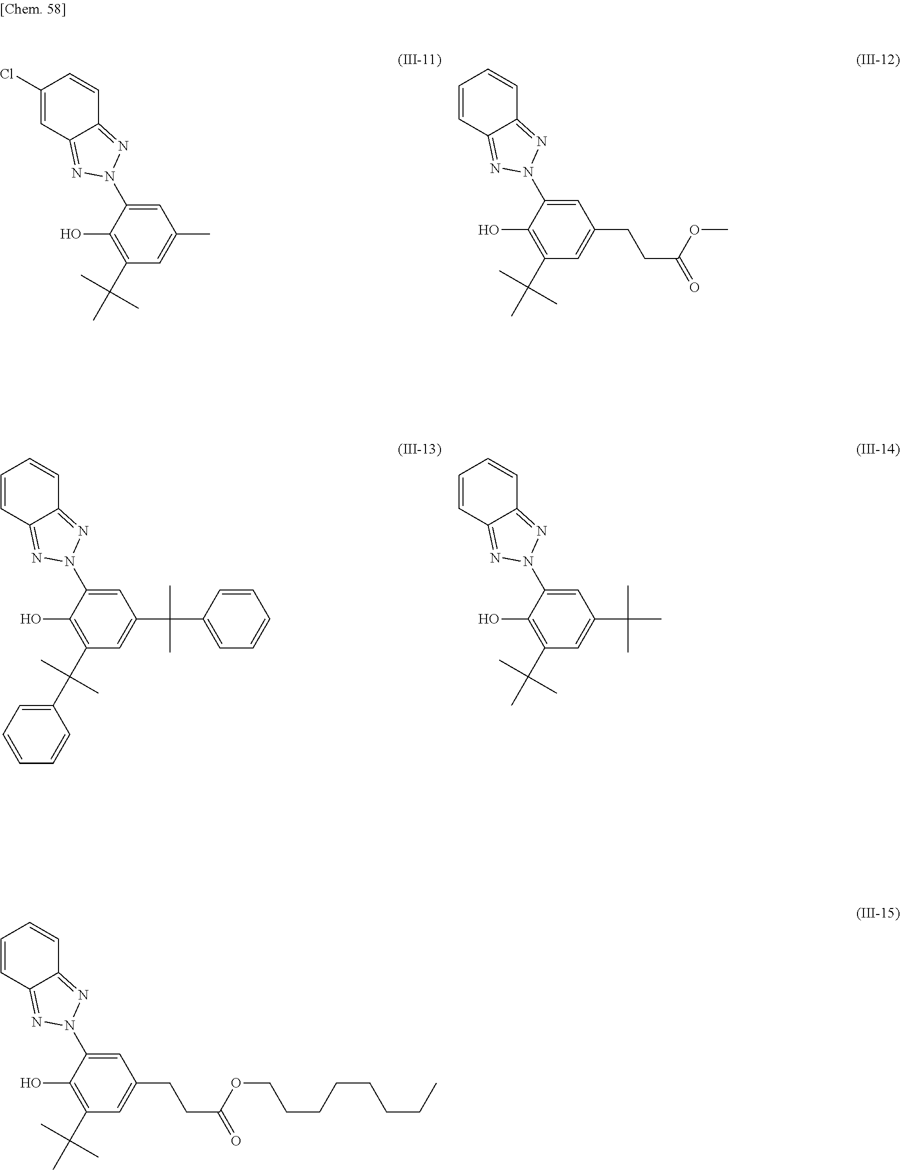 [SMILES: Cc1cc(-n2nc3ccc(Cl)cc3n2)c(O)c(C(C)(C)C)c1 ; COC(=O)CCc1cc(-n2nc3ccccc3n2)c(O)c(C(C)(C)C)c1 ; CC(C)(c1ccccc1)c1cc(-n2nc3ccccc3n2)c(O)c(C(C)(C)c2ccccc2)c1 ; CC(C)(C)c1cc(-n2nc3ccccc3n2)c(O)c(C(C)(C)C)c1 ; CCCCCCCCOC(=O)CCc1cc(-n2nc3ccccc3n2)c(O)c(C(C)(C)C)c1]

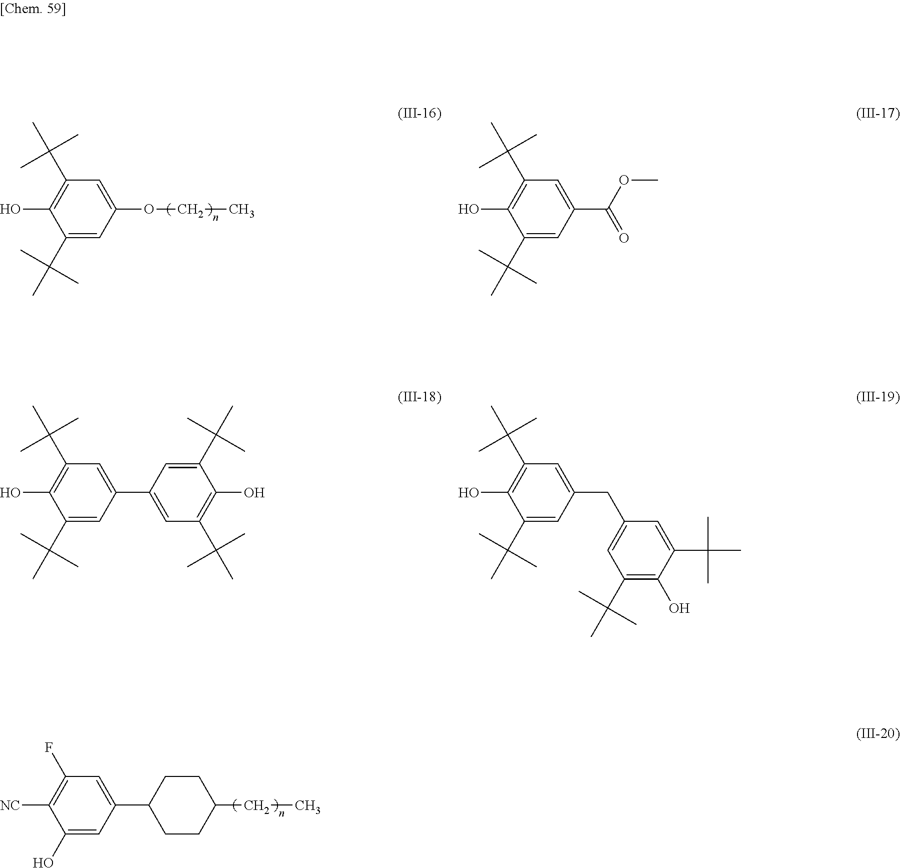 [SMILES: CCOc1cc(C(C)(C)C)c(O)c(C(C)(C)C)c1 ; COC(=O)c1cc(C(C)(C)C)c(O)c(C(C)(C)C)c1 ; CC(C)(C)c1cc(-c2cc(C(C)(C)C)c(O)c(C(C)(C)C)c2)cc(C(C)(C)C)c1O ; CC(C)(C)c1cc(Cc2cc(C(C)(C)C)c(O)c(C(C)(C)C)c2)cc(C(C)(C)C)c1O ; CCC1CCC(c2cc(O)c(C#N)c(F)c2)CC1]

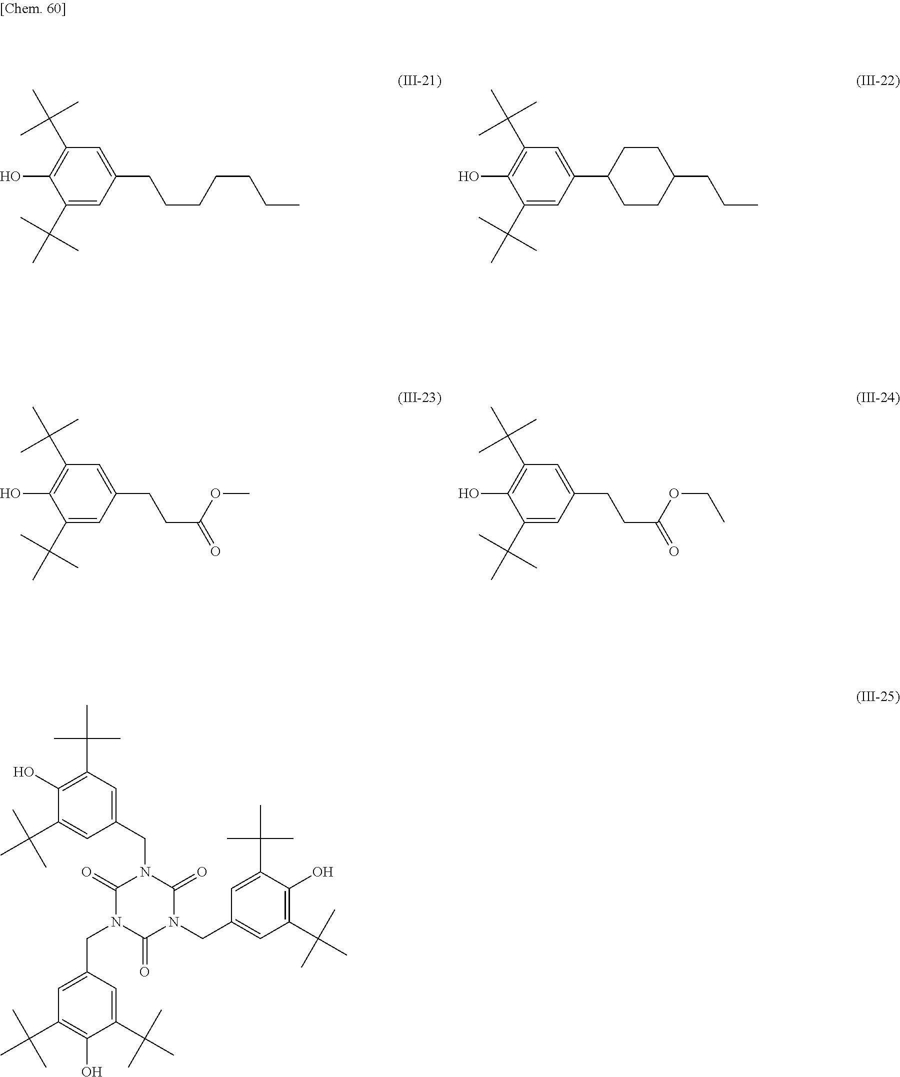 [SMILES: CCCCCCCc1cc(C(C)(C)C)c(O)c(C(C)(C)C)c1 ; CCCC1CCC(c2cc(C(C)(C)C)c(O)c(C(C)(C)C)c2)CC1 ; COC(=O)CCc1cc(C(C)(C)C)c(O)c(C(C)(C)C)c1 ; CCOC(=O)CCc1cc(C(C)(C)C)c(O)c(C(C)(C)C)c1 ; CC(C)(C)c1cc(Cn2c(=O)n(Cc3cc(C(C)(C)C)c(O)c(C(C)(C)C)c3)c(=O)n(Cc3cc(C(C)(C)C)c(O)c(C(C)(C)C)c3)c2=O)cc(C(C)(C)C)c1O]

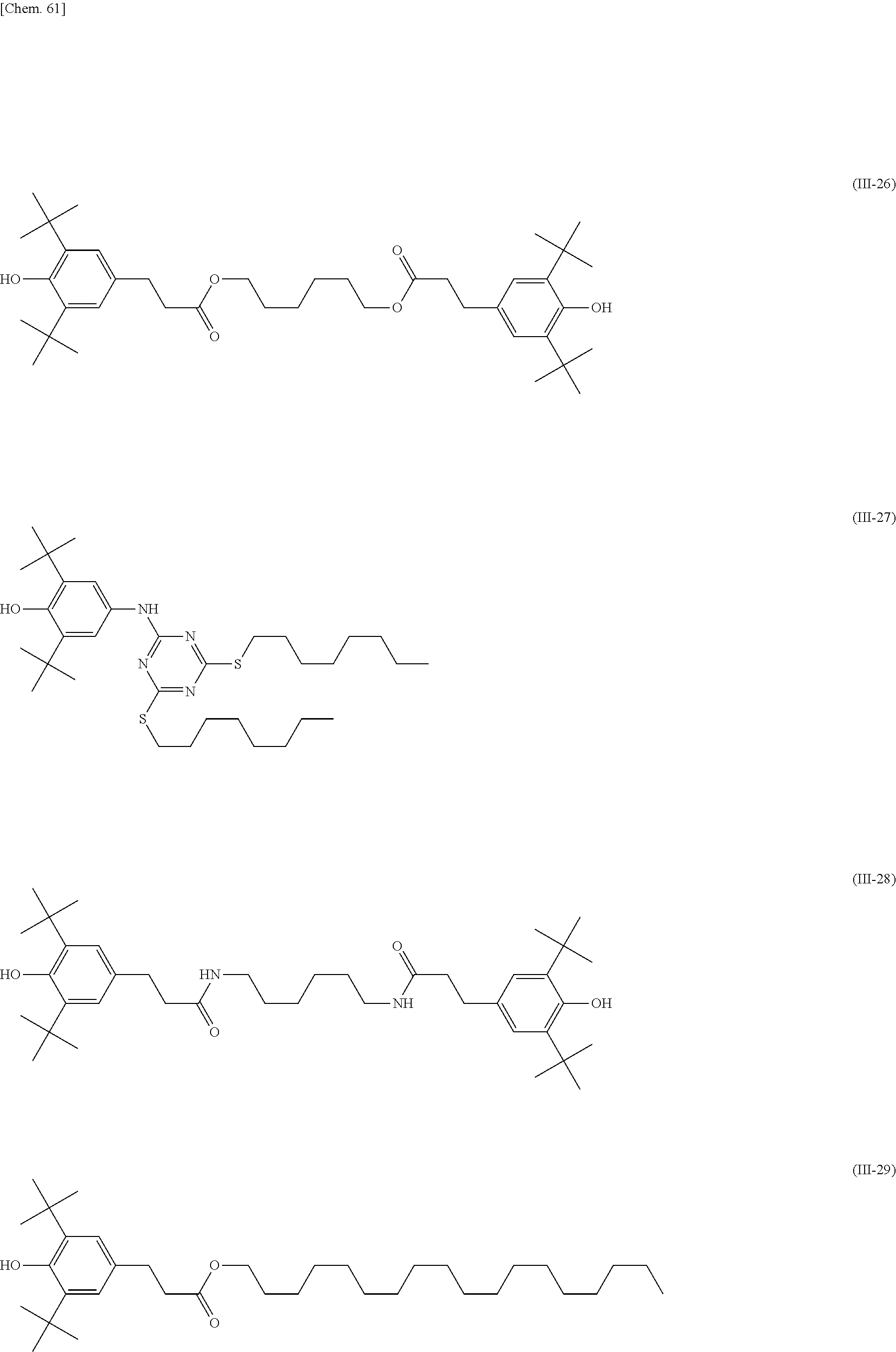 [SMILES: CC(C)(C)c1cc(CCC(=O)OCCCCCCOC(=O)CCc2cc(C(C)(C)C)c(O)c(C(C)(C)C)c2)cc(C(C)(C)C)c1O ; CCCCCCCCSc1nc(Nc2cc(C(C)(C)C)c(O)c(C(C)(C)C)c2)nc(SCCCCCCCC)n1 ; CC(C)(C)c1cc(CCC(=O)NCCCCCCNC(=O)CCc2cc(C(C)(C)C)c(O)c(C(C)(C)C)c2)cc(C(C)(C)C)c1O ; CCCCCCCCCCCCCCCCCCOC(=O)CCc1cc(C(C)(C)C)c(O)c(C(C)(C)C)c1]

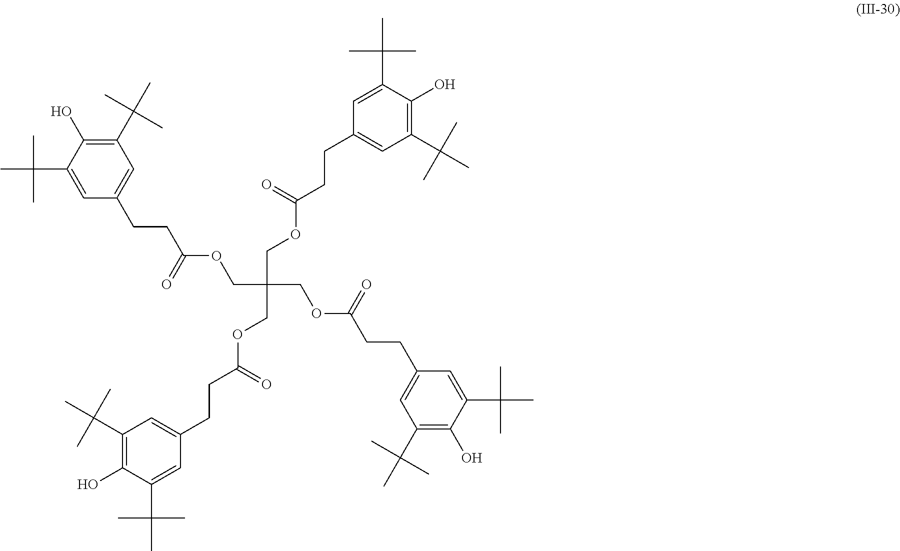 [SMILES: CC(C)(C)c1cc(CCC(=O)OCC(COC(=O)CCc2cc(C(C)(C)C)c(O)c(C(C)(C)C)c2)(COC(=O)CCc2cc(C(C)(C)C)c(O)c(C(C)(C)C)c2)COC(=O)CCc2cc(C(C)(C)C)c(O)c(C(C)(C)C)c2)cc(C(C)(C)C)c1O]

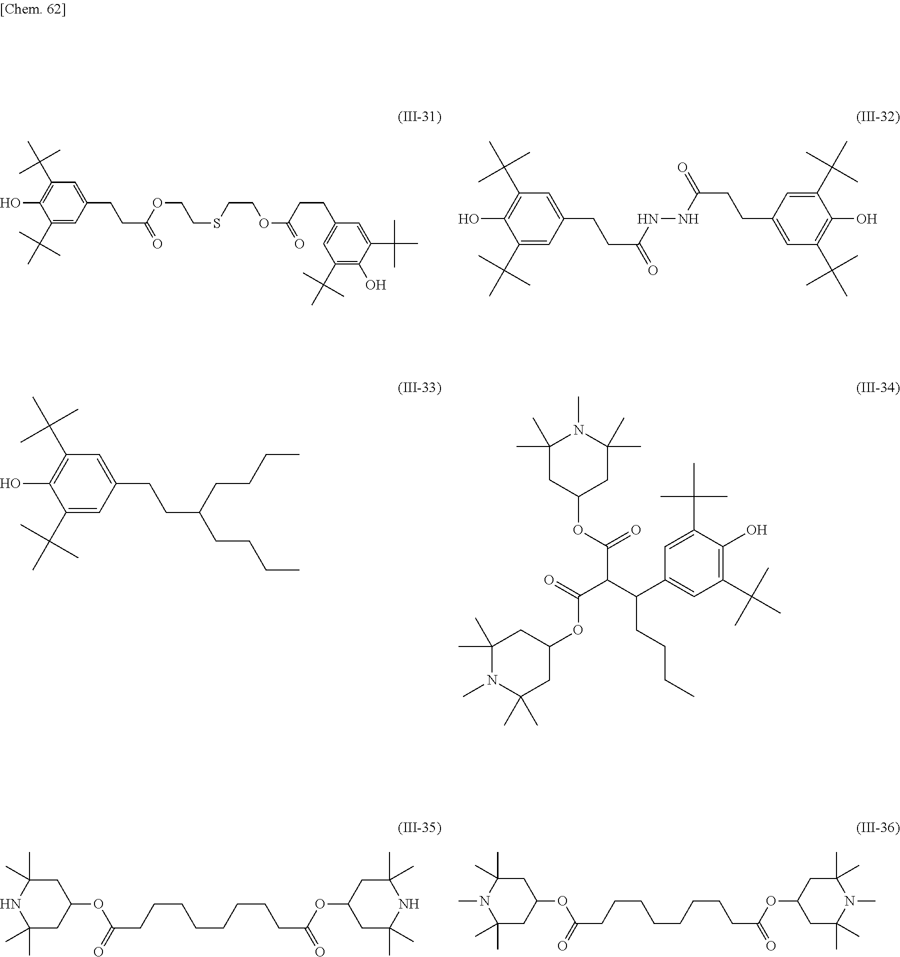

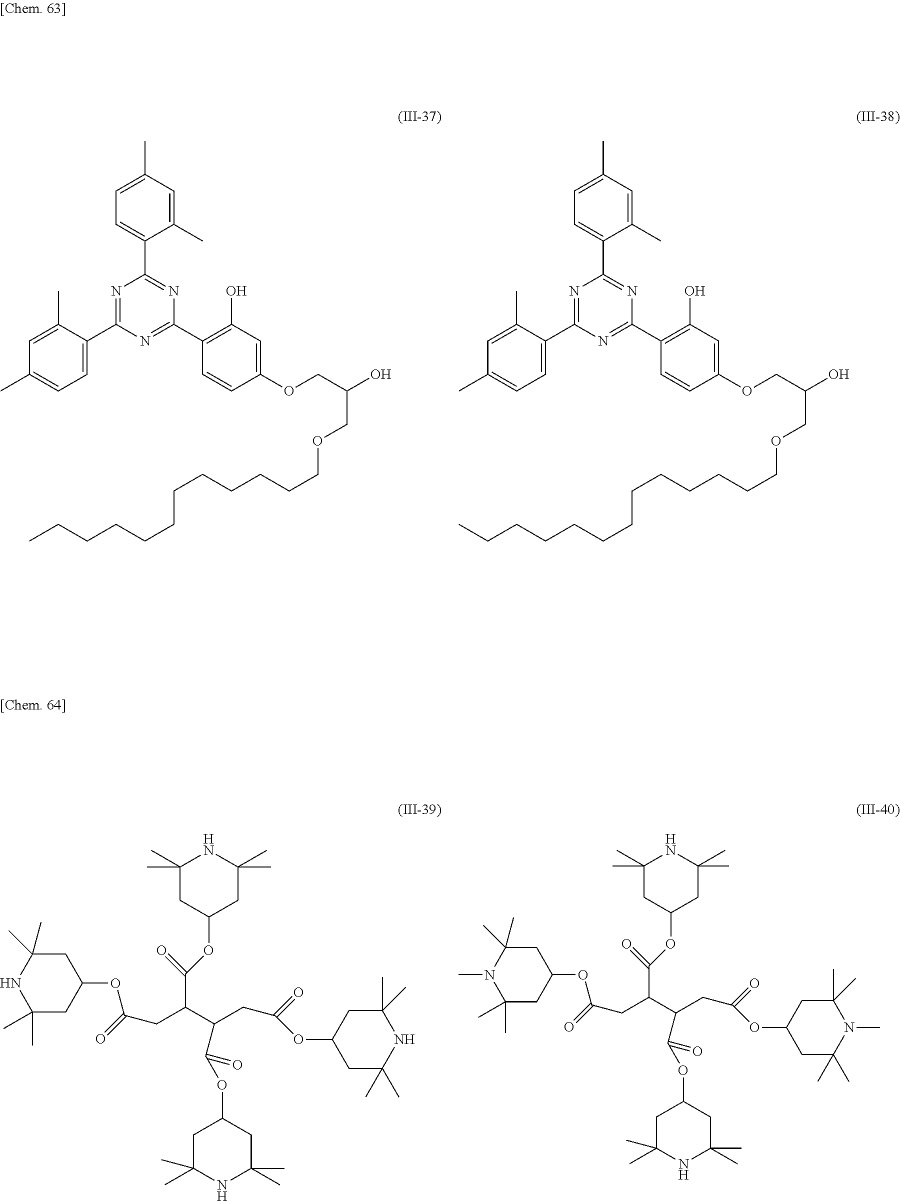

(in Formulae (III-1) to (III-38), n represents an integer of 0 to 20)

The composition according to the present invention preferably contains one or two or more compounds selected from the compounds represented by General Formula (Q) and the compound represented by General Formulae (III-1) to (III-38) and further preferably contains one to five compounds selected from the compound represented by General Formula (Q) and the compounds represented by General Formulae (III-1) to (III-38). The content of the selected compounds in the composition is preferably 0.001% to 1% by mass, is further preferably 0.001% to 0.1% by mass, and is particularly preferably 0.001% to 0.05% by mass.

When the polymerizable compound contained in the composition according to the present invention is polymerized by irradiation of ultraviolet radiation, liquid crystal orientation is imparted to the composition. This composition is used for producing the liquid crystal display device, which controls the amount of light penetration by using the birefringence of the composition.

In the case where the liquid crystal composition according to the present invention contains a polymerizable compound, the polymerizable compound is desirably polymerized at an adequate polymerization rate in order to achieve suitable orientation of the liquid crystals. Thus, the polymerizable compound is preferably polymerized by being irradiated with one or more types of active energy rays, such as ultraviolet radiation and an electron beam, at a time or sequentially. In the case where ultraviolet radiation is used, a polarized light source may be used. Alternatively, a non-polarized light source may also be used. In the case where the polymerizable compound-containing composition is polymerized while being sandwiched between two substrates, at least one of the substrates which is irradiated with light needs to have an adequate level of transparency to the active energy ray used. It is also possible to polymerize only a particular portion of the compound by using a mask when the compound is irradiated with light, subsequently change the orientation of the other portion of the compound, which has not been polymerized, by changing conditions, such as electric field, magnetic field, or temperature, and polymerize the other portion of the compound by irradiating the portion with an active energy ray. In particular, when ultraviolet exposure is performed, the ultraviolet exposure is preferably performed while an alternating electric field is applied to the polymerizable compound-containing composition. The frequency of the alternating electric field applied to the composition is preferably 10 Hz to 10 kHz and is more preferably 60 Hz to 10 kHz. The voltage is selected in accordance with the intended pretilt angle of the liquid crystal display device. In other words, the voltage determines the pretilt angle of the liquid crystal display device. In a horizontal electric field MVA-mode liquid crystal display device, it is preferable to adjust the pretilt angle to be 80 to 89.9 degrees in order to enhance orientation stability and contrast.

The temperature at which the composition is irradiated with light is preferably set to be within a temperature range in which the composition according to the present invention maintains a liquid crystal state. It is preferable to perform polymerization at a temperature close to room temperature, that is, typically 15° C. to 35° C. Examples of a lamp that emits ultraviolet radiation include a metal halide lamp, a high-pressure mercury-vapor lamp, and an extra-high pressure mercury-vapor lamp. The wavelengths of the ultraviolet light are preferably not included in the absorption wavelength range of the composition. It is preferable to block part of ultraviolet radiation as needed before use. The intensity of the ultraviolet radiation is preferably 0.1 mW/cm2 to 100 W/cm² and is more preferably 2 mW/cm² to 50 W/cm². The amount of energy of the ultraviolet radiation may be adjusted appropriately, is preferably 10 mJ/cm2 to 500 J/cm2 and is more preferably 100 mJ/cm2 to 200 J/cm2. The intensity of the ultraviolet radiation may be changed during the irradiation of ultraviolet radiation. The amount of time during which the irradiation of ultraviolet radiation is performed may be selected appropriately in accordance with the intensity of the ultraviolet radiation, is preferably 10 to 3600 seconds, and is more preferably 10 to 600 seconds.

The polymerizable compound is desirably polymerized at an adequate polymerization rate in order to achieve suitable orientation of the liquid crystals. Thus, the polymerizable compound is preferably polymerized by being irradiated with one or more types of active energy rays, such as ultraviolet radiation and an electron beam, at a time or sequentially. In the case where ultraviolet radiation is used, a polarized light source may be used. Alternatively, a non-polarized light source may also be used. In the case where the polymerizable compound-containing composition is polymerized while being sandwiched between two substrates, at least one of the substrates which is irradiated with light needs to have an adequate level of transparency to the active energy ray used. It is also possible to polymerize only a particular portion of the compound by using a mask when the compound is irradiated with light, subsequently change the orientation of the other portion of the compound, which has not been polymerized, by changing conditions, such as electric field, magnetic field, or temperature, and polymerize the other portion of the compound by irradiating the portion with an active energy ray. In particular, when ultraviolet exposure is performed, the ultraviolet exposure is preferably performed while an alternating electric field is applied to the polymerizable compound-containing composition. The frequency of the alternating electric field applied to the composition is preferably 10 Hz to 10 kHz and is more preferably 60 Hz to 10 kHz. The voltage is selected in accordance with the intended pretilt angle of the liquid crystal display device. In other words, the voltage determines the pretilt angle of the liquid crystal display device. In a horizontal electric field MVA-mode liquid crystal display device, it is preferable to adjust the pretilt angle to be 80 to 89.9 degrees in order to enhance orientation stability and contrast.

The temperature at which the composition is irradiated with light is preferably set to be within a temperature range in which the composition according to the present invention maintains a liquid crystal state. It is preferable to perform polymerization at a temperature close to room temperature, that is, typically 15° C. to 35° C. Examples of a lamp that emits ultraviolet radiation include a metal halide lamp, a high-pressure mercury-vapor lamp, and an extra-high pressure mercury-vapor lamp. The wavelengths of the ultraviolet light are preferably not included in the absorption wavelength range of the composition. It is preferable to block part of ultraviolet radiation as needed before use. The intensity of the ultraviolet radiation is preferably 0.1 mW/cm to 100 W/cm² and is more preferably 2 mW/cm² to 50 W/cm². The amount of energy of the ultraviolet radiation may be adjusted appropriately, is preferably 10 mJ/cm² to 500 J/cm² and is more preferably 100 mJ/cm² to 200 J/cm2. The intensity of the ultraviolet radiation may be changed during the irradiation of ultraviolet radiation. The amount of time during which the irradiation of ultraviolet radiation is performed may be selected appropriately in accordance with the intensity of the ultraviolet radiation, is preferably 10 to 3600 seconds, and is more preferably 10 to 600 seconds.

### “Alignment Layer”

In a preferable liquid crystal display device according to the present invention, as needed, an alignment layer may be disposed on the surfaces of the first and second substrates which come into contact with the liquid crystal composition in order to align liquid crystal molecules contained in the liquid crystal layer 5. Although the alignment layer is interposed between the photoconversion layer and the liquid crystal layer in a liquid crystal display device that requires an alignment layer, the alignment layer does not completely block the interaction between the light-emitting nanocrystals and the colorants, such as pigments, which constitute the photoconversion layer, and the liquid crystal compound constituting the liquid crystal layer since the thickness of the alignment layer is 100 nm or less at the most, that is, small.

In a liquid crystal display device that does not include an alignment layer, the interaction between the light-emitting nanocrystals and the colorants, such as pigments, which constitute the photoconversion layer, and the liquid crystal compound constituting the liquid crystal layer is larger than that in a liquid crystal display device that includes an alignment layer.

The alignment layer according to the present invention is preferably at least one alignment layer selected from the group consisting of a rubbed alignment layer and a photoalignment layer. In the case where a rubbed alignment layer is used, the rubbed alignment layer is not limited and publicly known polyimide alignment layers may be suitably used.

The rubbed alignment layer may be composed of a transparent organic material, such as polyimide, polyamide, BCB (benzocyclobutene polymer), or polyvinyl alcohol. The rubbed alignment layer is particularly preferably a polyimide alignment layer formed by imidization of a polyamic acid synthesized from a diamine such as an aliphatic or alicyclic diamine, such as p-phenylenediamine or 4,4′-diaminodiphenylmethane, with an aliphatic or alicyclic tetracarboxylic anhydride, such as butanetetracarboxylic anhydride or 2,3,5-tricarboxycyclopentylacetic anhydride, or with an aromatic tetracarboxylic anhydride, such as pyromellitic dianhydride. In the case where the alignment layer is a vertical alignment layer or the like, orientation is not necessarily imparted to the alignment layer.

### (Photoalignment)

In the case where the alignment layer according to the present invention is a photoalignment layer, the alignment layer contains one or more types of photoresponsive molecules. The photoresponsive molecules are preferably at least one type of photoresponsive molecules selected from the group consisting of photoresponsive dimerization molecules that form a crosslinked structure by dimerization upon receiving light, photoresponsive isomerization molecules that isomerize upon receiving light and become aligned substantially perpendicular or parallel to the polarizing axis, and photoresponsive decomposition high-molecular weight molecules the polymer chains of which become broken upon receiving light. The photoresponsive isomerization molecules are particularly preferable in terms of sensitivity and orientation control.

The light used when the photoresponsive isomerization high-molecular weight molecules isomerize upon receiving light and become aligned substantially perpendicular to the polarizing axis is preferably 200 to 500 nm, is more preferably 300 to 500 nm, and is further preferably 300 to 400 nm.

The weight-average molecular weight of the photoresponsive isomerization high-molecular weight molecules according to the present invention is preferably 10000 to 800000, is more preferably 10000 to 400000, is further preferably 50000 to 400000, and is particularly preferably 50000 to 300000.

The weight-average molecular weight (Mw) is measured by GPC (gel permeation chromatography).

### EXAMPLES

The present invention is described in further detail with reference to Examples below. However, the present invention is not limited by Examples below. In Examples, the following abbreviations are used for describing compounds. Note that, n represents a natural number.

(Side Chains)

| | | |
|---|---|---|
| -n | —CₙH₂ₙ₊₁ | Linear alkyl group having n |
| | | carbon atoms |
| n- | CₙH₂ₙ₊₁— | Linear alkyl group having n |
| | | carbon atoms |
| -On | —OCₙH₂ₙ₊₁ | Linear alkoxy group having n |
| | | carbon atoms |
| nO- | CₙH₂ₙ₊₁O— | Linear alkoxy group having n |
| | | carbon atoms |
| -V | —CH═CH₂ | |
| V- | CH₂═CH— | |
| -V1 | —CH═CH—CH₃ | |
| 1V- | CH₃—CH═CH— | |
| -2V | —CH₂—CH₂—CH═CH₃ | |
| V2- | CH₂═CH—CH₂—CH₂— | |
| -2V1 | —CH₂—CH₂—CH═CH—CH₃ | |
| 1V2- | CH₃—CH═CH—CH₂—CH₂ | |

### (Linking Groups)

—n— —cₙH₂ₙ—

—On— —O—CₙH₂ₙ—O—

—COO— —C(═O)—O—

—OCO— —O—C(═O)—

—CF2O— —CF₂—O—

—OCF2— —O—CF₂—

### (Ring Structures)

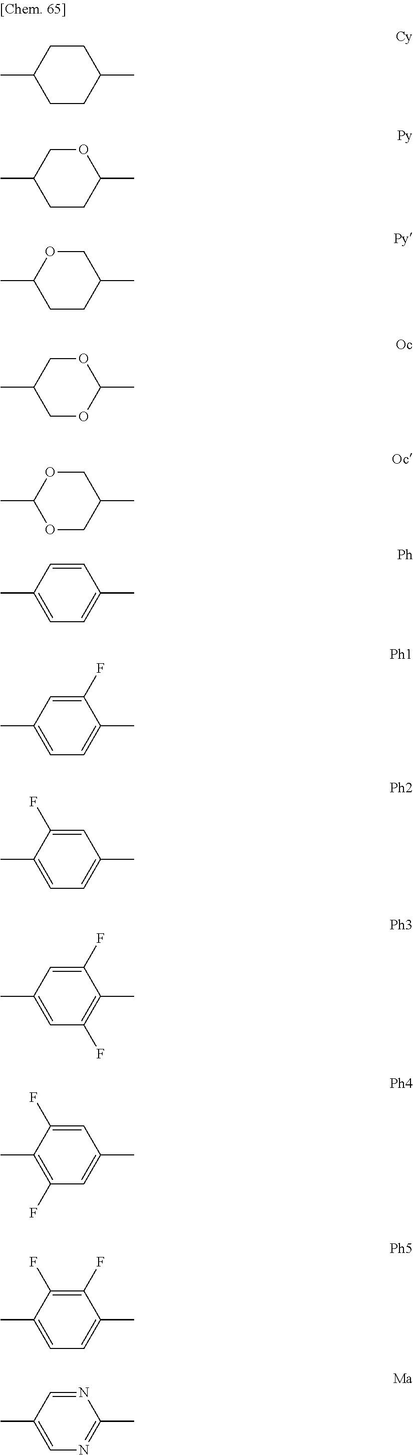

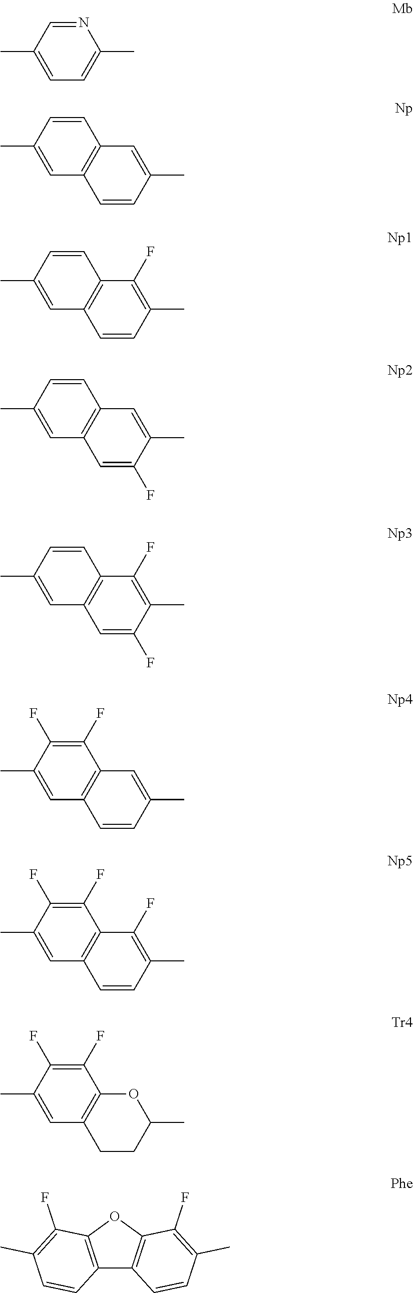

In Examples, the following properties were measured.

T_{NI}: Nematic phase-isotropic liquid phase transition temperature (° C.)

Δn: Anisotropy of refractive index at 20° C.

Δε: Dielectric anisotropy at 20° C.

η: Viscosity at 20° C. (mPa·s)

γ₁: Rotational viscosity at 20° C. (mPa·s)

K₁₁: Elastic constant K₁ at 20° C. (pN)

K₃₃: Elastic constant K₃₃ at 20° C. (pN)

K_{AVG}: Average of K₁₁ and K₃₃ (K_{AVG}=(K₁₁+K₃₃)/2) (pN)

### “VHR Measurement”

### (Voltage Holding Ratio at 333 K (%) at Frequency of 60 Hz and Voltage of 1 V)

### Lightfastness Test Using Blue LED Light Source Having Primary Emission Peak at 450 nm:

The VHR of a liquid crystal panel was measured before and after the liquid crystal panel had been irradiated with 68 J of 450-nm light for 14 hours using a blue monochromatic LED light source having a peak at 450 nm.

### Lightfastness Test Using LED Having Primary Emission Peak at 385 nm:

The VHR of a liquid crystal panel was measured before and after the liquid crystal panel had been irradiated with 10 J of 385-nm light for 60 seconds using a monochromatic LED having a peak at 385 nm.

### “Method for Preparing Liquid Crystal Panel, Backlight Unit, and Liquid Crystal Display Device”

### (1) Preparation of Liquid Crystal Panel

### (Production of Photoconversion Layer or Color Filter)

(A) “Preparation of Light-Emitting Nanocrystals”

The operation of producing light-emitting nanocrystals and the operation of producing an ink, which are described below, were conducted in a glove box filled with nitrogen or in a flask that was cut off from the atmosphere and under a nitrogen gas stream.

Each of the raw materials described below as an example was used after the atmosphere of the container containing the raw material had been replaced with a nitrogen gas by introducing a nitrogen gas into the container. In the case where a liquid material is used, the liquid material was used after oxygen dissolved in the liquid material had been replaced with a nitrogen gas by introducing a nitrogen gas into the liquid. Titanium oxide was used after being heated at a reduced pressure of 1 mmHg and 120° C. for 2 hours and subsequently left to cool in a nitrogen gas atmosphere.

Each of the organic solvents and liquid materials described below was used after 1 g of Molecular sieve 3A produced by KANTO CHEMICAL CO., INC. relative to 10 ml of the organic solvent or liquid material had been added to the organic solvent or liquid material in a nitrogen atmosphere and the resulting mixture had been dehydrated and dried for 48 hours or more.

### [Production of Red Light-Emitting Nanocrystals]

Into a 1000-ml flask, 17.48 g of indium acetate, 25.0 g of trioctylphosphine oxide, and 35.98 g of lauric acid were charged. While the resulting mixture was bubbled with a nitrogen gas, the mixture was stirred at 160° C. for 40 minutes. The mixture was further stirred for another 20 minutes at 250° C. and subsequently heated to 300° C. while being stirred. In a glove box, 4.0 g of tris(trimethylsilyl)phosphine was dissolved in 15.0 g of trioctylphosphine, and the resulting solution was charged into a glass syringe. The solution was injected into the flask heated at 300° C., and a reaction was conducted at 250° C. for 10 minutes. To the resulting reaction solution, 5 ml of a liquid mixture prepared by dissolving 7.5 g of tris(trimethylsilyl)phosphine in 30.0 g of trioctylphosphine inside a glove box was added dropwise over 12 minutes. The rest of the liquid mixture was added to the reaction solution in amounts of 5 ml at intervals of 15 minutes until the whole amount of the liquid mixture was used.

Into another three-necked flask, 5.595 g of indium acetate, 10.0 g of trioctylphosphine oxide, and 11.515 g of lauric acid were charged. While the resulting mixture was bubbled with a nitrogen gas, the mixture was stirred at 160° C. for 40 minutes. The mixture was further stirred for another 20 minutes at 250° C., subsequently heated to 300° C., and then cooled to 70° C. This mixed solution was added to the above-described reaction solution. To the reaction solution, 5 ml of a liquid mixture prepared by dissolving 4.0 g of tris(trimethylsilyl)phosphine in 15.0 g of trioctylphosphine inside a glove box was again added dropwise over 12 minutes. The rest of the liquid mixture was added to the reaction solution in amounts of 5 ml at intervals of 15 minutes until the whole amount of the liquid mixture was used. Subsequently, the reaction solution was stirred for 1 hour and cooled to room temperature. Then, 100 ml of toluene and 400 ml of ethanol were added to the reaction solution to cause the aggregation of microparticles. After the microparticles had been settled using a centrifugal separation apparatus, the supernatant liquid was removed. The settled microparticles were dissolved in trioctylphosphine to form a trioctylphosphine solution of indium phosphide (InP) red light-emitting nanocrystals.

### [Production of Green Light-Emitting Nanocrystals]

Into a 1000-ml flask, 23.3 g of indium acetate, 40.0 g of trioctylphosphine oxide, and 48.0 g of lauric acid were charged. While the resulting mixture was bubbled with a nitrogen gas, the mixture was stirred at 160° C. for 40 minutes. The mixture was further stirred for another 20 minutes at 250° C. and subsequently heated to 300° C. while being stirred. Inside a glove box, 10.0 g of tris(trimethylsilyl)phosphine was dissolved in 30.0 g of trioctylphosphine, and the resulting solution was charged into a glass syringe. The solution was injected into the flask heated at 300° C., and a reaction was conducted at 250° C. for 5 minutes. Subsequently, the flask was cooled to room temperature. Then, 100 ml of toluene and 400 ml of ethanol were added to the flask to cause the aggregation of microparticles. After the microparticles had been settled using a centrifugal separation apparatus, the supernatant liquid was removed. The settled microparticles were dissolved in trioctylphosphine to form a trioctylphosphine solution of indium phosphide (InP) green light-emitting nanocrystals.

### [Production of InP/ZnS Core-Shell Nanocrystals]

After the amounts of InP and trioctylphosphine contained in the trioctylphosphine solution of indium phosphide (InP) red light-emitting nanocrystals, which was synthesized above, had been adjusted to be 3.6 g and 90 g, respectively, the trioctylphosphine solution of indium phosphide (InP) red light-emitting nanocrystals was charged into a 1000-ml flask. To the flask, 90 g of trioctylphosphine oxide and 30 g of lauric acid were added. In a glove box, 42.9 ml of a 1 M hexane solution of diethylzinc and 92.49 g of a 9.09-weight % trioctylphosphine solution of bistrimethylsilyl sulfide were mixed with 162 g of trioctylphosphine to prepare a stock solution. After the flask had been purged with a nitrogen atmosphere, the target temperature of the flask was set to 180° C. When the temperature reached 80° C., 15 ml of the stock solution was added to the flask. Subsequently, the stock solution was added to the flask in amounts of 15 ml at intervals of 10 minutes (flask temperature was maintained to be 180° C.). After the final addition of the stock solution had been done, the temperature was held for another 10 minutes to terminate the reaction. After the reaction had been terminated, the solution was cooled to normal temperature. Subsequently, 500 ml of toluene and 2000 ml of ethanol were added to the solution to cause the aggregation of nanocrystals. After the nanocrystals had been settled using a centrifugal separation apparatus, the supernatant liquid was removed. The precipitate was again dissolved in chloroform such that the concentration of the nanocrystals in the resulting solution was 20% by mass. Hereby, a chloroform solution of (red light-emitting) InP/ZnS core-shell nanocrystals (QD dispersion liquid 1) was prepared.

A chloroform solution of (green light-emitting) InP/ZnS core-shell nanocrystals (QD dispersion liquid 2) was also prepared as described above, except that the above-described indium phosphide (InP) green light-emitting nanocrystals were used instead of the indium phosphide (InP) red light-emitting nanocrystals.

### [Exchange of Ligand of Light-Emitting Nanocrystals]

A triethylene glycol monomethyl ether ester of 3-mercaptopropanoic acid (triethylene glycol monomethyl ether mercaptopropionate) (TEGMEMP) was synthesized with reference to Japanese Unexamined Patent Application Publication No. 2002-121549 (unexamined patent publication of Mitsubishi Chemical Corporation) and dried under reduced pressure.

In a container filled with a nitrogen gas, ligand exchange was performed by mixing the nanocrystal (quantum dots) dispersion liquid 1 (containing the (red light-emitting) InP/ZnS core-shell nanocrystals) with 80 g of a chloroform solution containing 8 g of the TEGMEMP synthesized above and stirring the resulting mixture at 80° C. for 2 hours. Then, the temperature was reduced to room temperature.

Subsequently, while stirring was performed under reduced pressure at 40° C., toluene/chloroform was removed by evaporation in order to concentrate the dispersion liquid until the amount of the dispersion liquid reached 100 ml. To the dispersion liquid, n-hexane was added in an amount equal to four times the weight of the dispersion liquid in order to cause aggregation of QD. The supernatant liquid was removed by centrifugal separation and decantation. To the precipitate, 50 g of toluene was added. The resulting mixture was again dispersed using ultrasound. The above cleaning operation was conducted three times in total in order to remove free ligand components remaining in the liquid. The precipitate formed after decantation was vacuum-dried at room temperature for two hours. Hereby, 2 g of a powder of QD modified with TEGMEMP ((red light-emitting) QD-TEGMEMP) was prepared. A powder of QD ((green light-emitting) QD-TEGMEMP) was also prepared by the same method as described above.

### (B) Preparation of Coloring Composition, Light-Emitting Nanocrystal-Containing Composition, and Ink Composition

### [Red Light-Emitting Nanocrystal-Containing Composition 1]

With 30 parts by mass of the solid component of the red light-emitting nanocrystals (including the ligands), 30 parts by mass of dipentaerythritol hexaacrylate (KAYARAD (trade name) DPHA, produced by Nippon Kayaku Co., Ltd.), 5 parts by mass of a polymerization initiator (Irgacure-907 (trade name) produced by BASF SE), and 30 parts by mass of a polyester acrylate resin (ARONIX (trade name) M7100, produced by Toagosei Chemical Industry Co., Ltd.) were mixed. The resulting mixture was diluted with propylene glycol monomethyl ether acetate such that the solid content of the mixture was 20% by mass, subsequently stirred with a dispersion stirrer, and then filtered through a filter having a pore size of 1.0 μm. Hereby, a red light-emitting nanocrystal-containing composition 1 was prepared.

### [Red Coloring Composition]

Into a plastic bottle, 10 parts of a red pigment (C.I. Pigment Red 254, water-soluble content: 0.3%, specific electrical conductivity: 30 μS/cm) was charged. Into the plastic bottle, 55 parts of propylene glycol monomethyl ether acetate, 7.0 parts of DISPERBYK LPN21116 (produced by BYK-Chemie), and 0.3-to-0.4-mmϕ SEPR beads were added. The resulting mixture was dispersed for 4 hours using Paint Conditioner (produced by Toyo Seiki Kogyo Co., Ltd.) and then filtered through a 5-μm filter to prepare a pigment dispersion. Then, 75.00 parts of the pigment dispersion was mixed with 5.50 parts of a polyester acrylate resin (ARONIX (trade name) M7100, produced by Toagosei Chemical Industry Co., Ltd.), 5.00 parts of dipentaerythritol hexaacrylate (KAYARAD (trade name) DPHA, produced by Nippon Kayaku Co., Ltd.), 1.00 parts of benzophenone (KAYACURE (trade name) BP-100, produced by Nippon Kayaku Co., Ltd.), and 13.5 parts of UCAR Ester EEP while being stirred with a dispersion stirrer. The resulting mixture was filtered through a filter having a pore size of 1.0 μm. Thus, a red pigment coloring composition 1 was prepared.

The water-soluble content of the pigment was determined in accordance with JIS K5101-16-1 (Test methods for pigments-Part 16: Matter soluble in water-Section 1: Hot extraction method).

Specifically, the following method was used.

1. Into a 500-mL rigid beaker, 5.00 g of an accurately weighed pigment is charged. To the beaker, 200 mL of ion-exchange water (electrical conductivity: 5 μS/cm or less, pH: 7.0±1.0) is added. The ion-exchange water is added in small amounts at the beginning. After 5 mL of first-grade reagent methanol is added to the beaker to soak the pigment in the ion-exchange water to a sufficient degree, the rest of the ion-exchange water is added to the beaker. The resulting liquid mixture is boiled for 5 minutes.

2. The liquid mixture is cooled to room temperature and transferred to a 250-mL graduated cylinder. To the graduated cylinder, the above ion-exchange water is added until the volume of the liquid mixture becomes 250 mL. Subsequently, the liquid mixture is vigorously stirred and then filtered through a filter paper No. 5C produced by ADVANTEC.

3. Initially, about 50 mL of the filtrate is removed, and 100 mL of the remaining filtrate is weighed using a graduated cylinder and transferred to an evaporation pan of known mass. The filtrate adhering to the graduated cylinder is washed off with a small amount of ion-exchange water into the evaporation pan.

4. The evaporation pan is placed in a water bath, and evaporation to dryness is performed. The evaporation pan is dried for 2 hours in a drying machine kept at 105° C. to 110° C. and subsequently charged into a desiccator. After the evaporation pan is left to cool, the mass of the evaporation pan is measured. Thus, the amount of substance that remains after evaporation is determined.

5. The water-soluble content of the pigment is calculated using the following formula.

Water-soluble content of the pigment (%)=Amount of substance remaining after evaporation (g)×2.5/Mass of the pigment (g)×100

The specific electrical conductivity of a pigment was calculated in the following manner. The specific electrical conductivity of the ion-exchange water used was measured using a conductivity meter (e.g., Model: CM-30V produced by DKK-TOA CORPORATION). The specific electrical conductivity of the 100 mL of filtrate, which was weighed using a graduated cylinder in Step 3 above, was measured using the conductivity meter. Then, the specific electrical conductivity of the pigment was calculated by correcting the measured value by using the following formula.

Specific electrical conductivity of the pigment=Specific electrical conductivity of the filtrate−Specific electrical conductivity of the ion-exchange water used

### [Green Light-Emitting Nanocrystal-Containing Composition 1]

A green light-emitting nanocrystal-containing composition 1 was prepared as described above, except that the green light-emitting nanocrystals were used instead of the red light-emitting nanocrystals used for preparing the red light-emitting nanocrystal-containing composition.

### [Green Coloring Composition]

A green coloring composition 1 was prepared as described above, except that a pigment (water-soluble content: 0.4%, specific electrical conductivity: 50 μS/cm) prepared by mixing 6 parts of a green pigment 1 (C.I. Pigment Green 36, water-soluble content: 0.3%, specific electrical conductivity: 40 μS/cm) with 4 parts of a yellow pigment 2 (C.I. Pigment Yellow 150, water-soluble content: 0.6%, specific electrical conductivity: 70 μS/cm) was used instead of 10 parts of the red pigment 1 used for preparing the red pigment coloring composition 1.

### [Blue (Light-Emitting Nanocrystal-Containing) Composition]

In the preparation of a blue (light-emitting nanocrystal-containing) composition, a blue light-emitting nanocrystal-containing composition was prepared as described above, except that blue light-emitting nanocrystals were used instead of the red light-emitting nanocrystals used for preparing the red light-emitting nanocrystal-containing composition 1.

### [Blue Coloring Composition 1]

In the preparation of the blue coloring composition, propylene glycol monomethyl ether acetate, DISPERBYK LPN21116 (produced by BYK-Chemie), and 0.3-to-0.4-mmϕ zirconia beads “ER-120S” produced by Saint-Gobain S.A. were mixed. The resulting mixture was dispersed for 4 hours using Paint Conditioner (produced by Toyo Seiki Kogyo Co., Ltd.) and then filtered through a 1-μm filter to prepare a dispersion liquid. With 75 parts by mass of the dispersion liquid, 5.5 parts by mass of a polyester acrylate resin (ARONIX (trade name) M7100, produced by Toagosei Chemical Industry Co., Ltd.), 5 parts by mass of dipentaerythritol hexaacrylate (KAYARAD (trade name) DPHA, produced by Nippon Kayaku Co., Ltd.), 1 part by mass of benzophenone (KAYACURE (trade name) BP-100, produced by Nippon Kayaku Co., Ltd.), and 13.5 parts by mass of UCAR Ester EEP were mixed. The resulting mixture was stirred with a dispersion stirrer and subsequently filtered through a filter having a pore size of 1.0 μm. Thus, a blue coloring composition 1 was prepared.

### [Blue Coloring Composition 2]

In the preparation of the blue coloring composition, a blue dye 1 (C.I. Solvent Blue 7) was charged into a plastic bottle. To the plastic bottle, propylene glycol monomethyl ether acetate, DISPERBYK LPN21116 (produced by BYK-Chemie), and 0.3-to-0.4-mmϕ zirconia beads “ER-120S” produced by Saint-Gobain S.A. were added. The resulting mixture was dispersed for 4 hours using Paint Conditioner (produced by Toyo Seiki Kogyo Co., Ltd.) and then filtered through a 1-μm filter to prepare a pigment dispersion liquid.

With 75 parts by mass of the pigment dispersion liquid, 5.5 parts by mass of a polyester acrylate resin (ARONIX (trade name) M7100, produced by Toagosei Chemical Industry Co., Ltd.), 5 parts by mass of dipentaerythritol hexaacrylate (KAYARAD (trade name) DPHA, produced by Nippon Kayaku Co., Ltd.), 1.00 parts of benzophenone (KAYACURE (trade name) BP-100, produced by Nippon Kayaku Co., Ltd.), and 13.5 parts of UCAR Ester EEP were mixed. The resulting mixture was stirred with a dispersion stirrer and subsequently filtered through a filter having a pore size of 1.0 μm. Thus, a blue coloring composition 2 was prepared.

### [Yellow Light-Emitting Nanocrystal-Containing Composition]

In the preparation of a yellow light-emitting nanocrystal-containing composition, a yellow light-emitting nanocrystal-containing composition was prepared as described above, except that yellow light-emitting nanocrystals were used instead of the red light-emitting nanocrystals.

### [Yellow Coloring Composition]

A yellow coloring composition was prepared as described above, except that 10 parts of a yellow pigment (C.I. Pigment Yellow 150, water-soluble content: 0.6%, specific electrical conductivity: 70 μS/cm) was used instead of the red pigment used for preparing the red pigment composition.

### “Preparation of Ink Composition”

### [Preparation of Titanium Oxide Dispersion Liquid]

In a container filled with a nitrogen gas, 6 g of titanium oxide, 1.01 g of a polymer dispersant, and 1,4-butanediol diacetate were mixed such that the resulting mixture had a nonvolatile content of 40%. After zirconia beads (diameter: 1.25 mm) had been added to the mixture contained in the container filled with a nitrogen gas, the closed container filled with a nitrogen gas was shaken with Paint Conditioner for two hours in order to disperse the mixture. Hereby, a light-scattering particle dispersion 1 was prepared. Each of the above materials was used after dissolved oxygen had been replaced with a nitrogen gas by introduction of a nitrogen gas.

### [Preparation of Red Light-Emitting Nanocrystal-Containing Ink Composition 1]

The materials (1), (2), and (3) below were mixed uniformly in a container filled with a nitrogen gas. In a glove box, the resulting mixture was filtered through a filter having a pore size of 5 μm. Subsequently, a nitrogen gas was introduced into the ink in order to saturate the ink with a nitrogen gas. Then, the pressure was reduced to remove the nitrogen gas. Hereby, an ink composition was prepared. Thus, a final ink composition 1 that had been deoxidized and substantially did not contain moisture was prepared. The materials used were as follows.

### [Light-Scattering Particles]

Titanium oxide: MPT141 (produced by Ishihara Sangyo Kaisha, Ltd.)

### [Thermosetting Resin]

Glycidyl group-containing solid acrylic resin: “FINEDIC A-254”
   (produced by DIC Corporation)

### [Polymer Dispersant]

Polymer dispersant: BYK-2164
   (product name produced by BYK, “DISPERBYK” is a registered trademark)

### [Organic Solvent]

1,4-Butanediol diacetate (produced by Daicel Corporation)

(1) A QD-TEGMEMP dispersion liquid 1 (containing the (red light-emitting) InP/ZnS core-shell nanocrystals) prepared by mixing the QD ((red light-emitting) QD-TEGMEMP) with 1,4-butanediol diacetate that served as an organic solvent such that the nonvolatile content of the dispersion liquid was 30%: 22.5 g

(2) a thermosetting resin solution prepared by dissolving a thermosetting resin: “FINEDIC A-254” produced by DIC Corporation (6.28 g), a curing agent: 1-methylcyclohexane-4,5-dicarboxylic anhydride (1.05 g), and a curing accelerator: dimethylbenzylamine (0.08 g) in an organic solvent: 1,4-butanediol diacetate such that the nonvolatile content in the solution was 30%: 12.5 g

(3) the light-scattering particle dispersion 1: 7.5 g

### [Preparation of Green Light-Emitting Nanocrystal-Containing Ink Composition 2]

The ink composition 2 was prepared as in the preparation of the ink composition 1, except that a QD ((green light emitting) QD-TEGMEMP) dispersion liquid (containing the (green light-emitting) InP/ZnS core-shell nanocrystals) was used instead of the QD-TEGMEMP dispersion liquid 1 (containing the (red light-emitting) InP/ZnS core-shell nanocrystals).

### [Preparation of Ink Composition 3]

With 1.50 parts by mass of sodium chloride and 0.75 parts by mass of diethylene glycol, 0.50 parts by mass of Y138 (produced by BASF SE) was pulverized by friction. The resulting mixture was charged into 600 parts by mass of warm water and stirred for 1 hour. The water-insoluble component was separated by filtration, cleaned thoroughly with warm water, and subsequently dried with a fan at 90° C. to form a pigment. The size of particles of the pigment was 100 nm or less. The particles of the pigment had an average length/width ratio of less than 3.00. The resulting yellow pigment composed of a quinophthalone compound was used for conducting the following dispersion test and color filter evaluation test.

Into a glass bottle, 0.660 parts by mass of the pigment prepared from Y138 (produced by BASF SE) by the above method was charged. To the glass bottle, 6.42 parts by mass of propylene glycol monomethyl ether acetate, 0.467 parts by mass of DISPERBYK (registered trademark) LPN-6919 (produced by BYK-chemie), 0.700 parts by mass of an acrylic resin solution UNIDIC (registered trademark) ZL-295 produced by DIC Corporation, and 22.0 parts by mass of 0.3-to-0.4-mmϕSEPR beads were added. The resulting mixture was dispersed for four hours using Paint Conditioner (produced by Toyo Seiki Kogyo Co., Ltd.) to form a pigment dispersion liquid. Into a glass bottle, 2.00 parts by mass of the pigment dispersion liquid, 0.490 parts by mass of an acrylic resin solution UNIDIC (registered trademark) ZL-295 produced by DIC Corporation, and 0.110 parts by mass of propylene glycol monomethyl ether acetate were charged. Hereby, an ink composition 3 was prepared.

### [Preparation of Light-Scattering Ink Composition ScB]

A light-scattering ink composition ScB was prepared as in the preparation of the ink composition 1, except that 1,4-butanediol diacetate was used as a material (1) instead of the QD-TEGMEMP dispersion liquid 1 (containing the (red light-emitting) InP/ZnS core-shell nanocrystals).

### (C) Production of Photoconversion Layer

### (Preparation of Photoconversion Layers 1 to 5 by Photolithography)

The red light-emitting nanocrystal-containing composition was applied to a glass substrate, on which a black matrix had been deposited, by spin coating so as to form a coating film having a thickness of 2 μm. After being dried at 70° C. for 20 minutes, the coating film was exposed to ultraviolet radiation using an exposure machine including an extra-high pressure mercury lamp through a photomask in a striped pattern. The patterned coating film was subjected to spray development using an alkali developing solution for 90 seconds, then cleaned with ion-exchanged water, and air-dried. Subsequently, post-baking was performed in a clean oven at 180° C. for 30 minutes. Thus, red pixels constituted by a colored layer having a striped pattern were formed on the transparent substrate.

In the same manner, the green light-emitting nanocrystal-containing composition was also applied to the glass substrate by spin coating so as to form a coating film having a thickness of 2 μm. After being dried, the coating film was exposed to light using the exposure machine such that a colored layer having a striped pattern was formed at a position displaced from that of the red pixels. Then, development was performed. Thus, green pixels adjacent to the red pixels were formed.

Photoconversion layers 1, 3, and 5 that included red, green, and blue three-color striped pixels and a photoconversion layer 3 that included red, green, blue, and yellow four-color striped pixels were prepared using the red, green, blue, and yellow light-emitting nanocrystal-containing compositions and the red, green, blue, and yellow coloring compositions as described in Table 1 below.

A photoconversion layer 4 was prepared by applying the blue coloring composition 2 onto the entire surface of the photoconversion layer 1 and irradiating the coating film with ultraviolet radiation in order to form a blue layer over the entire surfaces of the red, green, and blue three-color striped pixels.

TABLE 1

| | Photoconversion | Photoconversion | Photoconversion | Photoconversion | Photoconversion |
|---|---|---|---|---|---|
| | layer 1 | layer 2 | layer 3 | layer 4 | layer 5 |
| R pixel | Red light- | Red light- | Red light- | Red light- | Red light- |
| portion | emitting | emitting | emitting | emitting | emitting |
| | nanocrystal- | nanocrystal- | nanocrystal- | nanocrystal- | nanocrystal- |
| | containing | containing | containing | containing | containing |
| | composition | composition | composition | composition + | composition + |
| | | | | red coloring | red coloring |
| | | | | composition | composition |
| G pixel | Green light- | Green light- | Green light- | Green light- | Green light- |
| portion | emitting | emitting | emitting | emitting | emitting |
| | nanocrystal- | nanocrystal- | nanocrystal- | nanocrystal- | nanocrystal- |
| | containing | containing | containing | containing | containing |
| | composition | composition | composition | composition + | composition + |
| | | | | green coloring | yellow coloring |
| | | | | composition | composition |
| B pixel | Blue coloring | Blue coloring | Blue light- | Blue coloring | Blue coloring |
| portion | composition 1 | composition 2 | emitting | composition 1 | composition 1 |
| | (without blue | (without blue | nanocrystal- | (without blue | (without blue |
| | light-emitting | light-emitting | containing | light-emitting | light-emitting |
| | nanocrystals) | nanocrystals) | composition | nanocrystals) | nanocrystals) |
| Y pixel | None | Yellow light- | None | None | None |
| portion | | emitting | | | |
| | | nanocrystal- | | | |
| | | containing | | | |
| | | composition | | | |
| Blue pixels | None | None | None | Blue coloring | Blue coloring |
| on the entire | | | | composition 2 | composition 2 |
| pixels | | | | (without blue | (without blue |
| | | | | light-emitting | light-emitting |
| | | | | nanocrystals) | nanocrystals) |

### [Preparation of Photoconversion Layer 6 by Ink-Jet Method]

Metal chromium was sputtered to a glass substrate composed of alkali-free glass (“OA-10G” produced by Nippon Electric Glass Co., Ltd.). After a pattern had been formed in the resulting chromium film by photolithography, a photoresist SU-8 (produced by Nippon Kayaku Co., Ltd.) was applied to the chromium film. Subsequently, exposure, development, and post-baking were performed. Hereby, an SU-8 pattern was formed on the chromium pattern.

The resulting partition pattern had openings corresponding to subpixels having a size of 100 μm×300 μm. The partition pattern had a linewidth of 20 μm and a thickness of 8 μm. This BM substrate was used for preparing the photoconversion layer 6.

A solid pattern was formed by the same method as described above. The contact angle of the solvent (1,4-BDDA) used for preparing the inks was 450. This confirms that the pattern had repellency against the solvent.

Using an ink-jet printer (produced by FUJIFILM Dimatix, Inc., product name “DMP-2850”), a light-scattering ink composition ScB was prepared as in the preparation of the red light-emitting nanocrystal-containing ink composition 1, except that the ink compositions 1 and 2 and the QD-TEGMEMP were not used. These ink compositions were ejected to the openings. The head unit of the ink-jet printer, through which the ink was ejected, had 16 nozzles formed therein. The amount of the ink composition ejected through each nozzle per ejection was set to 10 pL.

The black matrix (hereinafter, also referred to as “BM”) was disposed on a platen (substrate table) of the DMP-2850. After alignment had been done by conforming the scan direction of the head to the pattern of the black matrix disposed on the substrate, the ink was ejected to the openings of the BM at a rate of 6 m/second.

In the formation of the film, the ink was ejected until the thickness of a film formed by curing the ink was 80% or more of the thickness of the partition of the black matrix. The thickness of the cured-ink film printed and cured in the openings of the BM was measured with an optical interference-type thickness meter (Vert Scan).

The drying and curing of the ink were performed in the following manner.

In the case where a thermosetting ink is used, since the ink contains a solvent, the ink was dried under reduced pressure and then cured by being heated at 100° C. for 3 minutes and at 150° C. for another 30 minutes in a nitrogen atmosphere inside a glove box.

When a photopolymerizable ink was used, the printed substrate was charged into a closed container (purge box) that was filled with a nitrogen gas and had a light permeable window and subsequently irradiated with UV light emitted from an ultraviolet irradiation apparatus in order to cause curing.

In the above-described manner, pixel portions that convert blue light into red light, pixel portions that convert blue light into green light, and pixel portions that transmit blue light (without color conversion) which were composed of a light-scattering agent-containing dispersion liquid that did not contain light-emitting nanocrystals were formed on the BM substrate.

A patterned photoconversion layer 6 including a plurality of types of pixel portions was prepared by the above-described operations (the structure illustrated in FIG. 22).

### [Preparation of Photoconversion Layer 7 by Ink-Jet Method]

The photoconversion layer 1 was formed on a glass substrate by the same method as described above. Then, the ink composition 3 was applied onto a surface of the glass substrate which was opposite to the surface on which the photoconversion layer 1 was disposed, that is, to the cured ink compositions 1 to 2 and the cured ink composition ScB which served as pixel portions, by spin coating. The resulting coating film was dried and subsequently heated at 180° C. for 1 hour. Hereby, a photoconversion layer 7 that included a yellow color filter layer covering the entire surface of the photoconversion layer 7, the BM substrate, pixel portions that convert blue light into red light, pixel portions that convert blue light into green light, and pixel portions that transmit blue light (without color conversion) which were composed of a light-scattering agent-containing dispersion liquid that did not contain light-emitting nanocrystals, the pixel portions being formed in the openings of the BM substrate, was prepared (the structure illustrated in FIG. 20).

[Method for Producing Electrode Substrate Including in-Cell Polarizing Layer]

A “POVAL 103” aqueous solution (solid content concentration: 4% by mass) produced by Kuraray Co., Ltd. was applied to the photoconversion layer 1. The resulting coating film was dried and subsequently subjected to a rubbing treatment.

Onto the rubbed surface, a polarizing layer-forming liquid containing 0.03 parts by mass of MEGAFACE F-554 (produced by DIC Corporation), 1 part by mass of the azo colorant represented by Formula (az-1) below, 1 part by mass of the azo colorant represented by Formula (az-2) below,

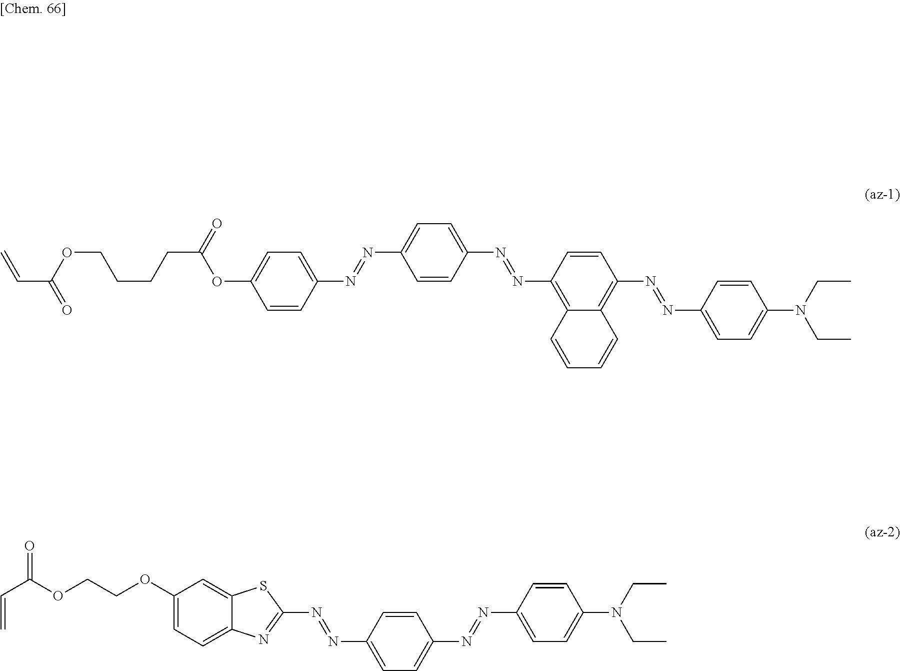 [SMILES: C=CC(=O)OCCCCC(=O)Oc1ccc(/N=N/c2ccc(/N=N/c3ccc(/N=N/c4ccc(N(CC)CC)cc4)c4ccccc34)cc2)cc1 ; C=CC(=O)OCCOc1ccc2nc(/N=N/c3ccc(/N=N/c4ccc(N(CC)CC)cc4)cc3)sc2c1]

98 parts by mass of chloroform, 2 parts by mass of ethylene oxide-modified trimethylolpropane triacrylate (V#360, produced by Osaka Organic Chemical Industry Ltd.), 2 parts by mass of dipentaerythritol hexaacrylate (KAYARAD DPHA, produced by Nippon Kayaku Co., Ltd.), 0.06 parts by mass of IRGACURE 907 (produced by Ciba Specialty Chemicals), and KAYACURE DETX (produced by Nippon Kayaku Co., Ltd.) was applied. The resulting coating film was dried. Hereby, a substrate 1 including a polarizing layer and the photoconversion layer 1 was prepared. ITO was deposited on the substrate by sputtering. Hereby, an opposite substrate 1 (i.e., a second (electrode) substrate) was prepared.

An opposite substrate 6 (i.e., a second (electrode) substrate) was prepared in the same manner as above, except that photoconversion layer 6 was used instead of the photoconversion layer 1.

An opposite substrate 7 (i.e., a second (electrode) substrate) was prepared in the same manner as above, except that photoconversion layer 7 was used instead of the photoconversion layer 1.

### <Preparation and Evaluation of VA-Mode Liquid Crystal Panel>

A polyimide vertical alignment layer was formed on the ITO included in the opposite substrate 1 (i.e., the second (electrode) substrate) and on the transparent electrode included in the first substrate. The first substrate provided with the transparent electrode and the polyimide vertical alignment layer and the opposite substrate 1 provided with the polyimide vertical alignment layer were arranged such that the two alignment layers faced each other and the orientations of the alignment layers were anti-parallel (180°) to each other. Subsequently, the peripheral portions of the two substrates were bonded to each other with a sealing agent while a certain gap (4 μm) was left between the two substrates. Into the cell gap defined by the surfaces of the alignment layers and the sealing agent, the liquid crystal composition (Composition example 1) described in Table 1 below was charged by vacuum injection. Then, a polarizing plate was bonded to the first substrate. Hereby, a VA-mode liquid crystal panel 1 was prepared. The measurement of VHR and the evaluation of display quality against UV were conducted using the liquid crystal panel as an evaluation device. VA-mode liquid crystal panels 2 to 8 were also prepared in the same manner as above, except that, instead of Composition example 1, Composition examples 2 to 8 described in Tables 1 to 5 below were charged into the cell gap by vacuum injection. The VA-mode liquid crystal panels 2 to 8 were also subjected to the measurement of VHR and the evaluation of display quality against UV. Tables 1 to 9 show the results. The numbers assigned to Composition examples of the liquid crystal composition correspond to the numbers assigned to the VA-mode liquid crystal panels.

TABLE 1

| | | Composition | Composition | Composition | Composition |
|---|---|---|---|---|---|
| | | example 1 | example 2 | example 3 | example 4 |
| VHR results | Initial | 99.0 | 98.5 | 98.6 | 98.2 |
| 450 nm LED | After 14 hours | 97.3 | 97.2 | 98.4 | 96.2 |
| | Reduction | 1.0 | 1.0 | 1.0 | 1.0 |
| VHR results | Initial | 99.3 | 99.2 | 99.5 | 99.0 |
| 385 nm LED | After 60 seconds | 97.3 | 92.5 | 98.2 | 96.8 |
| | Reduction | 1.0 | 0.9 | 1.0 | 1.0 |
| Properties | Tni | 76 | 76 | 74 | 74 |
| (25° C.) | Δn | 0.0930 | 0.0924 | 0.0931 | 0.0930 |
| | Δε | −2.63 | −2.82 | −2.77 | −2.69 |
| | γ1 | 87 | 89 | 101 | 84 |
| Composition | 5-Ph-Ph-1 | 11 | 9 | 12 | 11 |
| | 3-Cy-Cy-V | | | | 7 |
| | 3-Cy-Cy-2 | 18 | 20 | 16 | 18 |
| | 3-Cy-Cy-4 | 9 | 9 | 9 | 4 |
| | 3-Cy-Cy-5 | 5 | 5 | 5 | 3 |
| | 3-Cy-Ph-O1 | | 4 | | |
| | 3-Cy-Cy-Ph-1 | 7 | 7 | 7 | 7 |
| | 3-Cy-Cy-Ph-3 | 4 | 4 | 4 | 4 |
| | 3-Cy-1O-Ph5-O1 | 6 | | | 6 |
| | 3-Cy-1O-Ph5-O2 | 8 | 8 | 8 | 8 |
| | 2-Cy-Cy-1O-Ph5-O2 | 6 | | | 6 |
| | 3-Cy-Cy-1O-Ph5-O2 | 8 | 10 | 11 | 8 |
| | 3-Cy-Ph-Ph5-O3 | 6 | 7 | 6 | 6 |
| | 3-Cy-Ph-Ph5-O4 | 6 | | 6 | 6 |
| | 4-Cy-Ph-Ph5-O3 | 6 | 7 | 6 | 6 |
| | 3-Cy-1O-Np5-O4 | | 5 | | |
| | 5-Cy-1O-Np5-O2 | | 5 | | |
| | 3-Cy-1O-Tr4-5 | | | 5 | |
| | 5-Cy-1O-Tr4-5 | | | 5 | |

TABLE 2

| | | Composition | Composition |
|---|---|---|---|
| | | example 5 | example 6 |
| VHR results | Initial | 99.1 | 99.4 |
| 450 nm LED | After 14 hours | 97.9 | 96.7 |
| | Reduction | 1.0 | 1.0 |
| VHR results | Initial | 99.6 | 99.7 |
| 385 nm LED | After 60 seconds | 99.0 | 98.2 |
| | Reduction | 1.0 | 1.0 |
| Properties | Tni | 72.8 | 80.8 |
| (25° C.) | Δn | 0.094 | 0.0914 |
| | Δε | −2.58 | −2.49 |
| | γ1 | 86 | 81 |
| Composition | 5-Ph-Ph-1 | 4 | |
| | 3-Cy-Cy-V | | 30 |
| | 3-Cy-Cy-2 | 20 | |
| | 3-Cy-Ph-O1 | 16 | 11 |
| | 3-Cy-Cy-Ph-1 | 7 | 7 |
| | 3-Cy-Ph5-O4 | 7 | 6 |
| | 5-Cy-Ph5-O2 | 6 | 6 |
| | 3-Cy-Ph-Ph5-O2 | 10 | 10 |
| | 3-Cy-Ph-Ph5-O3 | 10 | 10 |
| | 2-Cy-Cy-Ph5-O2 | 10 | 10 |
| | 2-Cy-Cy-Ph5-O3 | 10 | 10 |

TABLE 3

| | | Composition example 7 |
|---|---|---|
| VHR results | Initial | 98.6 |
| 450 nm LED | After 14 hours | 97.1 |
| | Reduction | 1.0 |
| VHR results | Initial | 99.2 |
| 385 nm LED | After 60 seconds | 97.2 |
| | Reduction | 1.0 |
| Properties | Tni | 76.3 |
| (25° C.) | Δn | 0.0929 |
| | Δε | −2.75 |
| | γ1 | 84 |
| Composition | 3-Cy-Cy-2 | 20 |
| | 3-Cy-Cy-4 | 8 |
| | 3-Cy-Ph-O1 | 8 |
| | 3-Ph-Ph5-O2 | 13 |
| | 3-Cy-1O-Ph5-O2 | 6 |
| | 2-Cy-Cy-1O-Ph5-O2 | 14 |
| | 3-Cy-Cy-1O-Ph5-O2 | 10 |
| | 3-Cy-Cy-Ph-1 | 8 |
| | 3-Cy-Cy-Ph-3 | 3 |
| | 3-Cy-Ph-Ph-2 | 10 |

TABLE 4

| | | Composition example 8 |
|---|---|---|
| VHR results | Initial | 98.1 |
| 450 nm LED | After 14 hours | 95.5 |
| | Reduction | 1.0 |
| VHR results | Initial | 80.5 |
| 385 nm LED | After 60 seconds | 83.1 |
| | Reduction | 1.0 |
| Properties | Tni | 77 |
| (25° C.) | Δn | 0.1064 |
| | Δε | −2.65 |
| | γ1 | 93 |
| Composition | 3-Cy-Cy-V1 | 10 |
| | V2-Cy-Cy-Ph-1 | 5 |
| | 3-Cy-Ph-Ph-2 | 9 |
| | 3-Cy-Cy-Ph-1 | 9 |
| | 3-Cy-Cy-4 | 9 |
| | 3-Cy-Cy-5 | 8 |
| | 3-Cy-Cy-O1 | 2 |
| | 3-Cy-Ph-O1 | 5 |
| | 3-Cy-Ph5-O2 | 11 |
| | 3-Ph-Ph5-O2 | 15 |
| | 3-Cy-Cy-Ph5-O2 | 11 |
| | 3-Cy-Ph-Ph5-O2 | 3 |
| | 2O-Phe-O5 | 3 |

TABLE 5

| | | Composition example 9 |
|---|---|---|
| VHR results | Initial | 99.4 |
| 450 nm LED | After 14 hours | 99.0 |
| | Reduction | 1.0 |
| VHR results | Initial | 99.4 |
| 385 nm LED | After 60 seconds | 99.0 |
| | Reduction | 1.0 |
| Properties | Tni | 75 |
| (25° C.) | Δn | 0.0918 |
| | Δε | −2.47 |
| | γ1 | 81 |
| Composition | 3-Cy-Cy-2 | 19 |
| | 3-Cy-C-5 | 5 |
| | 3-Cy-Cy-4 | 8 |
| | 3-Cy-Ph-O1 | 8 |
| | 5-Cy-Ph5-O2 | 7 |
| | 3-Cy-Ph5-O2 | 7 |
| | 3-Cy-Ph-Ph5-O2 | 5 |
| | 3-Ph-Ph5-O2 | 5 |
| | 2-Cy-Cy-Ph5-O2 | 11 |
| | 3-Cy-Cy-Ph5-O2 | 11 |
| | 3-Cy-Cy-Ph-1 | 7 |
| | 3-Ph-Ph5-Ph-2 | 7 |

In Tables 1 to 5 above, the reduction in primary emission peak at 450 nm is “VHR after 14-hour lightfastness test/initial VHR (i.e., VHR before 14-hour lightfastness test)”, and the reduction in primary emission peak at 385 nm is “VHR after 60-second lightfastness test/initial VHR (i.e., VHR before 60-second lightfastness test)”. In other words, the closer to 1 the reduction in primary emission peak, the higher the stability against blue light having a primary emission peak at 450 nm or light having a primary emission peak at 385 nm. The above test results confirm that the liquid crystal display devices described above had excellent light fastness and were capable of reducing or preventing the degradation of light-emitting nanocrystals and the degradation of the liquid crystal layer which may occur when the liquid crystal layer is partially irradiated with a high-energy light beam.

It is confirmed that, when the liquid crystal display devices were irradiated with light having a primary emission peak at 385 nm, the liquid crystal display device that included Composition example 2 had the minimum VHR reduction. On the other hand, when attention is paid to the γ1 value, which is responsible for the high-speed responsivity of a liquid crystal display device, it is confirmed that Composition example 3 had the highest γ1 value. The reason for which the liquid crystal display device that included Composition example 2 had the minimum VHR reduction is presumably that Composition example 2, which included a liquid crystal compound containing two or more rings, such as a condensed ring (naphthalene), was likely to absorb light. The reason for which Composition example 3 had the highest γ1 value is presumably that Composition example 3, which included a liquid crystal compound containing two or more rings, such as a chroman ring, had a high viscosity.

### [VA-Mode Liquid Crystal Panel A1]

A VA-mode liquid crystal panel A1 (including the liquid crystal composition of Composition example 1) was prepared as in the preparation of the VA-mode liquid crystal panel 1, except that the opposite substrate 6 including the photoconversion layer 6 was used instead of the opposite substrate 1 used for preparing the VA-mode liquid crystal panel 1. As a result, a reduction in VHR after the 14-hour lightfastness test was not confirmed.

### [VA-Mode Liquid Crystal Panel B1]

A VA-mode liquid crystal panel B1 was prepared as in the preparation of the VA-mode liquid crystal panel 1, except that the opposite substrate 7 including the photoconversion layer 7 was used instead of the opposite substrate 1 used for preparing the VA-mode liquid crystal panel 1. As a result, a reduction in VHR after the 14-hour lightfastness test was not confirmed.

### [Retardation Property]

The liquid crystal composition described in Composition example 1 was subjected to a simulation of transmittance (with the LCDMaster produced by SHINTECH, INC.) using a VA-mode liquid crystal panel 2 prepared by changing the gap (4 μm) of the VA-mode liquid crystal panel 1 to 3.5 μm and a VA-mode liquid crystal panel 3 prepared by changing the gap (4 μm) of the VA-mode liquid crystal panel 1 to 2.8 μm. The results are shown below.

TABLE 7

| Re (retardation) value | Ratio of transmttance to 450-nm light |
|---|---|
| 325 nm | 1.0 |
| (VA-mode liquid crystal panel 2) | |
| 260 nm | 1.2 |
| (VA-mode liquid crystal panel 3) | |

The above results confirm that the reduction in retardation from 325 nm to 260 nm resulted in an increase in transmittance by about 20%.

The retardation (Re) is represented by Formula (1) below.

Re=Δn×d

(in Formula (1), Δn represents an anisotropy of refractive index at 589 nm, and d represents the cell thickness (μm) of the liquid crystal layer included in the liquid crystal display device)

Increases in transmittance were also confirmed in Composition examples 2 to 9. Therefore,

it is considered that setting the retardation (Re) to be 220 to 300 nm increases transmittance.

In Composition example 8, the lightfastness test using blue light having a primary emission peak at 450 nm and the lightfastness test using light having a primary emission peak at 385 nm may be conducted using a VA-mode liquid crystal panel prepared as in Composition example 8 above after 0.05 parts by mass of the antioxidant represented by Formula (111-22) below had been added to 100 parts by mass of the liquid crystal composition of Composition Example 8.

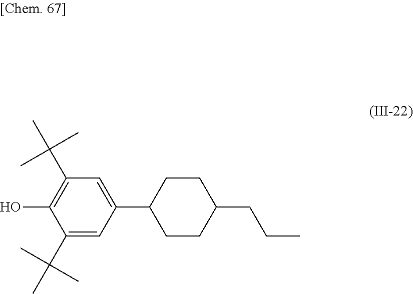 [SMILES: CCCC1CCC(c2cc(C(C)(C)C)c(O)c(C(C)(C)C)c2)CC1]

It is considered that, even in the case where the lightfastness test using blue light having a primary emission peak at 450 nm and the lightfastness test using light having a primary emission peak at 385 nm are conducted using Composition examples 12 to 22 described in Tables 6 and 7 below, which are other than Composition examples 1 to 9, stability against blue light having a primary emission peak at 450 nm or light having a primary emission peak at 385 nm is achieved. Composition example 22 is Example 30 of Japanese Patent No. 5122086.

TABLE 6
[Table 8]

| | | Composition | Composition | Composition | Composition | Composition |
|---|---|---|---|---|---|---|
| | No. | example 12 | example 13 | example 14 | example 15 | example 16 |
| Properties | Tni | 76 | 75 | 73 | 75 | 74 |
| (25° C.) | Δn | 0.115 | 0.110 | 0.113 | 0.113 | 0.115 |
| | ne | 1.598 | 1.598 | 1.603 | 1.601 | 1.605 |
| | no | 1.483 | 1.488 | 1.490 | 1.488 | 1.490 |
| | Δε | −4.4 | −2.8 | −2.6 | −3.1 | −2.5 |
| | e∥ | 3.8 | 3.5 | 3.4 | 3.5 | 3.4 |
| | e⊥ | 8.1 | 6.3 | 5.9 | 6.5 | 5.9 |
| | γ1 | 117 | 90 | 82 | 95 | 86 |
| Composition | 5-Ph-Ph-1 | | | 7 | | |
| | 3-Ph-Ph-1 | | 8 | 11 | 9 | 9 |
| | 3-Cy-Cy-V | | | | | |
| | 3-Cy-Cy-V1 | 12 | | | | |
| | V-Cy-Cy-Ph-1 | | | | | |
| | 3-Cy-Ph-Ph-2 | | 9 | | | 6 |
| | 3-Cy-Cy-Ph-1 | | | 7 | 9 | 9 |
| | 3-Cy-Cy-2 | 16 | 18 | 18 | 18 | 18 |
| | 3-Cy-Cy-4 | | 8 | 8 | 8 | 8 |
| | 3-Cy-Cy-O1 | | 6 | | | |
| | 3-Cy-Ph5-O2 | 13 | | | 7 | 8 |
| | 3-Ph-Ph5-O2 | 13 | | | 8 | 8 |
| | 2-Cy-Cy-Ph5-O2 | 7 | | | | |
| | 3-Cy-Cy-Ph5-O2 | 7 | | | | |
| | 3-Cy-1O-Ph5-O1 | | 4 | | | |
| | 3-Cy-1O-Ph5-O2 | | 7 | 8 | | |
| | 1V-Cy-1O-Ph5-O2 | | | | | |
| | 1V-Cy-1O-Ph5-O1 | | | | | |
| | 2-Cy-Cy-1O-Ph5-O2 | | 9 | 9 | 9 | 8 |
| | 3-Cy-Cy-1O-Ph5-O2 | | 9 | 9 | 10 | 8 |
| | 4-Cy-Cy-1O-Ph5-O2 | | | | | |
| | V-Cy-Cy-1O-Ph5-O2 | | | | | |
| | 1V-Cy-Cy-1O-Ph5-O1 | | | | | |
| | 1V-Cy-Cy-1O-Ph5-O2 | 6 | | | | |
| | 3-Cy-Ph-Ph5-O2 | 8 | 6 | 6 | 6 | 3 |
| | 2-Cy-Ph-Ph5-O2 | 8 | 6 | 6 | 6 | 3 |
| | 3-Cy-Ph-Ph5-O4 | | | 4 | | |
| | 3-Ph-Ph5-Ph-1 | | 5 | | | |
| | 3-Ph-Ph5-Ph-2 | | 5 | 7 | 5 | 5 |
| | 1-Ph-2-Ph-Ph5-O2 | 4 | | | | |
| | 3-Ph-2-Ph-Ph5-O2 | 6 | | | 5 | 7 |

TABLE 7
[Table 9]

| | | Composition | Composition | Composition | Composition | Composition |
|---|---|---|---|---|---|---|
| | No. | example 17 | example 18 | example 19 | example 20 | example 21 |
| Properties | T_{NI}/° C. | 72 | 74 | 78 | 86 | 87 |
| (25° C.) | Δn | 0.103 | 0.111 | 0.099 | 0.099 | 0.105 |
| | ne | 1.585 | 1.596 | 1.581 | 1.580 | 1.586 |
| | no | 1.482 | 1.485 | 1.462 | 1.481 | 1.482 |
| | Δε | −2.4 | −2.6 | −2.4 | −3.2 | −3.5 |
| | e∥ | 3.4 | 3.4 | 3.2 | 3.4 | 3.5 |
| | e⊥ | 5.8 | 6.0 | 5.6 | 6.6 | 6.9 |
| | γ1 | 66 | 85 | 82 | 97 | 116 |
| Composition | 3-Cy-Cy-2 | | 19 | 21 | | 19 |
| | 3-Cy-Cy-4 | | 8 | 8 | | 8 |
| | 3-Cy-Cy-5 | | 5 | 5 | | |
| | 3-Cy-Ph-O2 | | 8 | 7 | | 5 |
| | 3-Cy-Cy-V | 34 | | | 22 | |
| | 3-Cy-Cy-V1 | 8 | | | 8 | |
| | 3-Cy-Cy-Ph-1 | | | 7 | 7 | |
| | 3-Cy-Ph-Ph-2 | | | 3 | | |
| | 3-Cy-Ph5-O2 | 13 | 8 | 5 | 12 | S |
| | 5-Cy-Ph5-O2 | 6 | | | 6 | |
| | 3-Ph-Ph5-O2 | | 9 | 10 | 5 | 8 |
| | 5-Ph-Ph5-O2 | | | 4 | | |
| | 3-Cy-Cy-Ph5-O2 | 7 | 9 | 7 | 10 | 12 |
| | 3-Cy-Cy-Ph5-O3 | 4 | | | 8 | 10 |
| | 4-Cy-Cy-Ph5-O2 | | 5 | 7 | 10 | 10 |
| | 2-Cy-Ph-Ph5-O2 | 7 | 7 | 8 | 6 | 6 |
| | 3-Cy-Ph-Ph5-O2 | 8 | 8 | 8 | | 6 |
| | 3-Ph-Ph5-Ph-2 | 13 | 8 | | 6 | 4 |
| | 4-Ph-Ph5-Ph-2 | | 6 | | | 3 |

TABLE 8

| | | No. |
|---|---|---|
| | | Composition example 22 |
| Properties | T_{NI}/° C. | 81 |
| (20° C.) | Δn | 0.104 |
| | ne | 1.591 |
| | no | |
| | Δε | 8.5 |
| | e// | 11.9 |
| | e⊥ | |
| | γ1 | 65 |
| Composition | 3-Py-Cy-CF2O-Ph3-F | 6 |
| | 3-Cy-Cy-V | 36 |
| | 2-Ph-Ph3-CF2O-Ph3-F | 5 |
| | 3-Ph-Ph3-CF2O-Ph3-F | 4 |
| | V-Cy-Cy-Ph-1 | 20 |
| | 1-Ph-Ph-2V1 | 3 |
| | 2-Ph-Ph1-Ph-4 | 3 |
| | 2-Py-Ph-Ph3-CF2O-Ph3-F | 10 |
| | 3-Py-Ph-Ph3-CF2O-Ph3-F | 9 |
| | 3-Cy-Ph-Ph-2 | 4 |

### [PSVA-Mode Liquid Crystal Panel 1]

A polymerizable compound-containing liquid crystal composition 1 prepared by mixing 0.3 parts by mass of the following polymerizable compound

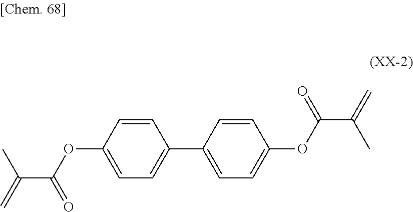 [SMILES: C=C(C)C(=O)Oc1ccc(-c2ccc(OC(=O)C(=C)C)cc2)cc1]

and 99.7 parts by mass of the composition example 5 was injected into, by vacuum injection, a liquid crystal panel having a cell gap of 4 μm and including substrates provided with ITOs having a fishbone structure and polyimide alignment films inducing vertical alignment. The vertical alignment films were formed using JALS2096 produced by JSR.

The liquid crystal panel including the liquid crystal composition containing a polymerizable compound was irradiated with ultraviolet radiation emitted from a high-pressure mercury-vapor lamp through a filter that blocks ultraviolet radiation of 325 nm or less, while a voltage of 10 V was applied to the liquid crystal panel at a frequency of 100 Hz. An adjustment was made such that the illuminance measured with a center wavelength of 365 nm was 100 mW/cm². The total amount of ultraviolet radiation was 10 J/cm². Subsequently, the liquid crystal panel was irradiated with a fluorescent UV lamp. An adjustment was made such that the illuminance measured with a center wavelength of 313 nm was 3 mW/cm². The total amount of ultraviolet radiation was 10 J/cm². Hereby, a PSVA-mode liquid crystal panel 1 was prepared. As in Composition example 5, the lightfastness test using blue light having a primary emission peak at 450 nm and the lightfastness test using light having a primary emission peak at 385 nm were conducted. Faulty display was not confirmed in any of the test using blue light having a primary emission peak at 450 nm and the test using light having a primary emission peak at 385 nm.

### [PSVA-Mode Liquid Crystal Panel 2]

A polymerizable compound-containing liquid crystal composition 2 prepared by mixing the following polymerizable compound (XX-5)

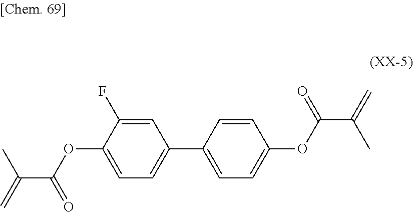 [SMILES: C=C(C)C(=O)Oc1ccc(-c2ccc(OC(=O)C(=C)C)c(F)c2)cc1]

and 99.7 parts by mass of the composition example 1 was injected into, by vacuum injection, a liquid crystal panel having a cell gap of 4 μm and including substrates provided with ITOs having a fishbone structure and polyimide alignment films inducing vertical alignment. The vertical alignment films were formed using JALS2096 produced by JSR.

The liquid crystal panel including the liquid crystal composition containing a polymerizable compound was irradiated with ultraviolet radiation emitted from a high-pressure mercury-vapor lamp through a filter that blocks ultraviolet radiation of 325 nm or less, while a voltage of 10 V was applied to the liquid crystal panel at a frequency of 100 Hz. An adjustment was made such that the illuminance measured with a center wavelength of 365 nm was 100 mW/cm². The total amount of ultraviolet radiation was 10 J/cm². Subsequently, the liquid crystal panel was irradiated with a fluorescent UV lamp. An adjustment was made such that the illuminance measured with a center wavelength of 313 nm was 3 mW/cm². The total amount of ultraviolet radiation was 10 J/cm². Hereby, a PSVA-mode liquid crystal panel 2 was prepared. As in Composition example 1, the lightfastness test using a blue LED having a primary emission peak at 450 nm and the lightfastness test using an LED having a primary emission peak at 385 nm were conducted. Faulty display was not confirmed in any of the test using a blue LED having a primary emission peak at 450 nm and the test using an LED having a primary emission peak at 385 nm.

### (Spontaneous Orientation-Type VA Liquid Crystal Panel 1)

The first substrate provided with a transparent electrode and the opposite substrate 6 (the second transparent electrode substrate) provided with the photoconversion layer 6 on which the in-cell polarizing layer was disposed were arranged such that the two electrodes faced each other. Subsequently, the peripheral portions of the two substrates were bonded to each other with a sealing agent while a certain gap (4 μm) was left between the two substrates. Into the cell gap defined by the surfaces of the alignment layers and the sealing agent, a liquid crystal composition prepared by mixing 2 parts by mass of the following spontaneous orientation aid (Formula (SA-1) below), 0.5 parts by mass of the polymerizable compound (XX-2), and 99.7 parts by mass of the composition example 7

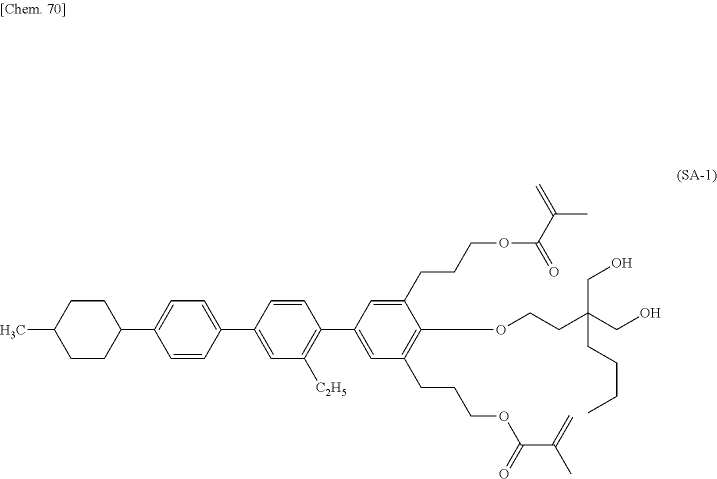 [SMILES: C=C(C)C(=O)OCCCc1cc(-c2ccc(-c3ccc(C4CCC(C)CC4)cc3)cc2CC)cc(CCCOC(=O)C(=C)C)c1OCCC(CO)(CO)CCCC]

was charged, by vacuum injection, into a liquid crystal panel having a cell gap of 4 μm and including substrates that included ITOs and did not include an alignment film.

The liquid crystal panel including the liquid crystal composition containing a polymerizable compound was irradiated with ultraviolet radiation emitted from a high-pressure mercury-vapor lamp through a filter that blocks ultraviolet radiation of 325 nm or less, while a voltage of 10 V was applied to the liquid crystal panel at a frequency of 100 Hz. An adjustment was made such that the illuminance measured with a center wavelength of 365 nm was 100 mW/cm. The total amount of ultraviolet radiation was 10 J/cm². Subsequently, the liquid crystal panel was irradiated with a fluorescent UV lamp. An adjustment was made such that the illuminance measured with a center wavelength of 313 nm was 3 mW/cm². The total amount of ultraviolet radiation was 10 J/cm². Hereby, a spontaneous orientation-type VA liquid crystal panel 1 was prepared. As in Composition example 7, the lightfastness test using blue light having a primary emission peak at 450 nm and the lightfastness test using light having a primary emission peak at 385 nm were conducted. In any of the test using blue light having a primary emission peak at 450 nm and the test using light having a primary emission peak at 385 nm, the initial VHR and the VHR after the lightfastness test were substantially the same as in Composition example 7.

### (Spontaneous Orientation-Type VA Liquid Crystal Panel 2)

The first substrate provided with a transparent electrode and the opposite substrate 6 (the second transparent electrode substrate) provided with the photoconversion layer 6 on which the in-cell polarizing layer was disposed were arranged such that the two electrodes faced each other. Subsequently, the peripheral portions of the two substrates were bonded to each other with a sealing agent while a certain gap (4 μm) was left between the two substrates. Into the cell gap defined by the surfaces of the alignment layers and the sealing agent, a liquid crystal composition prepared by mixing 2 parts by mass of the following spontaneous orientation aid (Formula (SA-2) below), 0.5 parts by mass of the polymerizable compound (XX-5), and 99.7 parts by mass of Composition example 4

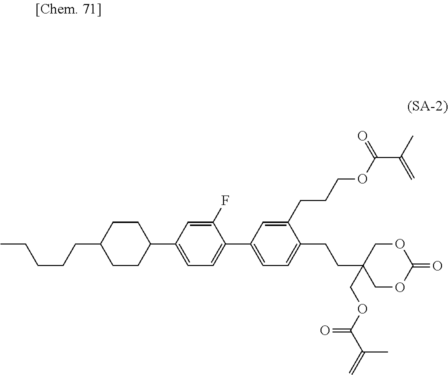 [SMILES: C=C(C)C(=O)OCCCc1cc(-c2ccc(C3CCC(CCCCC)CC3)cc2F)ccc1CCC1(COC(=O)C(=C)C)COC(=O)OC1]

was charged, by vacuum injection, into a liquid crystal panel having a cell gap of 3.5 μm and including substrates that included ITOs and did not include an alignment film.

The liquid crystal panel including the liquid crystal composition containing a polymerizable compound was irradiated with ultraviolet radiation emitted from a high-pressure mercury-vapor lamp through a filter that blocks ultraviolet radiation of 325 nm or less, while a voltage of 10 V was applied to the liquid crystal panel at a frequency of 100 Hz. An adjustment was made such that the illuminance measured with a center wavelength of 365 nm was 100 mW/cm. The total amount of ultraviolet radiation was 10 J/cm². Subsequently, the liquid crystal panel was irradiated with a fluorescent UV lamp. An adjustment was made such that the illuminance measured with a center wavelength of 313 nm was 3 mW/cm². The total amount of ultraviolet radiation was 10 J/cm². Hereby, a spontaneous orientation-type VA liquid crystal panel 2 was prepared. As in Composition example 4, the lightfastness test using blue light having a primary emission peak at 450 nm and the lightfastness test using light having a primary emission peak at 385 nm were conducted. In any of the test using blue light having a primary emission peak at 450 nm and the test using light having a primary emission peak at 385 nm, the initial VHR and the VHR after the lightfastness test were substantially the same as in Composition example 4.

### (Photoalignment Film-Type VA-Mode Liquid Crystal Panel)

The vertical alignment layer solution used in Example 22 of International Publication No. 2013/002260 was deposited on the transparent electrode disposed on the first substrate by spin coating. The resulting coating film was irradiated with polarized light and dried to form a photoalignment layer having a thickness of 0.1 μm. The alignment layer was also formed on the surface of the second transparent electrode substrate (the opposite substrate 1) provided with the photoconversion layer 1 on which a polarizing layer was disposed. The first substrate provided with the transparent electrode and the alignment layer and the opposite substrate 1, that is, the second (electrode) substrate, provided with the photoconversion layer 1 were arranged such that the two alignment layers faced each other and the orientations of the alignment layers were anti-parallel (180°) to each other. Subsequently, the peripheral portions of the two substrates were bonded to each other with a sealing agent while a certain gap (4 μm) was left between the two substrates. Into the cell gap defined by the surfaces of the alignment layers and the sealing agent, the liquid crystal composition described in Composition example 1 was charged by vacuum injection. Then, a polarizing plate was bonded to the first substrate. Hereby, a photoalignment film-type VA-mode liquid crystal panel was prepared.

### (IPS-Mode Liquid Crystal Panel)

An alignment layer solution was deposited on a pair of comb-teeth electrodes disposed on the first substrate by spin coating to form alignment layers. The first substrate provided with the comb-shaped transparent electrode and the alignment layer and the second substrate provided with the alignment layer, the in-cell polarizing layer, the photoconversion layer 1, and a planarization film disposed on the photoconversion layer 1 were arranged such that the two alignment layers faced each other and the directions in which the alignment layers were irradiated with linearly polarized light or rubbed in the horizontal direction were anti-parallel (180°) to each other. Subsequently, the peripheral portions of the two substrates were bonded to each other with a sealing agent while a certain gap (4 μm) was left between the two substrates. Into the cell gap defined by the surfaces of the alignment layers and the sealing agent, the liquid crystal composition (Composition example 6) was charged by vacuum injection. Then, the pair of polarizing plates were bonded to the first substrate and the second substrate, respectively. Hereby, an IPS-mode liquid crystal panel was prepared.

### (FFS-Mode Liquid Crystal Panel)

A flat-plate-like common electrode was formed on the first transparent substrate. An insulation layer film was formed on the common electrode. A transparent comb-teeth electrode was formed on the insulation layer film. An alignment layer solution was deposited on the transparent comb-teeth electrode by spin coating. Hereby, a first electrode substrate was formed. The alignment layer was also formed on the second substrate provided with an alignment layer, the in-cell polarizing layer, the photoconversion layer 1, and a planarization film. The first substrate provided with the comb-shaped transparent electrode and the alignment layer and the second substrate provided with the alignment layer, the polarizing layer, the photoconversion layer 1, and planarization film disposed on the photoconversion layer 1 were arranged such that the two alignment layers faced each other and the directions in which the alignment layers were irradiated with linearly polarized light or rubbed were anti-parallel (180°) to each other. Subsequently, the peripheral portions of the two substrates were bonded to each other with a sealing agent while a certain gap (4 μm) was left between the two substrates. Into the cell gap defined by the surfaces of the alignment layers and the sealing agent, the liquid crystal composition (Composition example 9) was charged by a falling-drop method. Hereby, an FFS-mode liquid crystal panel was prepared.

### (2) Preparation of Backlight Unit

### (Preparation of Backlight Unit 1)

A backlight unit 1 was prepared by arranging a blue LED light source on one of the edges of a light guide plate, covering the portions of the light guide plate which were other than the irradiation surface with a reflection sheet, and arranging a diffusion sheet on the irradiation side of the light guide plate.

### (Preparation of Backlight Unit 2)

A backlight unit 2 was prepared by arranging blue LEDs, in a grid pattern, on a lower reflector plate that scatters and reflects light, a diffusion plate immediately above the LEDs on the irradiation side, and a diffusion sheet on the irradiation side of the diffusion plate.

### (3) Preparation of Liquid Crystal Display Device and Measurement of Color Reproduction Area

A specific one of the backlight units 1 and 2 was attached to the VA-mode liquid crystal panel 1, the PSVA-mode liquid crystal panel 1, the VA-mode liquid crystal panel B1, the spontaneous orientation-type VA-mode liquid crystal panel 1, the spontaneous orientation-type VA-mode liquid crystal panel 2, and the photoalignment film-type VA-mode liquid crystal panel. Subsequently, the color reproduction areas of the above liquid crystal panels were measured. The results confirm that any of the liquid crystal display devices that included a photoconversion layer had a larger color reproduction area than the liquid crystal display devices known in the related art, which did not include a photoconversion layer.

A specific one of the backlight units 1 and 2 was also attached to the IPS-mode liquid crystal panel, and the color reproduction area of the liquid crystal panel was measured. The results confirm that any of the liquid crystal display devices that included a photoconversion layer had a larger color reproduction area than the liquid crystal display devices known in the related art, which did not include a photoconversion layer.

A specific one of the backlight units 1 and 2 was also attached to the FFS-mode liquid crystal panel, and the color reproduction area of the liquid crystal panel was measured. The results confirm that any of the liquid crystal display devices that included a photoconversion layer had a larger color reproduction area than the liquid crystal display devices known in the related art, which did not include a photoconversion layer.

### REFERENCE SIGNS LIST

1000: LIQUID CRYSTAL DISPLAY DEVICE
100: BACKLIGHT UNIT (101: LIGHT SOURCE SECTION, 102: LIGHT GUIDE SECTION, 103: PHOTOCONVERSION SECTION)
101: LIGHT SOURCE SECTION (L: LIGHT-EMITTING ELEMENT (105: LIGHT-EMITTING DIODE, 110: LIGHT SOURCE SUBSTRATE), 112a, b: FIXTURE)
102: LIGHT GUIDE SECTION (106: DIFFUSION PLATE, 104: LIGHT GUIDE PLATE)
103: LIGHT SOURCE, LIGHT GUIDE SECTION
110: LIGHT SOURCE SUBSTRATE
111: TRANSPARENT CONTAINER
112a, b: FIXTURE
NC: LIGHT-EMITTING NANOCRYSTAL (COMPOUND SEMICONDUCTOR)
1, 8: POLARIZING LAYER
2, 7: TRANSPARENT SUBSTRATE
3: FIRST ELECTRODE LAYER
3′: SECOND ELECTRODE LAYER
4: ALIGNMENT LAYER
5: LIQUID CRYSTAL LAYER
6: COLOR FILTER (INCLUDING CASE WHERE COLORANT IS INCLUDED IN RESIN)
9: SUPPORTING SUBSTRATE
11: GATE ELECTRODE
12: GATE INSULATION FILM
13: SEMICONDUCTOR LAYER
14: PROTECTION LAYER
16: DRAIN ELECTRODE
17: SOURCE ELECTRODE
18: PASSIVATION FILM
21: PIXEL ELECTRODE
22: COMMON ELECTRODE
23, 25: INSULATION LAYER

1. A liquid crystal display device comprising:
a pair of substrates consisting of first and second substrates arranged to face each other;
a liquid crystal layer sandwiched between the first and second substrates;
a pixel electrode disposed on at least one of the first and second substrates:
a common electrode disposed on at least one of the first and second substrates;
a light source section including a light-emitting element; and
a photoconversion layer including pixels of three primary colors consisting of red (R), green (G), and blue (B), the photoconversion layer containing a light-emitting nanocrystal that has an emission spectrum of any of red (R), green (G), and blue (B) upon receiving light emitted from the light source section on at least one of the three primary colors,
the liquid crystal layer containing a liquid crystal composition containing a compound represented by General Formula (i) in an amount of 10% to 50% by mass, 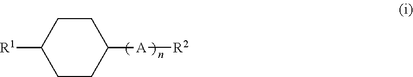
(in Formula (i), R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms; A represents a 1,4-phenylene group or a trans-1,4-cyclohexylene group; and n represents 0 or 1).

2. The liquid crystal display device according to claim 1, wherein the photoconversion layer includes a black matrix and contains a first light-emitting nanocrystal that absorbs blue light and emits red light and a second light-emitting nanocrystal that absorbs blue light and emits green light, and wherein the light source has an emission spectrum in a blue region.

3. The display device according to claim 2, wherein the light source section emits blue light, and wherein the photoconversion layer includes a blue pixel region forming a blue pixel, the blue pixel region being transmissive to the blue light.

4. The liquid crystal display device according to claim 1, wherein the photoconversion layer includes a black matrix and contains a third light-emitting nanocrystal that absorbs ultraviolet light and emits red light, a fourth light-emitting nanocrystal that absorbs ultraviolet light and emits green light, and a fifth light-emitting nanocrystal that absorbs ultraviolet light and emits blue light, and wherein the light source element has an emission spectrum in an ultraviolet region.

5. The liquid crystal display device according to claim 1, wherein the photoconversion layer is disposed on a substrate that faces the substrate disposed on a side on which the light source section is disposed.

6. The display device according to claim 1, further comprising at least one polarizing plate sandwiched between the first and second substrates.

7. The liquid crystal display device according to claim 1, wherein at least one emission spectrum of red (R), green (G), and blue (B) regions has a half-width of 20 to 50 nm.

8. The liquid crystal display device according to claim 1, wherein the light-emitting nanocrystal includes
a core containing at least one or two or more first semiconductor materials, and
a shell covering the core, the shell containing a second semiconductor material that is the same as or different from the semiconductor materials contained in the core.

9. The liquid crystal display device according to claim 8, wherein the first semiconductor material is one or two or more semiconductor materials selected from the group consisting of Group II-VI semiconductors, Group III-V semiconductors, Group I-III-VI semiconductors, Group IV semiconductors, and Group I-II-IV-VI semiconductors.

10. The liquid crystal display device according to claim 1, wherein the liquid crystal composition contains a compound represented by General Formula (N-1) in an amount of 20% to 80% by mass and having a dielectric anisotropy (Δε) of −1 or less, 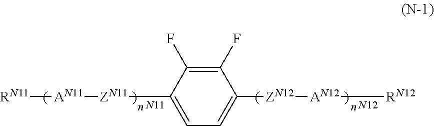
(in General Formula (N-1), R^{N11} and R^{N12} each independently represent an alkyl group having 1 to 8 carbon atoms and, in the alkyl group, one —CH₂— group or two or more —CH₂— groups that are not adjacent to one another may be each independently replaced with —CH═CH—, —C═C—, —O—, —CO—, —COO—, or —OCO—;
A^{N1} and A^{N2} each independently represent a group selected from the group consisting of
(a) a 1,4-cyclohexylene group (in this group, one —CH₂— group or two or more —CH₂— groups that are not adjacent to one another may be replaced with —O—),
(b) a 1,4-phenylene group (in this group, one —CH═ group or two or more —CH═ groups that are not adjacent to one another may be replaced with —N═),
(c) a naphthalene-2,6-diyl group, a 1,2,3,4-tetrahydronaphthalene-2,6-diyl group, or a decahydronaphthalene-2,6-diyl group (in the naphthalene-2,6-diyl group or the 1,2,3,4-tetrahydronaphthalene-2,6-diyl group, one —CH═ group or two or more —CH═ groups that are not adjacent to one another may be replaced with —N═), and
(d) a 1,4-cyclohexenylene group, and the group (a), the group (b), the group (c), and the group (d) may be each independently substituted with a cyano group, a fluorine atom, or a chlorine atom;
Z^{N11} and Z^{N12} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C═C—;
n^{N11} and n^{N12} each independently represent an integer of 0 to 3, and n^{N11}+n^{N12} is each independently 1, 2, or 3 and, when a plurality of the A^{N11}, A^{N12}, Z^{N11}, or Z^{N12} groups are present, they may be identical to or different from one another).

11. The liquid crystal display device according to claim 1, wherein the liquid crystal composition contains a compound represented by General Formula (J) in an amount of 5% to 60% by mass and having a dielectric anisotropy (As) of 1 or more, 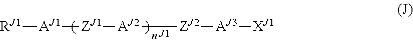
(in General Formula (J), R^{J1} represents an alkyl group having 1 to 8 carbon atoms and, in the alkyl group, one —CH₂— group or two or more —CH₂— groups that are not adjacent to one another may be each independently replaced with —CH═CH—, —C═C—, —O—, —CO—, —COO—, or —OCO—;
n^{J1} represents 0, 1, 2, 3, or 4;
A^{J1}, A^{J2}, and A^{J3} each independently represent a group selected from the group consisting of
(a) a 1,4-cyclohexylene group (in this group, one —CH₂— group or two or more —CH₂— groups that are not adjacent to one another may be replaced with —O—),
(b) a 1,4-phenylene group (in this group, one —CH═ group or two or more —CH═ groups that are not adjacent to one another may be replaced with —N═), and
(c) a naphthalene-2,6-diyl group, a 1,2,3,4-tetrahydronaphthalene-2,6-diyl group, or a decahydronaphthalene-2,6-diyl group (in the naphthalene-2,6-diyl group or the 1,2,3,4-tetrahydronaphthalene-2,6-diyl group, one —CH═ group or two or more —CH═ groups that are not adjacent to one another may be replaced with —N═), and the group (a), the group (b), and the group (c) may be each independently substituted with a cyano group, a fluorine atom, a chlorine atom, a methyl group, a trifluoromethyl group, or a trifluoromethoxy group;
Z^{J1} and Z^{J2} each independently represent a single bond, —CH₂CH₂—, —(CH₂)₄—, —OCH₂—, —CH₂O—, —OCF₂, —CF₂O—, —COO—, —OCO—, or —C═C—;
when n^{J1} is 2, 3, or 4 and a plurality of the A^{J2} groups are present, they may be identical to or different from one another, when n^{J1} is 2, 3, or 4 and a plurality of the Z^{J1} groups are present, they may be identical to or different from one another; and
X^{J1} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group).

12. The liquid crystal display device according to claim 1, wherein the liquid crystal composition contained in the liquid crystal layer has an Δn of 0.05 to 0.15.
